(19) United States
(12) Patent Application Publication
(10) Pub. No.: US 2008/0281727 A1
(43) Pub. Date: Nov. 13, 2008

(54) Method of applying to purchase or lease a unit in a multiunit building or building complex

(76) Inventor: Christopher J. Moss, New York, NY (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/079,918

(22) Filed: Mar. 28, 2008

Related U.S. Application Data
(60) Provisional application No. 60/909,220, filed on Mar. 30, 2007.

(51) Int. Cl. G06Q 10/00; G06Q 30/00

(52) U.S. Cl. 705/27; 705/26; 705/1

(57) ABSTRACT

A computer-implemented method is provided for applying to purchase or lease a unit in a multiunit building or building complex. An administration computer is provided for hosting a plurality of electronic applications for purchase or lease of a unit in a multiunit building or building complex, hosting one or more contributors, and hosting a plurality of reviewers. Each electronic application includes one or more electronic documents that are useful for evaluating factors relevant to an applicant's potential purchase or lease of the unit. The one or more contributors and the plurality of reviewers interact with an electronic application via an electronic network. The one or more contributors contribute to the one or more electronic documents of the electronic application so as to produce the electronic application. The plurality of reviewers access the one or more electronic documents of the electronic application so as to review the electronic documents and decide whether to accept the application.

### CROSS-REFERENCE TO RELATED APPLICATIONS

This application claims the benefit of U.S. Provisional Application No. 60/909,220 filed Mar. 30, 2007.

### BACKGROUND OF THE INVENTION

In certain jurisdictions, such as New York, potential buyers or lessors of co-ops and condominiums must apply to a co-op or condo Board and receive Board approval before a sale or lease can be completed. The conventional process is to assemble a “board package” or “application package” of the necessary documents that the Board wishes to review in making its decision. The types of documents that are typically requested include, but are not limited to, the following documents:

Contract or proposed sublease

Basic “application form” for applicant

Mortgage loan application and commitment

Lien search

Authorizations to verify credit records, banking records and employment history, and to contact previous landlords and the like

Previous two years of income tax returns with supporting documentation (e.g., W-2's)

Net worth statements

Personal and/or Business letters of reference (recommendation)

Payment for application fee and credit check

These documents are typically manually assembled by the Broker of the potential purchase (or directly by the potential purchaser) into a physical package of papers. A paper copy of the package is then made for each of the Board members. An original of the documents and the copies are then delivered to the Board members for their review. After review, security concerns arise because Board members may not have ready access to paper shredders or other means to securely dispose of their copy of the package which contains a wealth of personal information about the applicants.

There is an unmet need for a fully automated process to manage some or all of the entire document assembly process and to reduce the need for handling and printing out paper at all stages of the application process.

### BRIEF SUMMARY OF THE INVENTION

A computer-implemented method is provided for applying to purchase or lease a unit in a multiunit building or building complex. An administration computer is provided for hosting a plurality of electronic applications for purchase or lease of a unit in a multiunit building or building complex, hosting one or more contributors, and hosting a plurality of reviewers. Each electronic application includes one or more electronic documents that are useful for evaluating factors relevant to an applicant's potential purchase or lease of the unit. The one or more contributors and the plurality of reviewers interact with an electronic application via an electronic network. The one or more contributors contribute to the one or more electronic documents of the electronic application so as to produce the electronic application. The plurality of reviewers access the one or more electronic documents of the electronic application so as to review the electronic documents and decide whether to accept the application.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. That is, each of the figures shows one preferred embodiment. It should be understood, however, that the invention is not limited to the precise arrangements and instrumentalities shown.

In the drawings:

FIG. 1 is an overview that displays the entire process.

FIG. 2 is a table showing the results of the profile target audience questionnaire.

FIG. 3 is a table showing the Feature Comparison Matrix.

FIGS. 4A and 4B, taken together, is a table showing the System Workflow Listing

FIGS. 5-27 are workflow diagrams.

FIG. 28 is a table that describes standard buttons and icons that appear throughout the

FIG. 29 is a wireframe model showing how the various frames compose the complete web page.

FIG. 30 is an image of how one of the pages appear on the site.

FIG. 31 shows an action bar.

FIG. 32 represents Quick Links.

FIG. 33 is an alternative set of Quick Links for the Login window and for use during the Recover Forgotten Password, Register via Invitation and Self-Registration workflows.

FIGS. 34-135 show application screens and functionalities of selections that can be made via application screens.

FIGS. 136-263 show user interface display screens.

FIGS. 264-268 show sample reports.

FIG. 269 shows the data model for the application.

FIG. 270 shows a table of favorable attributes.

FIG. 271 is a listing of various scenarios.

FIG. 272 is a listing of document names.

FIGS. 273A-276G show various business scenarios.

FIG. 277 is a schematic block diagram of one preferred architecture.

### DETAILED DESCRIPTION OF THE INVENTION

Certain terminology is used herein for convenience only and is not to be taken as a limitation on the present invention.

### I. DEFINITIONS

The following definitions and explanations are provided to promote understanding of the present invention.

administration computer: a computer or processor that administers the application process. The administration computer may be a single computer or a network of computers, such as a server or network of servers.
electronic document: an “electronic document” means any computer data (other than programs or system files) that are intended to be used in their computerized form, without being printed (although printing is usually possible). An “electronic document” includes an electronic representation (bits and bytes) of a paper document encoded in some machine processable form, such as ASCII, page description language (e.g., PDF, PCL, PostScript), markup language (e.g., HTML), MS Word, TIFF. An “electronic document” further includes “web forms.” A web form is a standard interface that can be downloaded from the Internet. A web form contains text boxes for a user to enter data. Users can then submit the form (e.g., a report) to the receiver.
electronic application: an electronic representation of an application. The electronic application defined herein includes one or more electronic documents. When referring to a co-op or condo purchase application, the electronic application is an electronic representation of the conventional paper-based “application package” that is provided to Board members of the co-op or condo. This application package is also sometimes referred to as a “board package.”
contributor: an entity that contributes to an electronic application. A contributor makes one or more of the following contributions to the one or more electronic document of an electronic application:

i. add a new electronic document

ii. edit content to an existing electronic document or application

iii. review an existing electronic document or application

iv. comment on an existing electronic document or application, such as by posting a message on a message board or making comments directly in the electronic document or electronic application

v. approve an existing electronic document

vi. act on a step or process of the application

A contributor is typically a person, but some contributors could be electronic entities, such as a credit service that receives a credit report request and automatically returns a credit report that flows into the electronic application, or a lien service that receives a request to provide a lien search and automatically returns a lien search report that flows into the electronic application.
collaborator: an entity that works together with one or more other entities. In the context of the present invention, there are collaborators on the application creation side, and collaborators on the application review side. Most of the contributors in the present application are also collaborators. However, some contributors are not collaborators in the strict sense of the word because they are merely asked to contribute information and do not collaborate with other contributors when providing their information.
finished electronic application: a finished electronic application is an electronic application that is ready for review by reviewers. Typically, one of the contributors has the authority to designate the electronic application as being “finished” (that is, no more contributions are to be made to the document) and ready to be given to reviewers. The reviewers may decide that the electronic application is not ready for review and may send back the electronic document for further contributions, thereby designating the electronic application as being unfinished.
completed electronic document: an electronic document is considered as being “completed” when it conforms to a set of predetermined parameters for the document. The parameters may include fields that must be completed (i.e., mandatory fields), field values that must conform to certain types of data (e.g., all numbers, all letters), field value ranges, and the like.
reviewer: an entity that reviews an electronic application so as to decide whether to accept an application. A Board member is one type of reviewer. The reviewers typically work collaboratively. The role of some reviewers is limited to providing input regarding the quality of the electronic application, whereas the role of other reviewer(s) is to decide whether or not to accept the electronic application (here, acceptance allows the applicant to purchase or lease the unit being applied for).
A reviewer is typically a person, but some reviewers could be electronic entities that automatically evaluate one or more of the electronic documents or the contents thereof, and automatically return a report that contains the evaluation.
A reviewer typically reviews only finished applications, but may review applications that are in an unfinished state.
invitation: One or more of the contributors may “invite” one or more of the other contributors to contribute to the electronic application. If the other contributor is already registered in the administration computer, the inviting contributor merely has to indicate to the administration computer to allow the other contributor to obtain access to the electronic application. If the other contributor is not already registered in the administration computer, contact information regarding the other contributor may be entered in and the other contributor is notified, such as by email, that access rights have been established.
cooperative (co-op): A type of multiple ownership in which the owners of a multiunit housing, multiunit complex, or commercial complex own shares in the cooperative corporation that owns the property, giving each owner the right to occupy or use a specific apartment or unit of the property.
condominium: A type of ownership in real property where all of the owners own the property, common areas and buildings together, with the exception of the interior of the unit to which they have title.

### II. OVERVIEW OF DISCLOSURE

The present invention is described in the context of a preferred embodiment of a web-based software application provided by Moss Real Estate Group, Inc. for co-op or condo applications. However, the scope of the present invention is not limited to this particular implementation of the invention. Furthermore, the scope of the present invention is not limited to co-op and condo applications and includes other types of real property or interests in property, such as applications for rental units, or applications to purchase or lease other types real property or interests in property, wherein a management entity associated with the real property has the legal right to refuse an applicant.

The present invention is described in the context of a plurality of distributed computers, all of which are linked together by an electronic network, such as the Internet. The computers may be any type of computing device that allows a user to interact with a web site via a web browser. For example, the computers may be personal computers (PC) that run a Microsoft Windows® operating system. The computers may also be handheld, wireless devices.

### III. DETAILED DISCLOSURE

A Specification Document that provides one preferred embodiment of the present invention is set forth below.

### 1. Overview

The Application Process described herein provides a means of streamlining and reducing the paper used in the process of submitting and processing applications for condominiums and cooperatives. This process is currently handled in a different fashion by each building and is highly paper intensive.

Organizational Overview: This section displays a high level diagram of the entire system and highlights the relevant sections for this Specification Document.

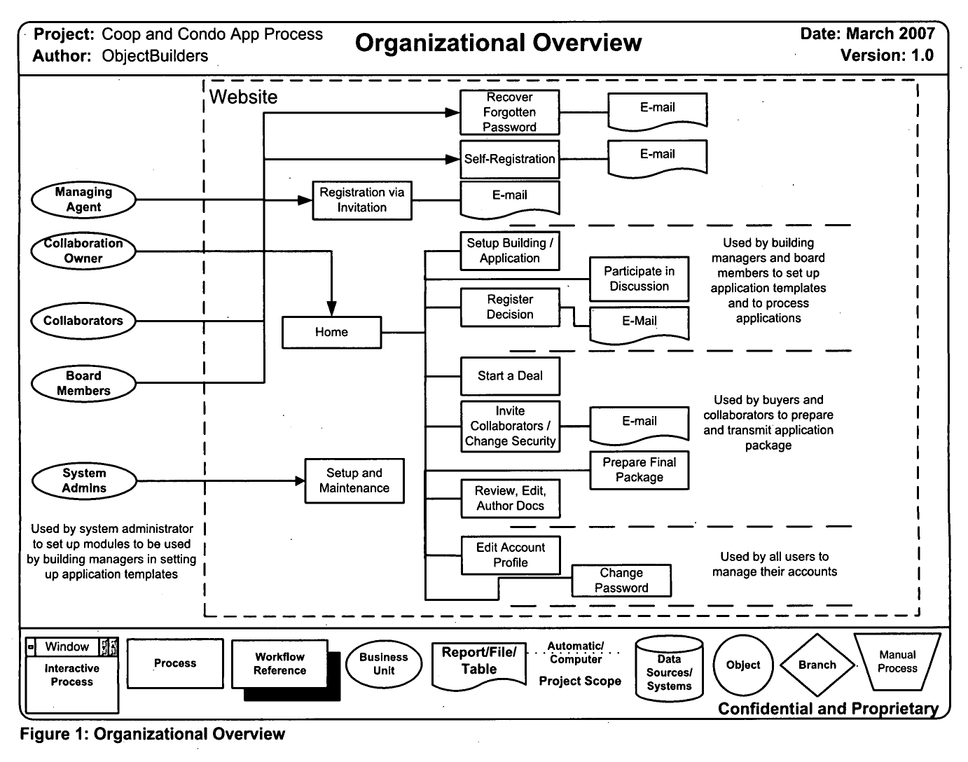

FIG. 1 is an overview that displays the entire process.

### 2. Questionnaire

2a. Profiling Target Audience Questionnaire

A questionnaire is used to profile the target audience. Individual interviews are used if required. The questionnaire used contains at least the following questions:
Q1: Do you have access to a computer? Yes or No
   If Yes: Are you able to look at web sites on the internet? Yes or No
      The following questions are only for those who have access to the internet through a computer.
Q2: How often do you use the internet? Times Per Day, Week, Month,
Q3: Do you know what Adobe PDF reader is? Yes or No
   If, Yes: Do you have Adobe PDF reader installed on your computer?
Q4: Do you have an e-mail address? Yes or No
Q5: Do you do your banking online? Yes or No
   If Yes, what products or sites do you use. List only the top 2 or 3:
Q6: Do you do shopping online? Yes or No

If Yes, what products or sites do you use. List only the top 2 or 3:
Q7. What operating system do you use on your computer? (Examples are Microsoft Windows, Apple Macintosh, and Linux.)
Q8. What browser do you use on your computer? (Examples are Microsoft Internet Explorer, Apple Safari, Firefox, and Opera.) If you use multiple browsers, list the one you use the most.
Q9. Do you have a high-speed internet connection? (Examples include cable modems, DSL, and connection through ethernet networks.)
   2b. Profiling Target Audience Questionnaire Results

The target audience can be divided into the following categories.
a. Residents and potential residents of cooperatives and condominiums
b. Members of the boards of cooperatives and condominiums
c. Real estate agents and brokers

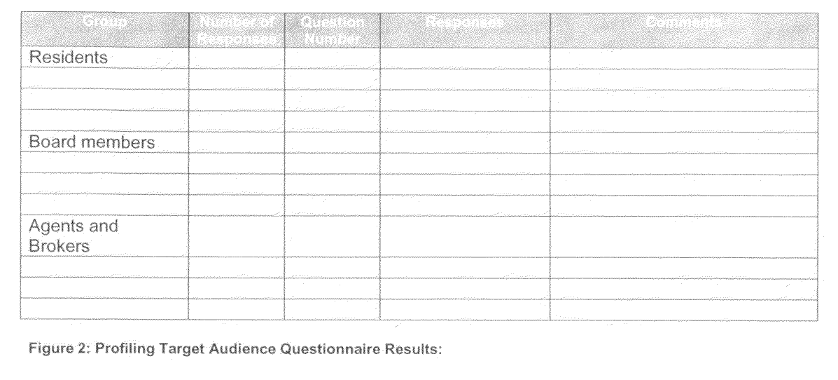

FIG. 2 is a table showing the results of the profile target audience questionnaire.

### 3. Product and Web Site Analysis

3a. This Specification

This application enables the parties involved in the application for a condominium or cooperative to electronically store and share the various documents related to the application process. Since the system allows organizations representing the properties to configure their own application templates, it allows each building to customize the application process for their own situation.

3b. Apartment Management Companies

There are a number of sites where apartment buildings use forms that can be completed on-line to allow users to apply for apartment rentals. However, these sites appear to be able to handle only a single application from a single user rather than handling complex application agreements requiring the involvement of multiple parties to handle multiple documents. Furthermore, these sites involve only a single property or properties being handled by a single management company. Some examples of these sites are listed below.
a. http://WorldWideWeb.regency-tower.com/application.html
b. http://WorldWideWeb.singhweb.com/apartments/online_application.asp
c. http://WorldWideWebjsmproperties.com/ma_online_ap.html
d. http://WorldWideWeb.lifestylepropertiesithaca.com/rentalApplication.html
   3c. Listing Services

There are a number of web sites that provide listings of properties for rent and sale. In addition to the Multiple Listing Services maintained by the real estate brokers in many areas, there are a number of companies that provide listings of properties on their web sites. However, these sites appear to only provide contact information for the management companies handling the properties rather than facilitating the information transfer themselves. Some examples of these sites are listed below.
a. http://WorldWideWeb.apartmentcities.com
b. http://WorldWideWeb.apartmentlinks.com
   3d. Feature Comparison Matrix

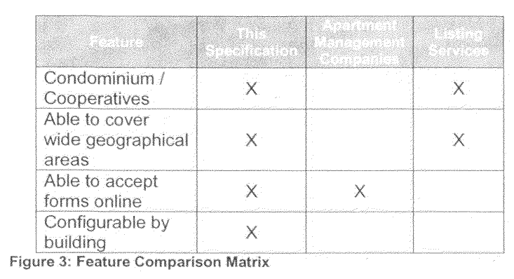

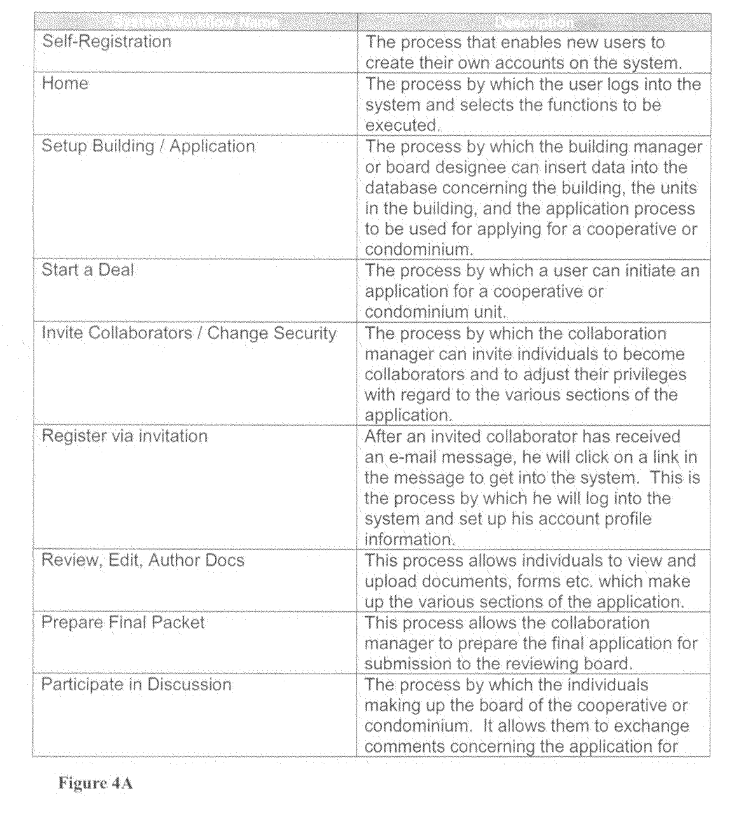

FIG. 3 is a table showing the Feature Comparison Matrix.

### 4. System Workflow

Each of the above blocks is drilled down in this section as a system workflow.

4a. System Workflow Listing

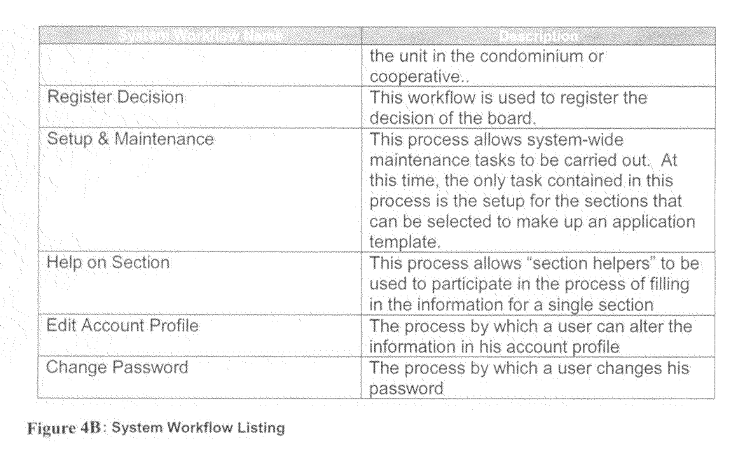

FIGS. 4A and 4B, taken together, is a table showing the System Workflow Listing

4b. System Workflows

4b1. Self-Registration

Users are able to create their own accounts using this process. After he/she (hereafter, “he”) completes the screens, he is sent an e-mail containing his password and information on connecting to the system. This enables the system to verify that the e-mail address used to log on to the system actually belongs to the user.

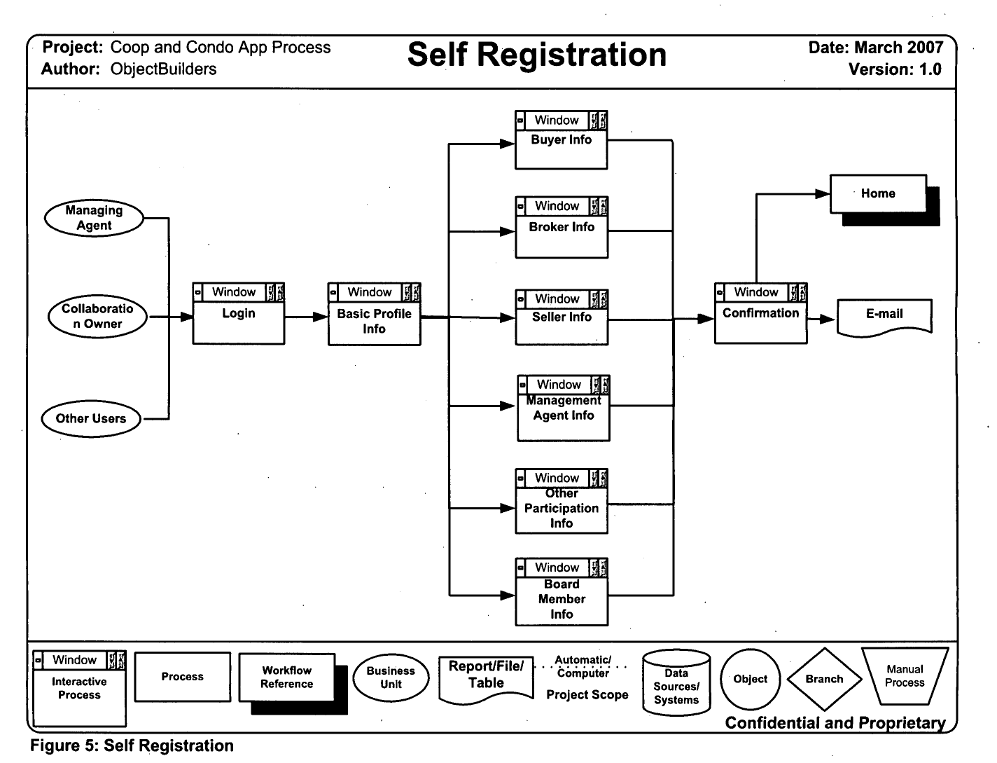

FIG. 5 is a workflow diagram of the Self Registration Workflow Process.

4b2. Home

This workflow represents the login process for the various users. After logging in with a user id and password, a screen is presented which displays the applications with which the user is associated and allows the user to create a new application or carry out one of a set of actions with respect to the application.

If the user has forgotten his password, there is a link on the initial page that initiates a process for recovering his password.

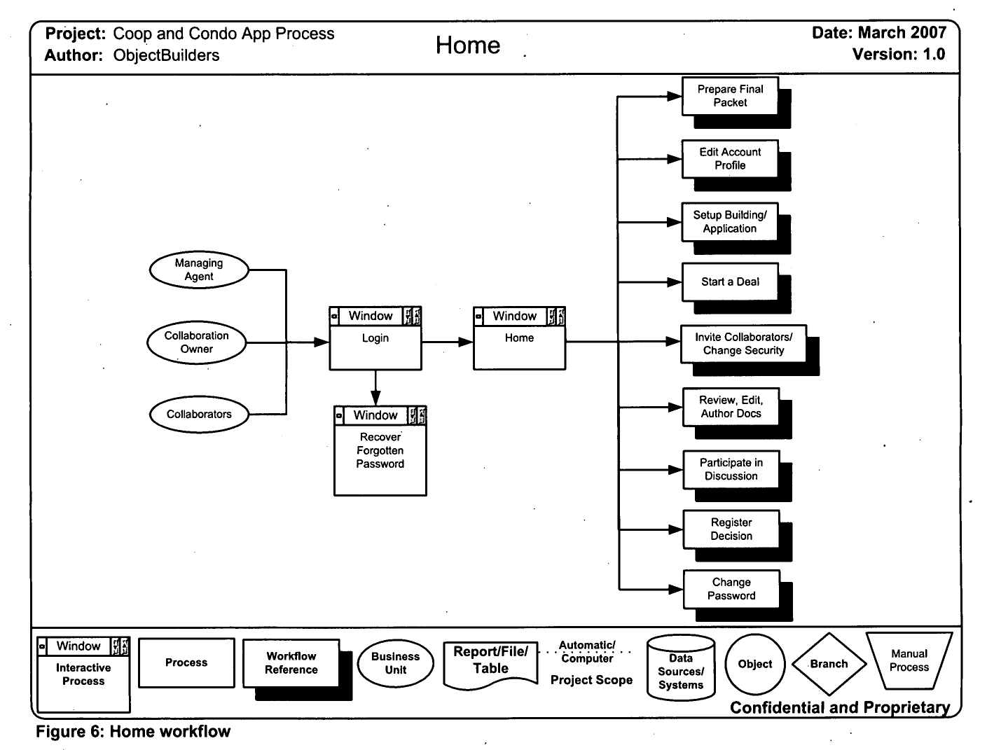

FIG. 6 is a workflow diagram of the Home Workflow Process.

4b3. Setup Building/Application

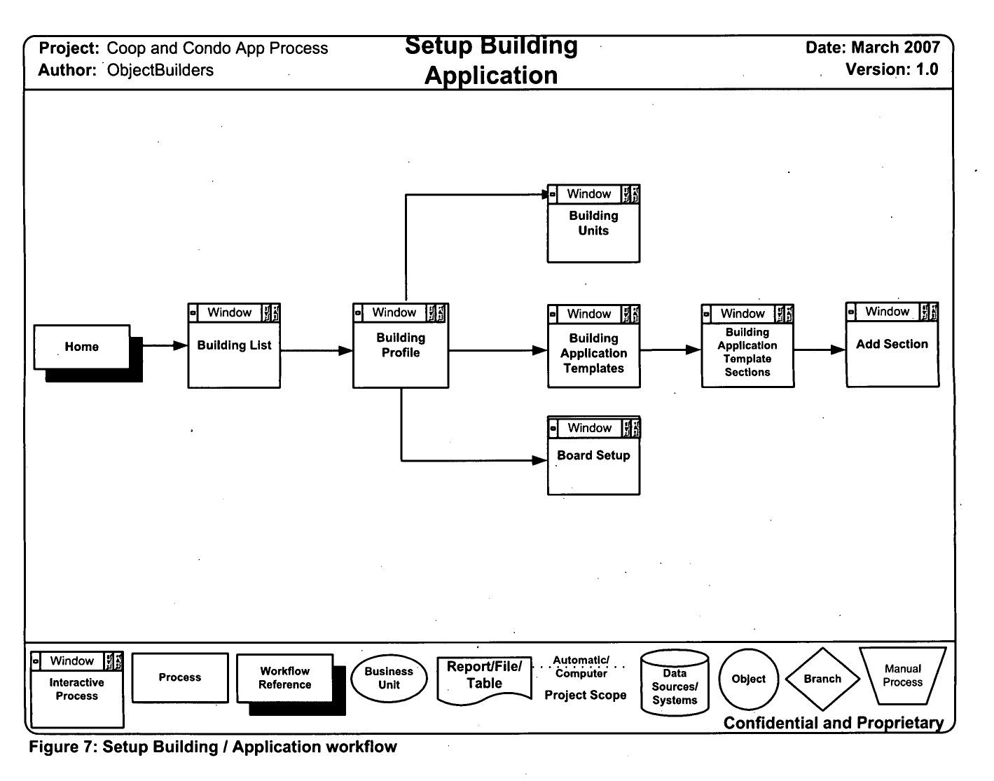

FIG. 7 is a workflow diagram of the Setup Building/Application Workflow Process.

4b4. Start a Deal

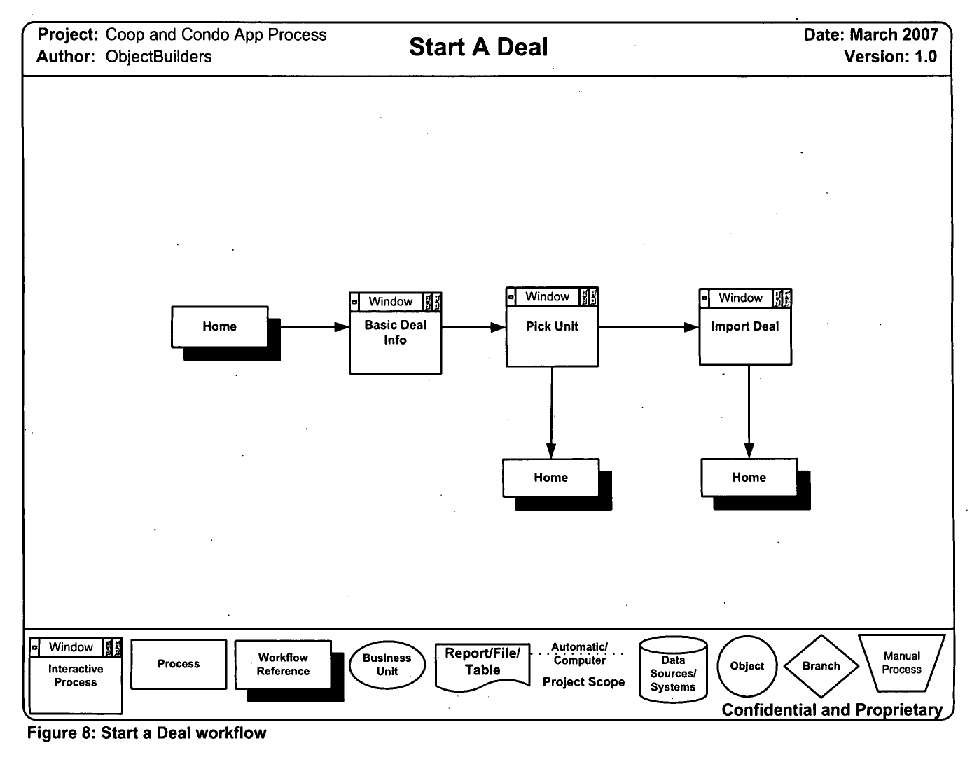

FIG. 8 is a workflow diagram of the Start a Deal Workflow Process.

4b5. Invite Collaborators/Change Security

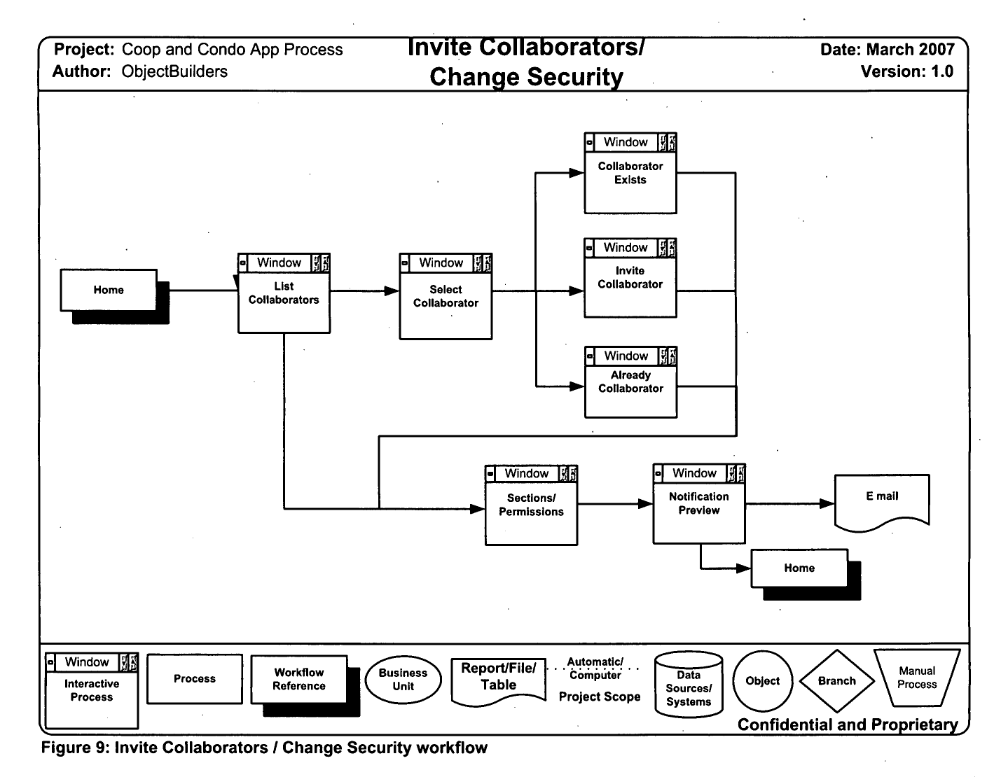

FIG. 9 is a workflow diagram of the Invite Collaborators/Change Security Workflow Process.

4b6. Register via Invitation

For this workflow, the user has received an invitation via e-mail which contains a link to log onto the system. When the recipient clicks on the e-mail via the link, he is presented with a screen that collects information for insertion into the database.

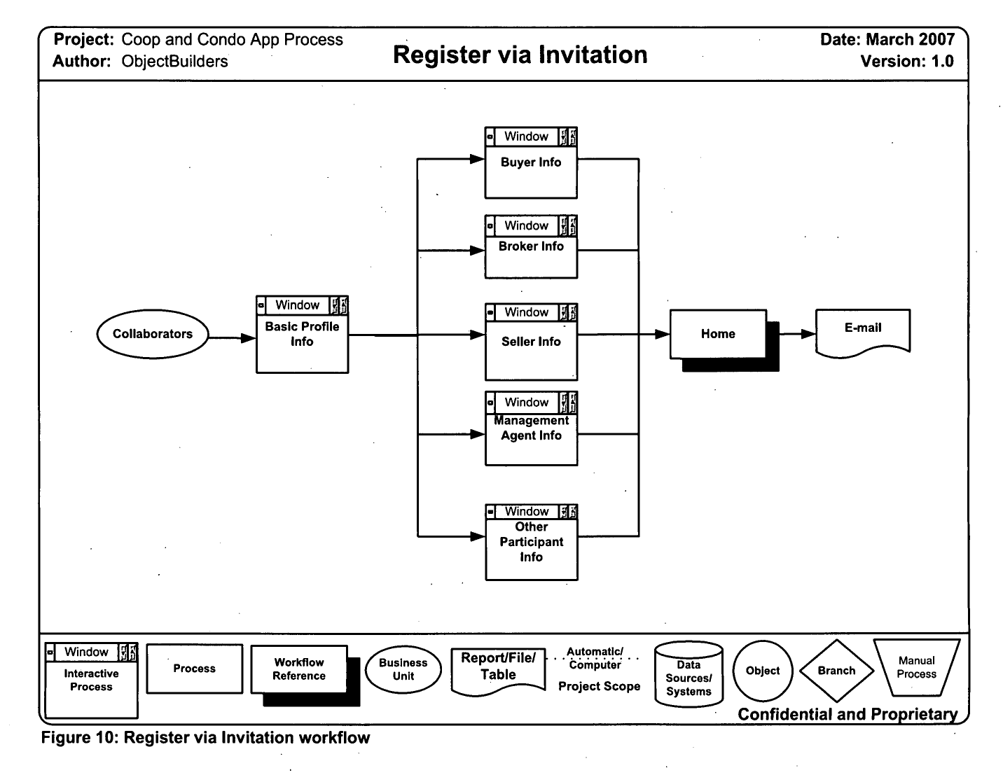

FIG. 10 is a workflow diagram of the Register via Invitation Workflow Process.

4b7. Review, Edit, Author Docs

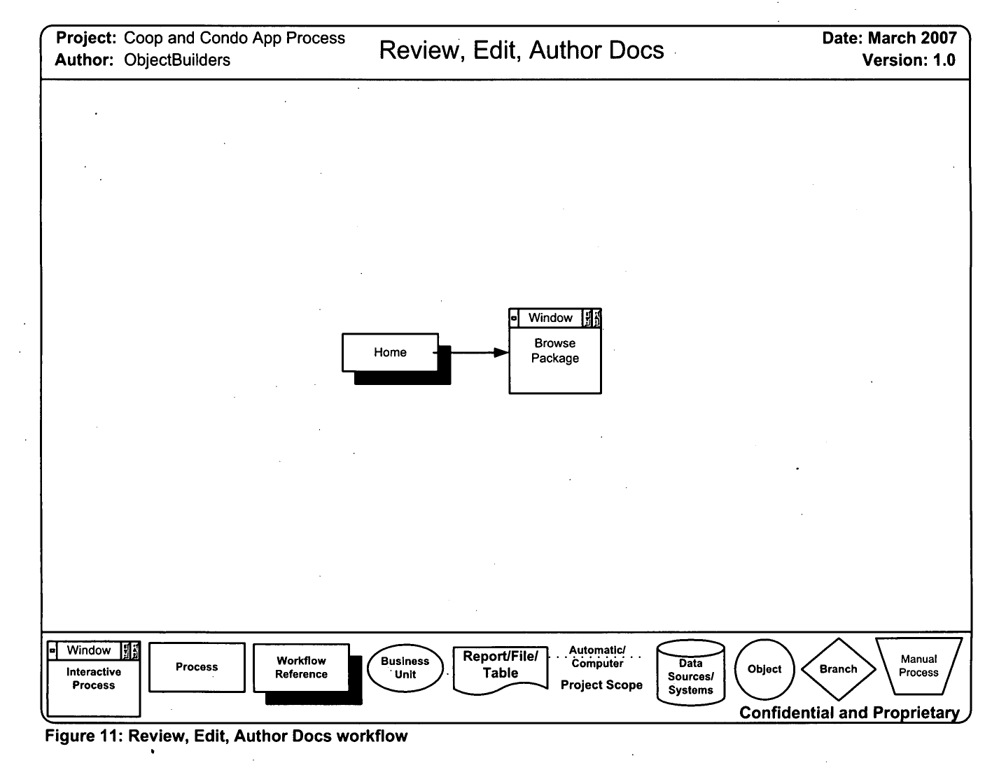

FIG. 11 is a workflow diagram of the Review, Edit, Author Docs Workflow Process.

4b8. Prepare Final Packet

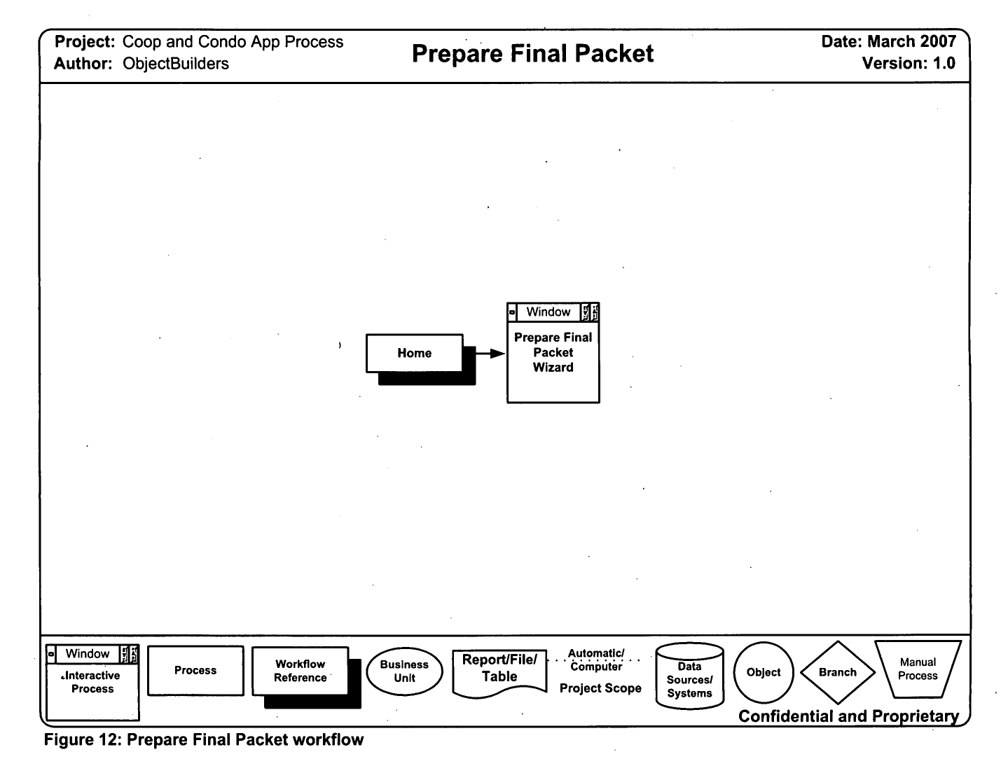

FIG. 12 is a workflow diagram of the Prepare Final Packet Workflow Process.

4b9. Participate in Discussion

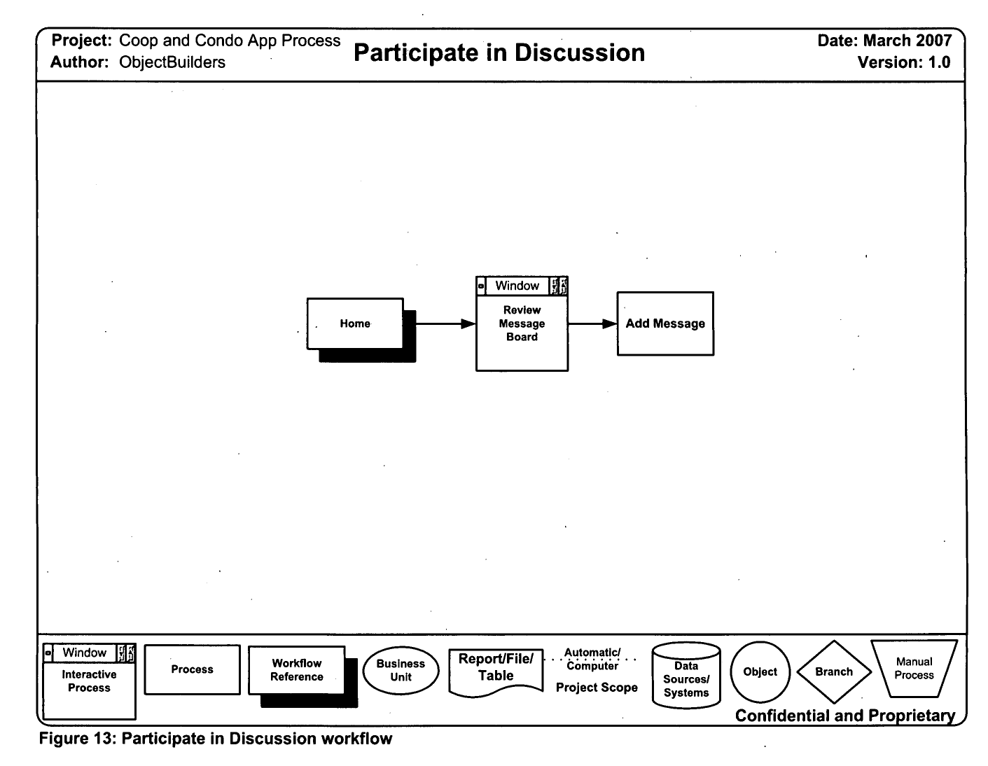

FIG. 13 is a workflow diagram of the Participate in Discussion Workflow Process.

4b10. Register Decision

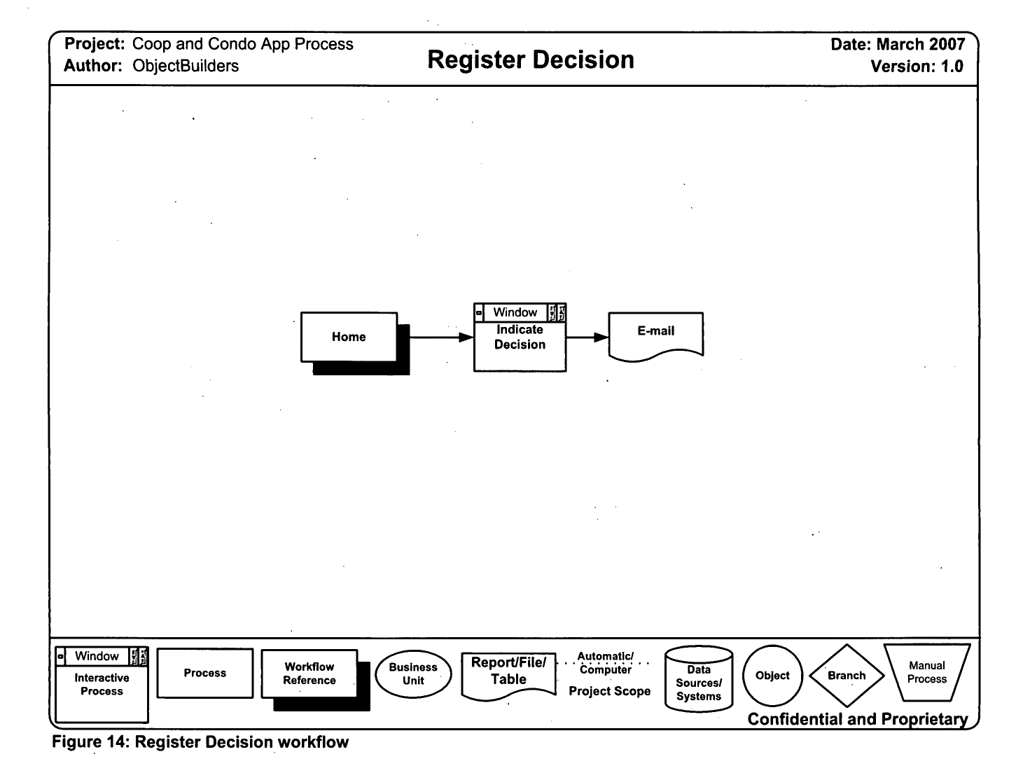

FIG. 14 is a workflow diagram of the Register Decision Workflow Process.

4b11. Setup & Maintenance

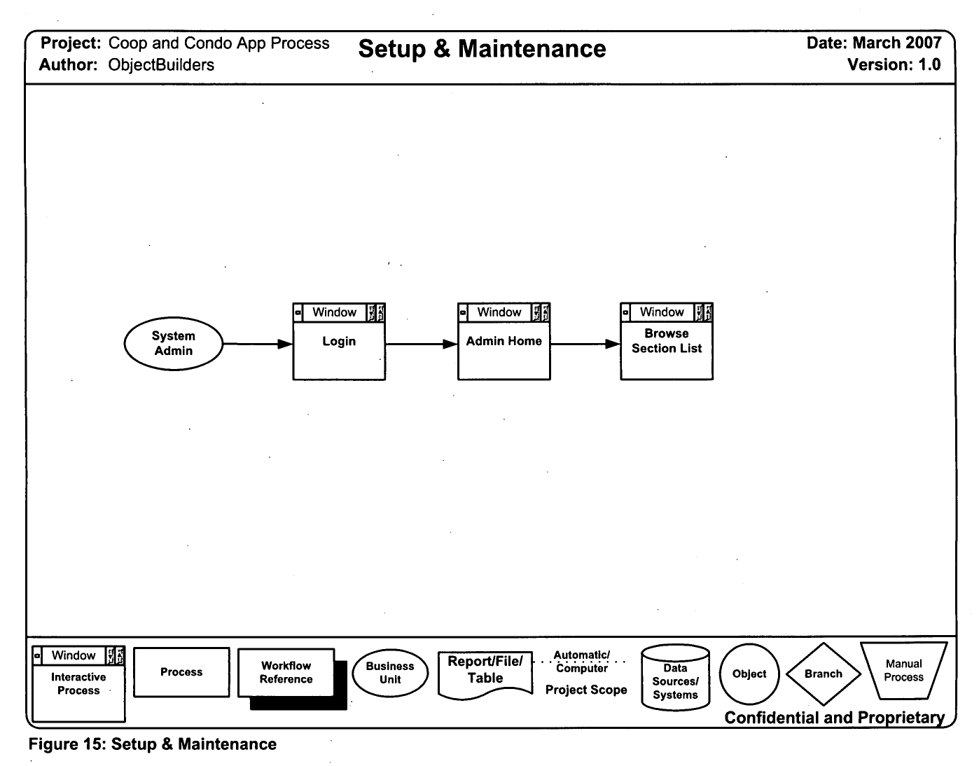

FIG. 15 is a workflow diagram of the Setup & Maintenance Workflow Process.

4b12. Help on Section

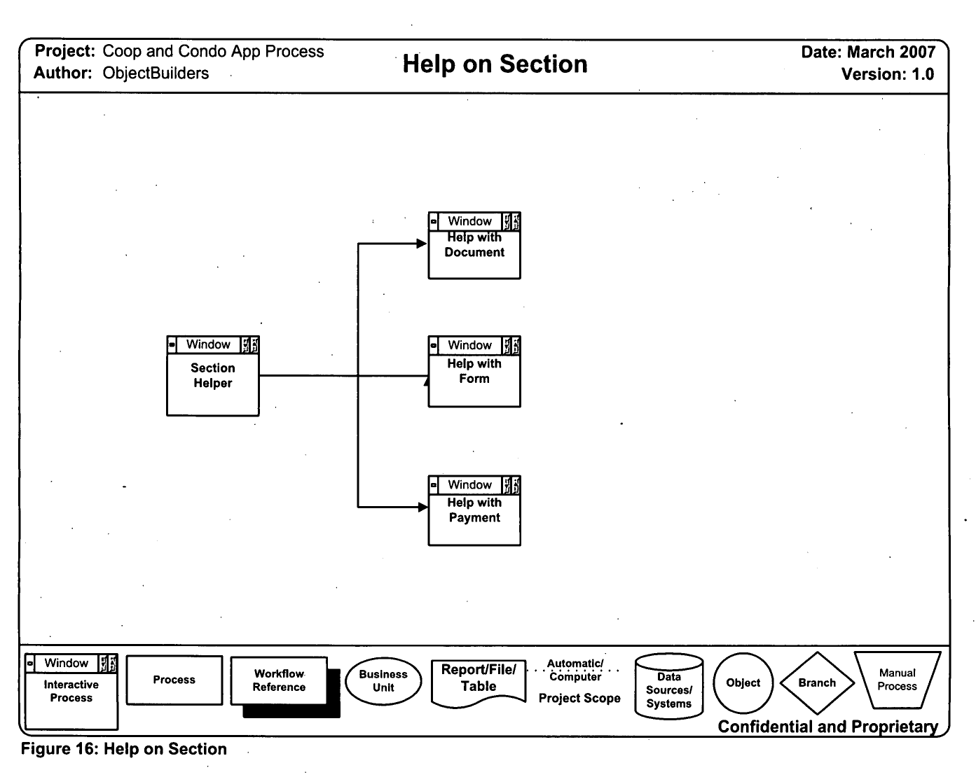

FIG. 16 is a workflow diagram of the Help on Section Process.

4b13. Edit Account Profile

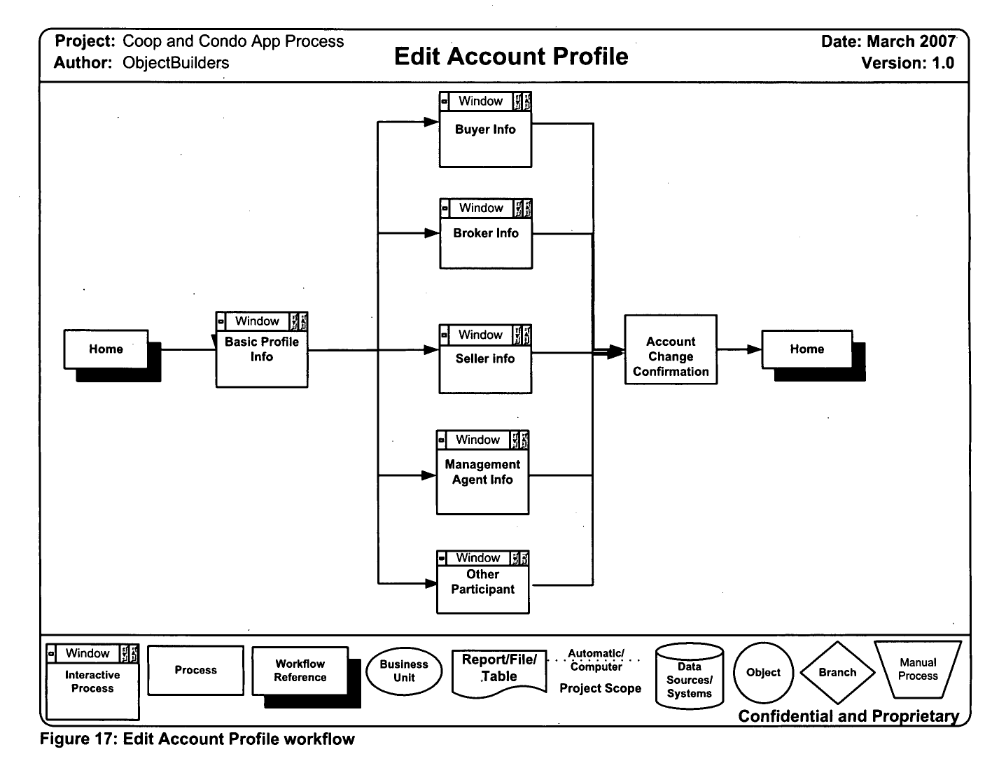

FIG. 17 is a workflow diagram of the Edit Account Profile Workflow Process.

4b14. Change Password

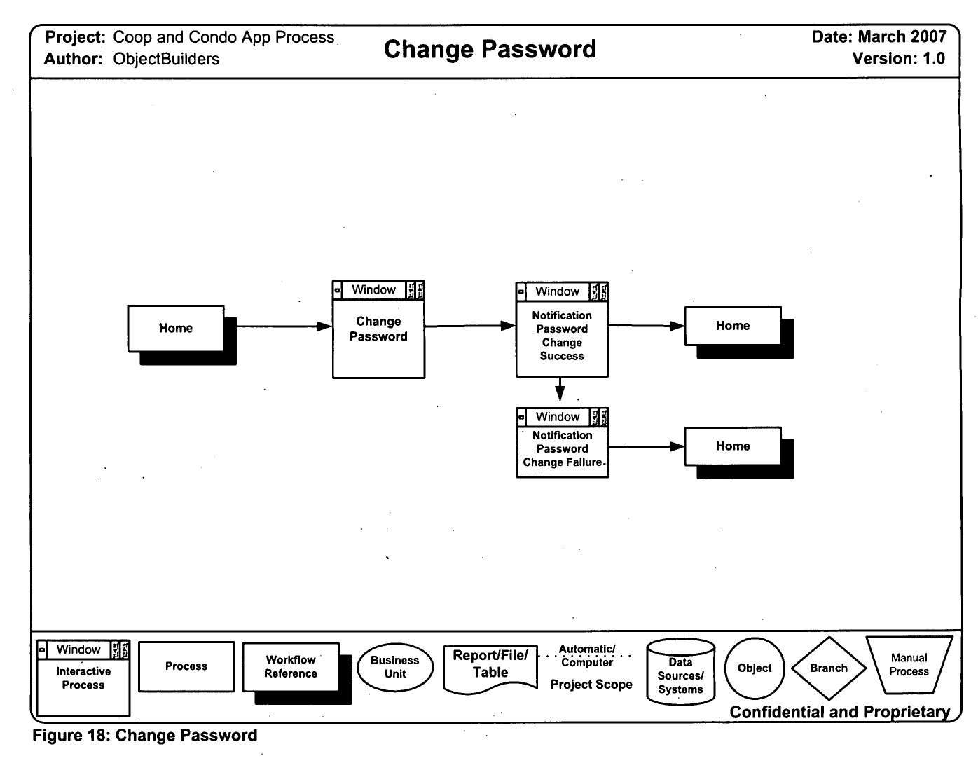

FIG. 18 is a workflow diagram of the Change Password Workflow Process.

4c. Detailed System Workflows

Because of the nature of this application, there are actually several major workflows in this system: describing the buildings and units, construction of the layouts of the applications, the actions of the buyer, and the actions of the board in reviewing the application. Detailed workflows are provided for each one of these fundamental system functions.

4c1. Detailed System Workflow—Building Configuration

This workflow covers the actions of the building manager in setting up the configuration information for the building. This includes the description of the building, the building units, the application templates, and the information on the board members.

Because of the size of this workflow, it is split into four figures, with connectors indicating the links between the figures.

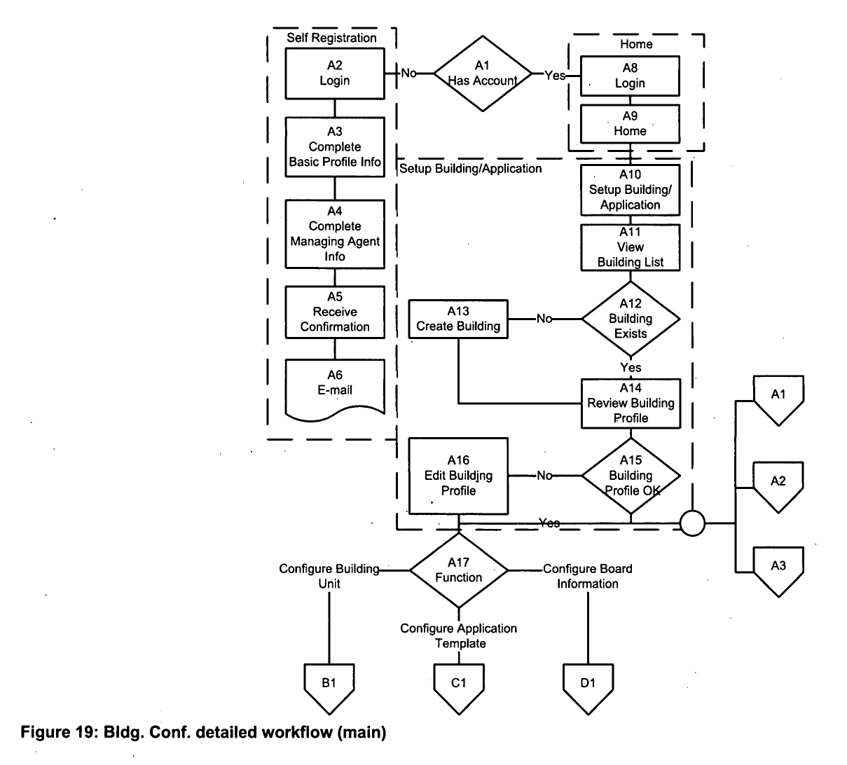

FIG. 19 is a workflow diagram of the Bldg. Conf. detailed workflow (Main) Process. All of the items on this detailed workflow take place using the Building Units window.

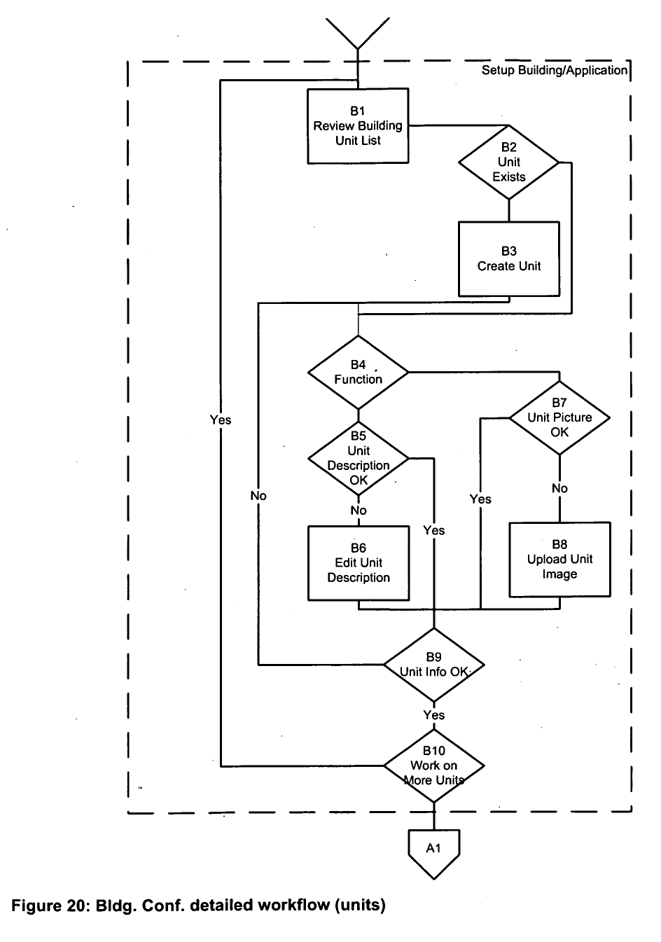

FIG. 20 is a workflow diagram of the Bldg. Conf. detailed workflow (units) Process.

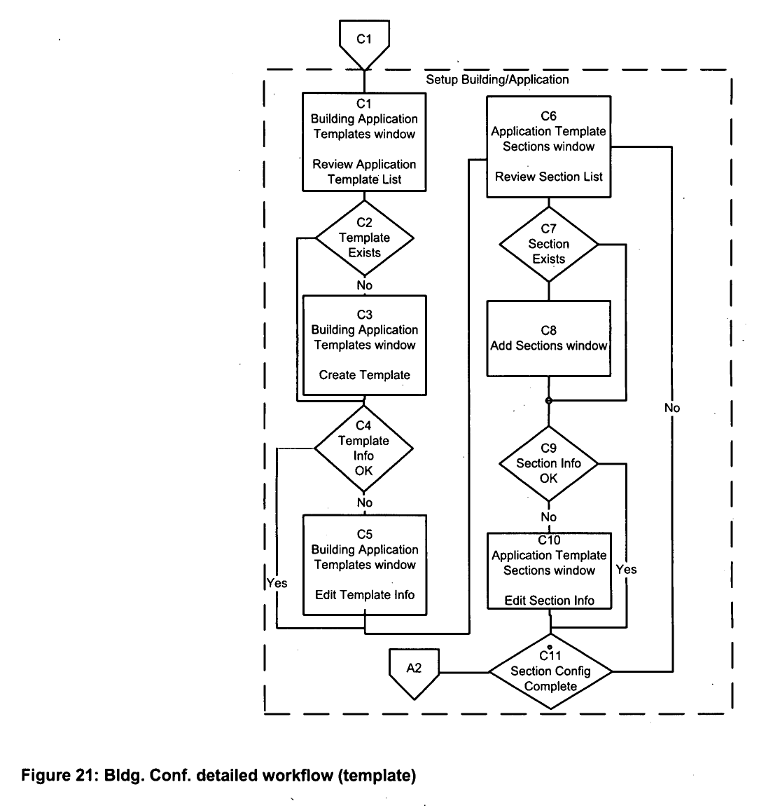

FIG. 21 is a workflow diagram of the Bldg. Conf. detailed workflow (Template) Process. All of the items on this portion of the detailed workflow take place using the Board Setup window.

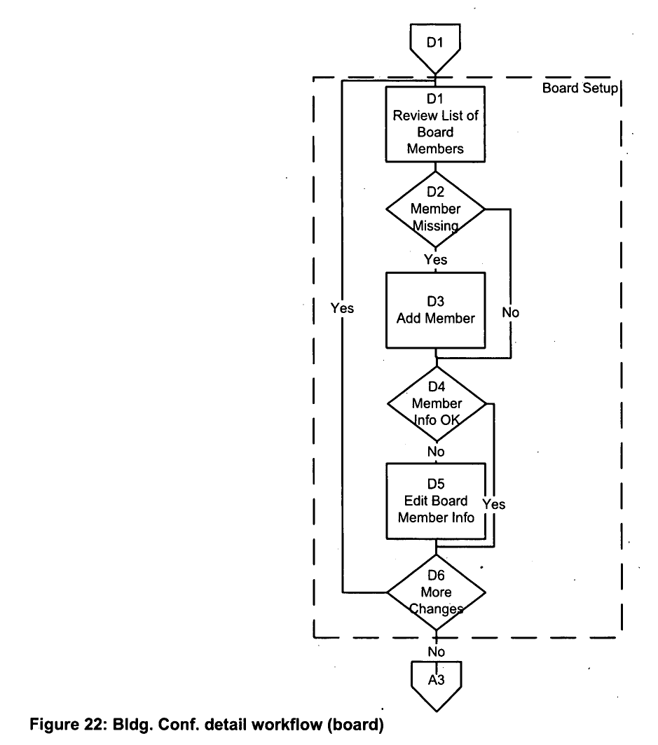

FIG. 22 is a workflow diagram of the Bldg, Conf. detailed workflow (board) Process.

4c2. Detailed System Workflow—Setup & Maintenance

All of the actions described within this detailed workflow, except for Login (E1) and Admin Home (E2), take place on the Browse Section List window.

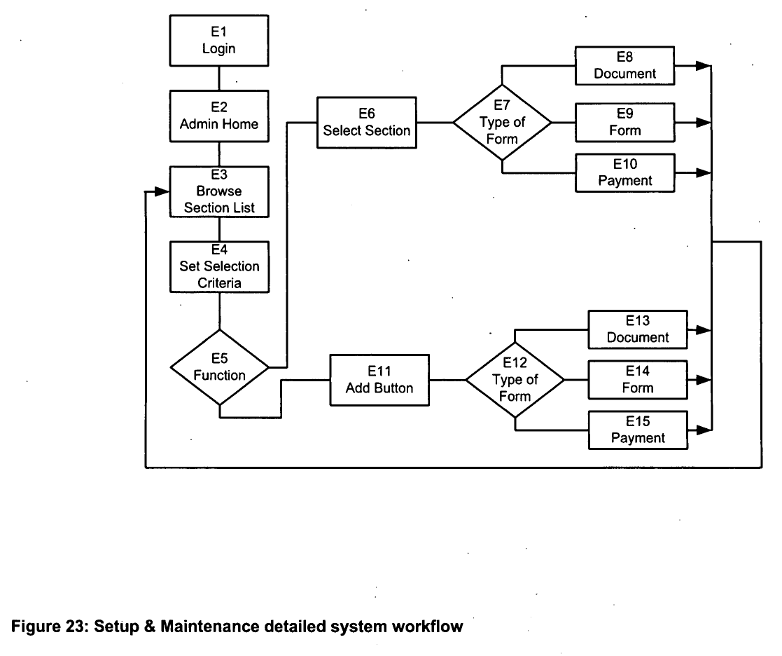

FIG. 23 is a workflow diagram of the Setup & Maintenance detailed system workflow Process.

4c3. Detailed System Workflow—Working on Application

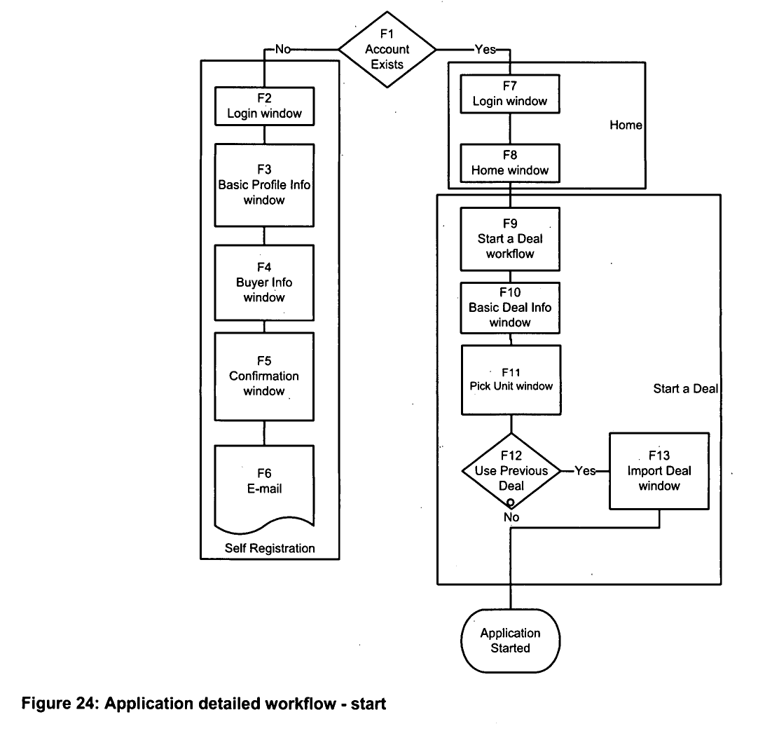

FIG. 24 is a workflow diagram of the Application detailed workflow—start Process.

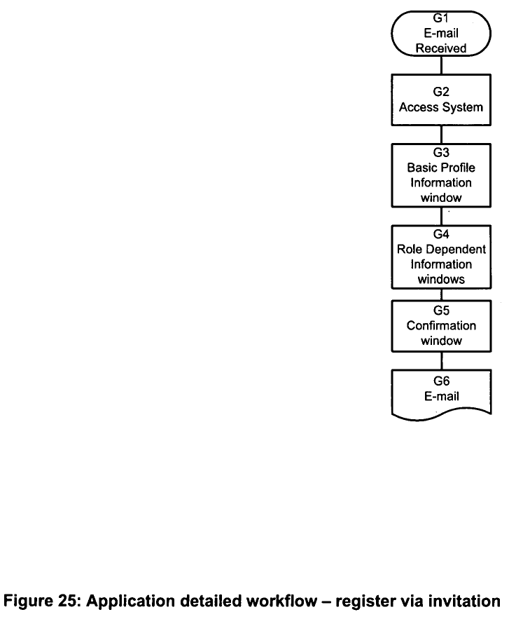

FIG. 25 is a workflow diagram of the Application detailed workflow—register via invitation.

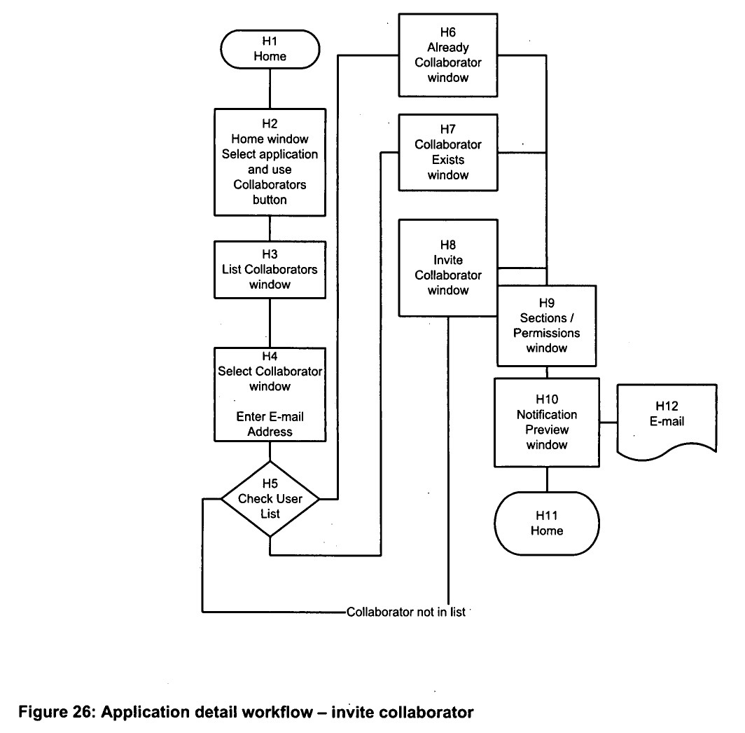

FIG. 26 is a workflow diagram of the Application detailed workflow—invite collaborator.

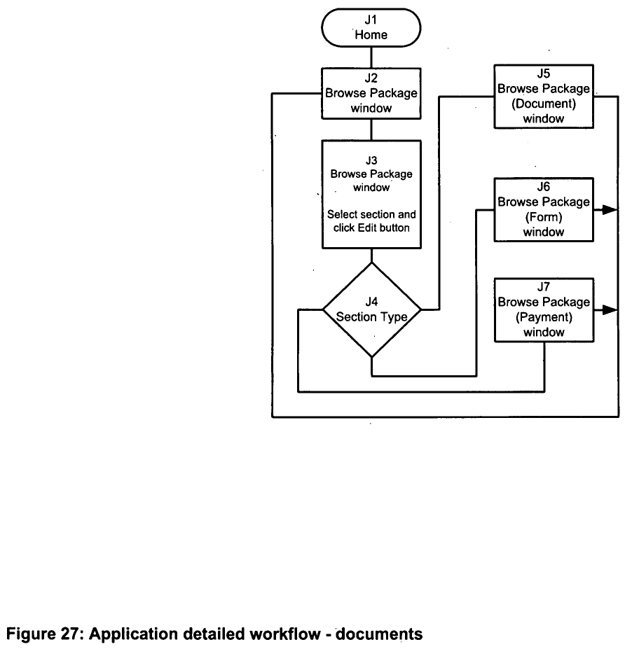

FIG. 27 is a workflow diagram of the Application detailed workflow—documents.

### 5. Screens

This section shows all screens in the application.

Note: All search fields perform a “Begins With” style of search, unless otherwise noted.
5a. Standard Buttons

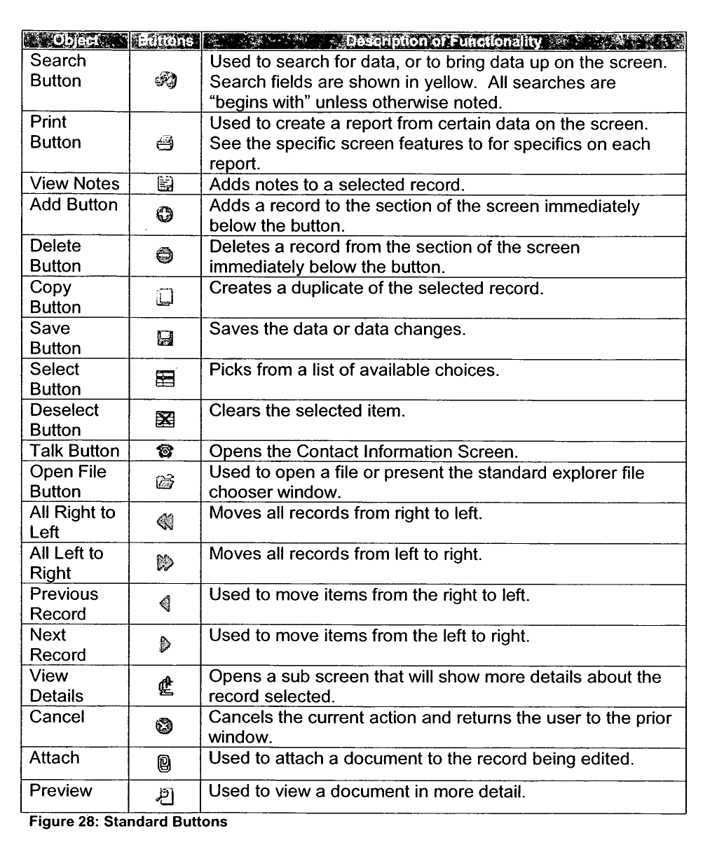

FIG. 28 is a table that describes standard buttons and icons that appear throughout the application screens.

5b. Overall Screen Layout

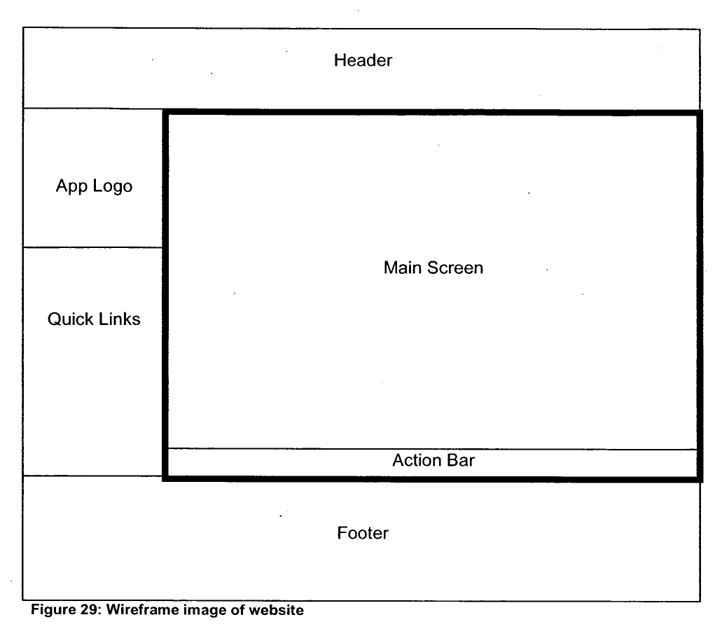

FIG. 29 is a wireframe model showing how the various frames compose the complete web page.

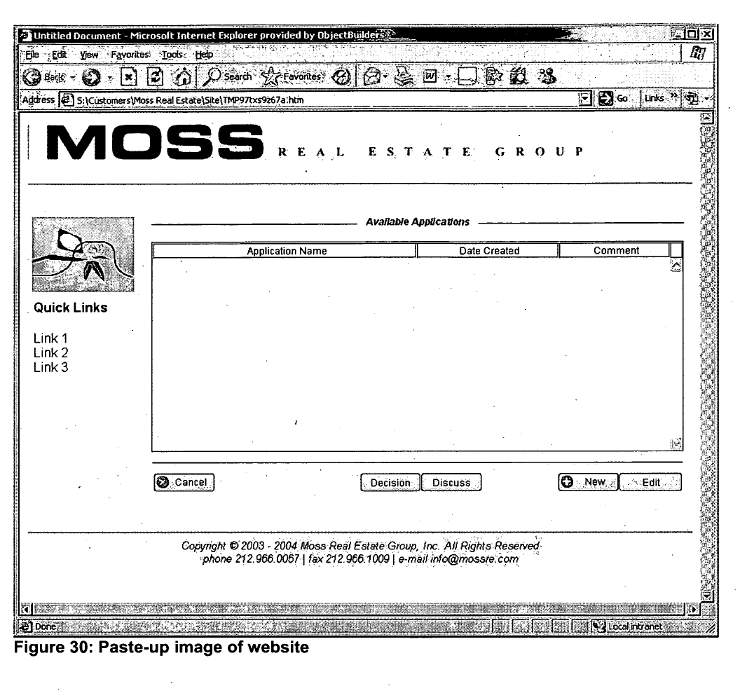

FIG. 30 is an image of how one of the pages appear on the site.

There is a box in the header indicating the number of pieces of paper and/or natural resources saved by this application with the amount of paper being calculated as discussed in the business rules section.

5c. Action Bar

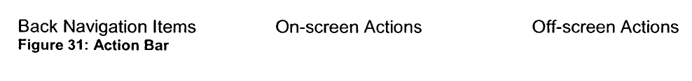

FIG. 31 is located at the bottom of the screen and is composed of three different sections.

5c1. Back Navigation Items

This group of buttons are left justified in the action bar and represents actions that take the user back to a previous window. This includes the List and Cancel buttons.

5c2. On-Screen Actions

This group of buttons are centered in the action bar and represents actions that do not transport the user to another window. It includes Add, Delete, and Save.

5c3. Off-Screen Actions

This group of buttons are right justified in the action bar and represents actions that transport the user to a new window. (This is opposed to the Back Navigation Items, which transport the user to a previous window.) It includes Templates, Units, Board, Discussion, Decision, New, Import Deal, and Import Sections.

5d. Quick Links

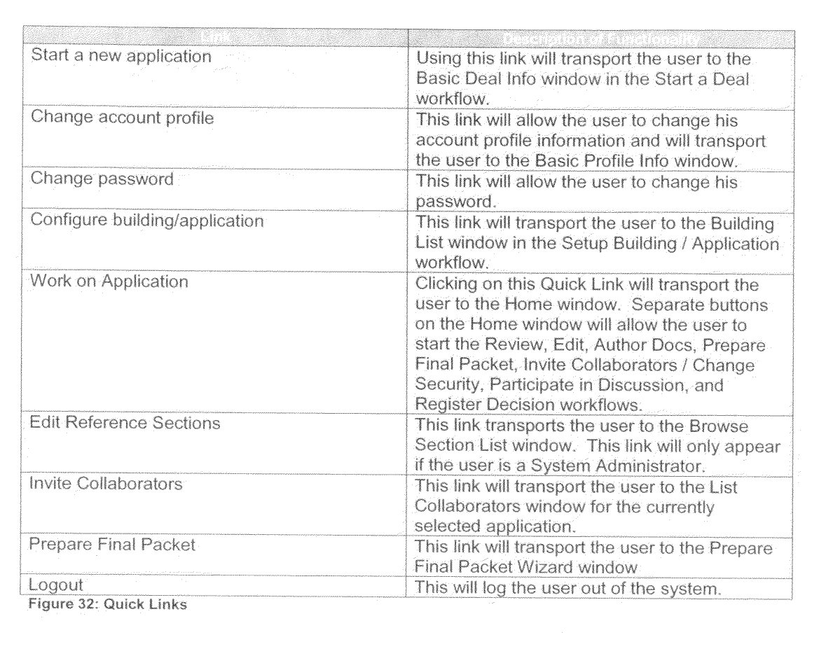

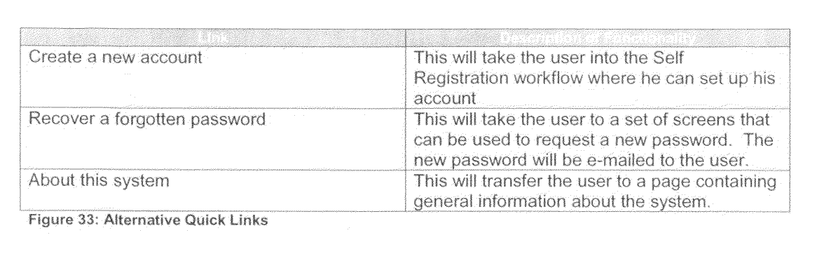

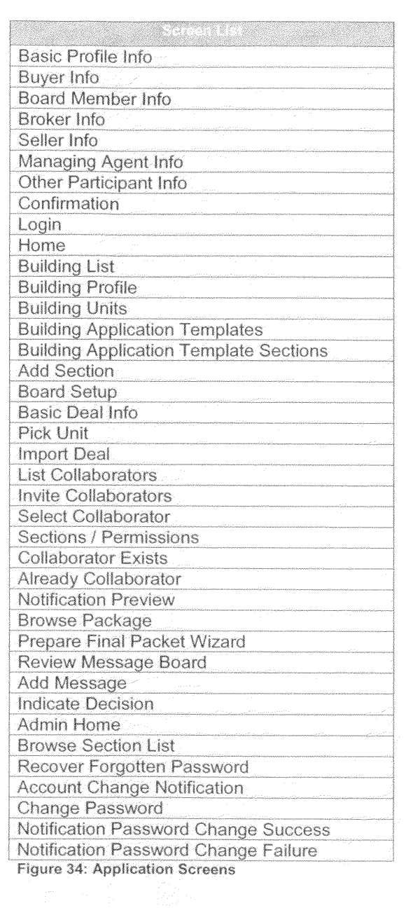

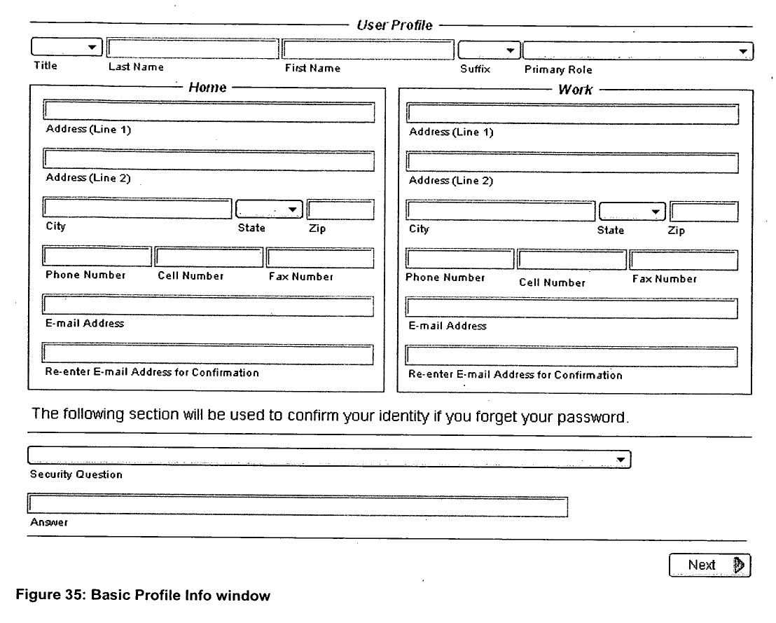

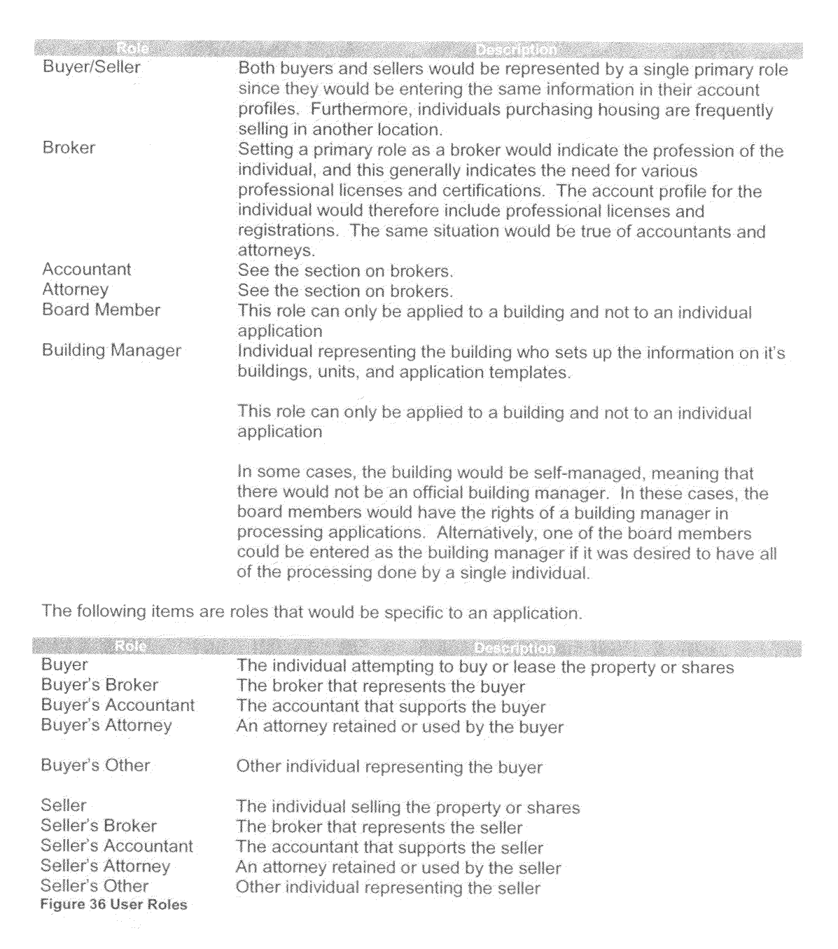

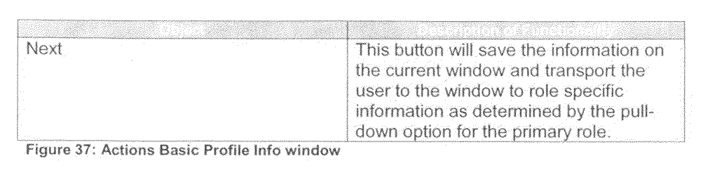

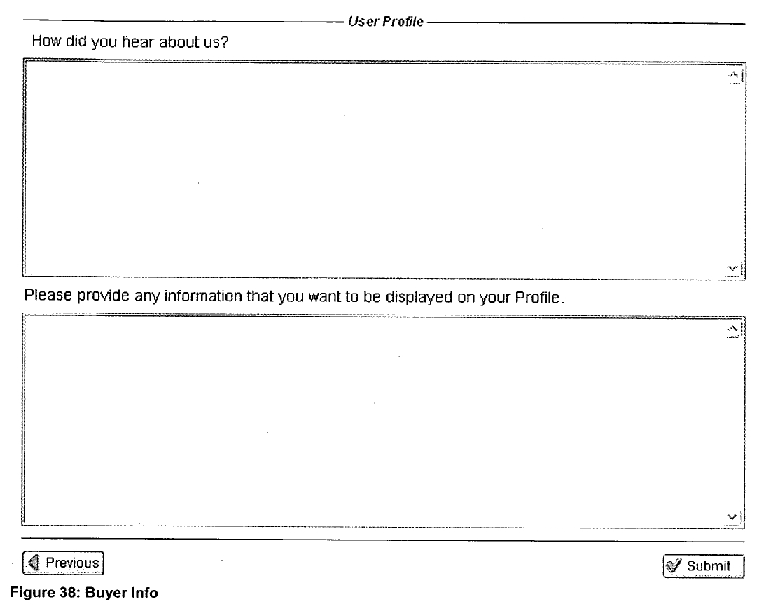

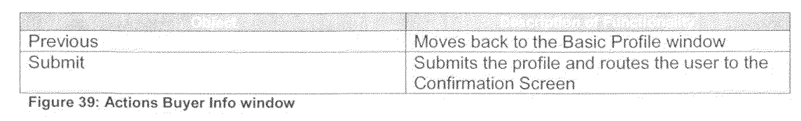

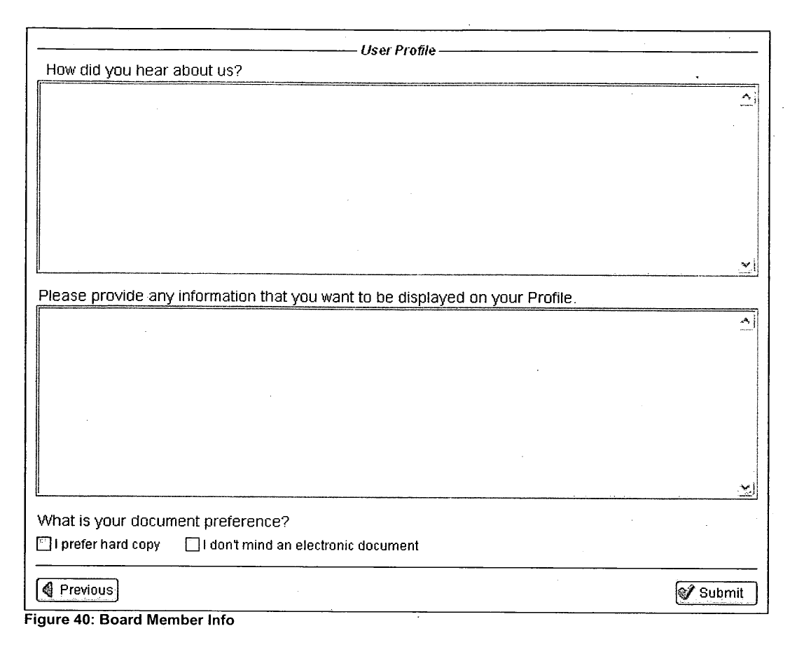

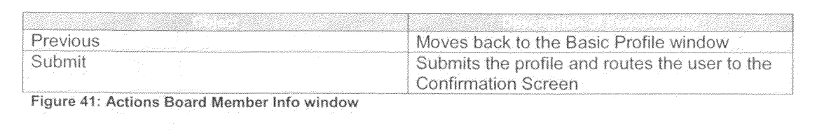

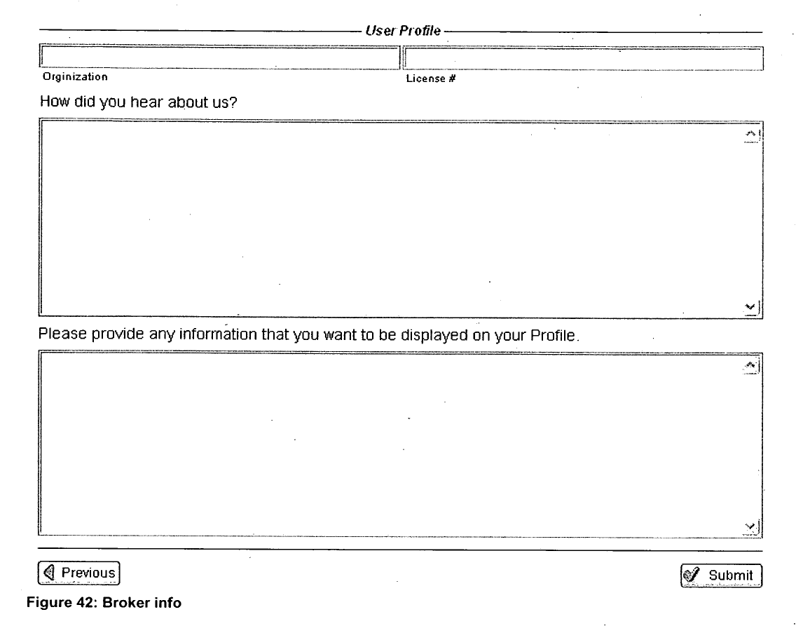

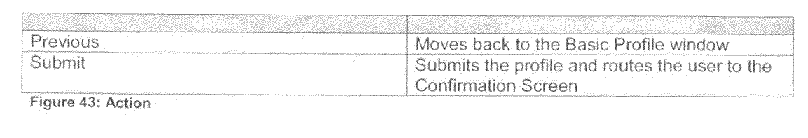

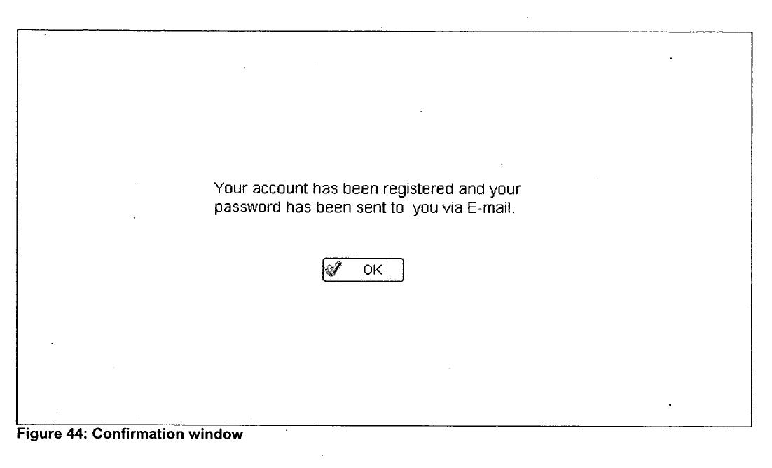

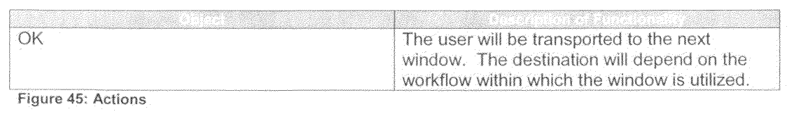

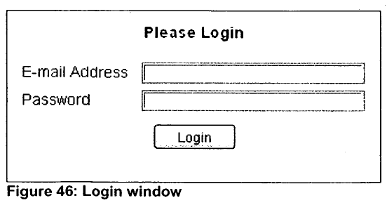

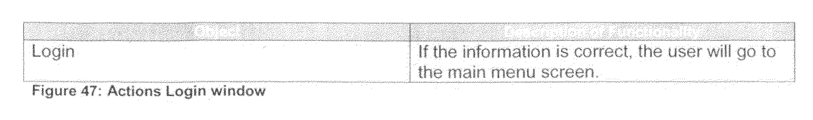

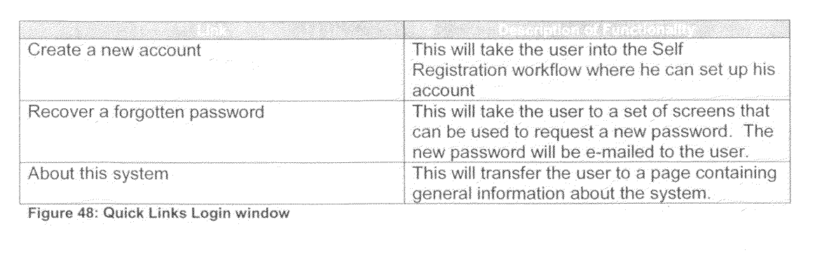

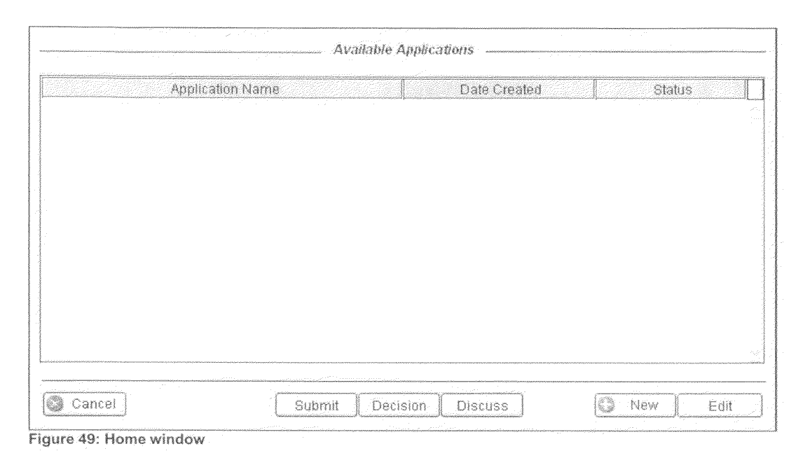

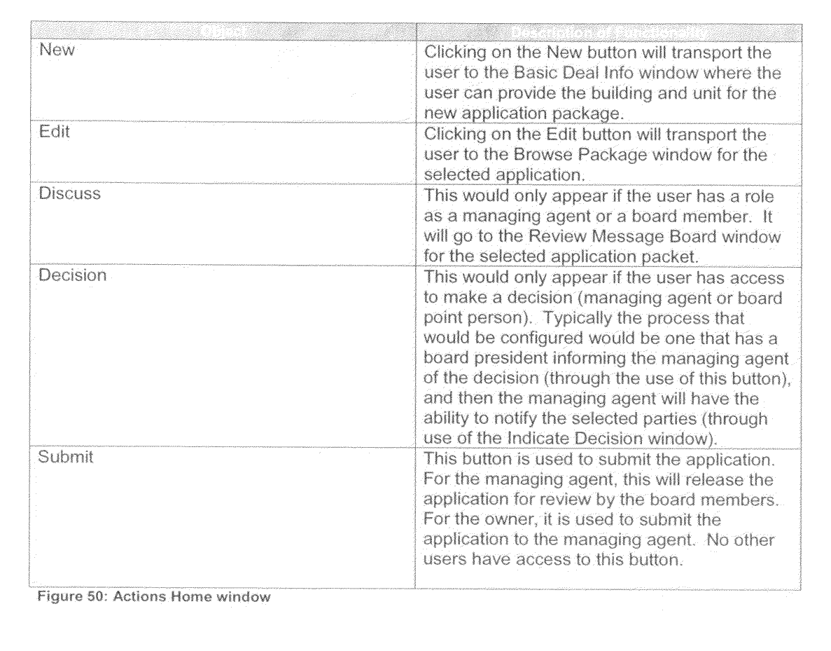

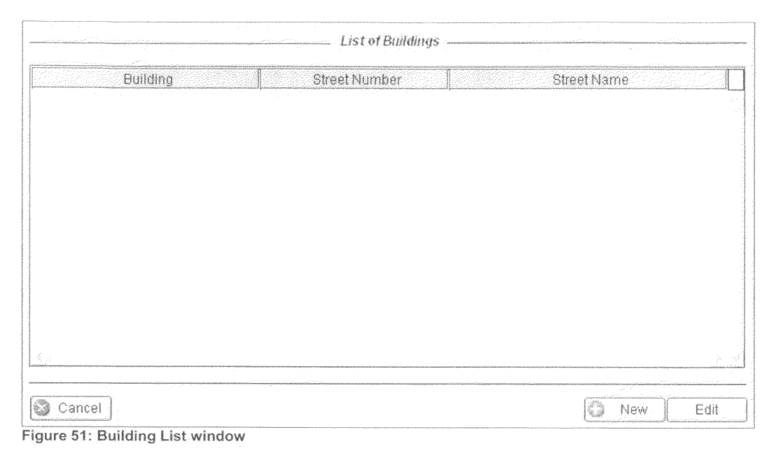

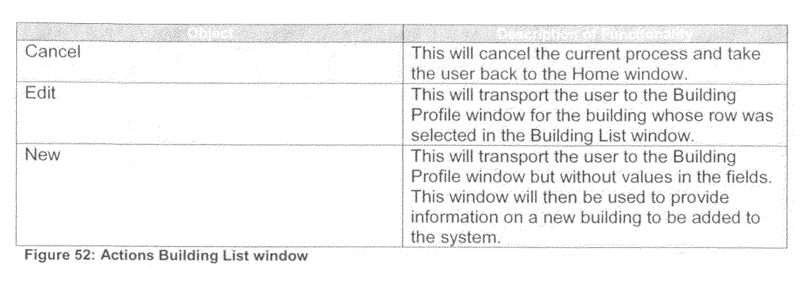

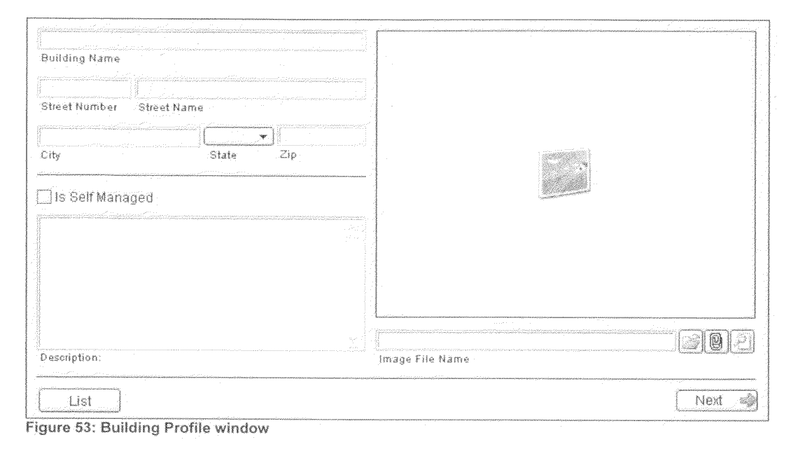

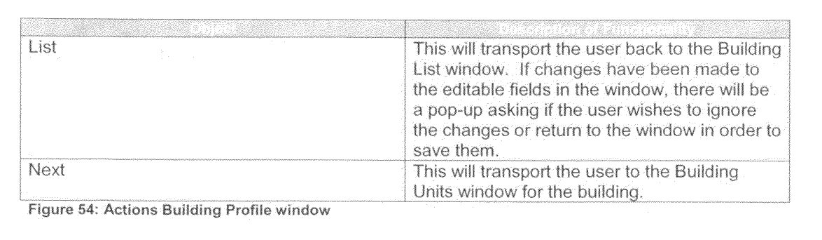

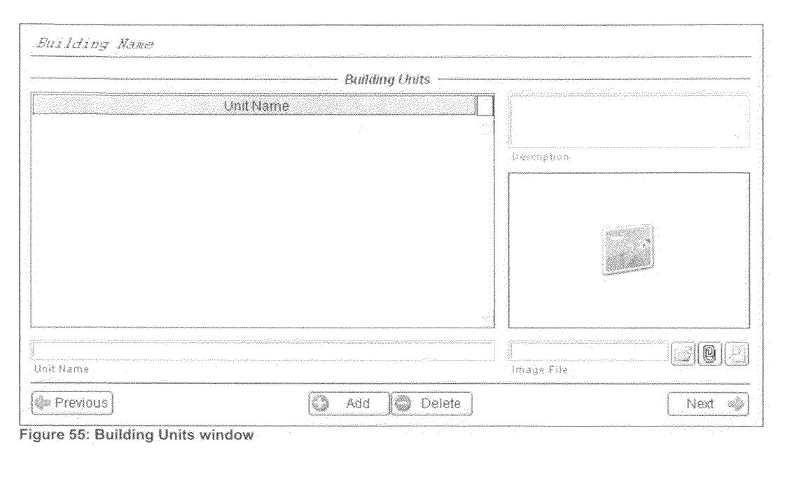

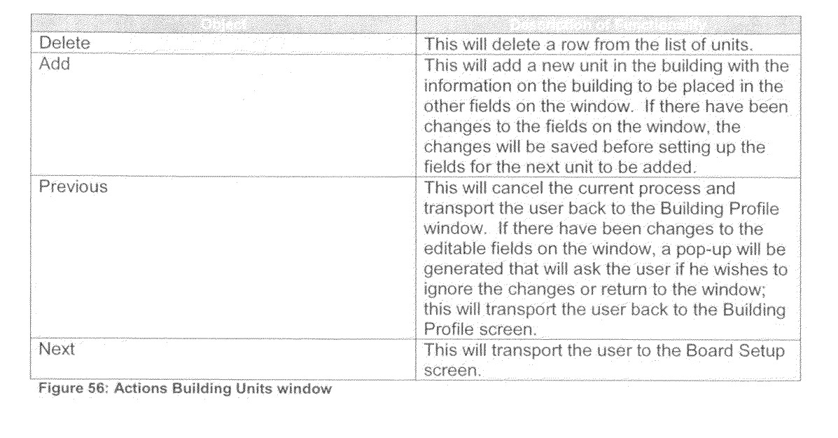

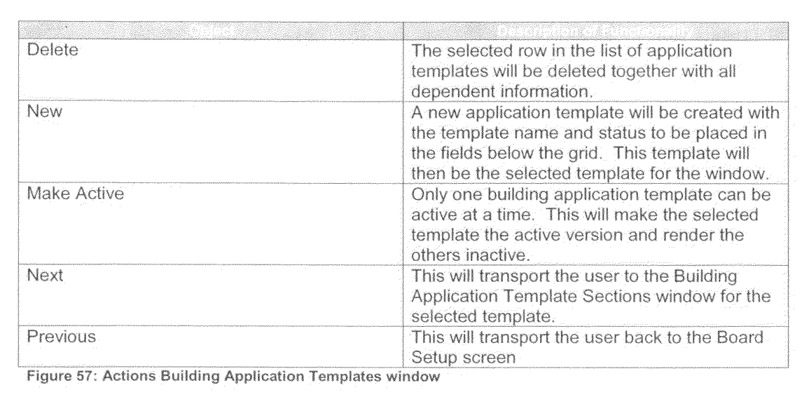

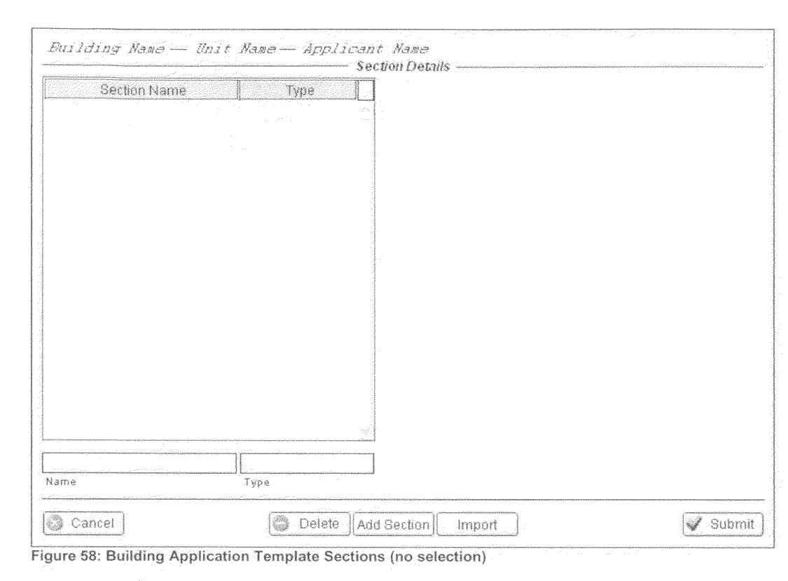

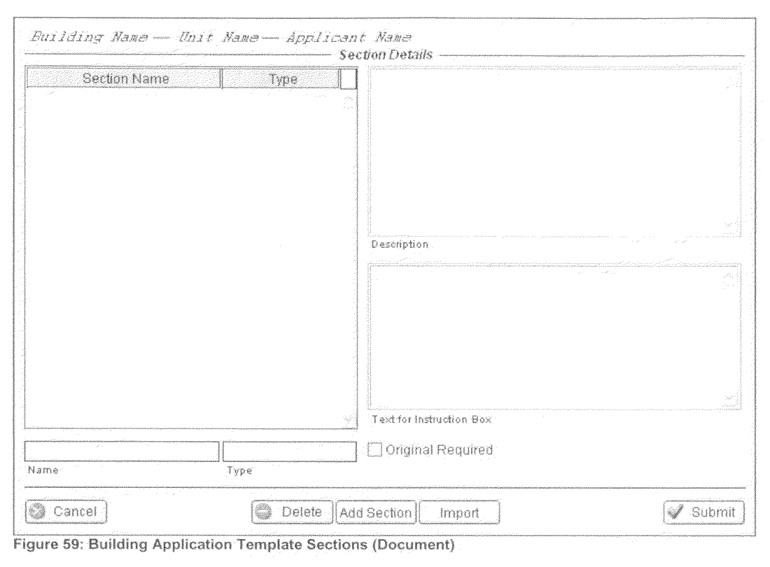

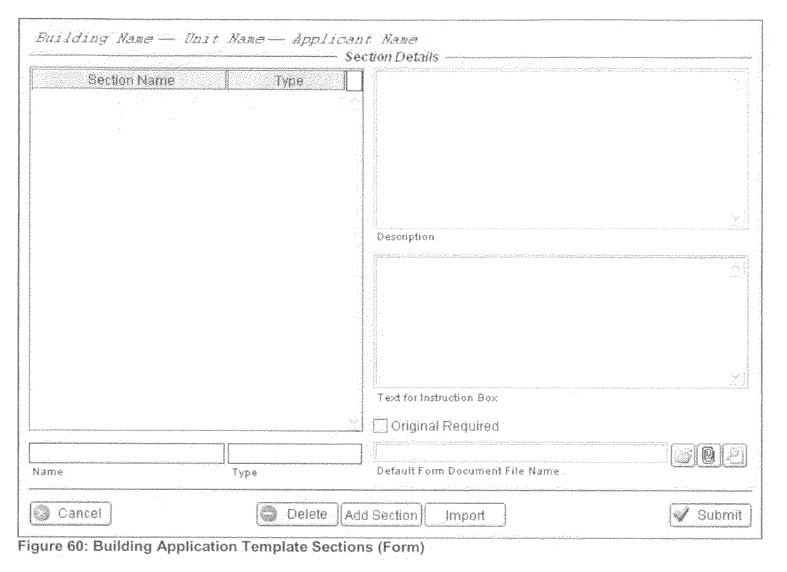

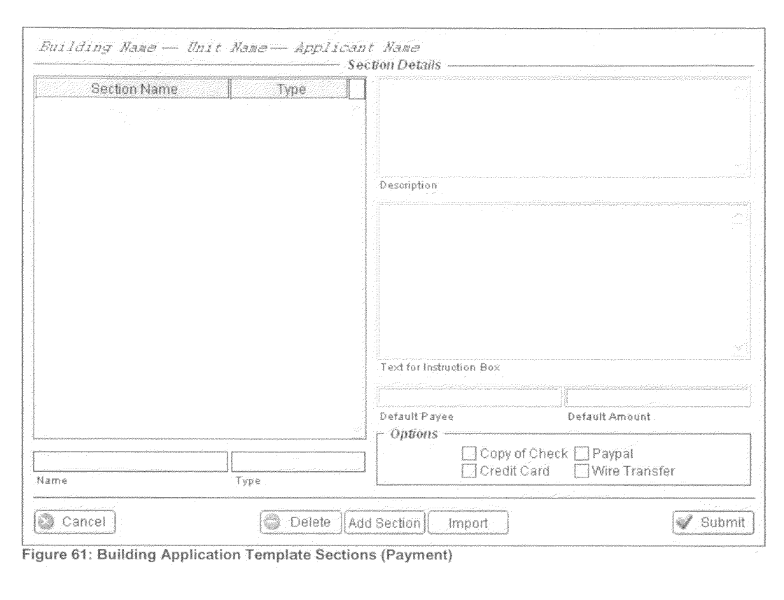

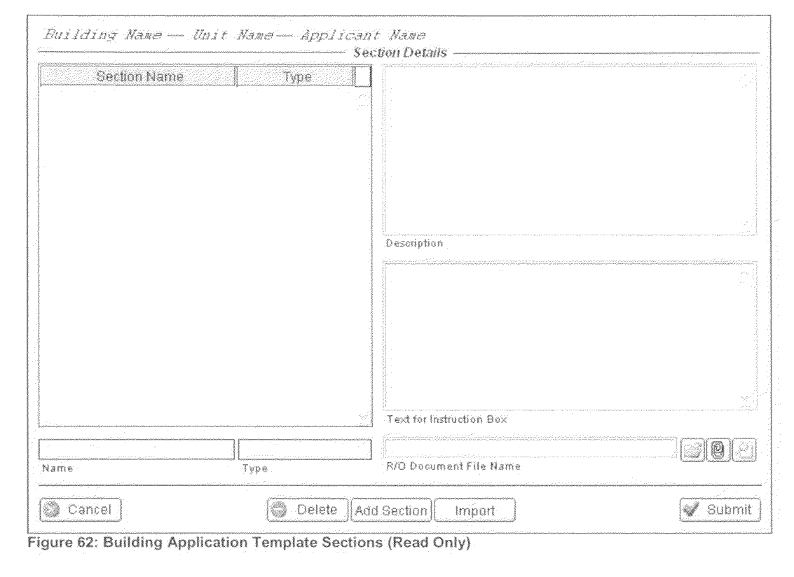

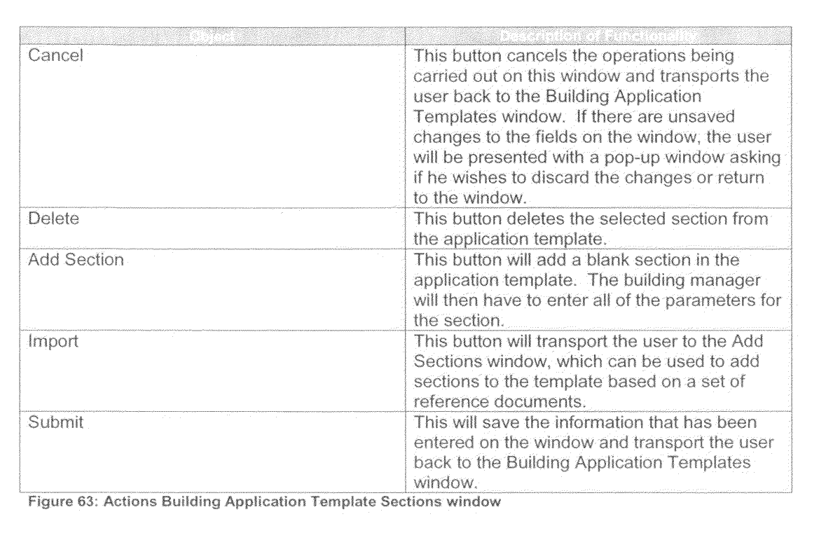

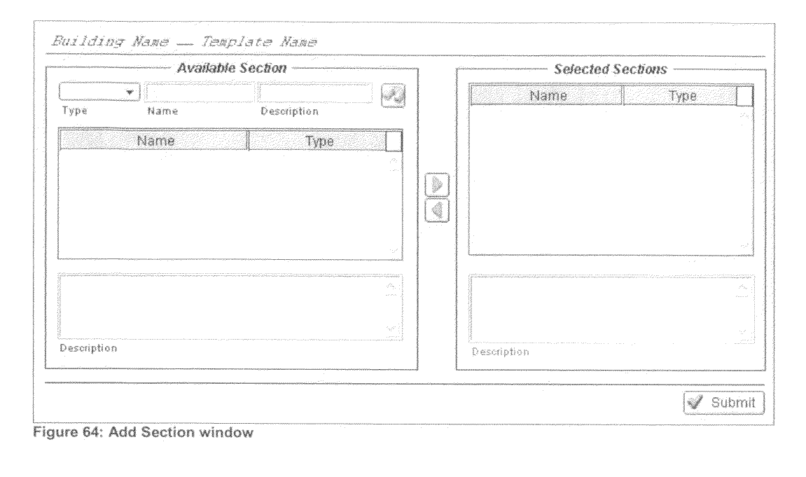

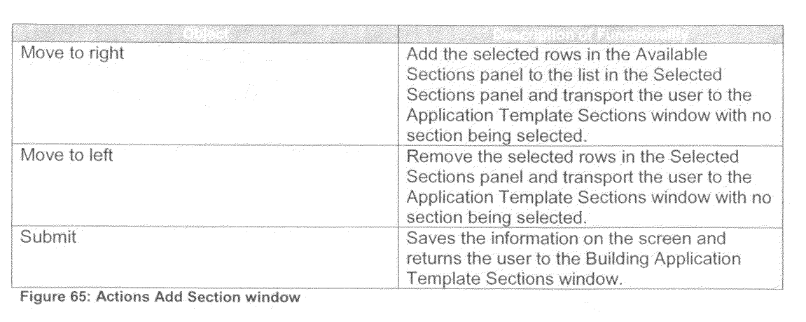

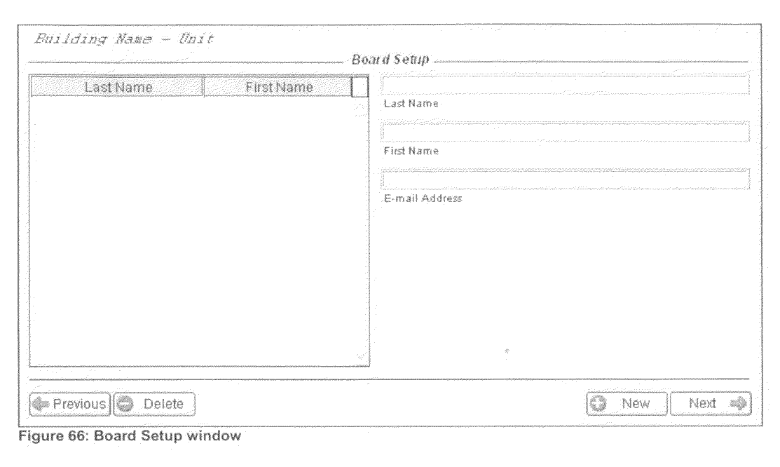

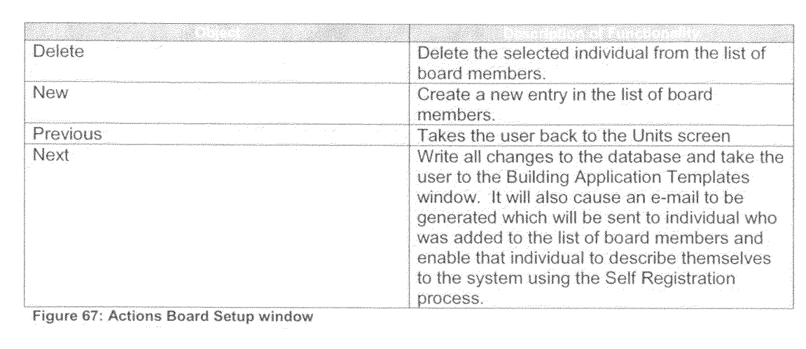

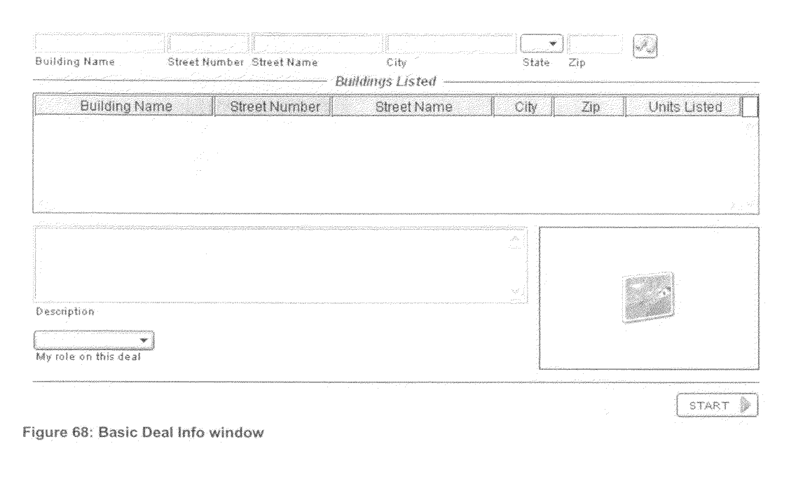

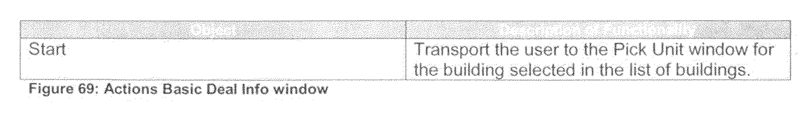

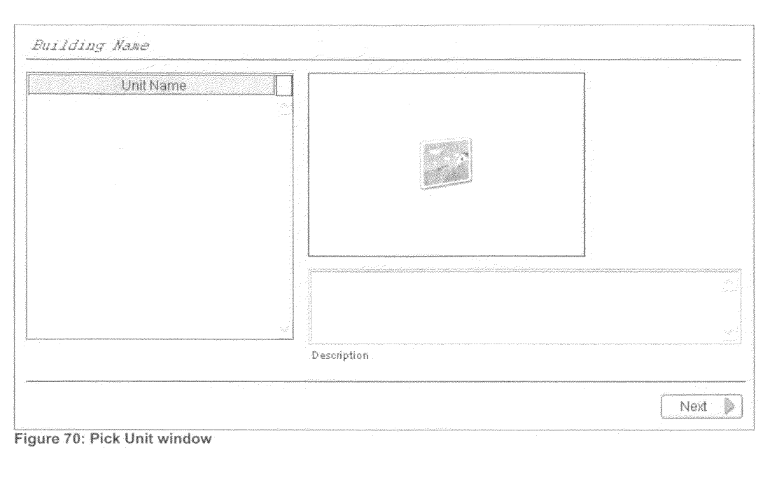

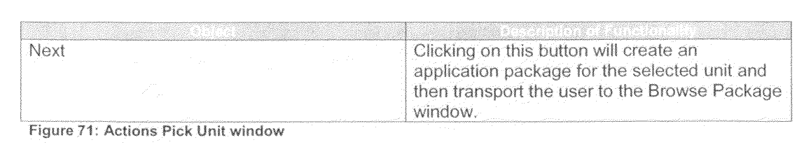

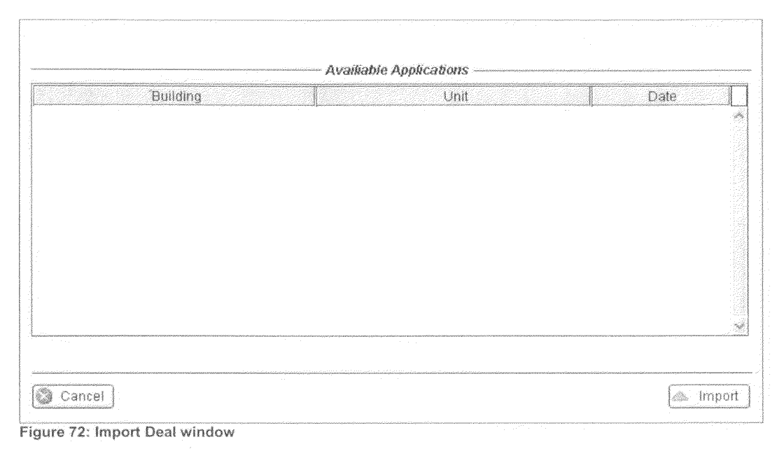

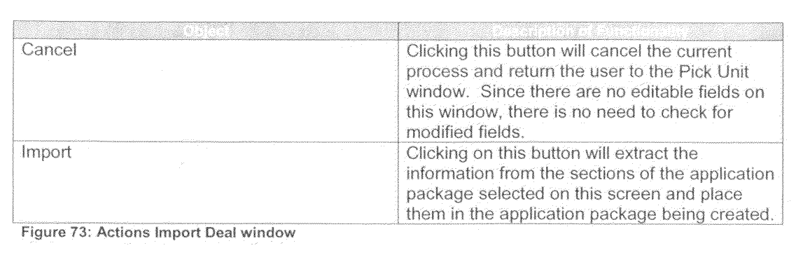

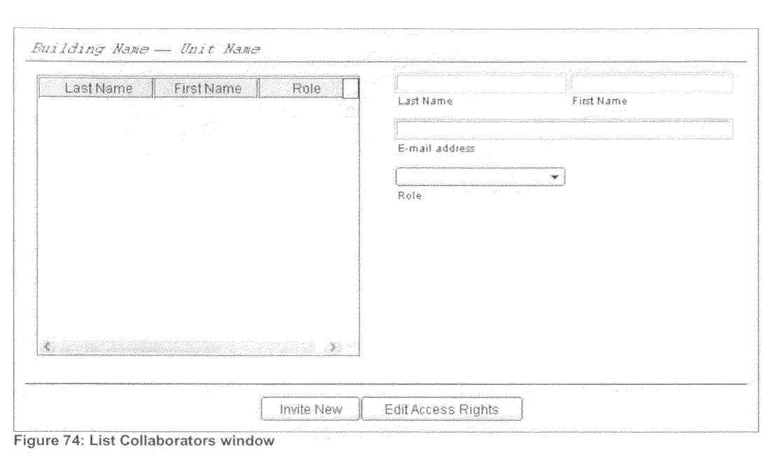

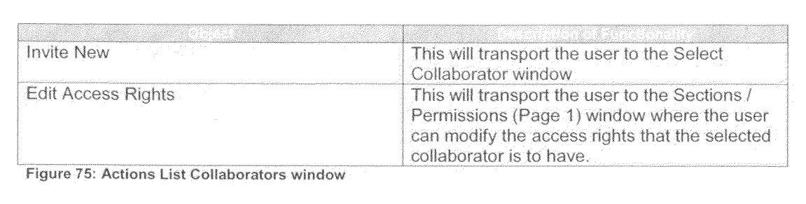

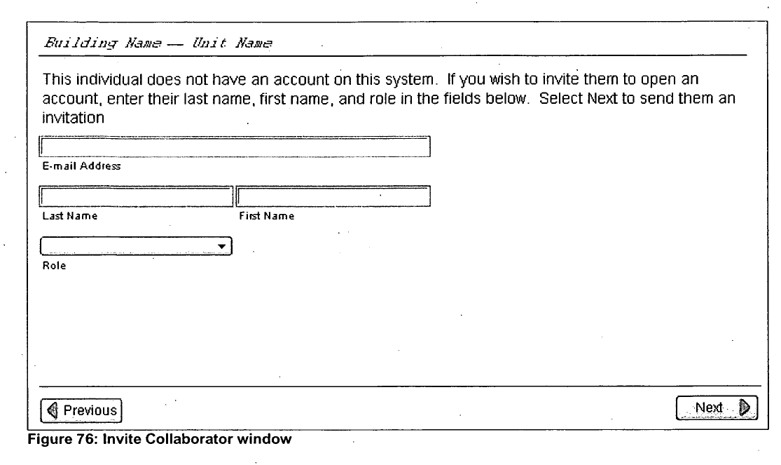

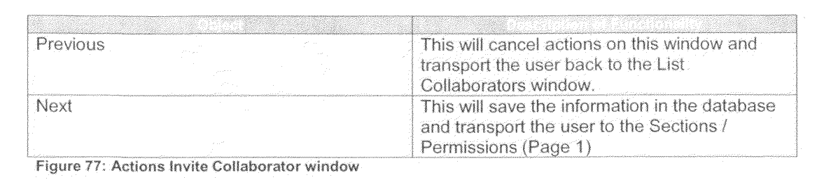

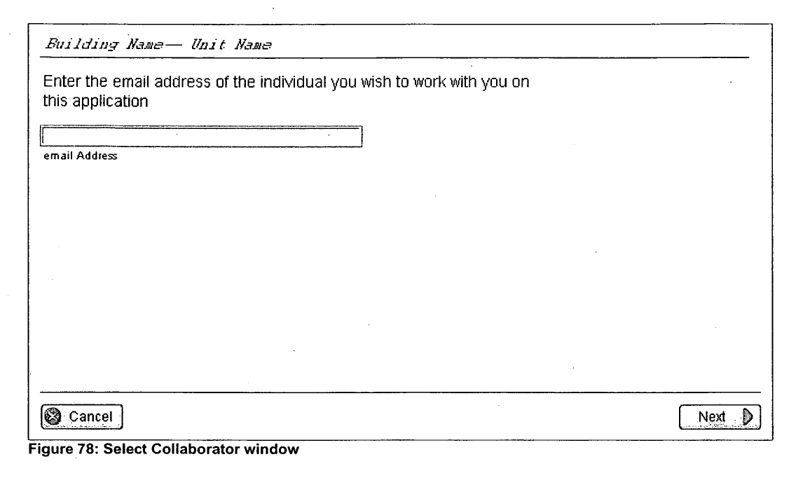

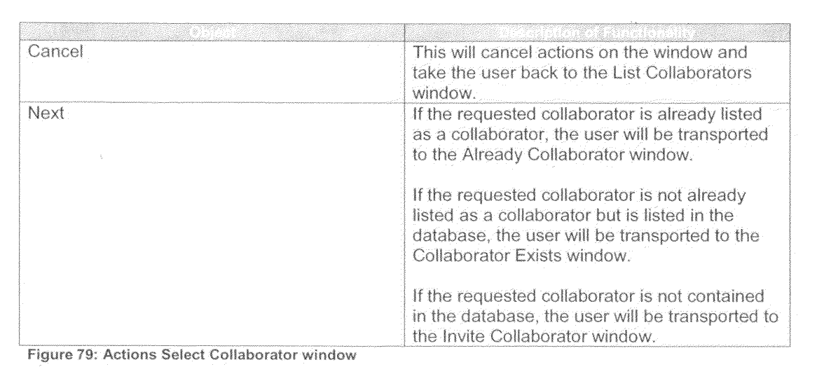

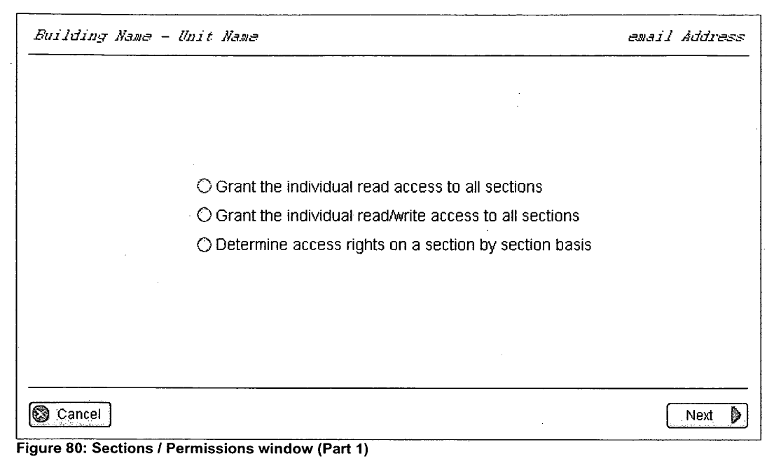

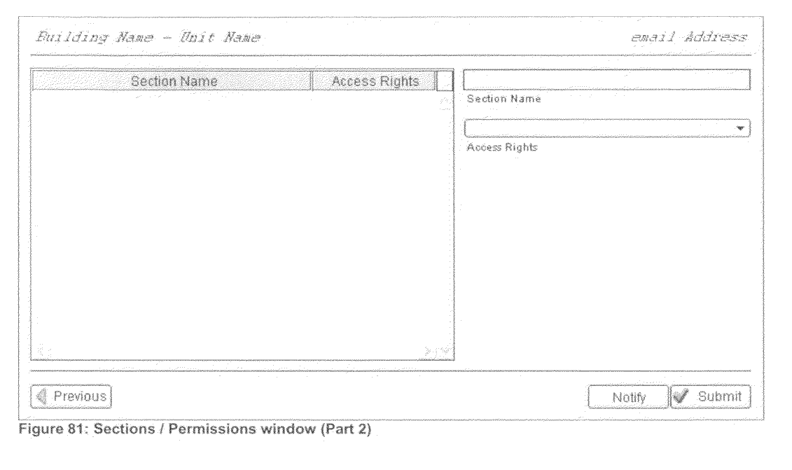

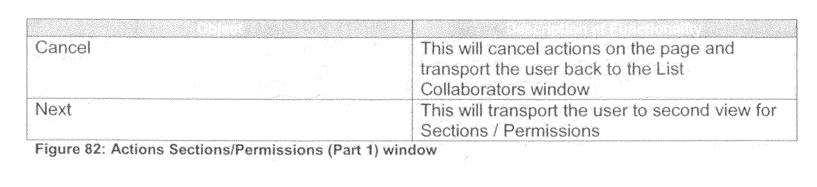

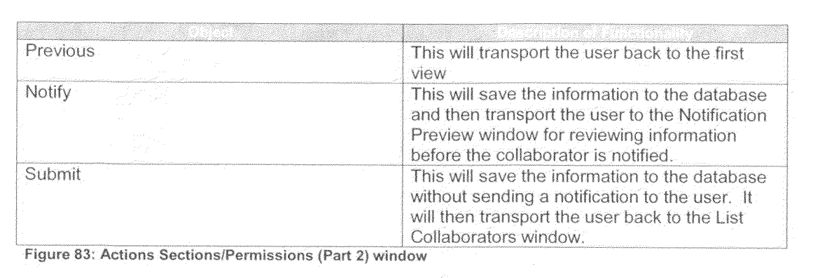

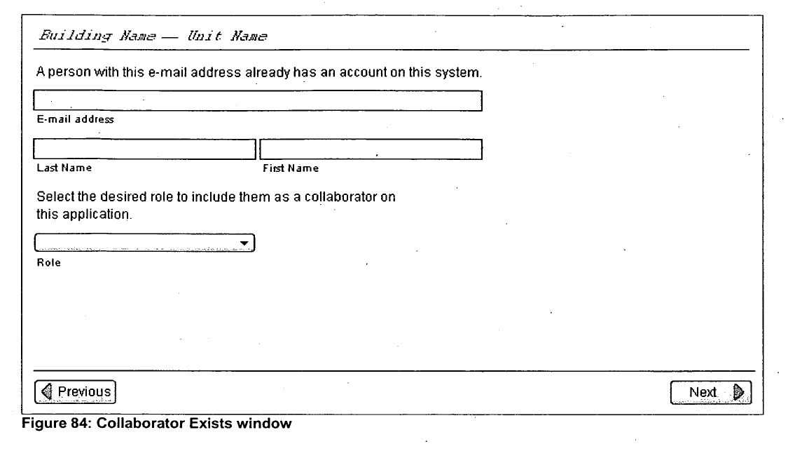

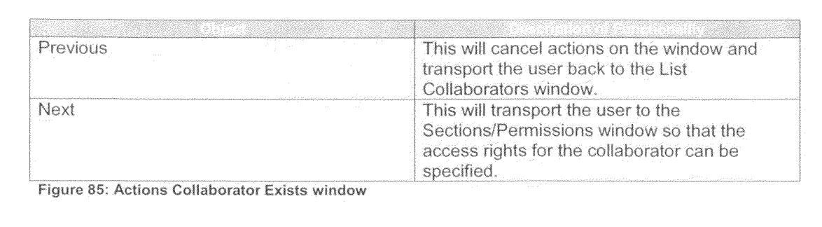

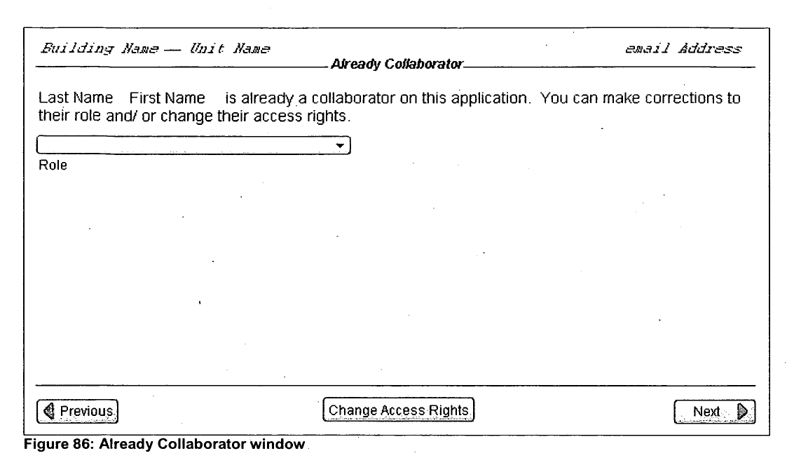

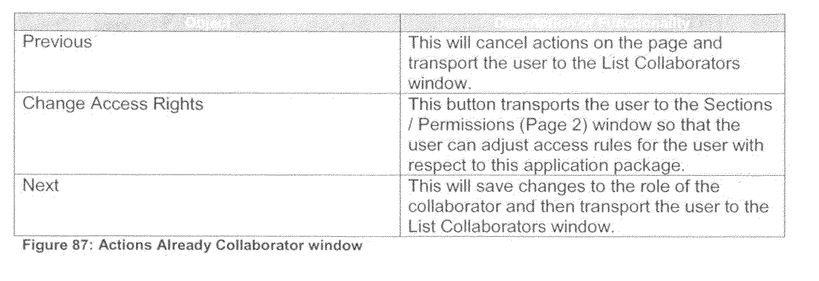

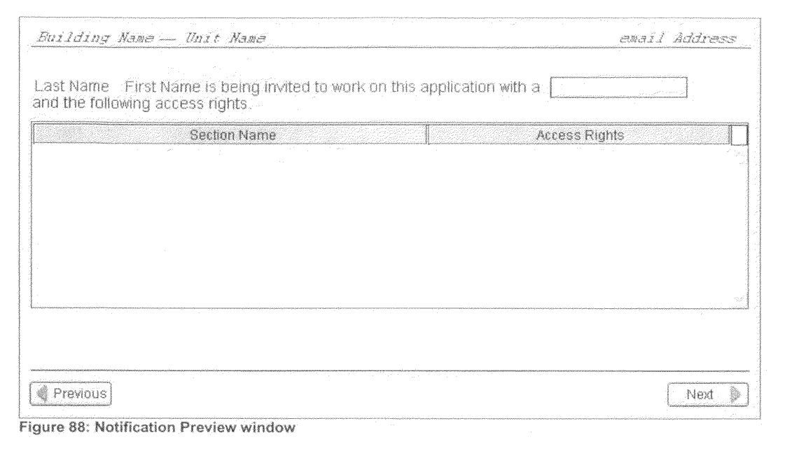

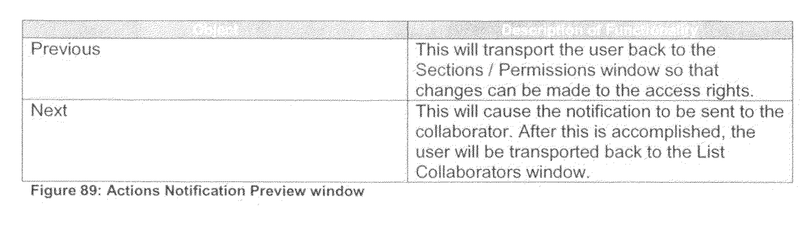

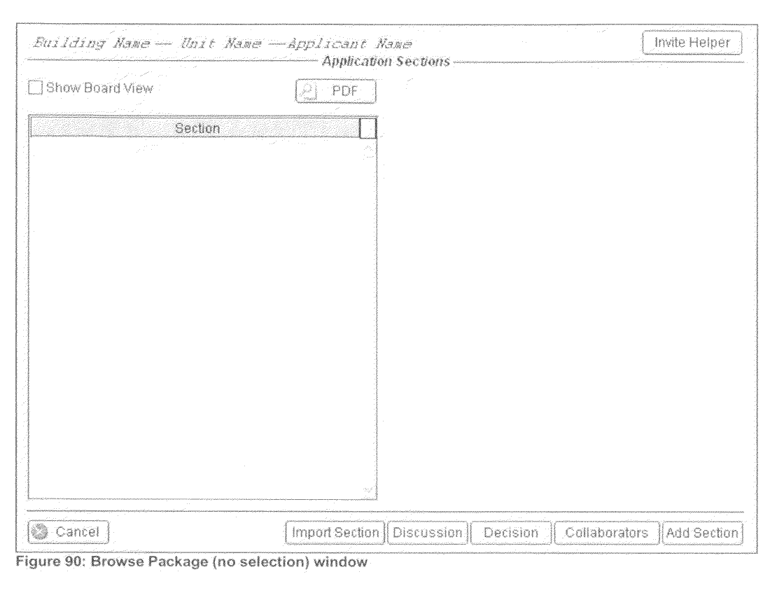

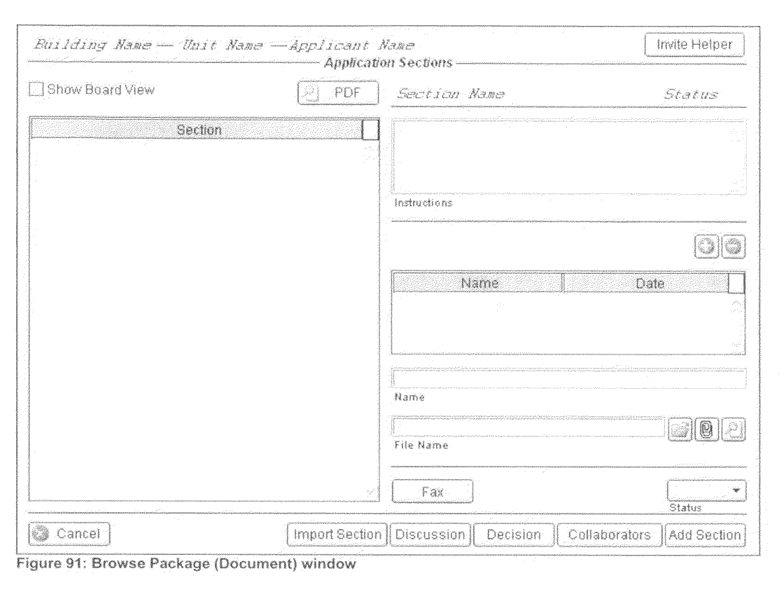

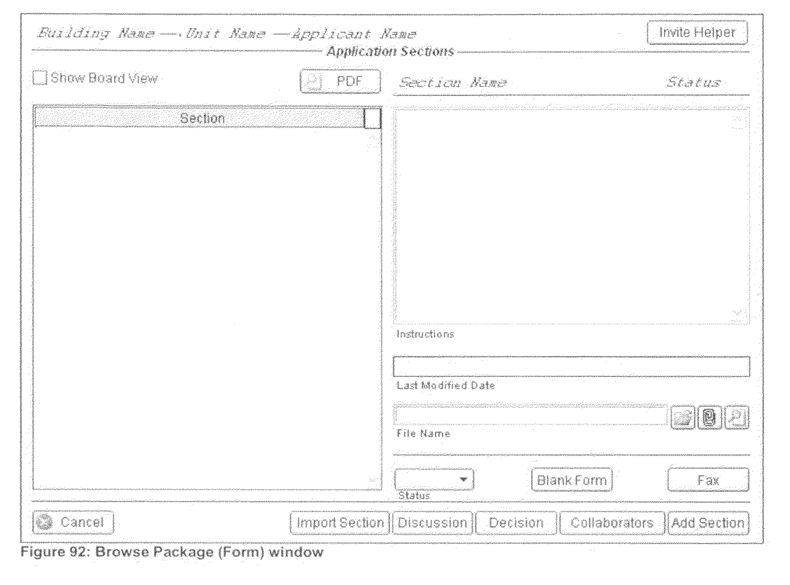

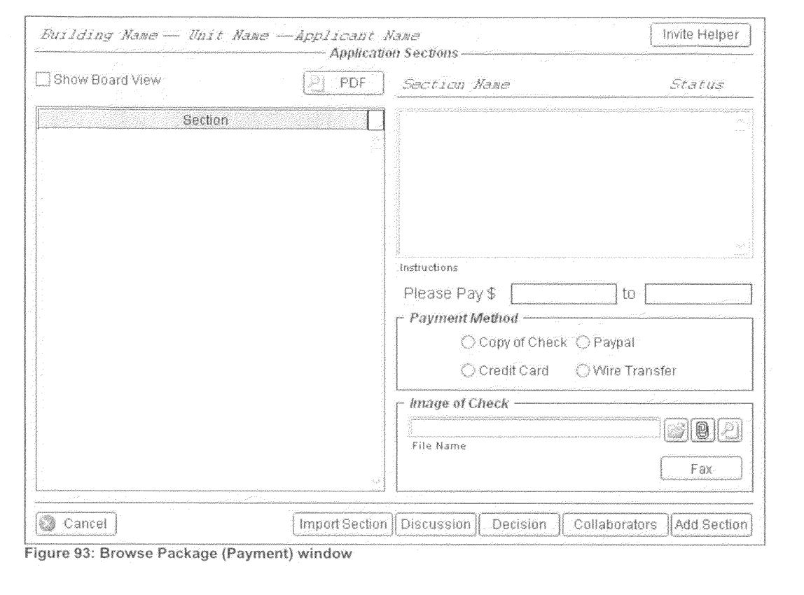

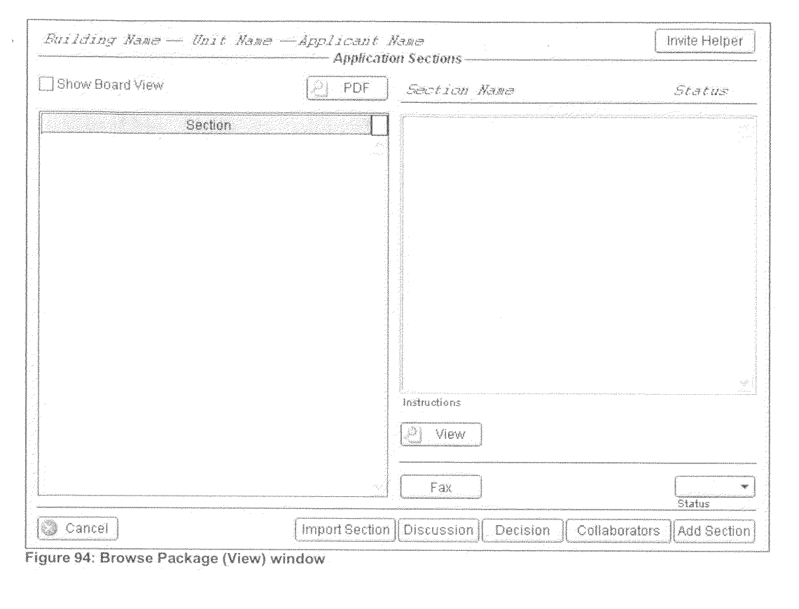

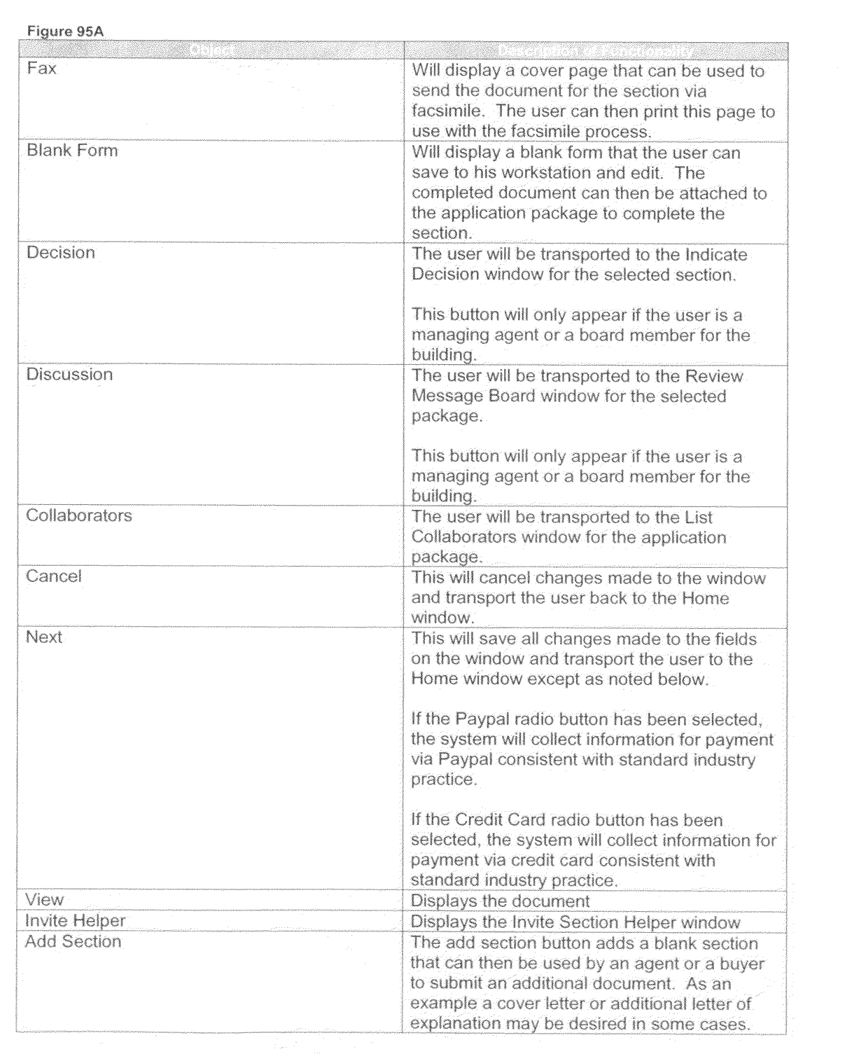

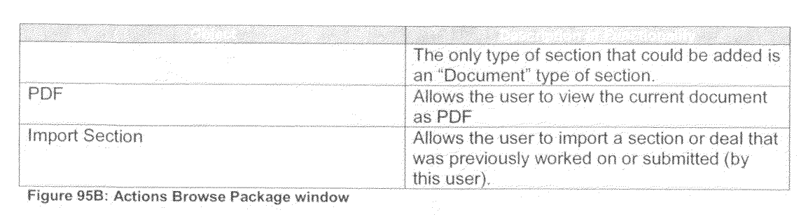

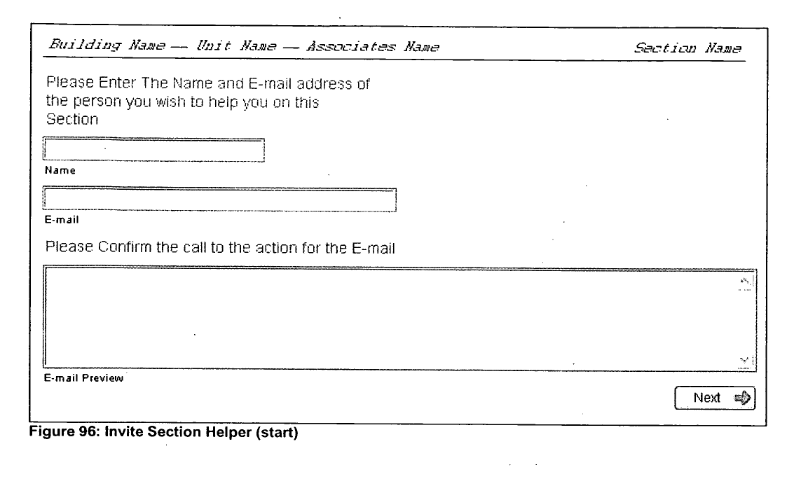

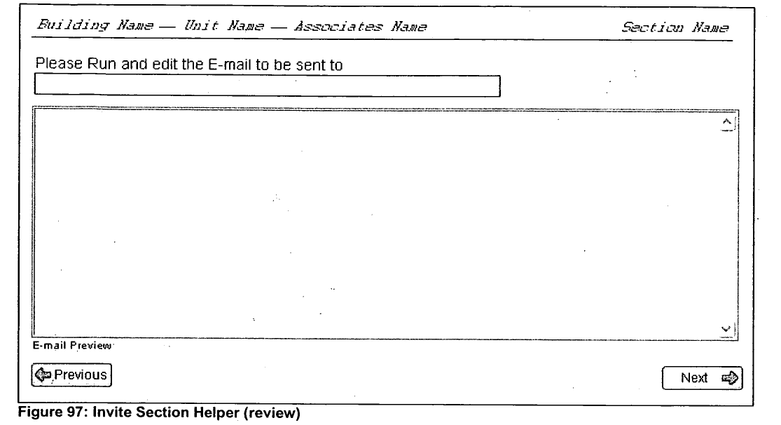

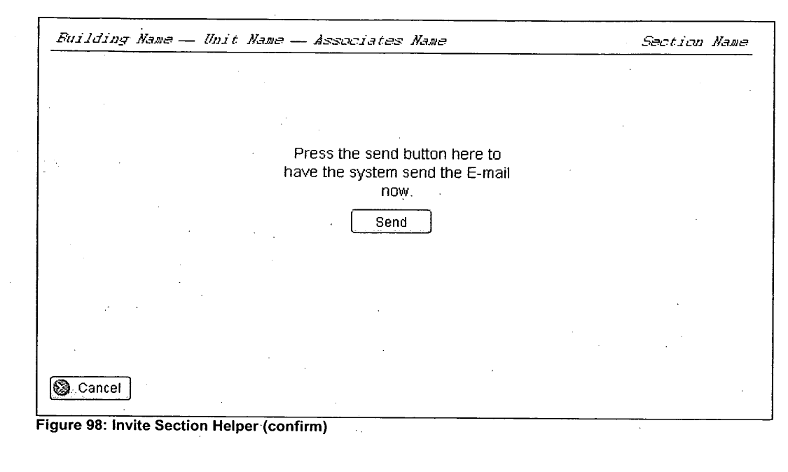

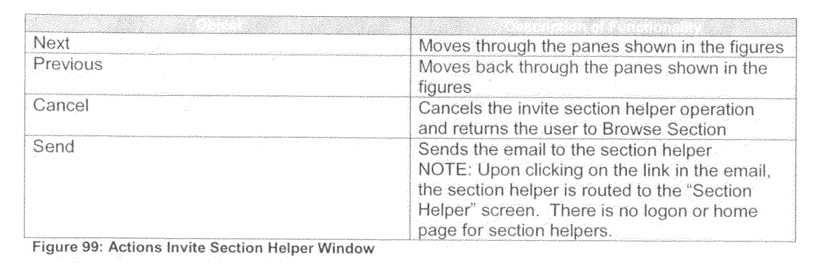

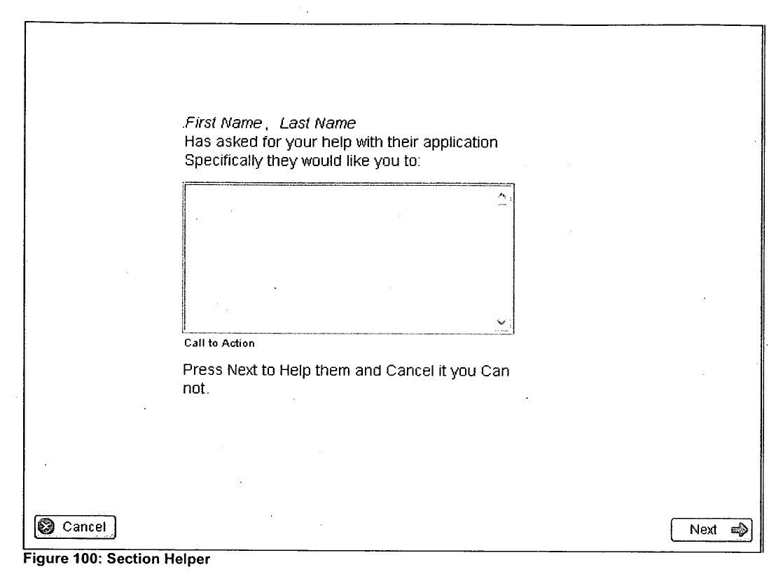

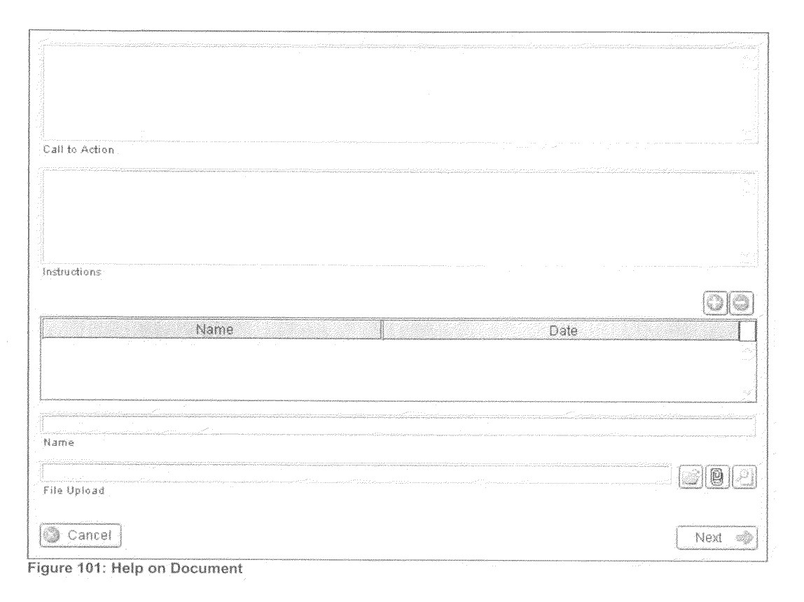

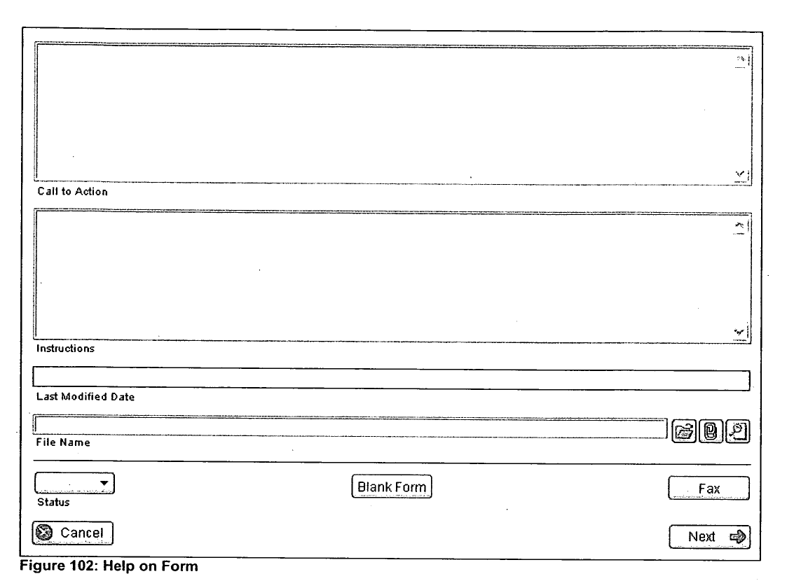

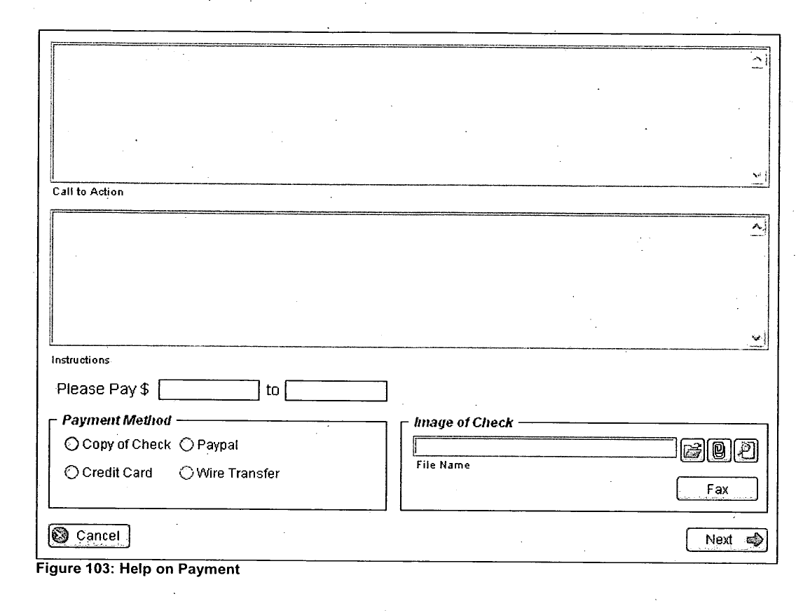

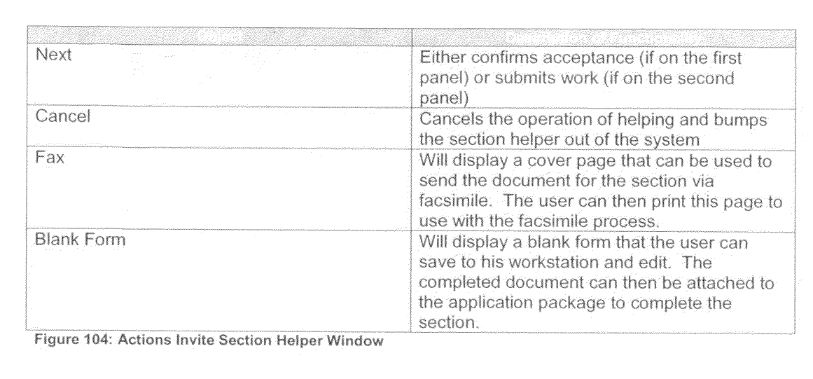

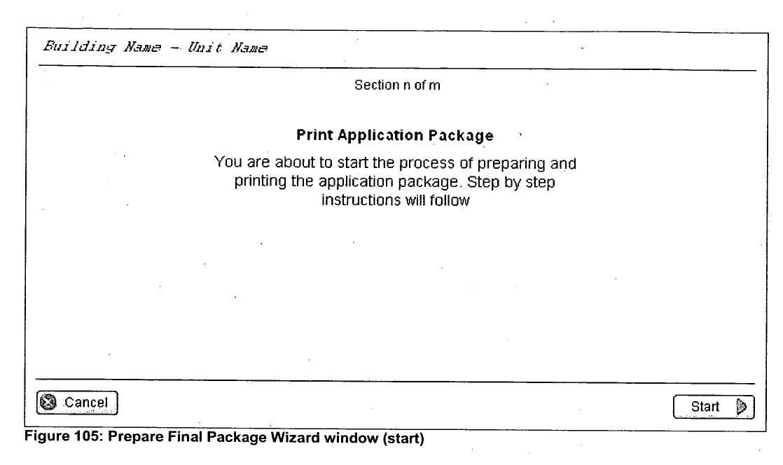

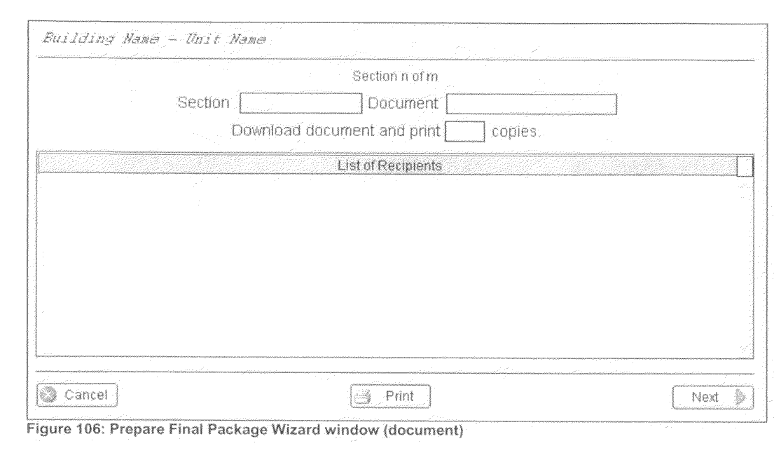

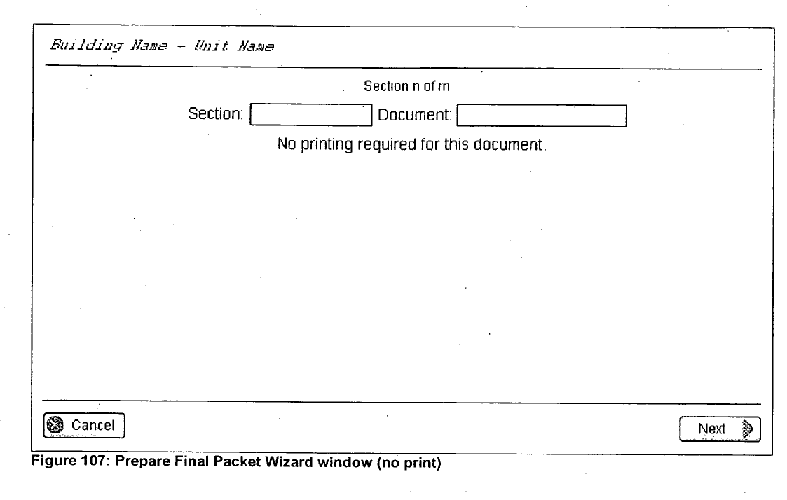

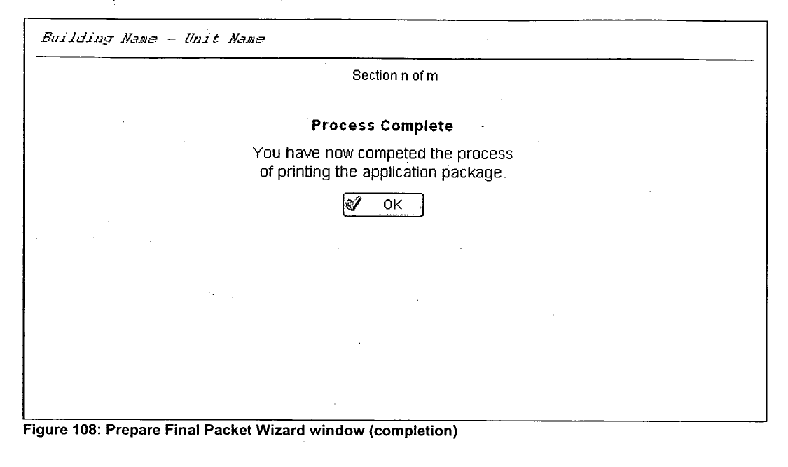

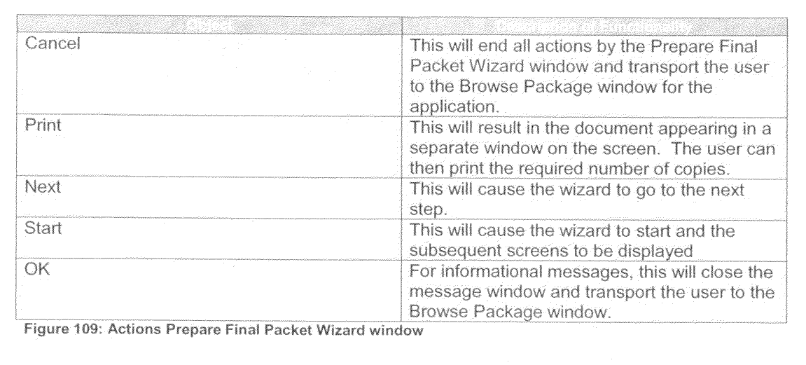

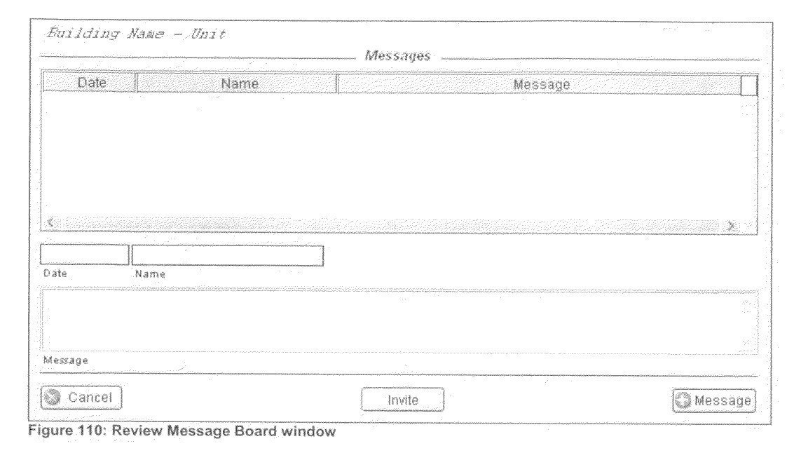

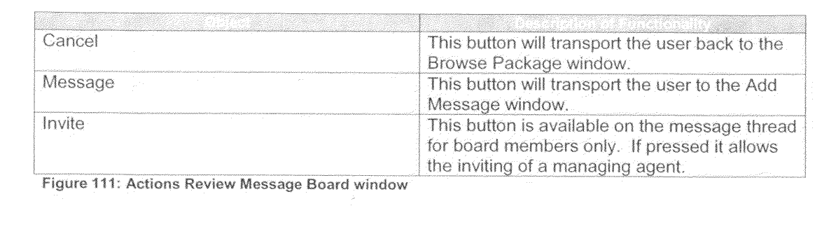

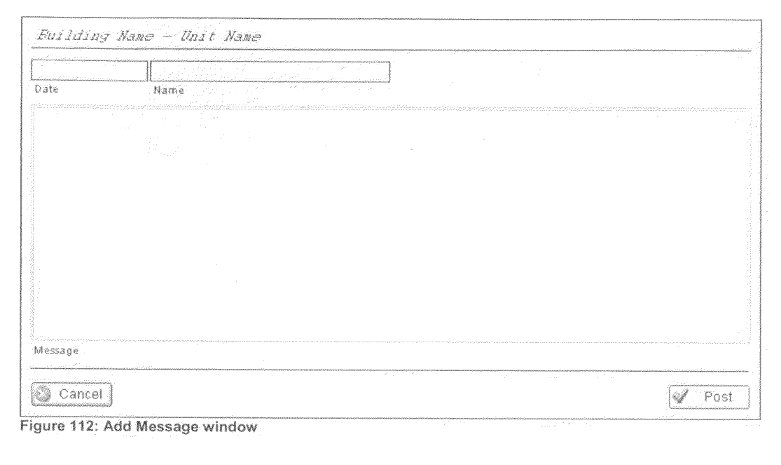

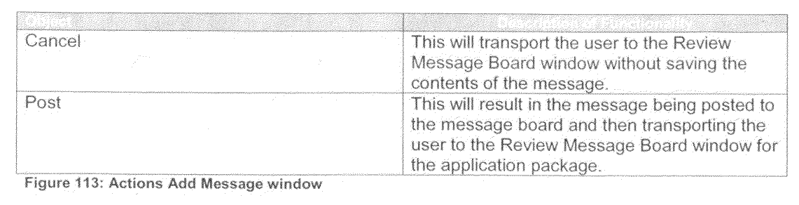

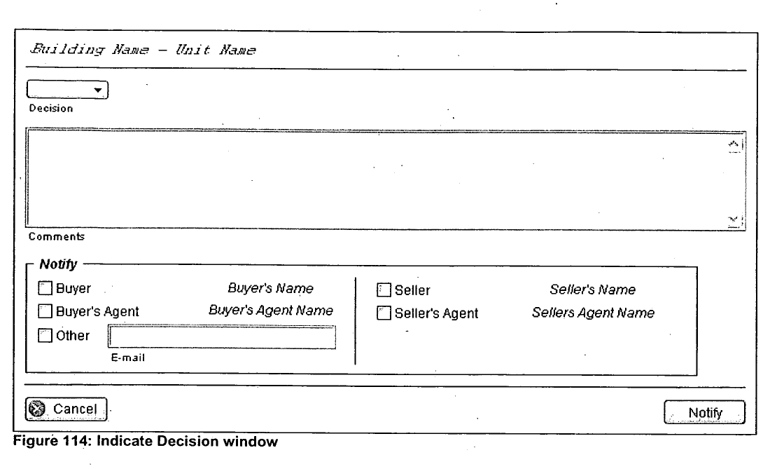

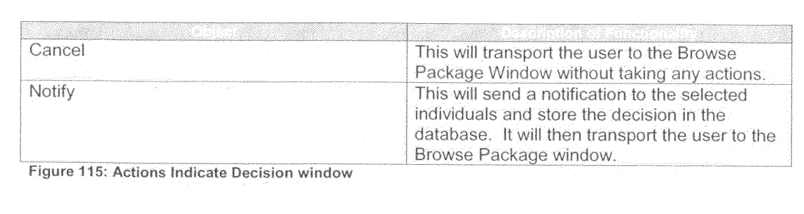

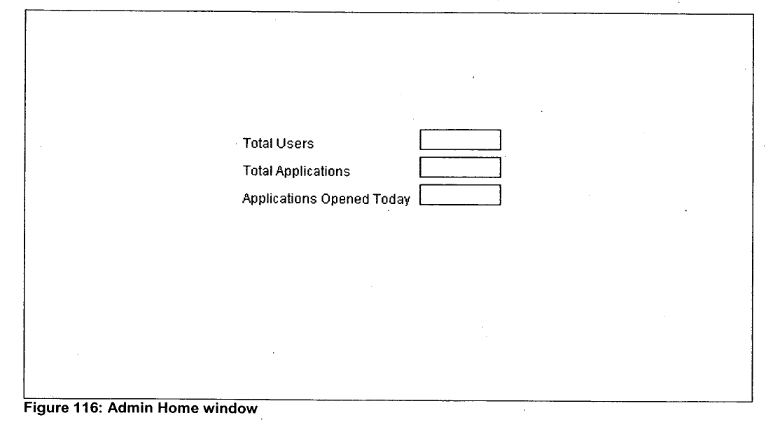

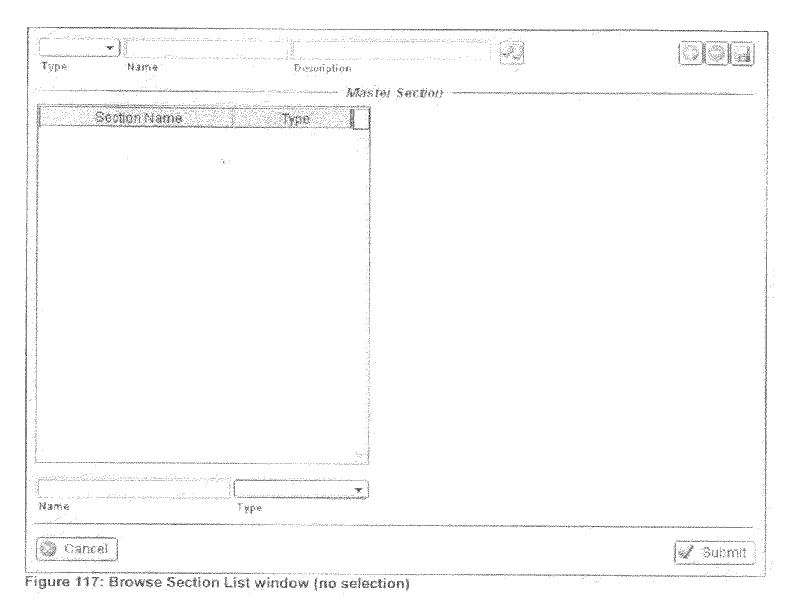

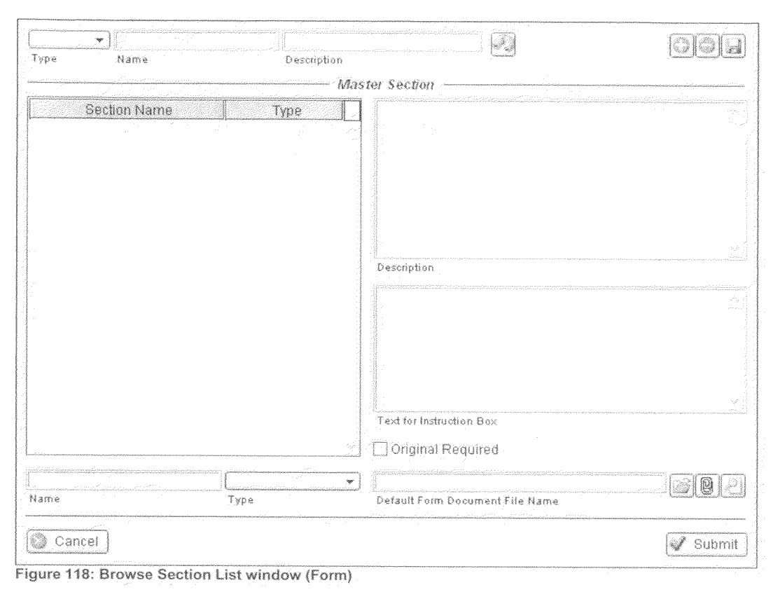

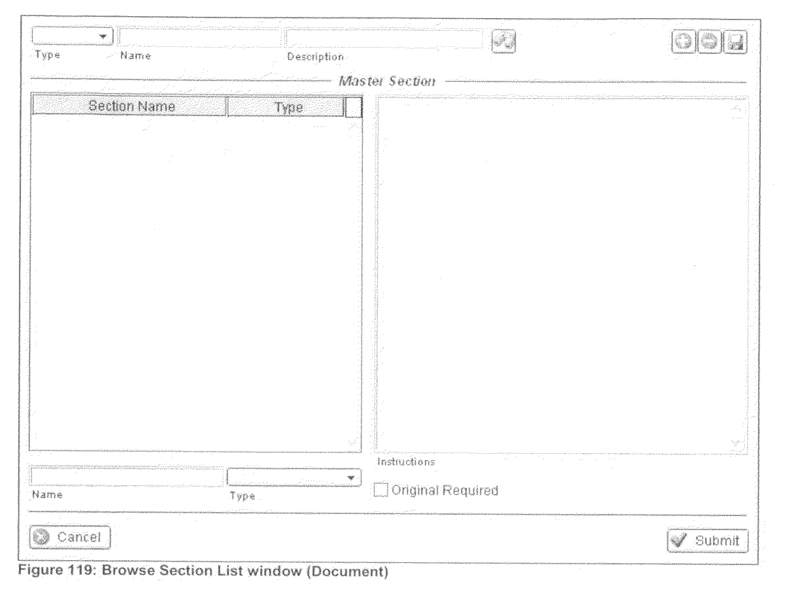

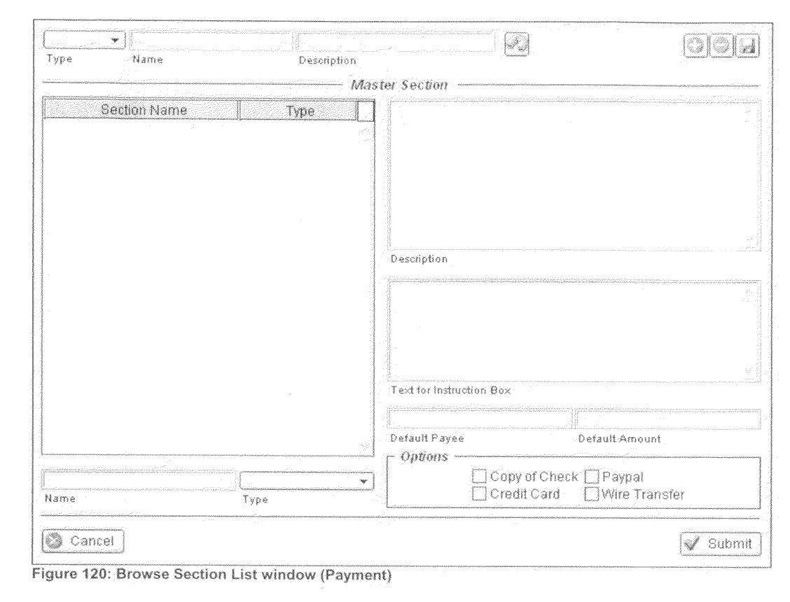

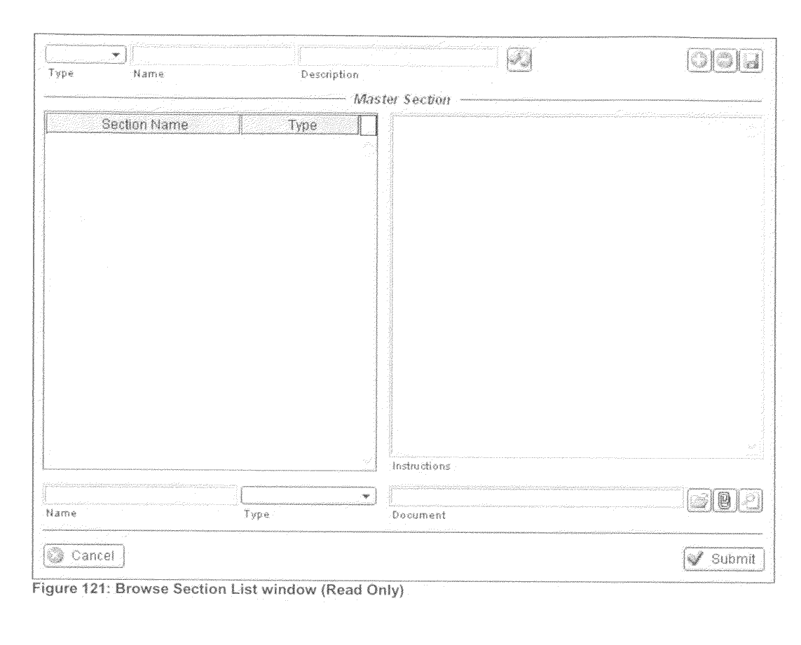

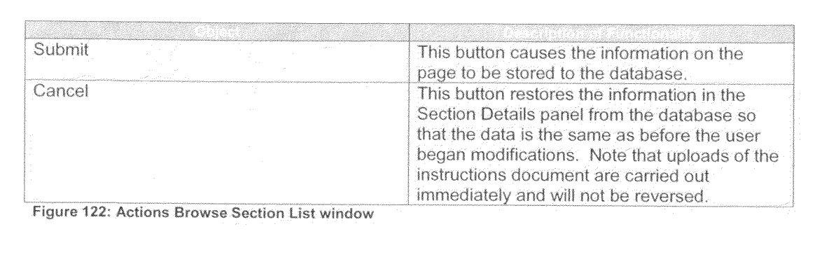

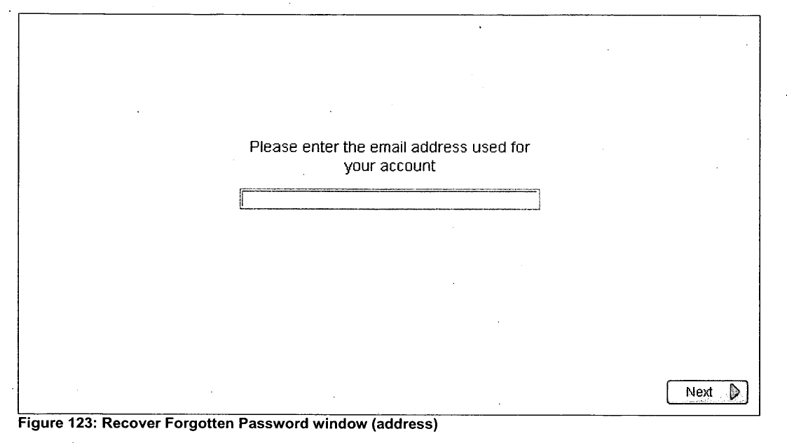

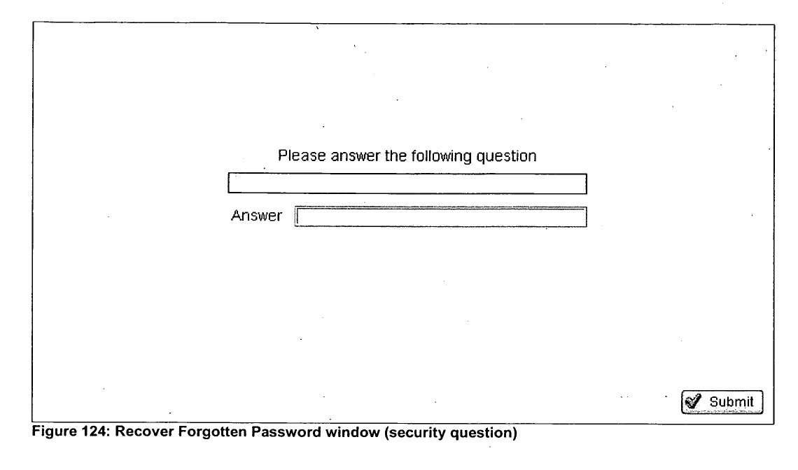

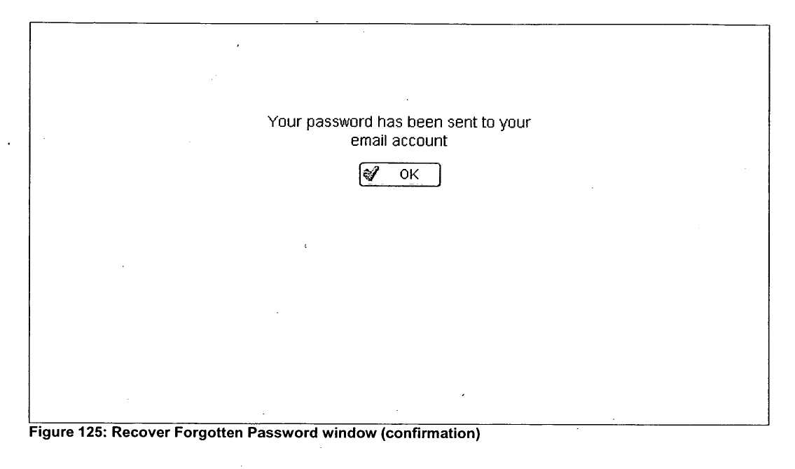

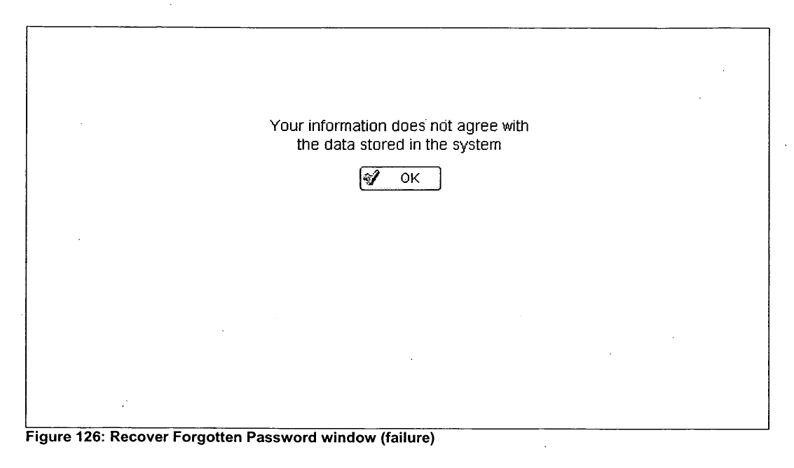

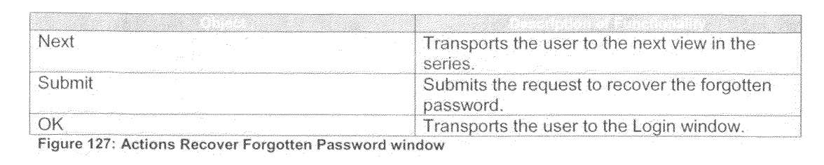

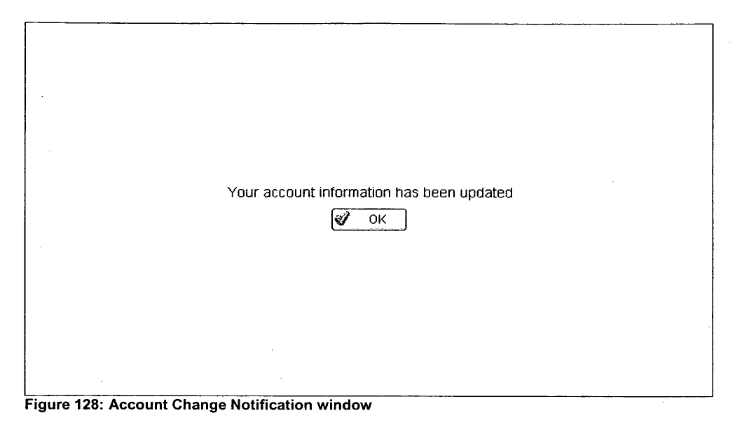

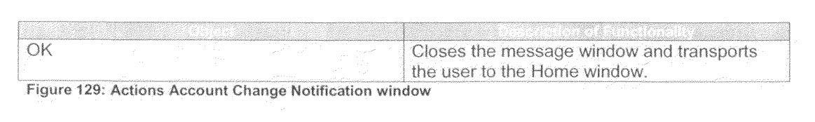

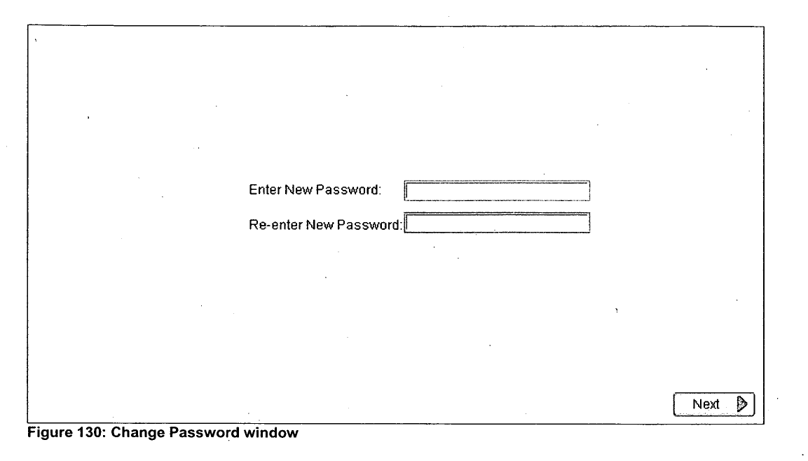

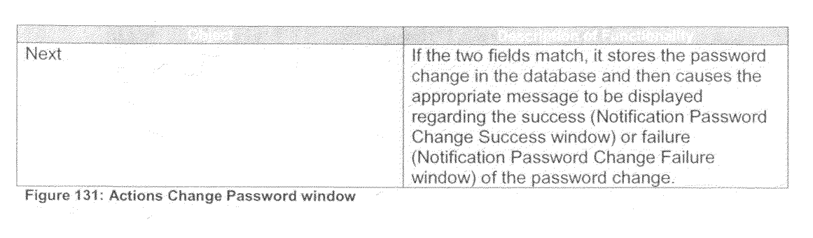

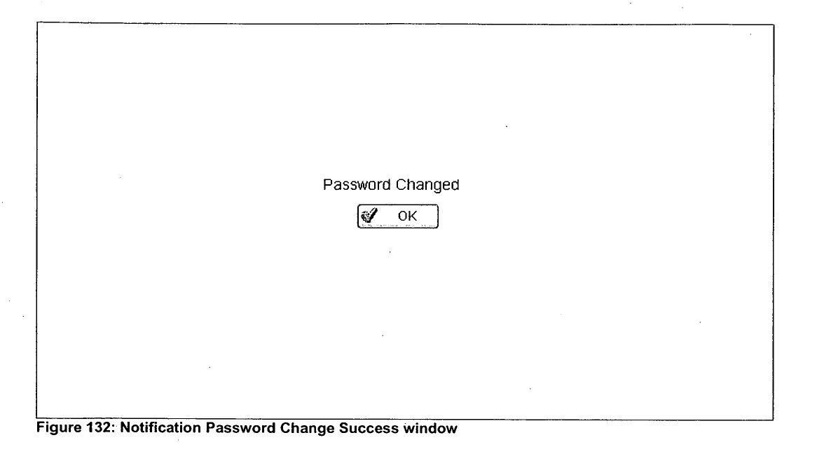

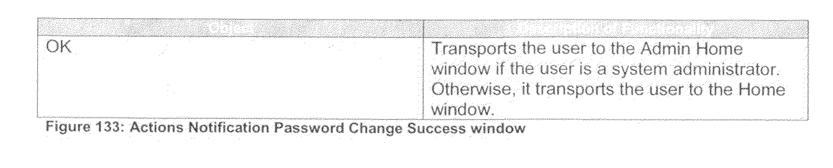

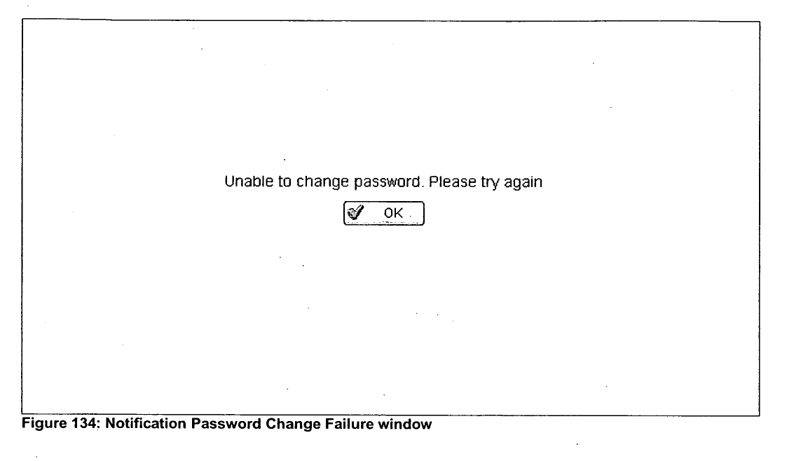

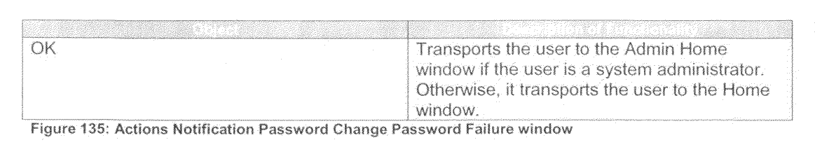

FIG. 32 represents Quick Links. Except for the Login window, all of the screens cause the same set of Quick Links to be used. However, some of the links may not be displayed based on the security attributes of the users. The system allows administrators to enable or disable various Quick Links for each user type or users.

FIG. 33 is an alternative set of Quick Links for the Login window and for use during the Recover Forgotten Password, Register via Invitation and Self-Registration workflows.

5e. Application Screens

The screens listed in the application screens section are accessible from the various portions of the application. The System Workflows section indicates the flow of the screens and how a given user may navigate to a screen.

Each screen has built-in user help. This is a commonly found attribute of many web applications and it is familiar to those skilled in the art. Upon moving the mouse over a given control, screen element or area of the screen, a message may be displayed to the user that indicates information on that particular area or screen element or screen control.

FIG. 34 is helpful to the user in using the screen.

5e1. Basic Profile Info

Overview

FIG. 35 is part of both the Self Registration, Register via Invitation, and Edit Account Profile workflows. It contains information common to all types of users.

Features

The primary roles are roles that are independent of the application. For example, an accountant is likely to work for the buyer on one application and for a seller on another application. FIG. 36 shows a listing of these roles.

Actions

FIG. 37 shows the actions.

Quick Links

If this window is displayed as part of the Edit Account Profile workflow, the Quick Links are the standard set used for all screens. If the window is displayed as part of the Register via Invitation or Self-Registration workflows, the set of Quick Links is the one from the Login window. This also applies to the windows for role-specific account information.

5e2. Buyer Info

Overview

In addition to the Basic Profile Info window, there are a number of windows for entering data specific to various types of roles. FIG. 38 is used for information that is specific to buyers, while other windows are used for brokers, sellers, management agents, and others.

Features

This screen collects information specific to buyers. In this example additional generic information is captured.

Actions

FIG. 39 represents the actions of the screen.

Quick Links

See the discussion of Quick Links for Basic Profile Info.

5e3. Board Member Info

Overview

FIG. 40 is used to collect profile specific information to Board Members. It is similar to that screen used for the Buyer (Buyer Info) except that a document preference is collected. This document preference is then used in preparation of the board package for review by this board member.

Actions

FIG. 41 shows a list of actions for this screen.

5e4. Broker Info

Overview

FIG. 42 is used to collect profile specific information for a Broker. It is similar to that screen used for the Buyer (Buyer Info) except that an organization name can be entered and a license number is collected.

Features

This screen collects information specific to brokers. In this example additional generic information is captured in addition to an organization name (the name of the agency or organization to which this broker belongs) and the license number.

Actions

FIG. 43 lists the actions of the screen.

5e5. Seller Info

See the section on buyer info.

5e6. Managing Agent Info

See the section on broker info.

5e7. Other Participant Info

See the section on broker info.

5e8. Confirmation

Overview

FIG. 44 shows the Overview of the screen.

Features

This window is part of the Self-Registration and Registration via Invitation workflows.

Actions

FIG. 45 shows the actions of the screen.

5e9. Login

Overview

FIG. 46 shows the login window.

Features

This window is the first thing the user normally sees when he uses his browser to access the system. The user is identified by his e-mail address and also has to enter a password in order to gain access to the system.

The Login window is part of the Self Registration and Home workflows.

Actions

FIG. 47 shows the actions of the login window.

Quick Links

FIG. 48 is in a frame to the left of this page.

5e10. Home

Overview

FIG. 49 shows the home screen.

Features

The main body of the Home window is a grid containing a list of all of the applications where the user has a role. It is fully populated when the window is first displayed.

The Application Name is a concatenation of the building name, the unit name, and the last name of the buyer, and is intended to provide a unique identification of the application. Even if there are multiple applications having the same parameters, the date created enables the viewer to distinguish between them. The Status field indicates the current status of the application and contains one of the following values: “pending approval”, “accepted”, “rejected”, and “in progress”.

This window is part of the Home workflow.

Actions

Clicking on the following buttons results in an action only if an application has been selected in the grid. FIG. 50 shows the button actions.

5e11. Building List

Overview

FIG. 51 is a screen shot of the Building List Screen.

Features

This window is used to select the building for which the building and unit information, application templates, and board information is to be set up. The only buildings that appear on this list are those for which the user has rights as a building manager.

This building is part of the Setup Building/Application workflow.

Actions

FIG. 52 shows the actions of the Building List Screen.

5e12. Building Profile

Overview

FIG. 53 is a screen shot of the Building Profile Screen.

Features

This window allows information to be entered for a building. In order to edit information on a building, the user is required to have a role as a managing agent for that building (meaning either the managing agent or the designated board member). When the building manager (or designated board member) first enters information for a building, it is necessary for the system administrator to confirm the entry before it can be viewed by others. This is required to verify that the individual is authorized to act as the building manager. If “Is self managed” is checked, the person setting up the building is deemed as a Board point person. This “point person” is designated as playing the building manager role, and as such receives the same information that the building manager does. Example: An applicant submits a completed package; if there is a building manager, it appears on that person's home screen; if there is no building manager the person who setup the building (point person) receives the application. The point person or managing agent will review, may ask for changes, and then may submit to the board.

This window is part of the Setup Building/Application workflow.

Actions

FIG. 54 shows the actions of the Building Profile Screen.

5e13. Building Units

Overview

FIG. 55 is a screen shot of the Building Units Screen.

Features

This window is used to edit information on the units within a building and can only be used if the user has a role as managing agent for the building. The main portion of the window is a scrolling list containing a list of units. Selecting a row in the list causes information on that unit to appear in the other fields on the screen.

This window is part of the Setup Building/Applications workflow.

Actions

FIG. 56 shows the actions of the Building Units Screen.

5e14. Building Application Templates

Overview

The purpose of this window is to allow the addition, deletion, and editing of application templates for a building.

Features

The Application Templates are templates that can be used to construct the Application Packages involved in the applications for condominiums and cooperatives. The data exists in a hierarchical structure of building (table CM_PCC_BUILDING in the database), application template (table CM_PCC_TEMPLATE), application template section (table CM_PCC_TEMPLATE_SECTION), and documents belonging to the application template section (table CM_PCC_TEMPLATE_CONTENT).

This window lists all of the application templates belonging to a specific building, and allows the addition and deletion of templates.

This window is part of the Setup Building/Application workflow.

Actions

FIG. 57 shows the actions for the Setup Building/Application workflow screen.

5e15. Building Application Template Sections

Overview

The Building Application Template Sections screen is used by managing agents or the given board designee to select the necessary sections for the application template to be used by buyers. Shown as FIG. 58.

FIG. 59 is a screen shot of the building application template sections (Document).

FIG. 60 is a screen shot of the building application template sections (form).

FIG. 61 is a screen shot of the building application template sections (Payment).

FIG. 62 is a screen shot of the building application template sections (Read Only).

Features

See the discussion of the Application Building Templates window for a discussion of the hierarchical structure represented by this window. This window allows a user to see all of the sections belonging to an application template. It also allows users to edit the information for an individual section.

The main portion of the window is a tree structure listing the sections in the template. A specific section can be selected by clicking on the row for the section, and this controls the behavior of the other fields and controls on the window. The other fields on the window always contain information for the selected section.

The order of the sections may be modified by the user (building manager or board point person) by dragging any section above or below another section.

On-line help is provided that assists the building user in completing these forms.

Example: when going to add a new section, examples of the different types of sections are provided. For example, the system could tell the user that an example of a “Read Only” section may be house rules, or a fire safety pamphlet. For a Form section, examples include: Basic application, schedule of stocks and bonds, etc.

FIG. 63 is part of the Setup Building/Application workflow.

5e16. Add Section

Overview

FIG. 64 is a screen shot of the add section window.

Features

The sections in an application template are based on reference sections (contained in the CM_PCC_REF_SECTIONS table in the database). This window can be used to select a subset of the reference sections to comprise an application template.

The list of available sections are fully populated when the screen is first displayed. (This is the same as a search with no selection criteria applied.) As the number of sections increases, it may be necessary to present an empty list when the screen is first created, and the list would only be populated after selection criteria are created.

It is possible to change the order of the selected sections by dragging individual items up and down in the list.

This window is part of the Setup Building/Application workflow.

Actions

FIG. 65 shows the actions for the add section.

5e17. Board Setup

Overview

FIG. 66 is a screen shot of the board setup window.

Features

This window allows the managing agent for a building to enter information on the board members for the building. The main body of the window is a scrolling grid containing a list of board members.

This window is part of the Setup Building/Application workflow.

Actions

FIG. 67 shows the actions of the board setup window.

5e18. Basic Deal Info

Overview

FIG. 68 is a screen shot of the Basic Deal Info Screen.

Features

This window is used to select a building when creating an application package.

The list of buildings are completely populated when the window first appears (no selection criteria) in the initial installation. As the number of buildings listed in the system increases, it may be necessary to provide an empty list when the screen is first created, and only fill in the table after selection criteria are provided.

This window is part of the Start a Deal workflow.

Actions

FIG. 69 shows the actions of the Basic Deal Screen.

5e19. Pick Unit

Overview

FIG. 70 is a screen shot of the Pick Unit Window.

Features

The purpose of this window is to select the building unit for which the application package is to be created. It is also possible to specify a previously existing deal from which the contents of the various sections of the application package are to be extracted. This import deal capability is described later on a different screen.

This window is part of the Start a Deal workflow.

Actions

FIG. 71 shows the actions of the Pick Unit Window.

5e20. Import Deal

Overview

FIG. 72 is a screen shot of the Import Deal Window.

Features

The main portion of this window is a grid listing all of the applications that the user has access to. He can then select one of the application packages and click on the Import button to transfer the information from the selected application to the application currently being set up. When the window is displayed, it includes all of the application packages in which the user has a role.

This window is part of the Start a Deal workflow.

Actions

FIG. 73 shows the Actions for the Import Deal Window.

5e21. List Collaborators

Overview

FIG. 74 is a screen shot of the List Collaborators screen.

Features

This window is used to display and edit information on the users who have been entered as collaborators on an application package. The user creating the application package is known as the collaboration manager and has the authority to make changes to the list of collaborators.

The main portion of this window is a scrolling grid containing a list of collaborators. Clicking on an entry in the grid causes details for that collaborator to appear in the right hand side of the window.

This window is part of the Invite Collaborators/Change Security workflow.

Actions

FIG. 75 shows the actions of the Window.

5e22. Invite Collaborator

Overview

FIG. 76 is a screen show of the invite collaborator window.

Features

This window is used when the user tries to add an individual as a collaborator using the Select Collaborator window, but the user is not a user on the system.

This window is part of the Invite Collaborators/Change Security workflow.

Actions

FIG. 77 shows the actions that go with the invite collaborator window.

5e23. Select Collaborator

Overview

FIG. 78 is a screen shot of select collaborator window.

Features

This window is used to indicate an individual who is to be selected as a collaborator on the application package.

This window is part of the Invite Collaborator/Change Security workflow.

Actions

FIG. 79 shows the actions of the window.

5e24. Sections/Permissions

Overview

FIG. 80 is a screen shot of the sections/permissions windows (Part 1).

FIG. 81 is a screen shot of the sections/permissions windows (Part 2).

Features

When adding a user as a collaborator, this window is used by the collaboration manager (the user inviting a collaborator) to specify what rights the individual has with respect to the various sections in the application package. Rights can be one of the following: no access, read access, and read/write access. This window can also be used to change the access rights of an existing collaborator.

The first screen shown allows the collaboration manager to select one of two special cases: read access to all sections and read/write access to all sections.

This window is part of the Invite Collaborator/Change Security workflow.

Actions

FIG. 82 shows the actions for window part 1.

FIG. 83 shows the actions for window part 2.

5e25. Collaborator Exists

Overview

FIG. 84 is a screen shot of the Collaborator Exists Screen.

Features

This window is displayed when an attempt is made to invite, an individual as a collaborator and the individual already has an account on the system. It displays information on the potential collaborator so that the collaboration manager can verify that he is selecting the correct individual. The collaboration manager can select the role that the individual is to have on the application package and then click on the Next button to go to the next step in the process.

This window is part of the Invite Collaborator/Change Security workflow.

Actions

FIG. 85 shows the actions of the screen.

5e26. Already Collaborator

Overview

FIG. 86 is a screen shot of the Already Collaborator Screen.

Features

This window is displayed when an attempt is made to invite an individual as a collaborator, but the individual is already a collaborator on the application package. For such individuals, this window can be used to alter the role of the individual on the application package and to change the individual's access rights.

This window is part of the Invite Collaborator/Change Security workflow.

Actions

FIG. 87 shows the actions of the screen.

5e27. Notification Preview

Overview

FIG. 88 is a screen shot of the Notification Preview Window.

Features

When the collaboration manager invites a new collaborator or changes the access rights of an existing collaborator, this window allows the transmission of a notification to the collaborator concerning the changes to the collaboration roles and accesses. It lists the role and the rights that the collaborator has on the project so that the collaboration manager can review the information prior to sending the notification.

This window is part of the Invite Collaborator/Change Security workflow.

Actions

FIG. 89 shows the actions of the screen.

5e28. Browse Package

FIG. 90 is a screen shot of the Browse Package (No Selection Window).

Overview

FIG. 91 is a screen shot of the Browse Package (Document) Window.

Note: An alternative view may be provided whereby the documents are not listed to the right of the tree structure; rather they are listed within the tree structure on the left hand side.

FIG. 92 is a screen shot of the Browse Package (Form) Window.

FIG. 93 is a screen shot of the Browse Package (Payment) Window.

FIG. 94 is a screen shot of the Browse Package (View) Window.

Features

This window allows the user to work on the various sections of the application package. The main portion of the window is a scrolling grid containing a list of the sections in the application package. Clicking on one of the rows in the grid causes detailed information on the section to appear in the window.

This window has four variations. The first is for when the window is first populated and has the right side of the window blank. This is the “no selection” option. Once a section has been selected in the grid, the appearance of the window depends on the type of section selected (Document, Form or Payment).

The radio buttons in the Browse Package (Payment) view affects the appearance of the page and the action of the Next button.
a. The “Image of Check” panel for Browse Package (Payment) is only visible if the “Copy of Check” radio button is selected.
b. If the Paypal radio button is selected, clicking the Next button results in the system displaying windows for the handling of Paypal payments consistent with standard industry practice. After the processing is complete, the user is transported to the Home window.
c. If the Credit Card radio button is selected, clicking the Next button results in the system displaying windows for the handling of credit card payments consistent with standard industry practice. After the processing complete, the user is transported to the Home window.

This window is part of the Review, Edit, Author Docs workflow.

The instructions section of the windows above describe the instructions that are needed by the end user to fulfill that section. The system screens may be designed in such a way that it is more intuitive for the end user to see how to accomplish each section. If this were the case, the instructions would not be needed or could be optional. Upon moving his mouse over a given control, information is displayed to the end user explaining that control's use.

The ability to annotate sections with notes is a mandatory feature of the form viewing capability listed in the Appendix section.

Actions

FIG. 95 is a list of actions for the Browse Package screen.

5e29. Invite Section Helper

Overview

FIG. 96 is a screen shot of the invite section helper window (Start).

FIG. 97 is a screen shot of the invite section helper (Review).

FIG. 98 is a screen shot of the invite section helper (Confirm).

Features

This window allows the user to invite someone to participate on the currently selected section. This is different than the collaborator button in that it applies only to a given section and it is used where a helper is to be invited only for a single operation. If someone helps on various sections, they are not a section helper, rather they are a collaborator. Overall the screen flow allows the inviting of a helper (by name and email address) and allows the user to review the “Call to action” by default a call to action is generated that says “please help with this section.” It may then be changed by the user to anything that they want. Examples include “please add a document to this section” etc. The “Call to action” gets incorporated into the email that is ultimately sent to the section helper. The email is previewed after user presses next. Finally the user sees a confirmation screen and then upon pressing “send” the email is generated.

Actions

FIG. 99 is a list of actions in the invite section helper window.

5e30. Section Helper

Overview

FIG. 100 is a screen shot of the Section Helper Window.

FIG. 101 is a screen shot of the Help on Document.

FIG. 102 is a screen shot of the Help on Form.

FIG. 103 is a screen shot of the Help on Payment.

Features

This screen is displayed once the section helper clicks on the link in the email sent to them by the system. The system first confirms with the section helper that they can participate. If they cannot, they are routed out of the system. If they can participate, they indicate this by pressing “Next.” After pressing “Next” the system displays the appropriate window based on the type of section that they need to participate on. The call to action that was confirmed by the person asking for help is displayed along with the instructions for that particular section. Only those controls that are needed to fulfill the specific section are provided.

Actions

FIG. 104 shows a list of the actions used for this screen.

5e31. Prepare Final Packet Wizard

Overview

FIG. 105 is a screen shot of the prepare final package wizard (Start).

FIG. 106 is a screen shot of the prepare final package wizard (Document).

FIG. 107 is a screen shot of the prepare final packet wizard (no print).

FIG. 108 is a screen shot of the prepare final pack wizard (Completions).

Features

The purpose of this window is to walk the user through the process of printing the various hard-copy documents that make up the application packet. As the user goes through the process, it tells the user how many copies to make of each document and provides a window from which the document can be printed.

This window is part of the Prepare Final Packet workflow.

Upon invoking this process; a snap-shot of the current application (with only those documents listed as “Active”) is taken and submitted to the managing agent or the board point person for review. The status of the application is changed from In-Progress to Pending approval. The owner of the application is the only one who can see the submit button. The item remains in the home with the new status.

Actions

FIG. 109 is a list of actions for the Prepare Final Packet Wizard Window.

5e32. Review Message Board

Overview

FIG. 110 is a screen shot of the Review Message Board Window.

Features

Before the application package has been submitted and after, the system provides a message board for the collaborators to use. After the application package has been printed and submitted, the system provides a second message board for the board members to discuss the application packages.

The two message boards are separate and not available to either party.

The main portion of this window is a scrolling grid that provides information on the messages that have been entered on the message board. Selecting the row for a message provides the complete text of the message in a separate scrolling grid.

There is also a button on the window that the board member can use to add a message to the message board.

This window is part of the Participate in Discussion workflow.

Actions

FIG. 111 is a list of actions for the screen.

5e33. Add Message

Overview

FIG. 112 is a screen shot of the Add Message Window.

Features

This window allows a board member to add a message to the message board for an application package.

This window is part of the Participate in Discussion workflow.

Actions

FIG. 113 is a list of actions used for this window.

5e34. Indicate Decision

Overview

FIG. 114 is a screen shot of the Indicate Decision Window.

Features

This window allows the managing agent to indicate whether the application package has been accepted or rejected (or that further content is needed). This decision results in the transmittal of an e-mail message to the buyer and/or buyer's agent. If a given application is rejected, it stays in the list of applications for the owner, however it is removed from the list of visible applications provided to the board members and managing agent. Business rules may be used such as Date of rejection+30 days to control the expiration of access to the system for collaborators.

This window is part of the Register Decision workflow.
Actions

FIG. 115 is a list of actions that go with this window.

5e35. Admin Home

Overview

FIG. 116 is a screen shot of the Admin Home Window.

Features

This window represents the screen that the System Administrator sees after logging in to the system.

This window is part of the Setup & Maintenance workflow.

### Actions

### None

5e36. Browse Section List

Overview

FIG. 117 is a screen shot of the Browse Section List Window.

FIG. 118 is a screen shot of the Browse Section List Window (Form).

FIG. 119 is a screen shot of the Browse Section List Window (Document).

FIG. 120 is a screen shot of the Browse Section List Window (Payment).

FIG. 121 is a screen shot of the Browse Section List Window (Read Only).

Features

The purpose of this window is to create the application reference sections that is used to construct the sections in the application templates. The layout of the window depends on the type of section being created: document, form, or payment.

These windows are part of the Setup & Maintenance workflow.

Actions

FIG. 122 is a list of actions for the window.

5e37. Recover Forgotten Password

Overview

The process is started by clicking on a link on the opening page for the site. When the user clicks on the link to recover a password, the following message is displayed and the user enters his e-mail address. All e-mail addresses are converted to lower case before being used by the system.

FIG. 123 is a screen shot of the Recover Forgotten Password Window (Address)

The system then retrieves the security question and the answer that was entered when the user set up his account profile. This must be on a second screen because different users have different security questions.

FIG. 124 is a screen shot of the Recover Forgotten Password Window (Security Question).

If the information submitted by the user agrees with the information in the database, a new password is sent to the user via e-mail. After this is accomplished, the following message to shown to the user to verify that the information was correct.

FIG. 125 is a screen shot of the Recover Forgotten Password Window (Confirmation)

If the information submitted by the user does not agree with what is stored in the database, no action is taken and the following message is displayed.

FIG. 126 is a screen shot of the Recover Forgotten Password Window (Failure). These windows are part of the Home workflow.

Features

The purpose of these windows is to enable a user to recover his passwords if he (or she) has forgotten it. Information on the windows is provided next to the screen shots in the overview above. Security is provided in that password information is only be sent to the e-mail address belonging to the account.

These windows are part of the Home workflow.

Actions

FIG. 127 is a list of actions that go with this window.

Quick Links

The Quick Links for this window are the same as those for the Login window.

5e38. Account Change Notification

Overview

FIG. 128 is a screen shot of the Account Change Notification Window.

Features

This window is generated when the user changes his account profile information as a confirmation of the change.

This window is part of the Edit Account Profile workflow.

Actions

FIG. 129 is a list of actions for this screen.

5e39. Change Password

Overview

FIG. 130 is a screen shot of the Change Password Window.

Features

The user can reach this window by using the Change Password quick link. He is required to enter his password twice and the text field on the window does not display the text being entered. This helps guard against typographical errors in entering the password and the possibility that people standing near the workstation might be able to learn the password.

This window is part of the Change Password workflow.

Actions

FIG. 131 is a list of the actions that go with this screen.

5e40. Notification Password Change Success

Overview

FIG. 132 is a screen shot of the Notification Password Change Success Window.

Features

This window is presented to the user after clicking on Next in the Change Password window to indicate that the password change has been successfully carried out.

This window is part of the Change Password workflow.

Actions

FIG. 133 is a list of the actions that go with this window.

5e41. Notification Password Change Failure

### Overview

FIG. 134 is a screen shot of the Notification Password Change Failure Screen.

Features

This window is presented to the user after clicking on Next in the Change Password window to indicate that the password change was unable to be successfully carried out.

This window is part of the Change Password workflow.

Actions

### 6. Business Logic

This section lists the events being created or modified to support the business requirements.

6a. Paper Savings

For each document in the final packet, the paper savings are calculated as n×l (where n is the number of board members selecting soft-copy as the preference and l is the number of pages in the document) for Document sections and (n+1)×l for Form sections. The paper savings for the entire application package is summation of the savings of each individual document.

This calculation shall be made during the processing of the Prepare Final Packet wizard and the total value is added to the box in the header of the containing window. (See the section on overall screen layout.)

The calculation of other natural resource savings may be displayed along with the Paper Savings.

### 7. Manual Processes

Communications that is not related to the construction of the application packet takes place outside of the system.

### 8. Reports

This section shows reports that can be executed within the application, the data, and how it relates to the database.
a. List of applications for a building
b. List of units for a building
c. List of buildings
d. List of accounts

8a. E-mail Messages
a. Acceptance or rejection notice generated from the Indicate Decision window in the Register Decision workflow.
b. Notification of password generated by the Confirmation window in the Self-Registration workflow.
c. Notification of password generated by the Confirmation window in the Registration via Invitation workflow.
d. Notification of change of account information generated from the Account Change Notification window in the Edit Account Profile workflow.
e. Notification of change in access rights generated by the Notification Preview window in the Invite Collaborators/Change Security workflow.

8b. Fax Cover Sheet

In order to accept documents via facsimile, it is necessary to provide a computer readable page that can serve to identify the documents to the system. For this reason, the Section Detail screens can be used to print cover sheets which can be read by the system when they are fed in through facsimile.

8c. List of Applications for a Building

This report enables the managing agent or system administrator to review the list of application packets for a building.

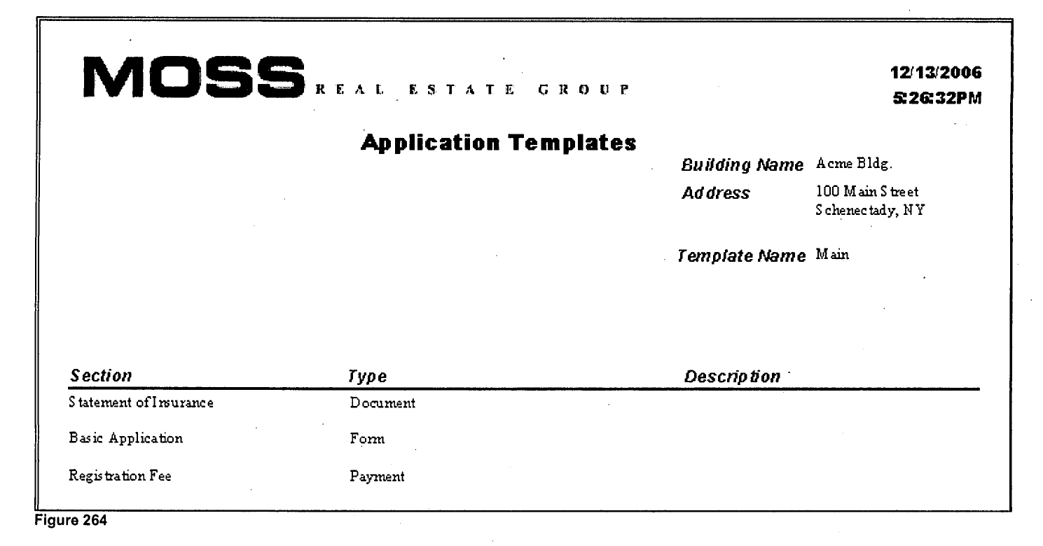

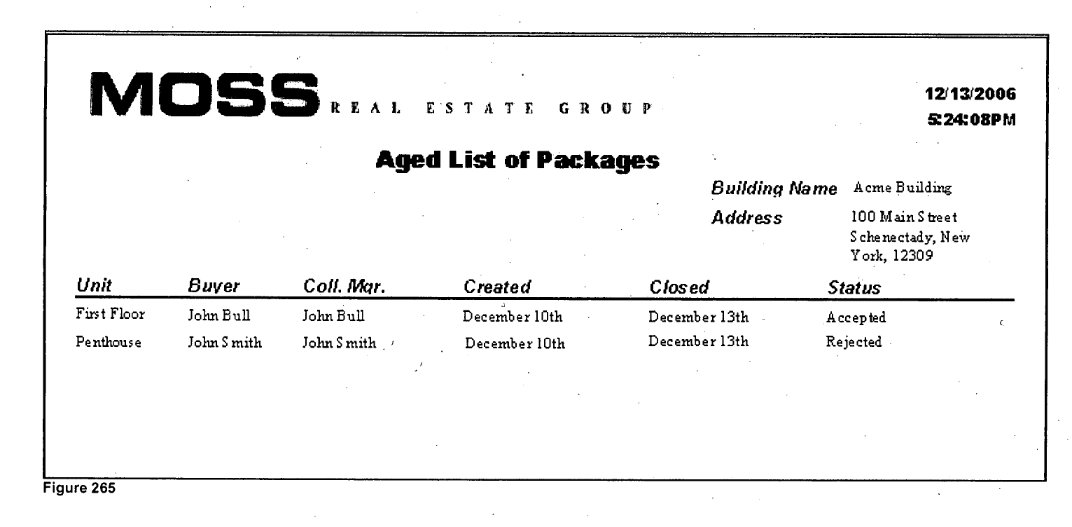

FIG. 264 shows an example of this report.

The parameters include the following:
Search criteria for building (same as on Basic Deal Info window)

The report includes the following items:
Name and address of building
Name of each section together with descriptive information and instructional text from window

8d. Aged List of Applications

This report enables a managing agent or system administrator to obtain lists of open or closed application packages based on criteria for the creation or closure dates. Some of the purposes for which this report may be used are as follows:
a. Identify applications that have been open for a period greater than a given parameter. (e.g., 2 years) These applications were often started in error or abandoned after creation, and consideration should be given to removing them from the system.
b. Generate reports that can show changes in number of application packages over time.

FIG. 125 shows an example of this report.

The following are parameters to be included for the reports.
a. Check box for including active application packages
b. Check box for including accepted application packages
c. Check box for including rejected application packages
d. Date range for creation of application packages
e. Date range for closure of application packages
f. Search criteria for selecting buildings (Same as on Basic Deal Info window)

The report includes the following information:
a. Name and address of building
b. Name of unit
c. Name of buyer
d. Name of collaboration manager
e. Date of application package creation
f. Date of application package closure
g. Status of application package

8e. List of Units for a Building

This report enables the managing agent to obtain a list describing all units within a building.

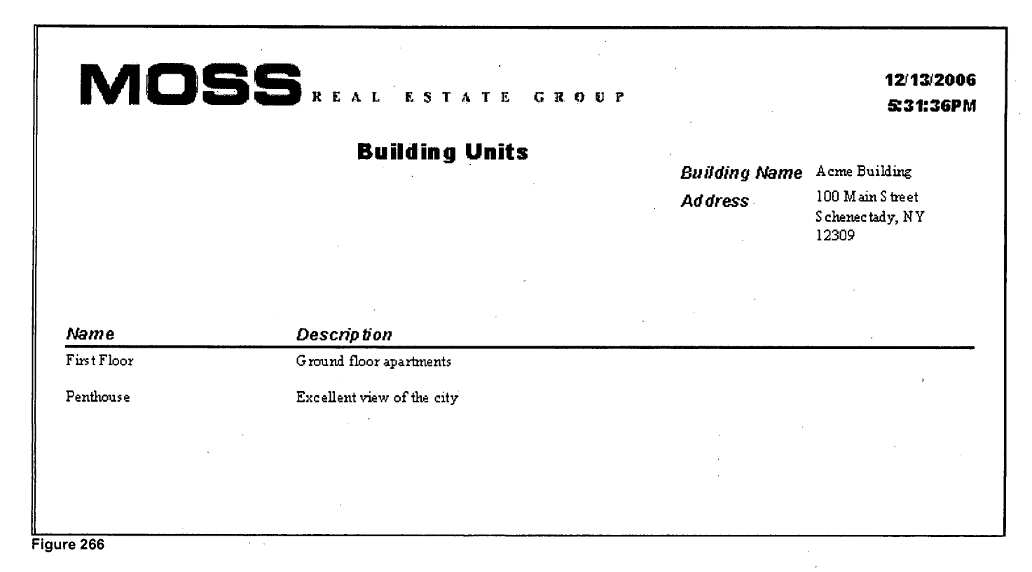

FIG. 266 shows an example of this report.

The parameters include the following item:
Search criteria for building (same as on Basic Deal Info window)

The report includes the following items:
Name and address of building
Name of each unit together with the descriptive information

8f. List of Buildings

This report enables the system administrator to review the list of buildings in the system.

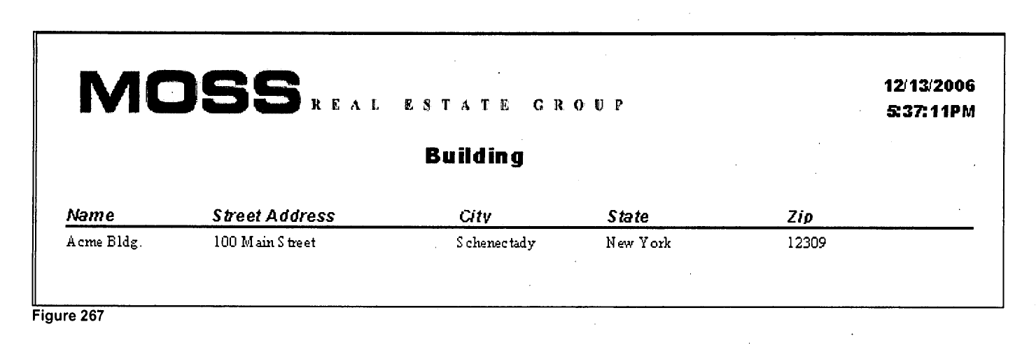

FIG. 267 shows an example of this report.

The following are parameters for the report.
a. Search criteria for building (same as on Basic Deal Info window)

The following items are listed on the reports:
b. Name and address of building
c. Name and address of managing agent for building

8g. List of Accounts

This report enables the system administrator to review the list of users on the system.

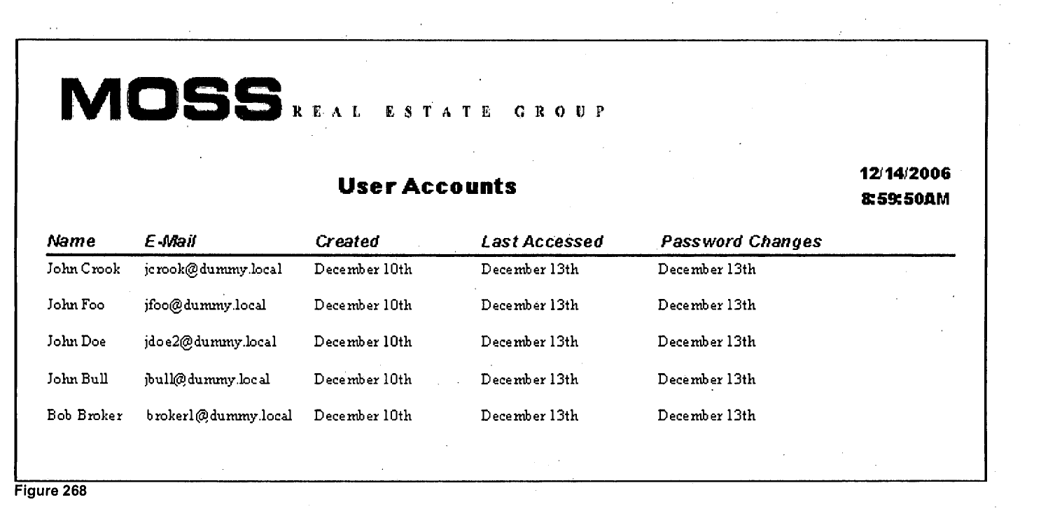

FIG. 268 shows an example of this report.

The following represent parameters for the report:
a. Date range for creation of account
b. Date range for last access by account
c. Date range for last password change by account

The following items are listed on the report:
a. E-mail address for account
b. Name of user (prefix, first name, last name, suffix)
c. Address of user
d. Date account created
e. Date account last accessed
f. Date of last password change

### 9. Data Model

This data model involves a number of hierarchical structures
a. Building, Unit, Application, Section, Document—This represents the hierarchy for a specific application package.
b. Building, Application Type, Section, Document—This represents the hierarchy for an application type.

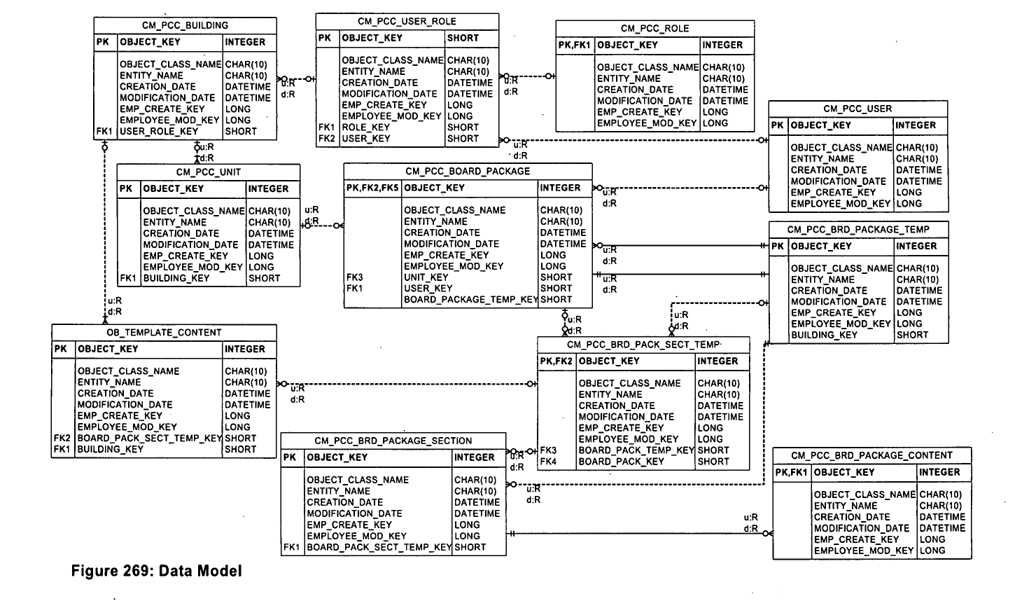

FIG. 269 shows the data model for the application.

### 10. Appendix A Forms Component

A variety of options may be used for displaying and capturing the data for those sections of a board package that are considered “forms.” In the embodiment described in this document, editable PDF forms are used. Alternative mechanisms include use of alternative forms products, HTML forms, and a fully custom developed plug-in. While the details of such mechanisms are well known to those skilled in the art, it is relevant to consider a set of favorable attributes for these mechanisms to allow selection of the best mechanism to meet the needs of any particular implementation of this invention.

Favorable attributes are listed and several currently known mechanisms are compared in a matrix.

FIG. 270 shows a table of these favorable attributes.

A brief description is now given of each of the 3 mechanisms that were considered.

i. Editable PDF Forms (w/ Security)

PDF is a widely used format for the distribution of electronic documents as well as electronic forms. Editable PDF forms allow a user to download a file, open it in a PDF viewer (in the browser or outside of the browser) enter data into a form, and then save that file to be uploaded back to a server. An enhanced version (in use in many settings) of this is used which allows for an encrypted file. As the user opens the file, a message is sent to the server asking if the user currently has access to view the file, only if the user has access to the file is the file then unencrypted and viewed. This mechanism prevents the case where a secure document is downloaded, viewed, and subsequently forgotten about. In such a scenario if the document was later found, and attempted to be viewed, an authentication request with the server would result in a denial because the expiration period would have passed. As such, the document would not be able to be opened and the sensitive information would be protected. The main drawback of this mechanism is that it requires the user to be familiar with the concept of computer files and it requires the user to download the file and then upload it when they are ready.

ii. HTML Forms

This approach basically requires that a custom HTML form be created for each electronic form that is required. This is the major drawback of this approach. The creation of an HTML form is currently a task that requires some software development skills. It is advantageous to allow building managers to create forms for their buildings; requiring that they create an HTML version of the form will inhibit wide-spread use of the system. In this approach, as a user selects a form, the form is displayed on their screen seamlessly, unlike the Editable PDF Forms (w/security) approach, no file download or management is necessary. The information entered into the forms is transmitted directly to the server using normal security mechanisms such as SSL.

iii. Custom Plug-in that uses PDF API

This approach attempts to address the negative aspects of the Editable PDF Forms (w/ security). It is known to those skilled in the art that a custom application plug-in may be created to replace the PDF viewer for a given website. This custom PDF viewer abstracts the user from the file transfer intricacies, thereby creating a more seamless end user experience. Specifically, this custom PDF viewer displays the PDF form within the browser and has one button on it. When depressed, this button saves the file, closes the viewer, uploads the file to the server, and then automatically deletes the file from the user's computer. While this approach solves the usability issue of the standard PDF viewer, it creates a new issue. Presently, many computers are configured in such a manner that they do not allow the downloading of such custom plug-ins. However, upon reconfiguration, this approach becomes a viable alternative.

### 11. Appendix B Scenario Listing

This is the list of scenarios that cover this application. They are kept as separate documents as referenced below.

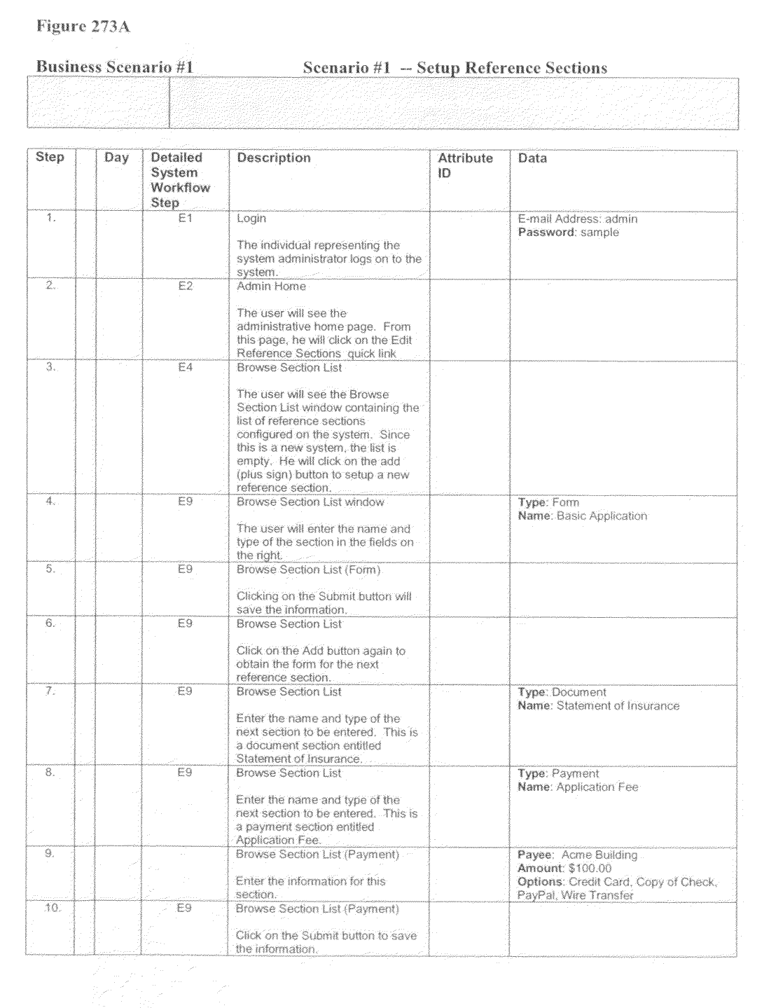

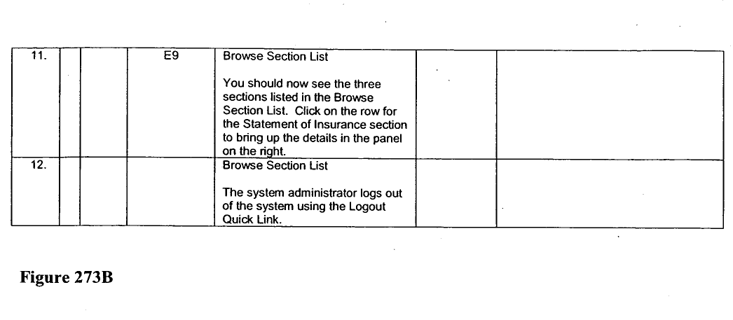

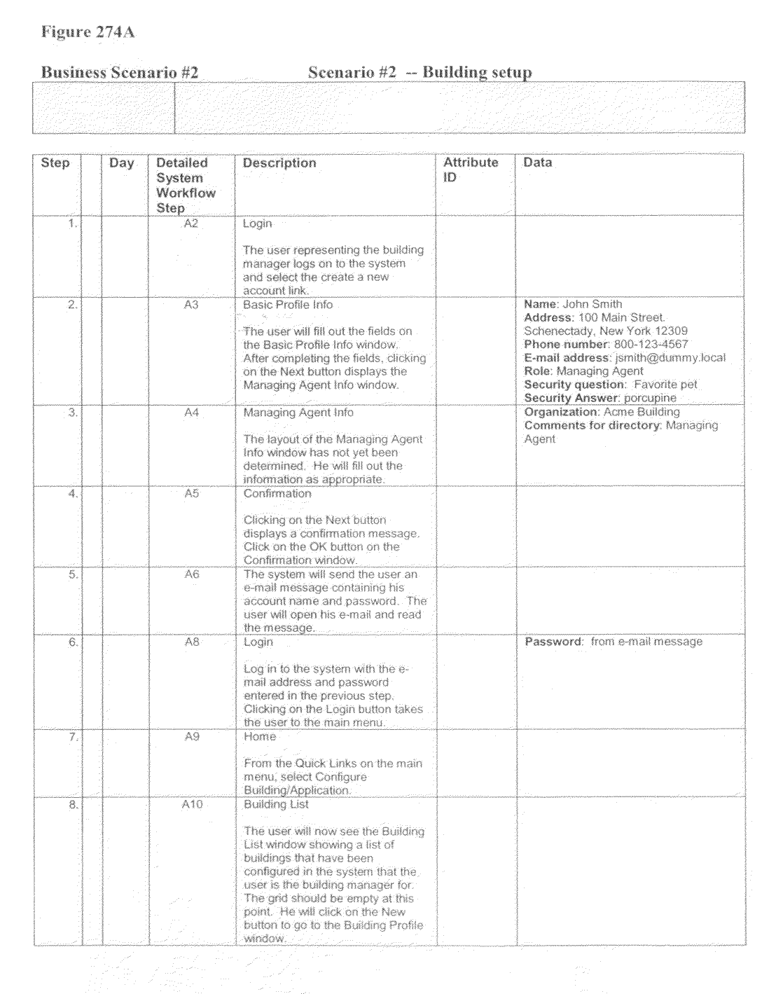

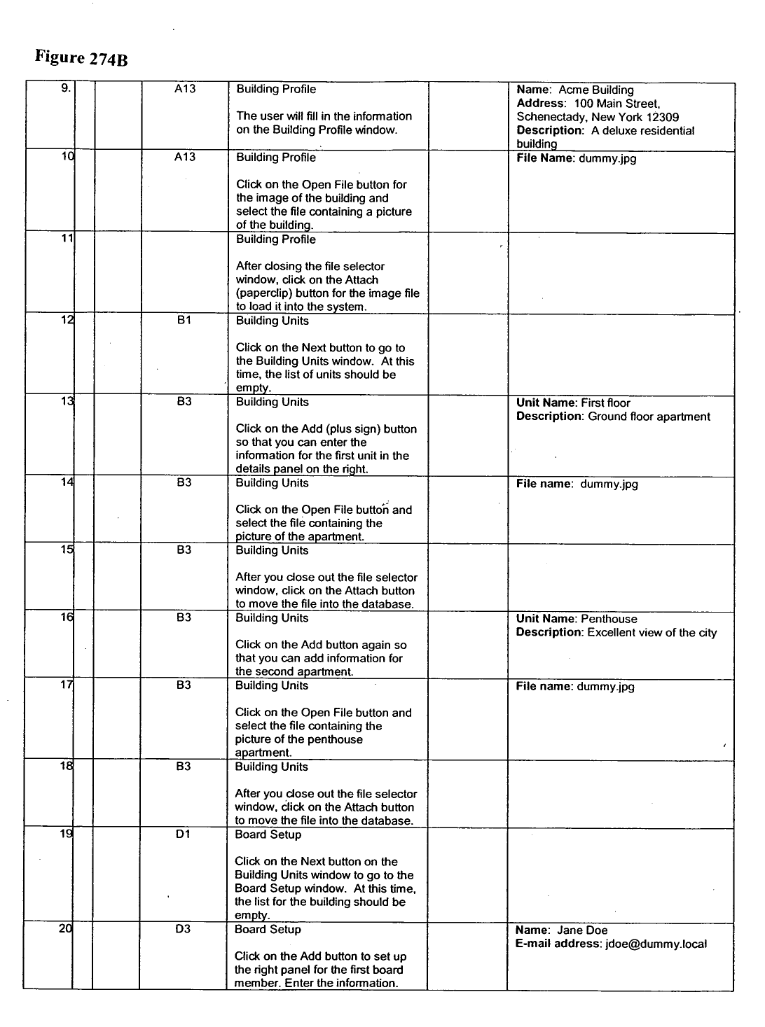

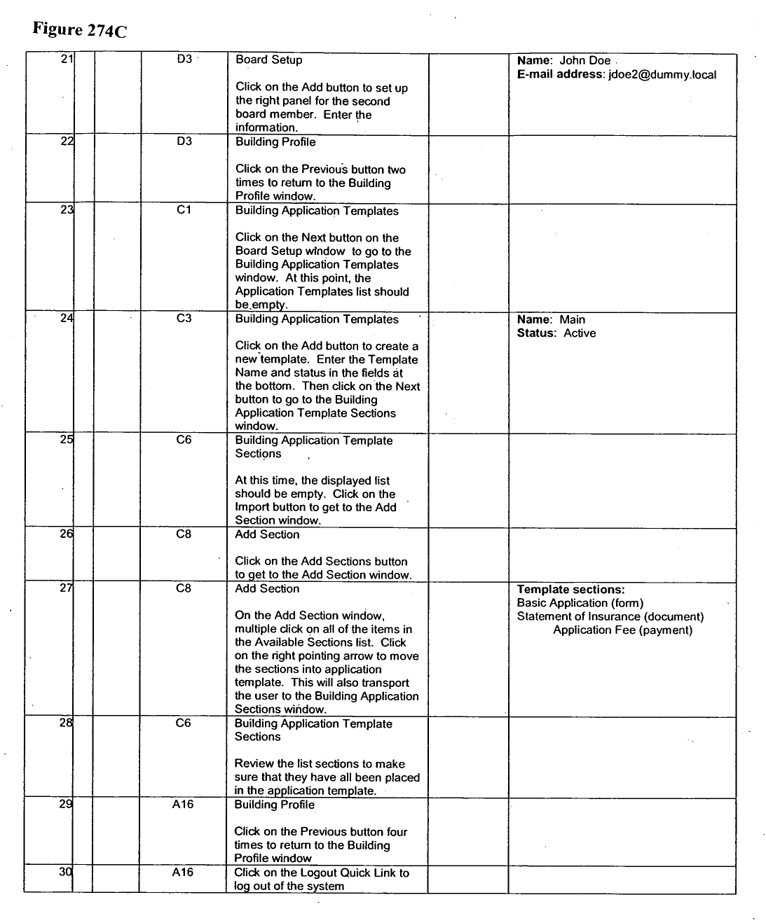

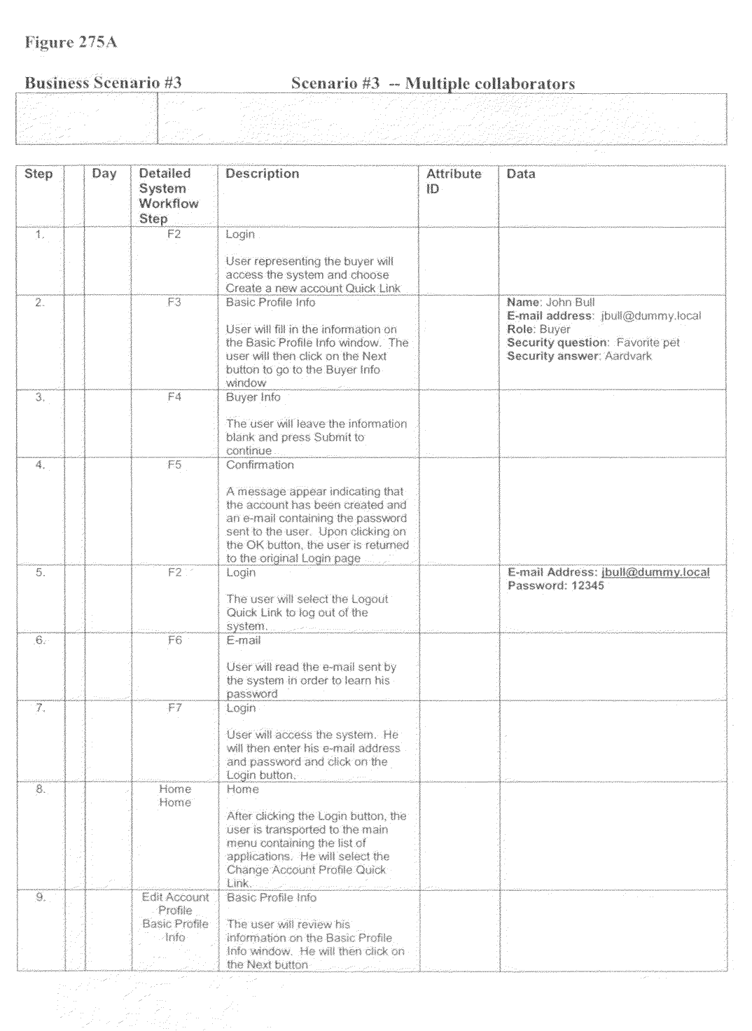

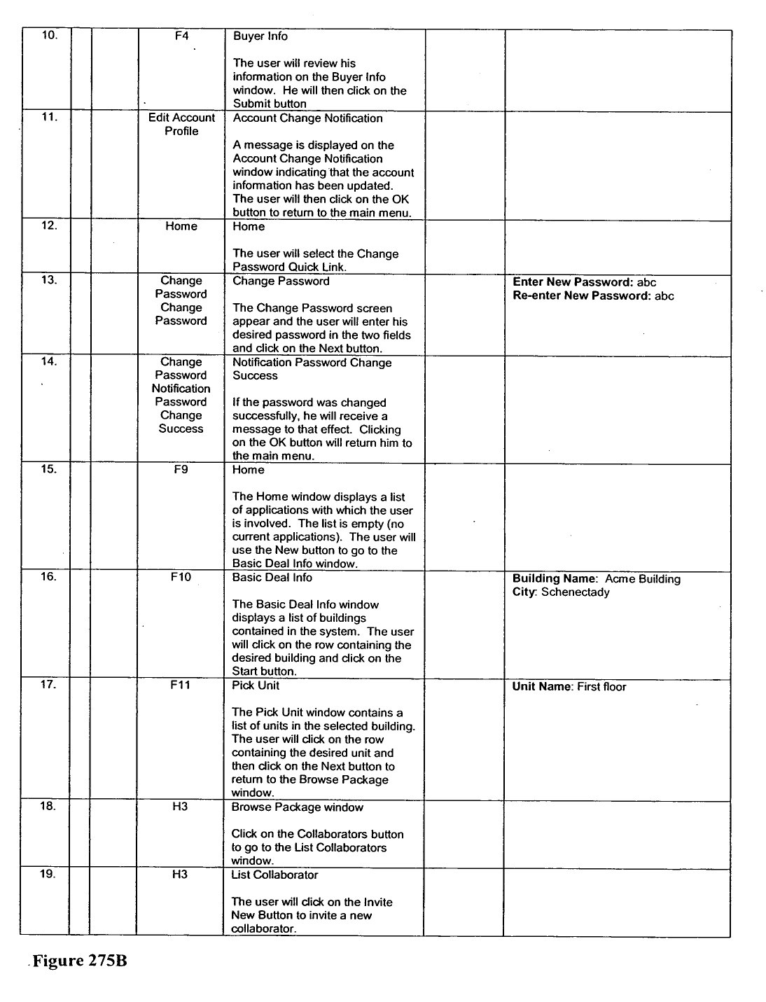

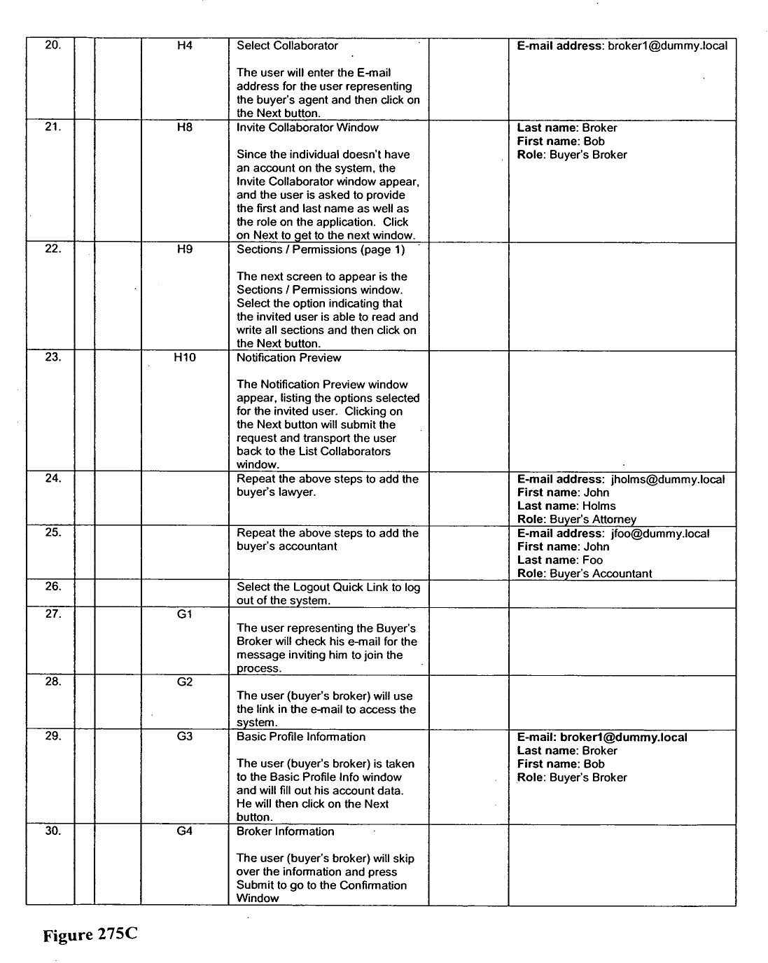

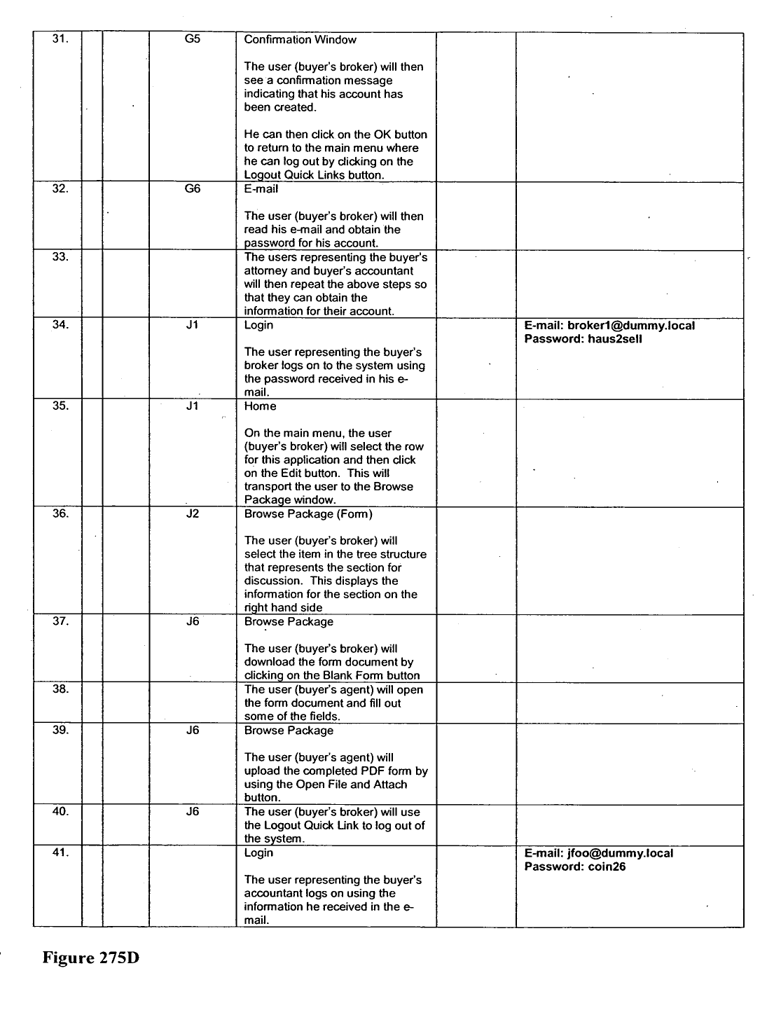

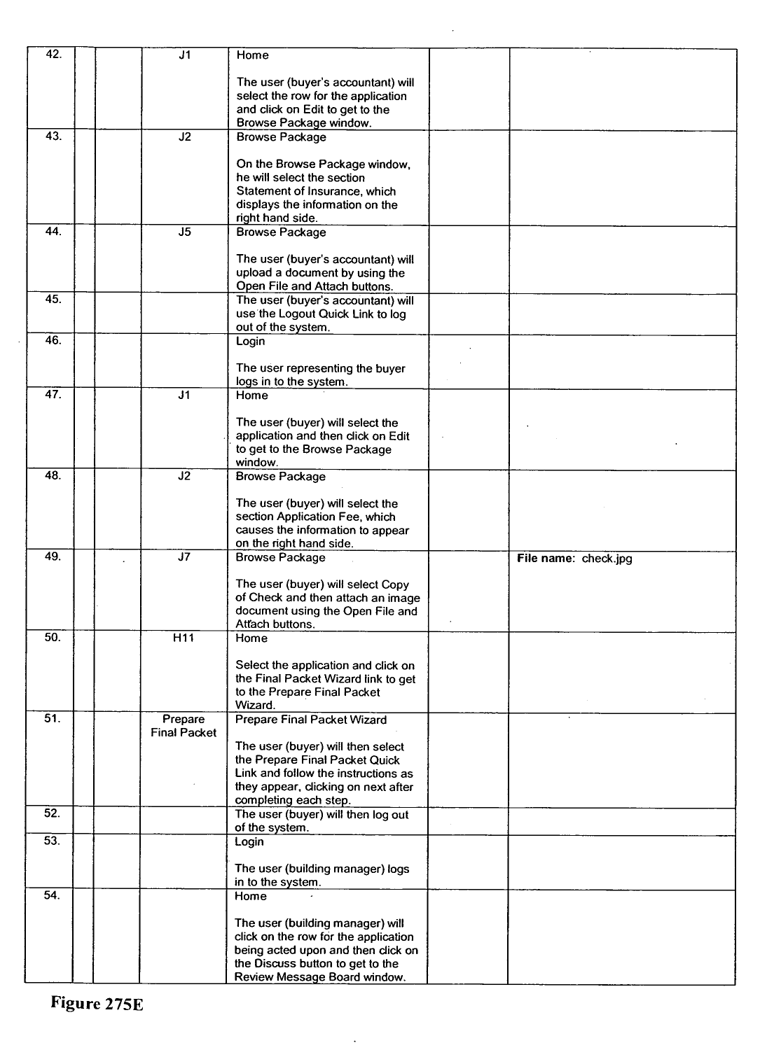

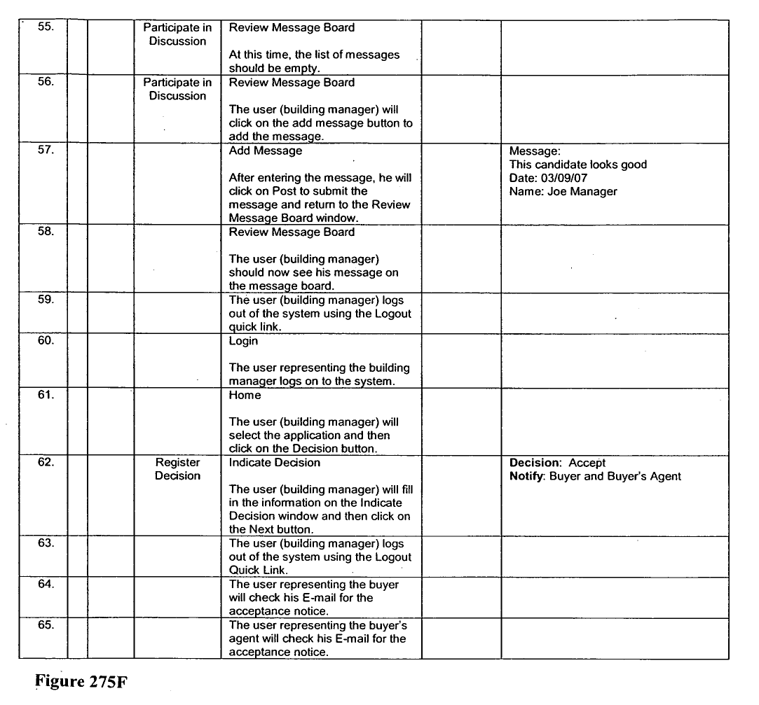

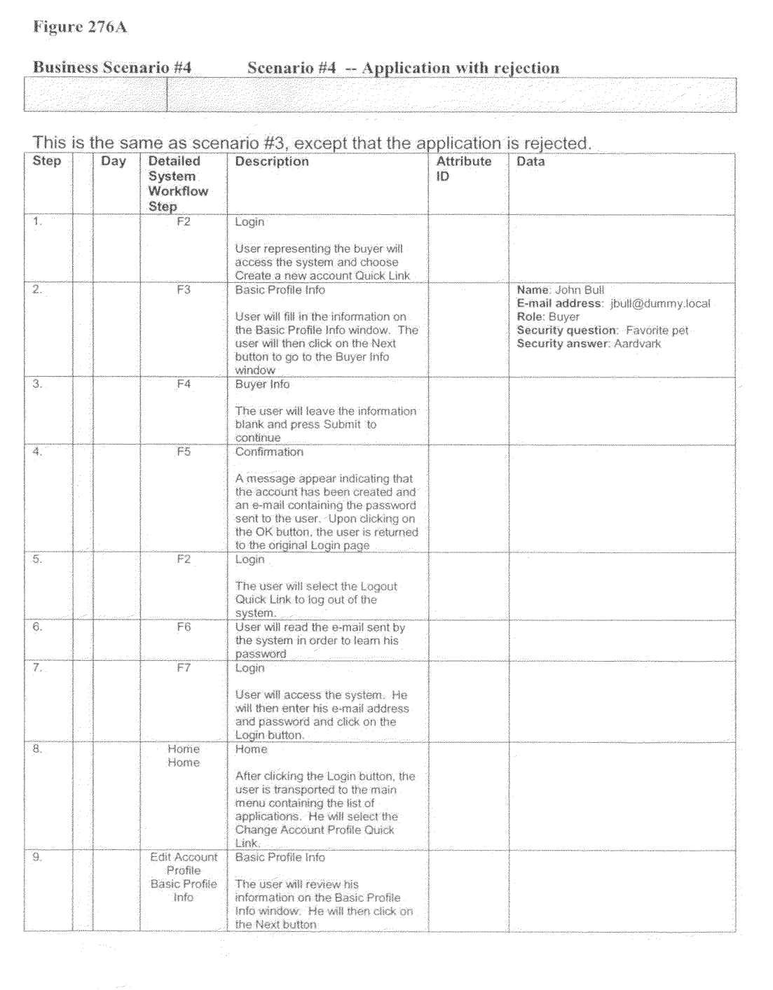

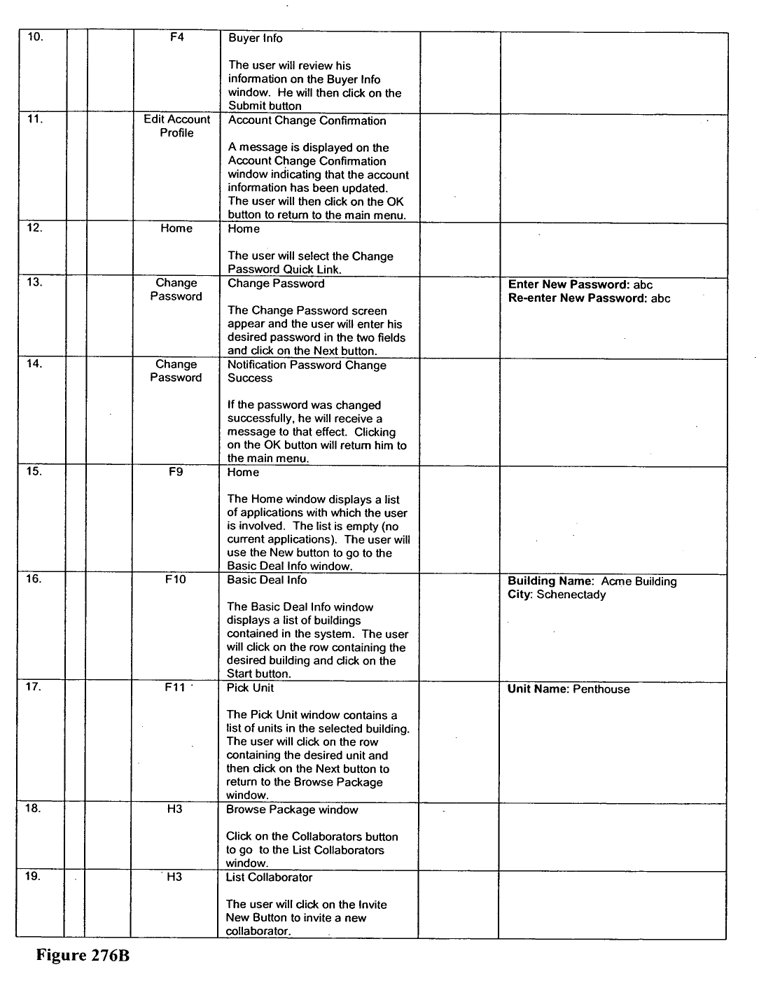

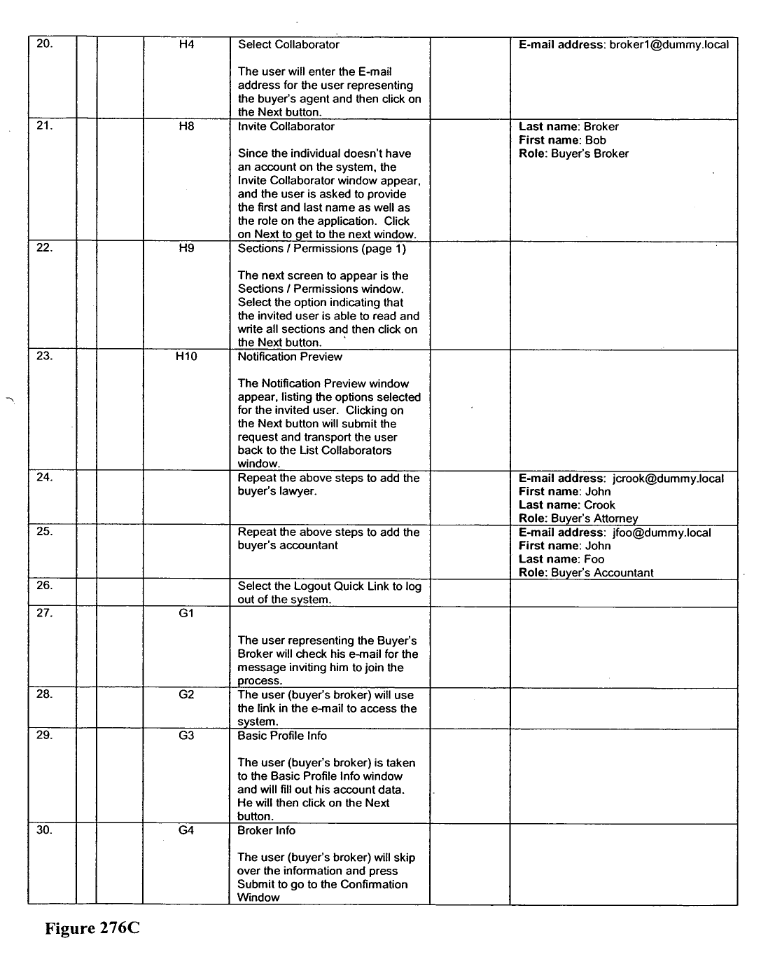

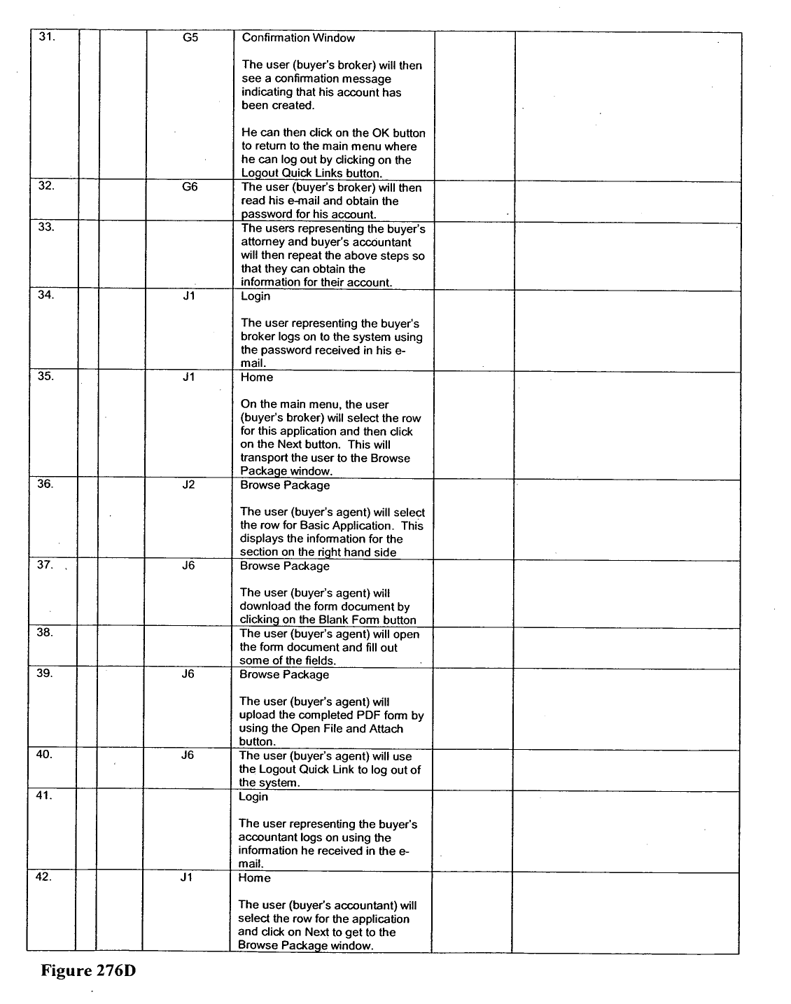

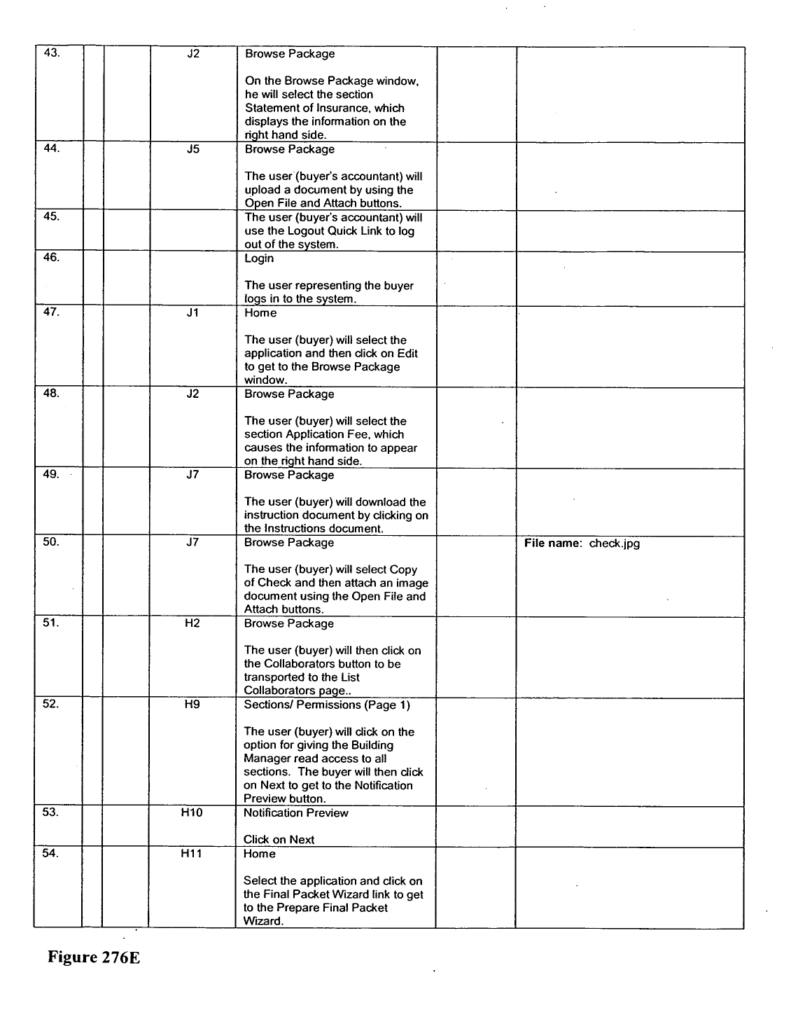

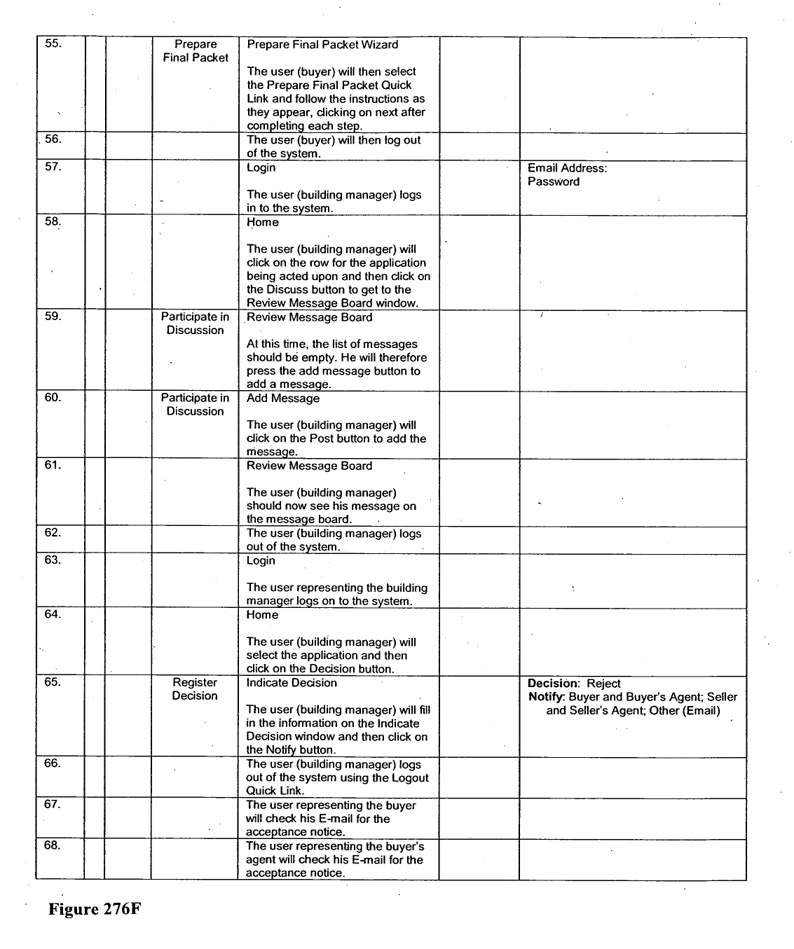

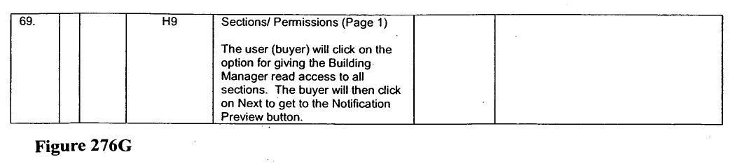

FIG. 271 is a listing of the scenarios.
11a. Setup reference sections—See FIGS. 273A-273B
11b. Building setup—See FIGS. 274A-274C
11c. Multiple collaborators—See FIGS. 275A-275F
11d. Application with rejection—See FIGS. 276A-276G

### 12. Appendix C System Example

The scenario labeled “Multiple Collaborators” from the previous section is used as a full example through the system. Screen shots are shown for each step of the scenario

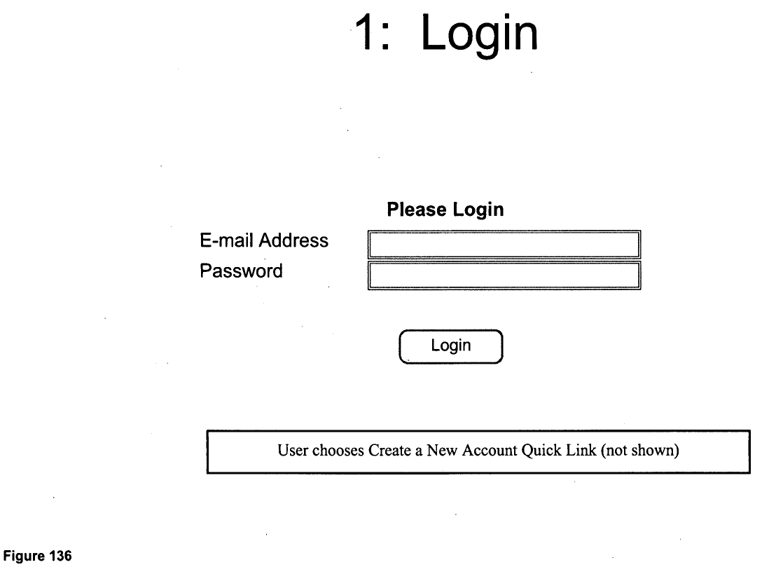

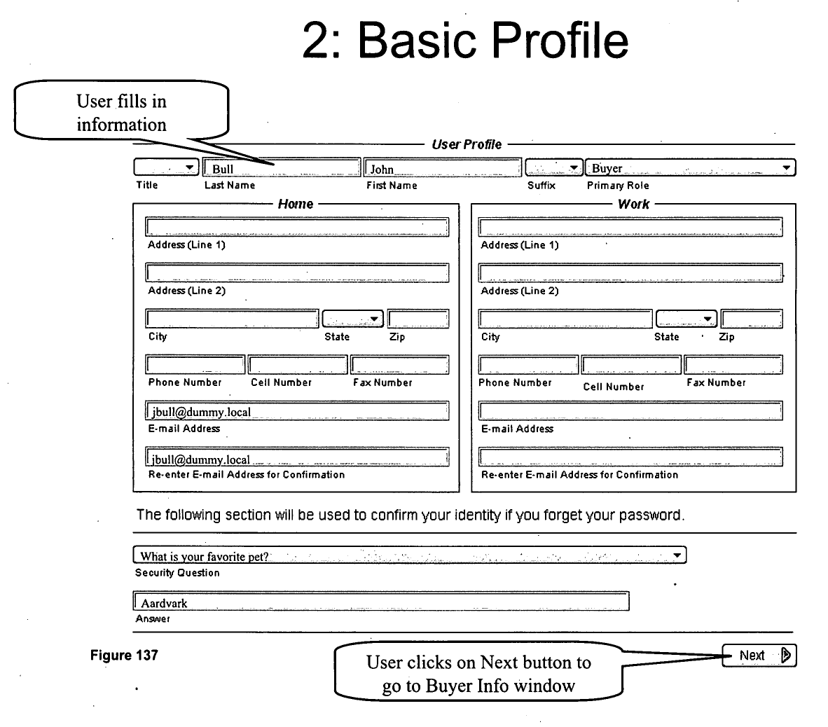

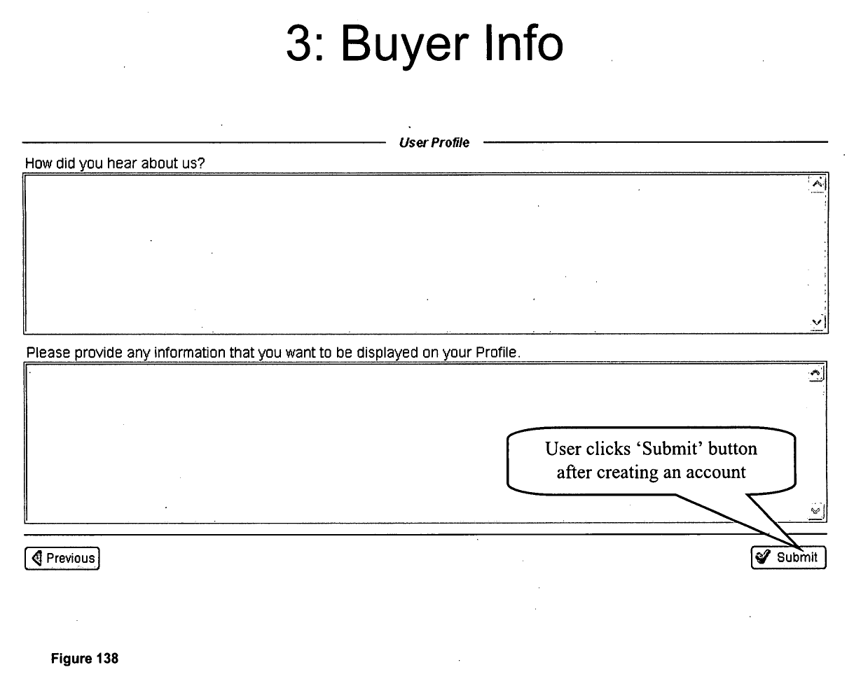

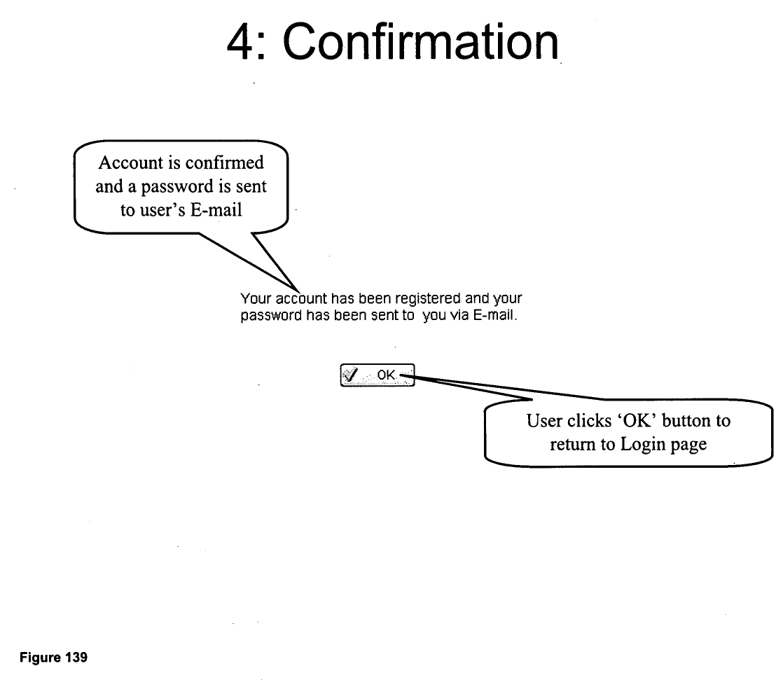

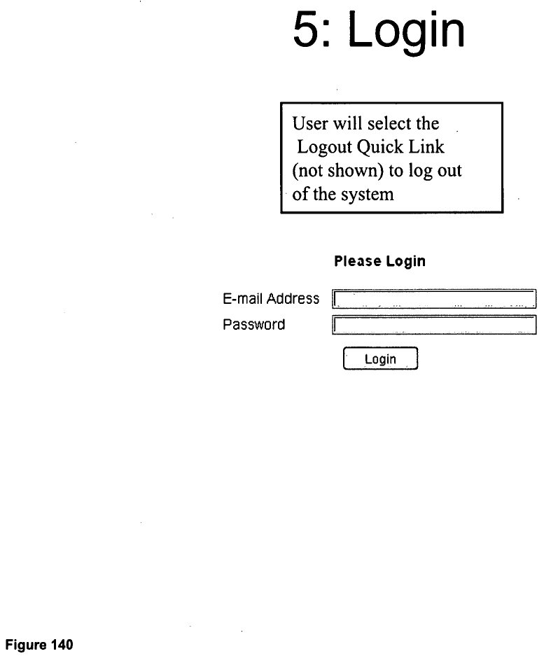

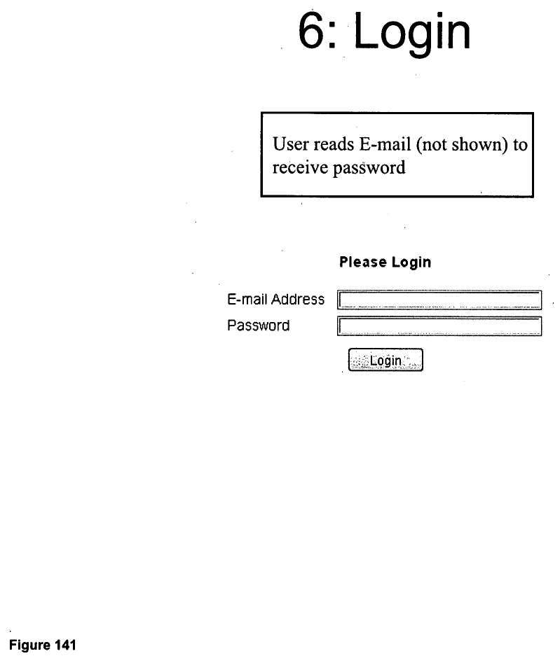

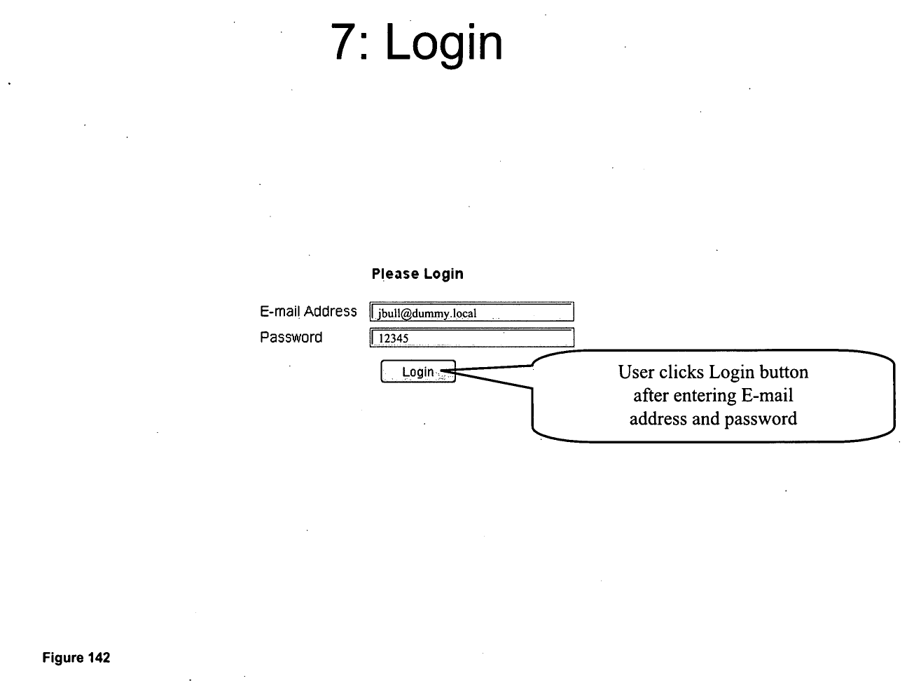

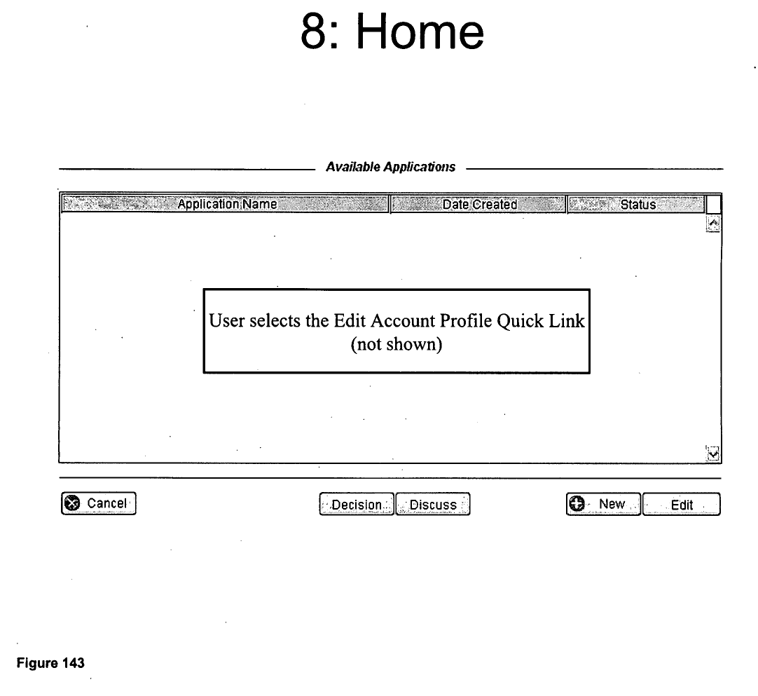

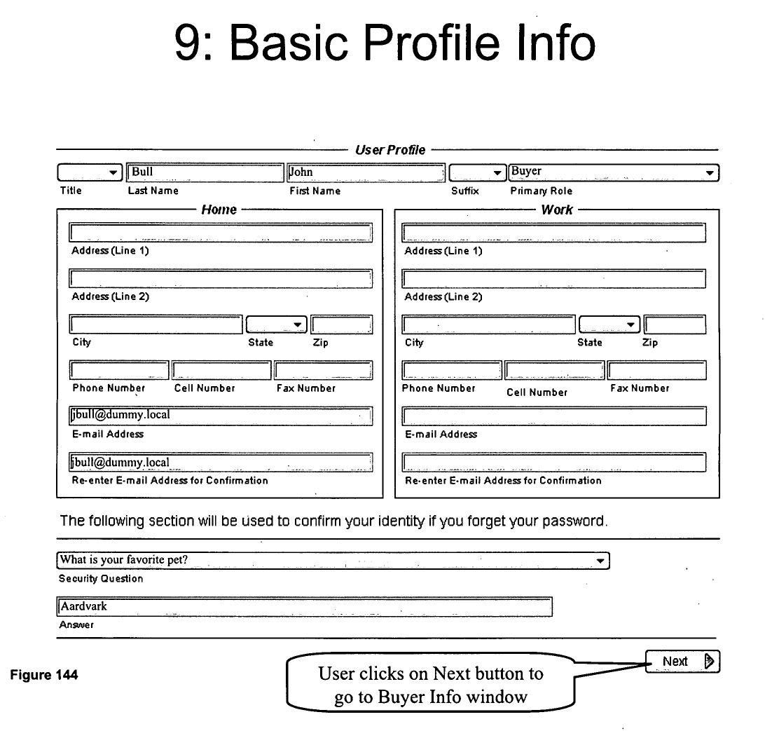

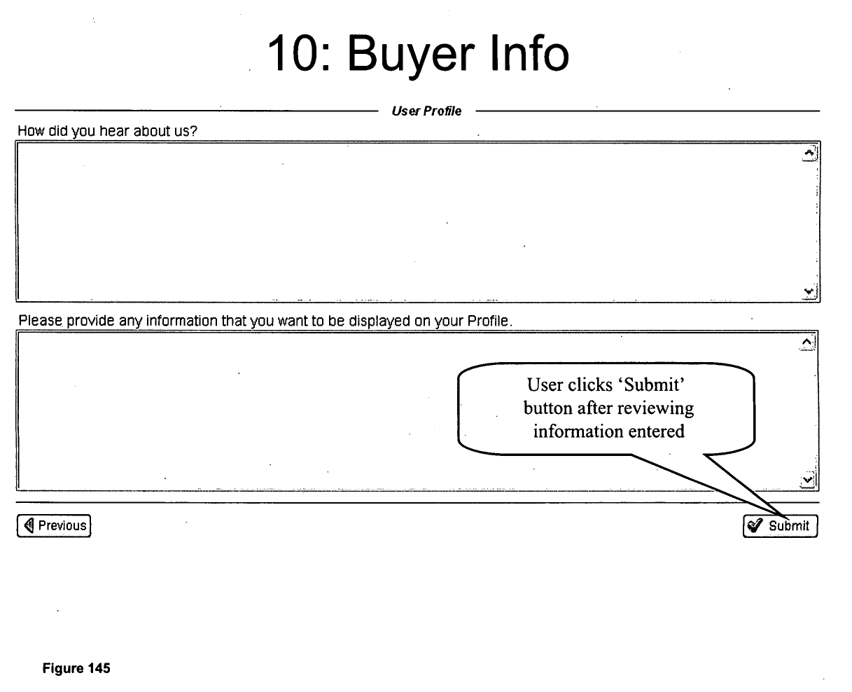

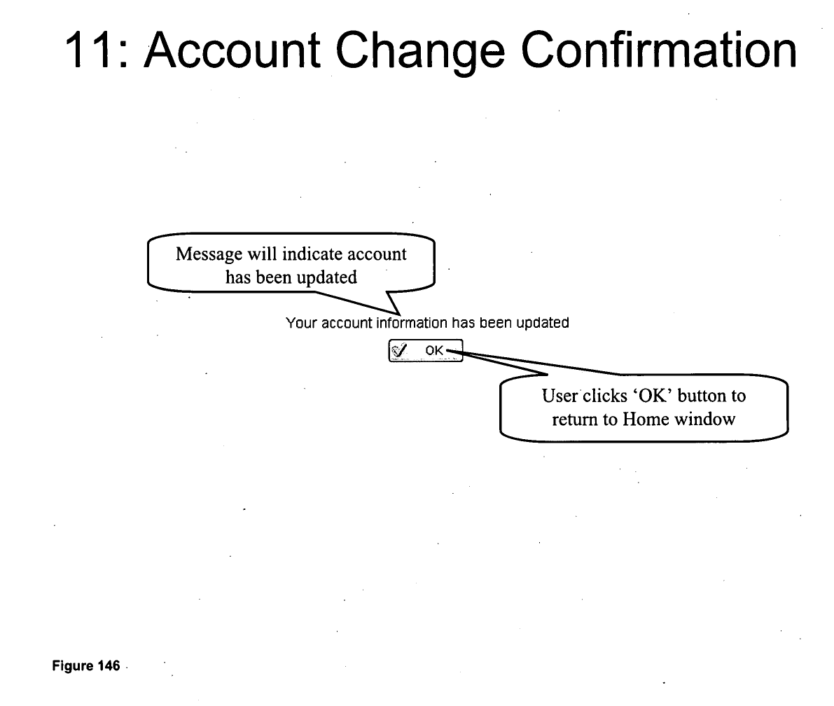

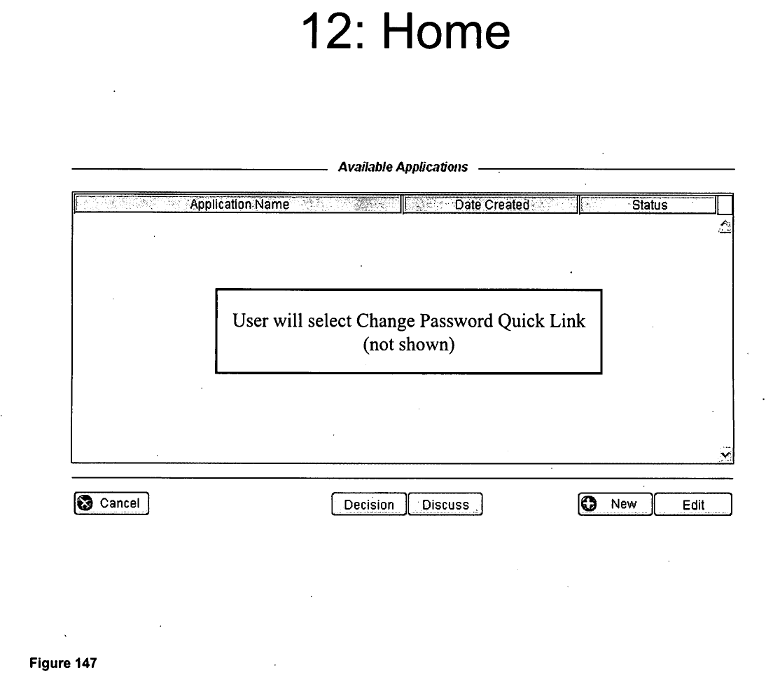

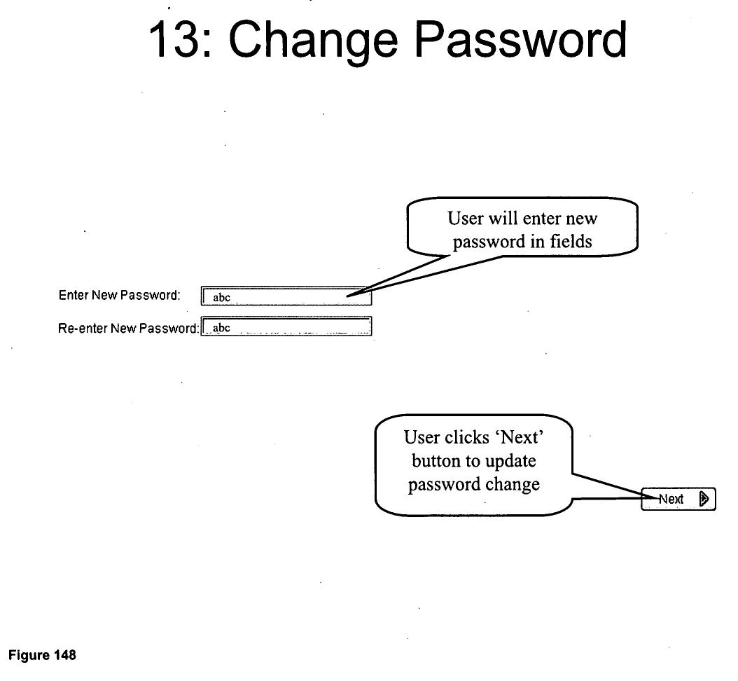

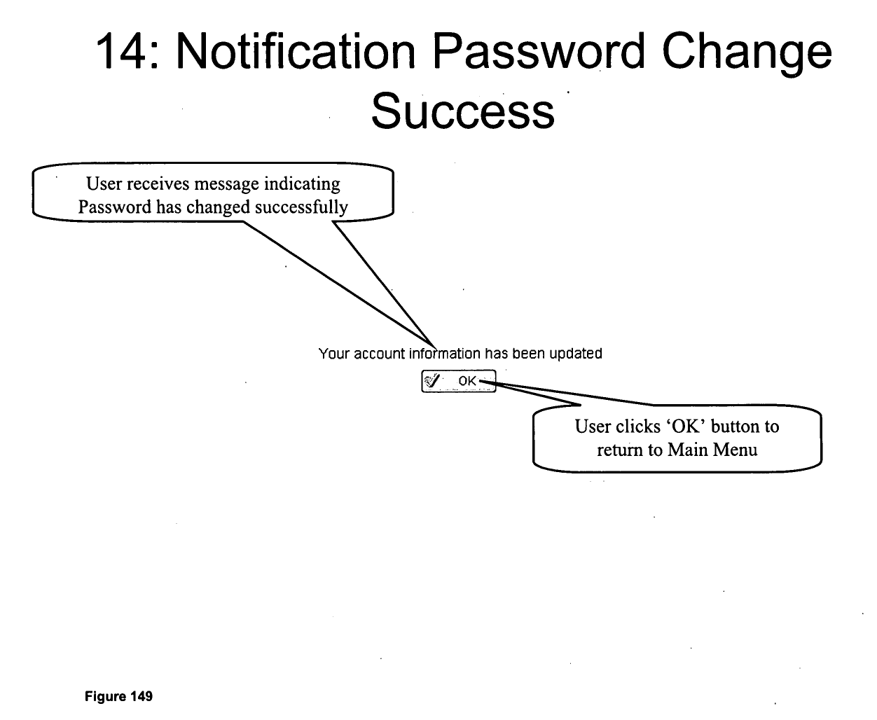

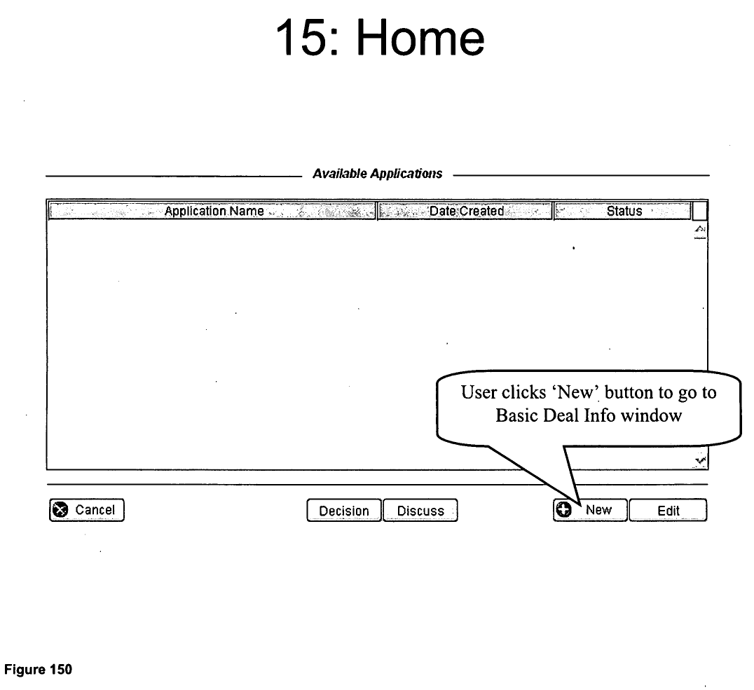

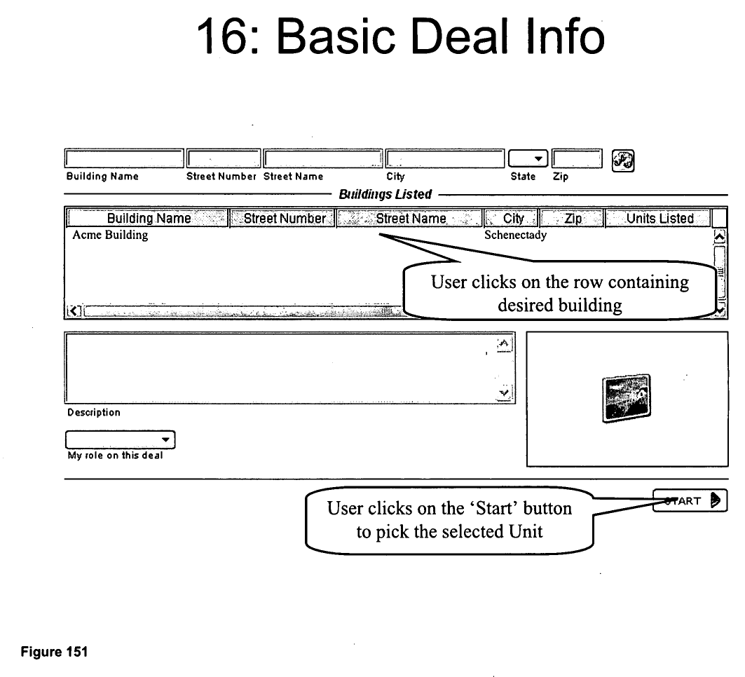

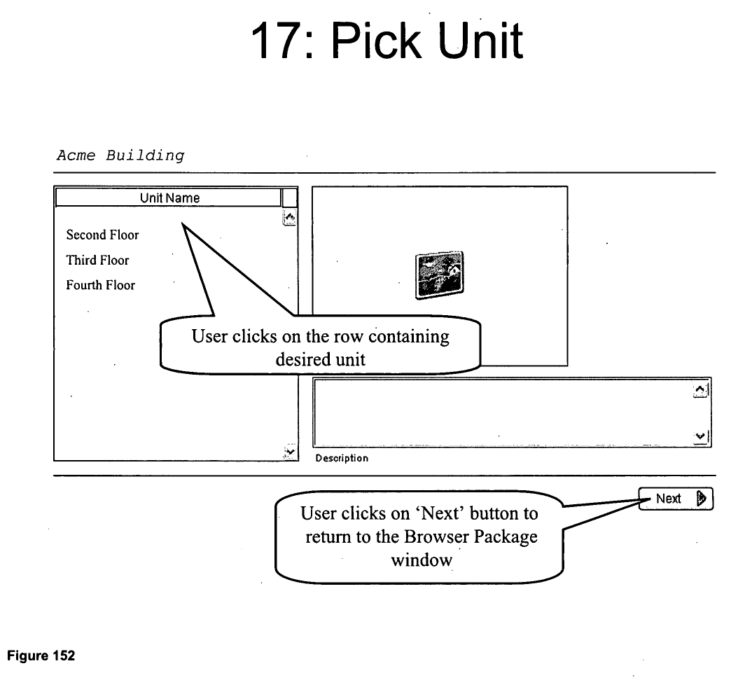

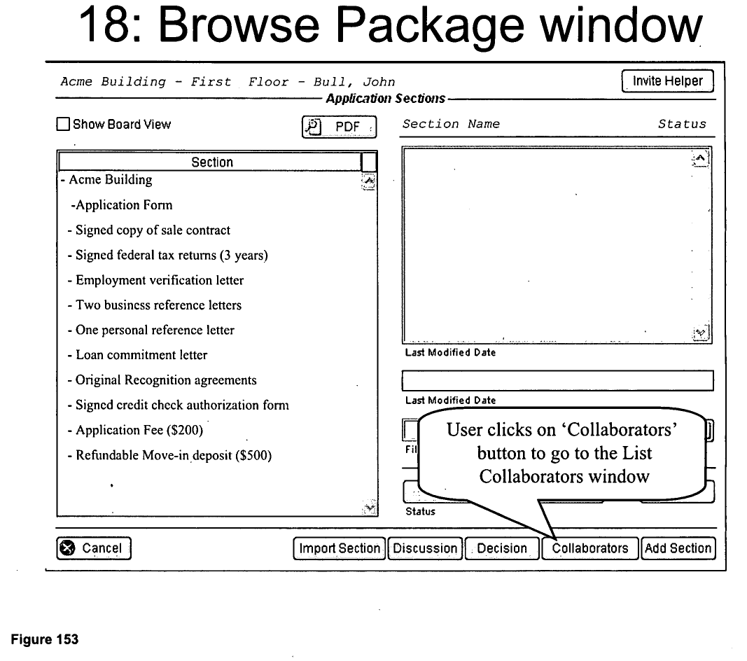

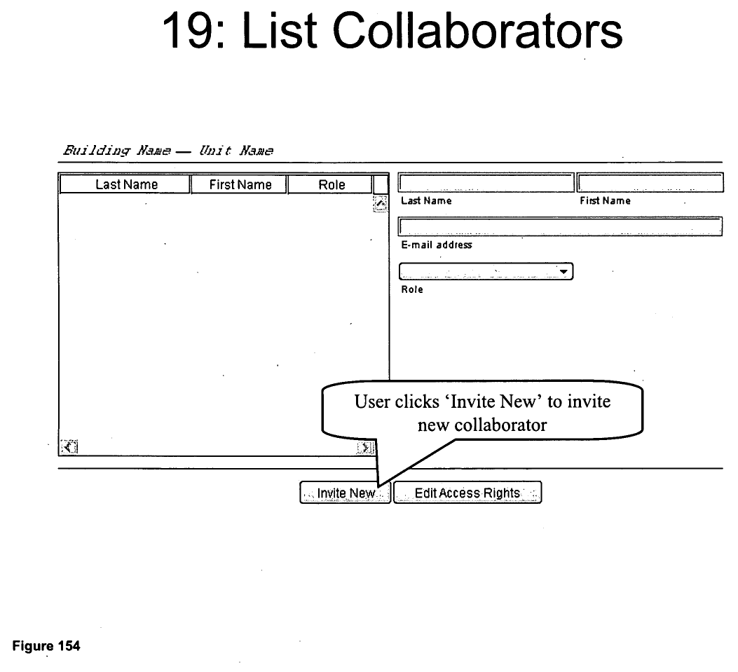

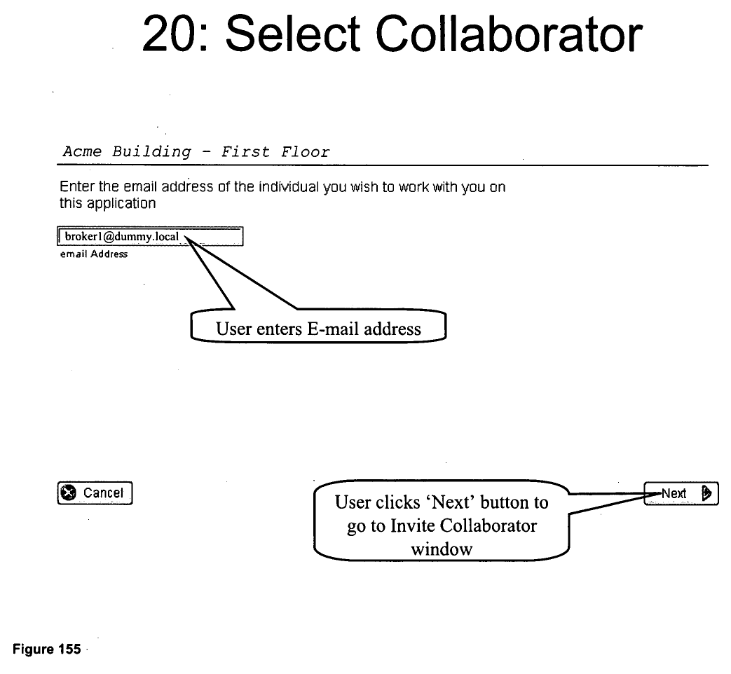

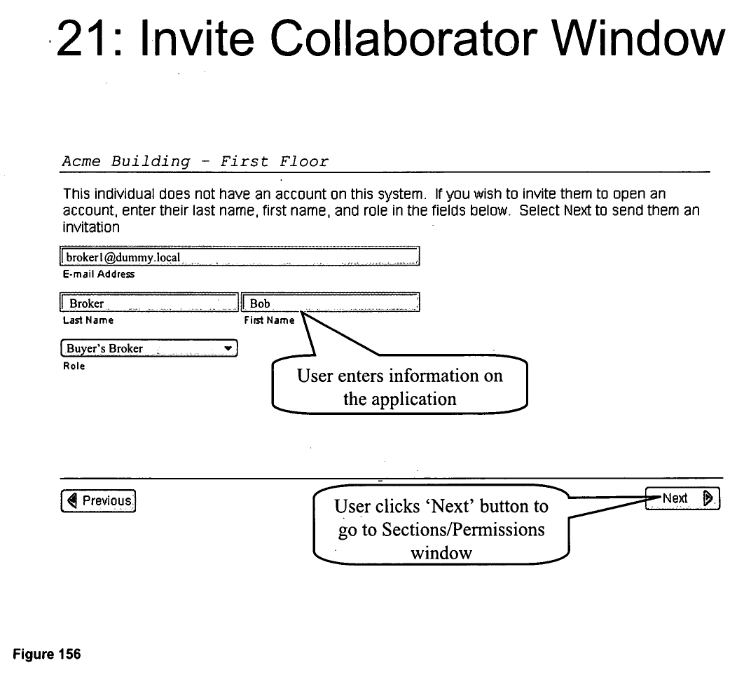

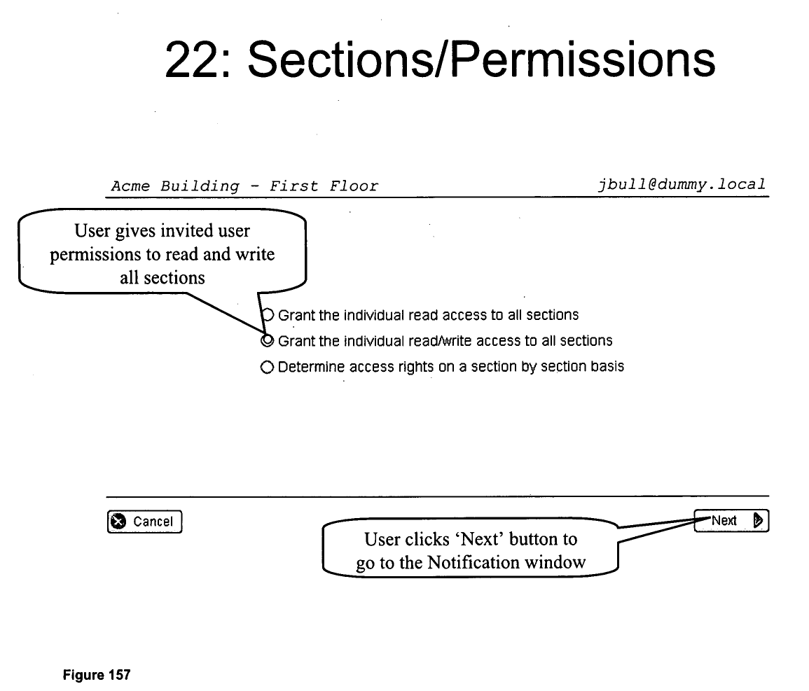

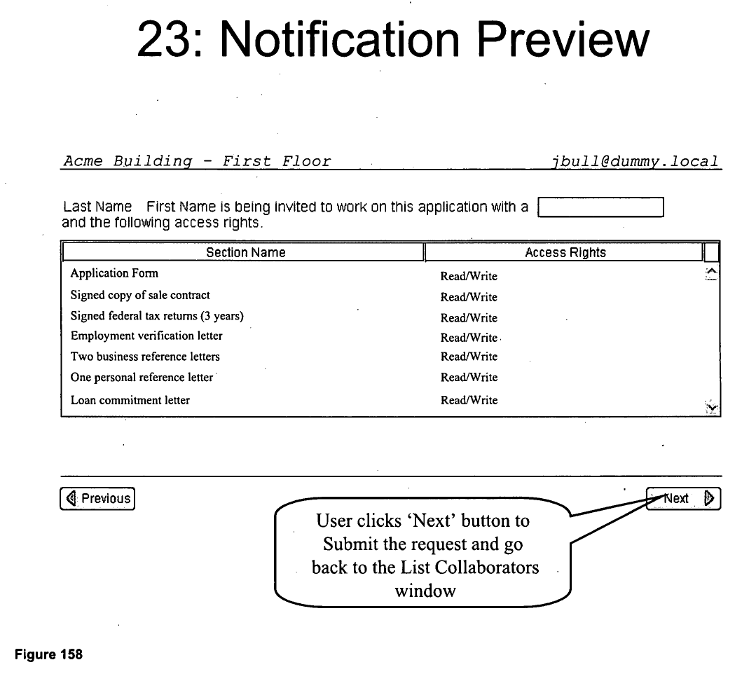

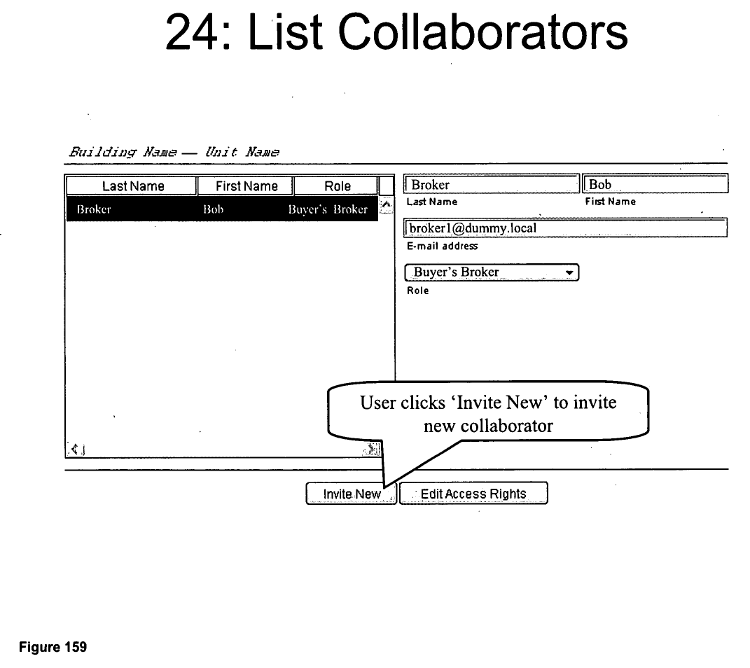

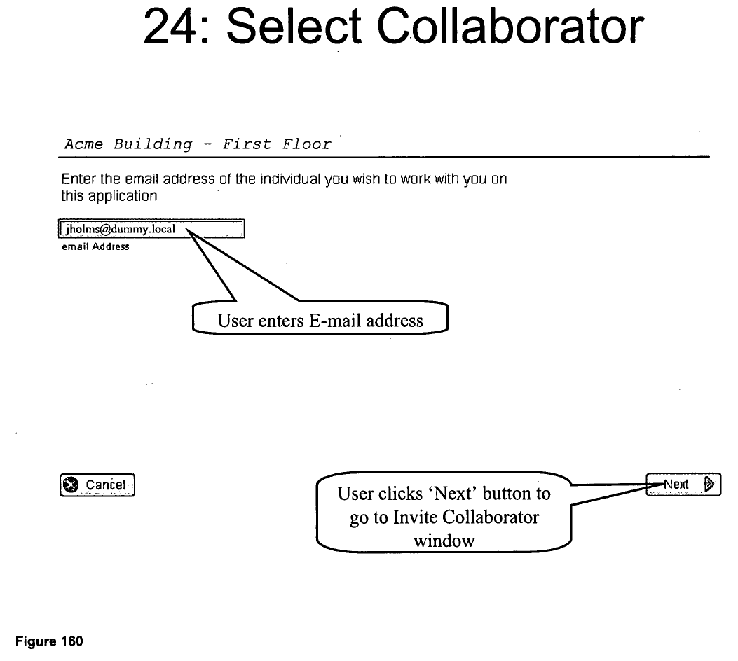

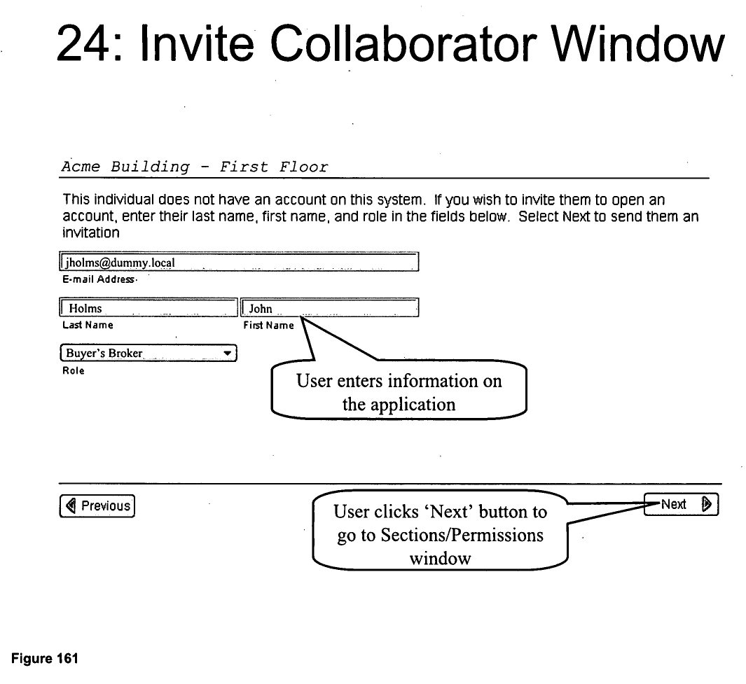

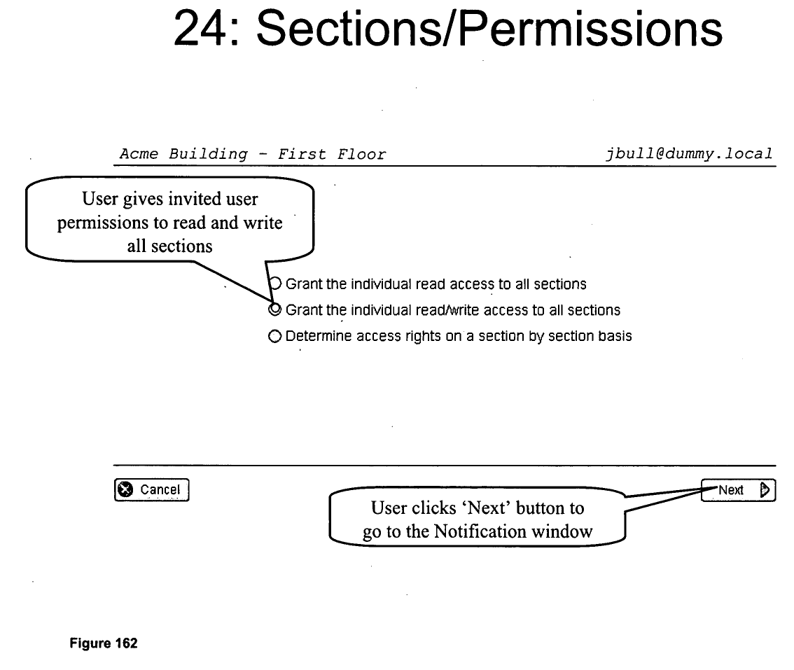

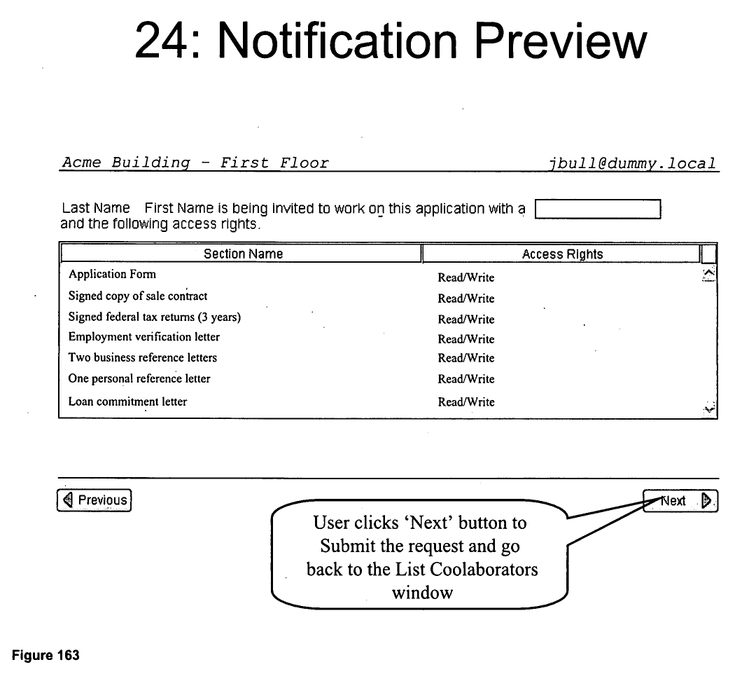

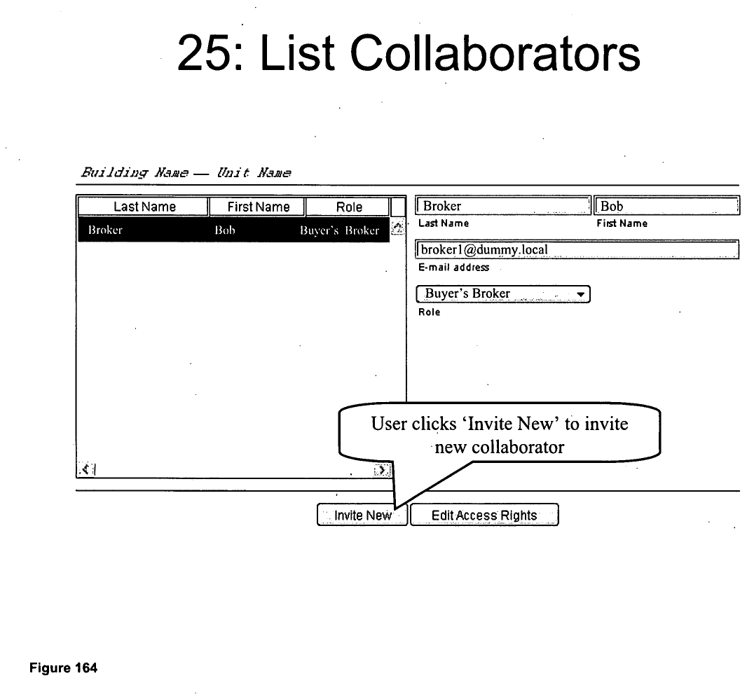

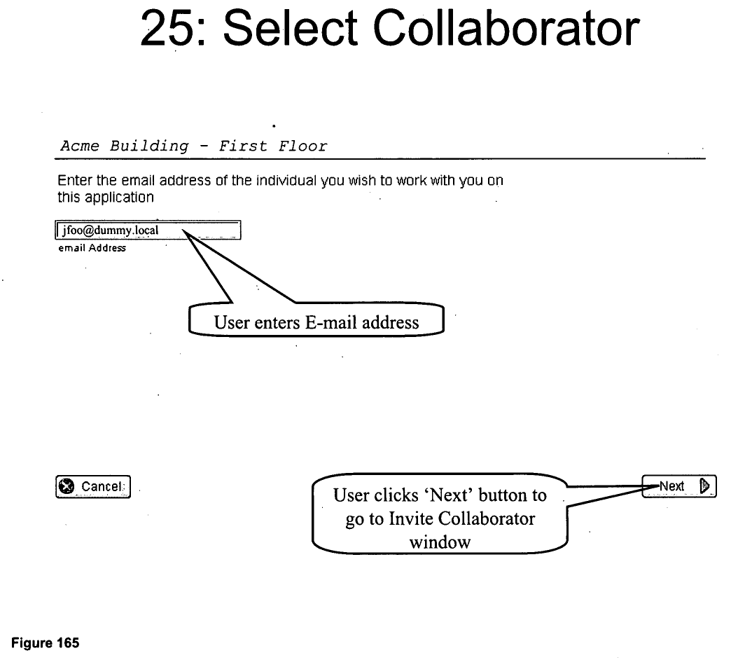

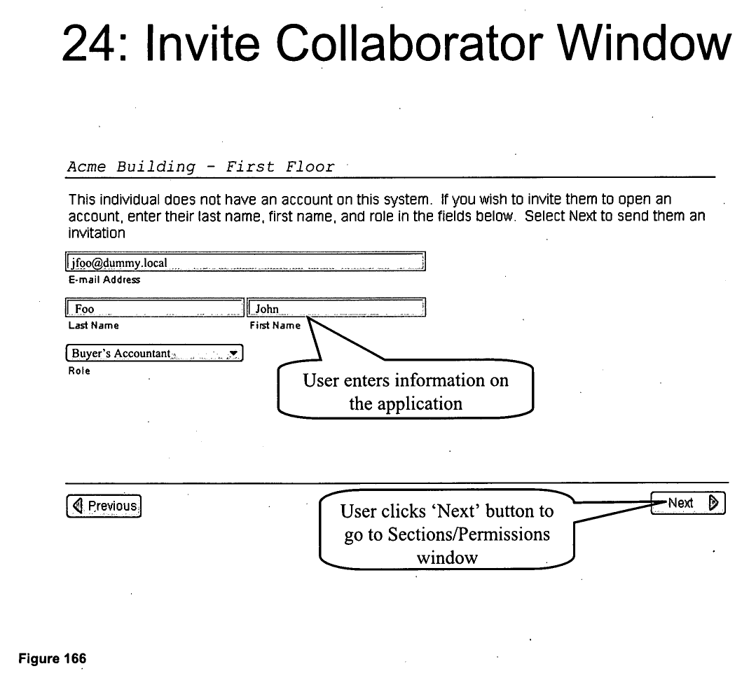

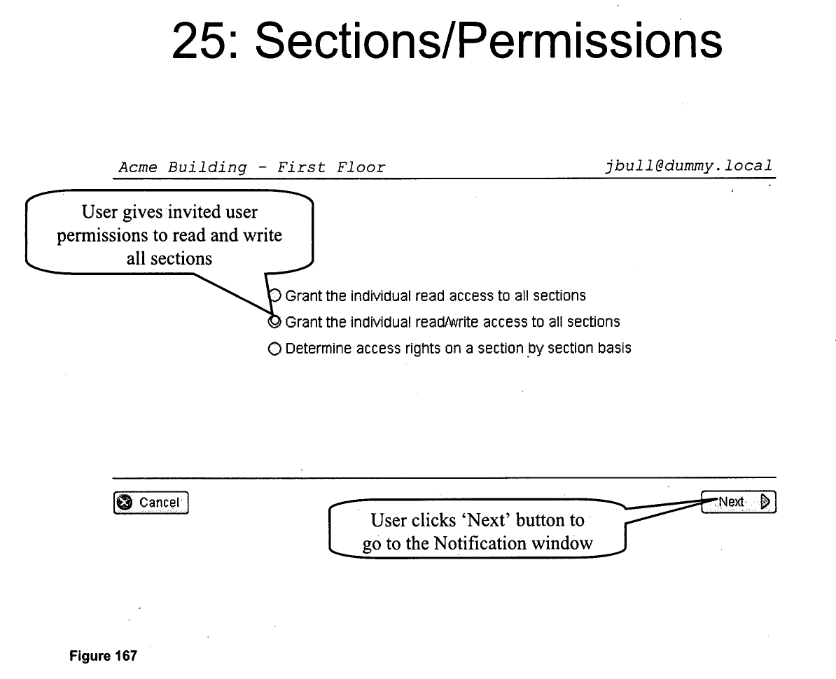

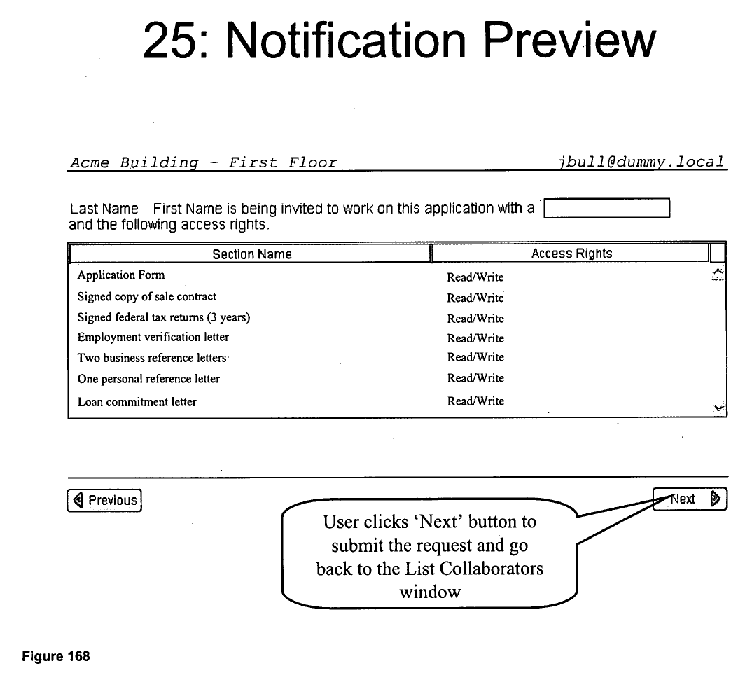

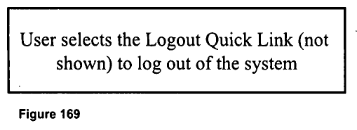

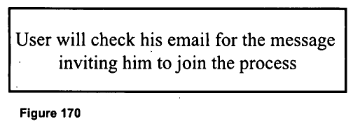

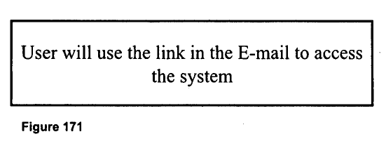

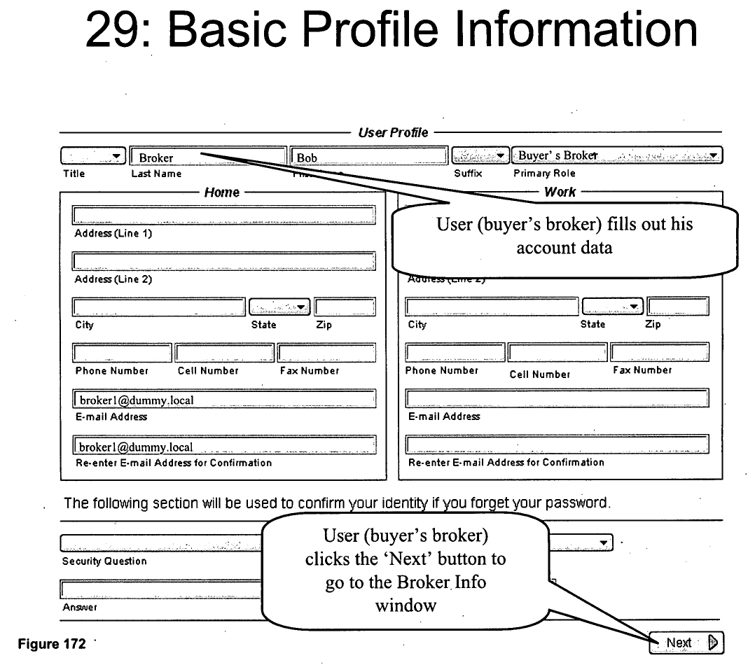

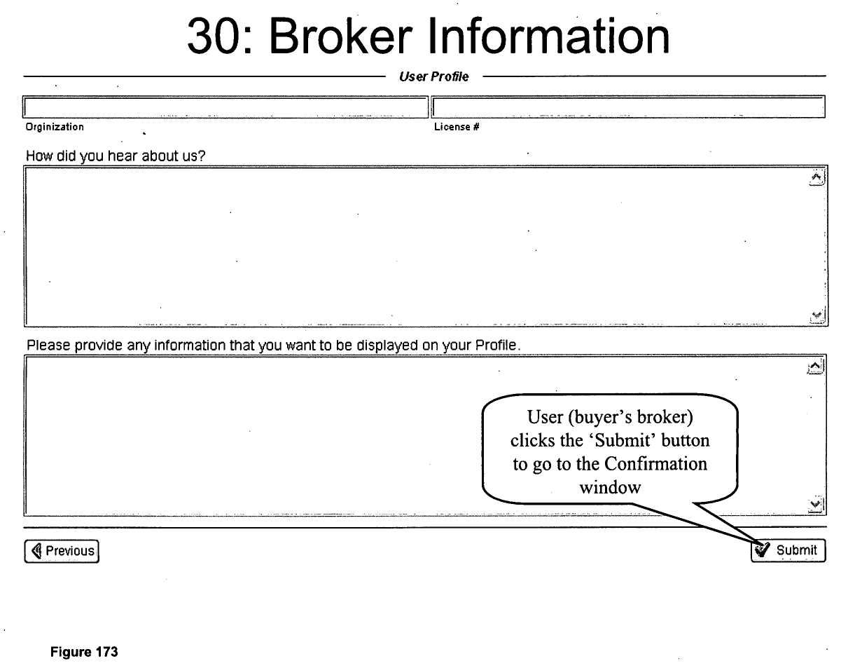

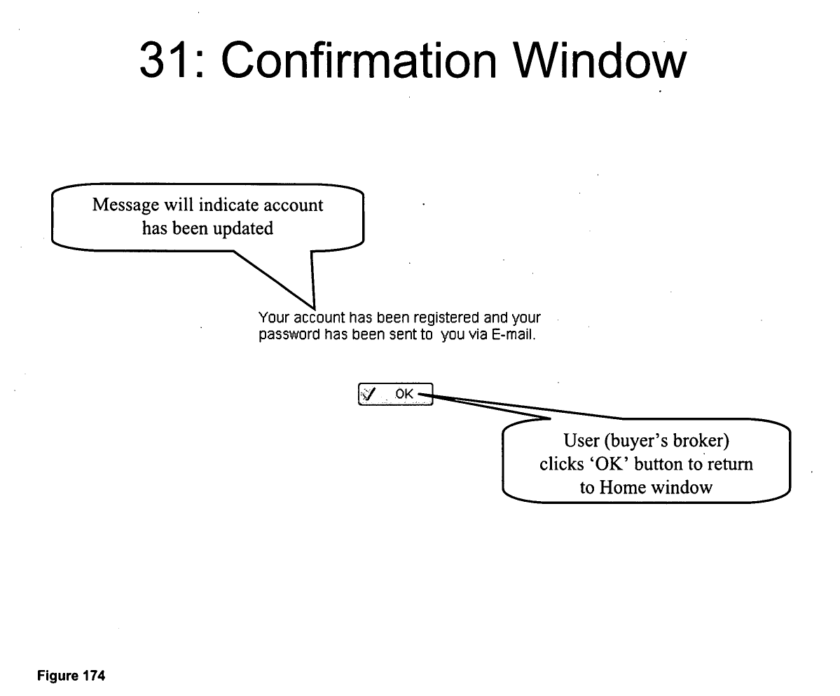

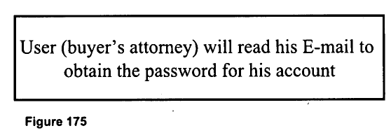

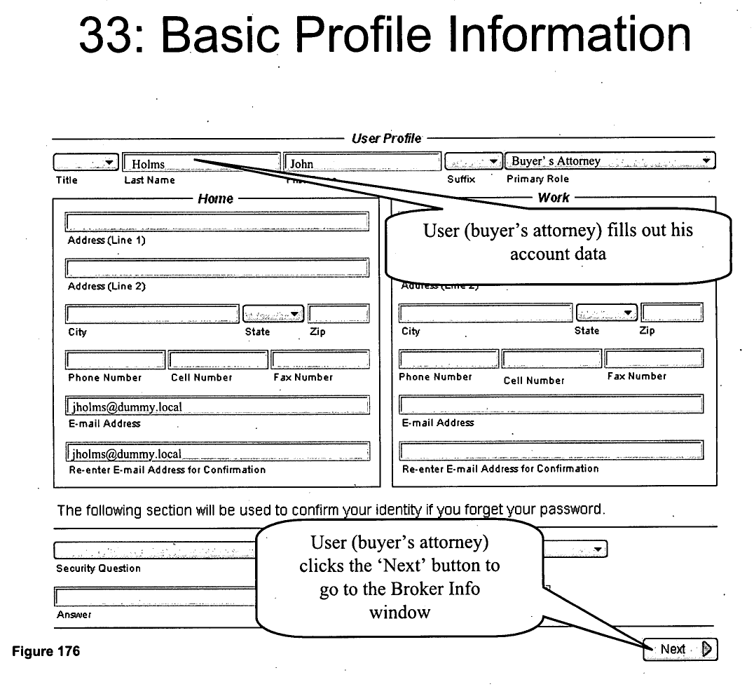

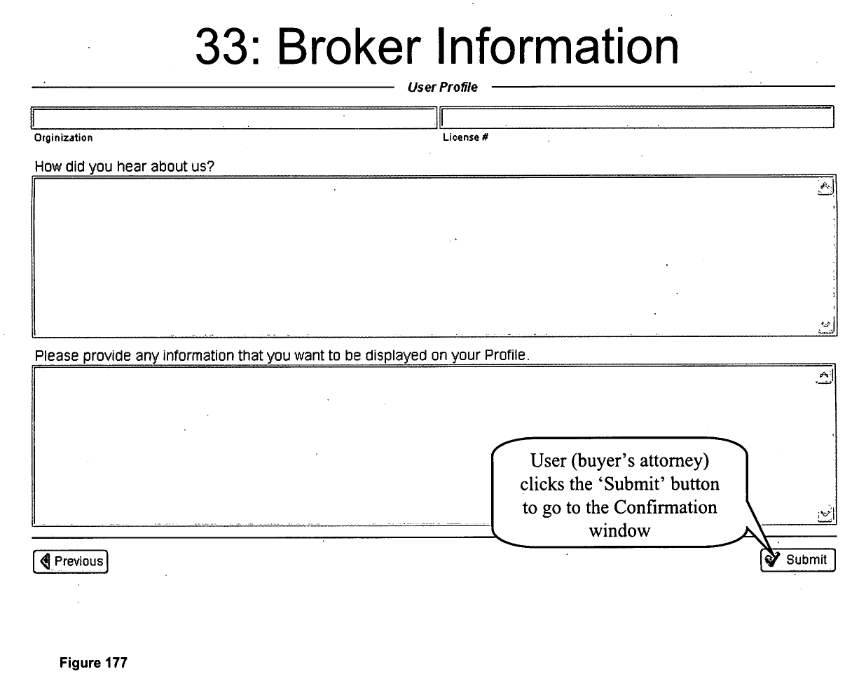

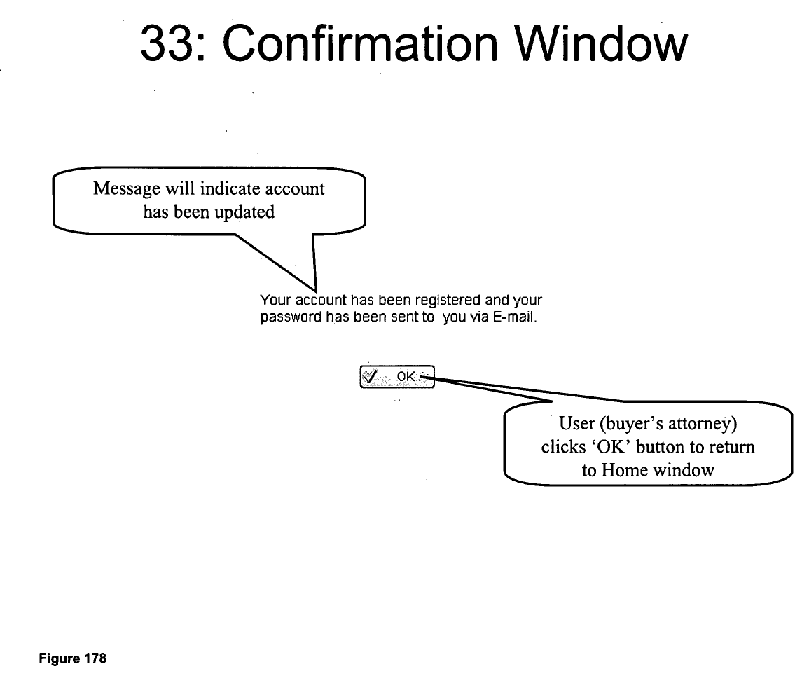

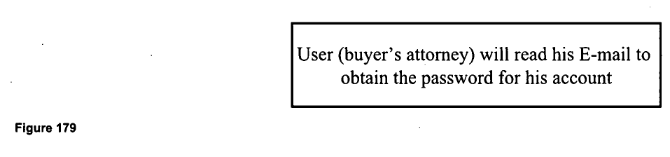

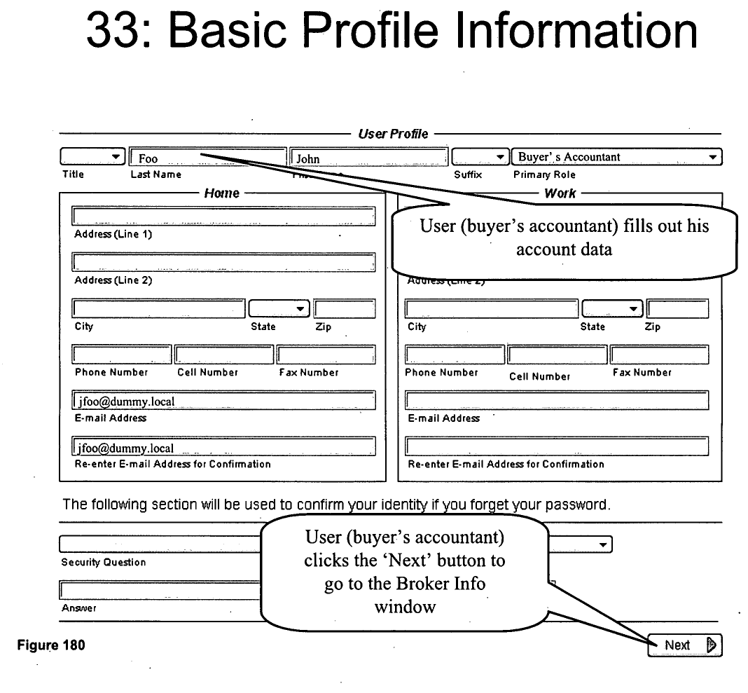

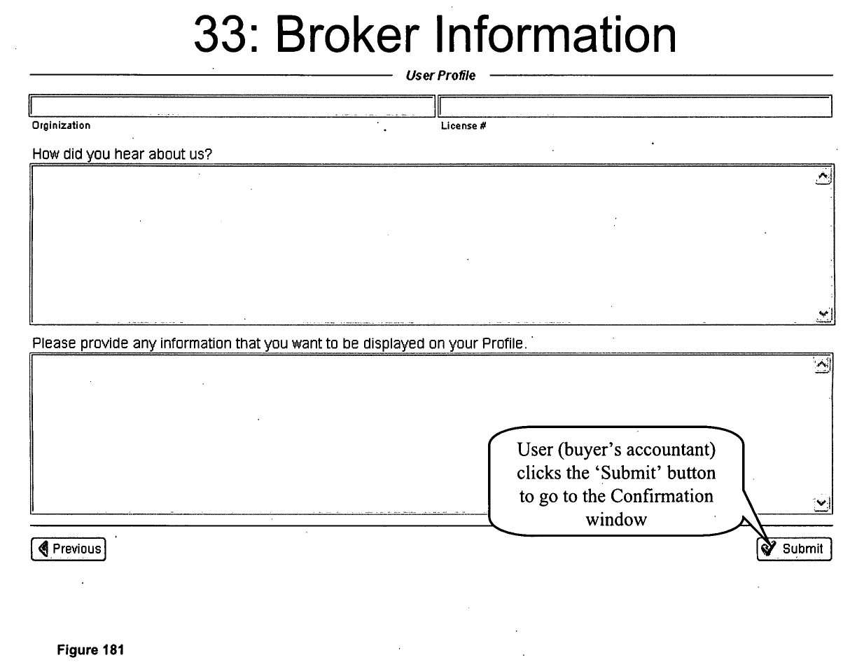

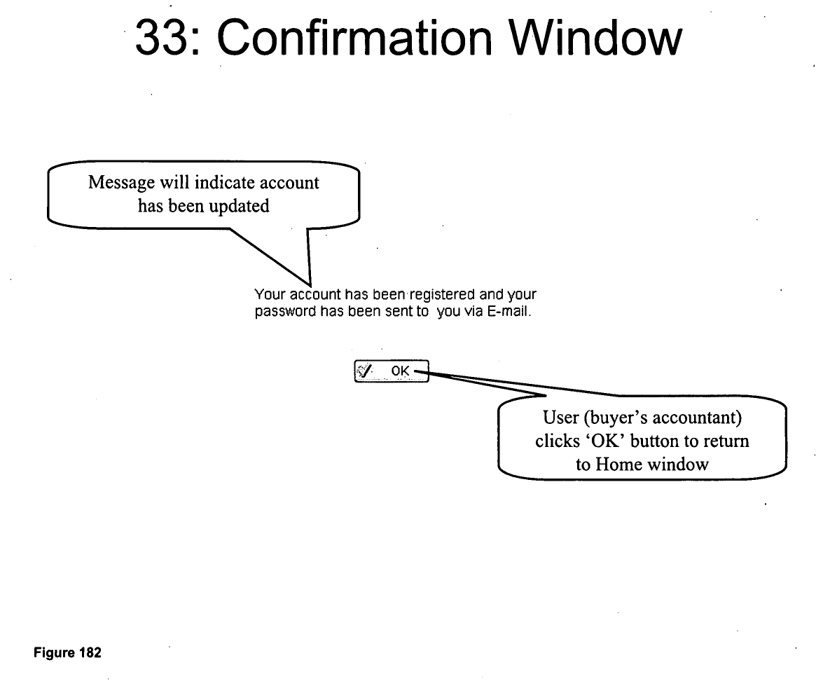

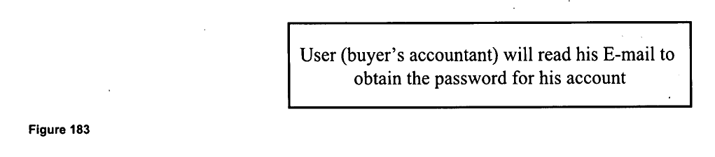

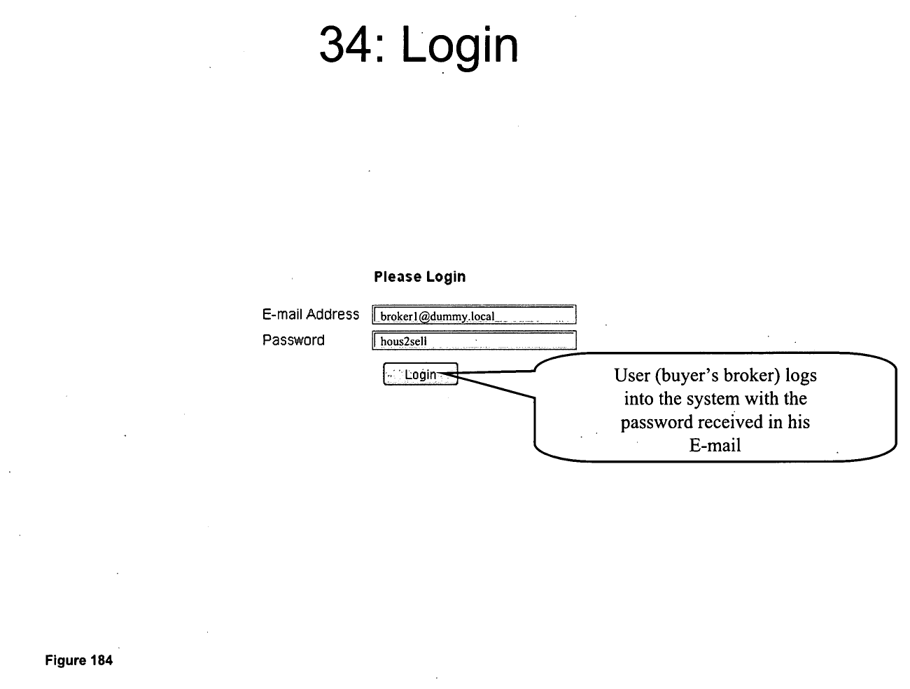

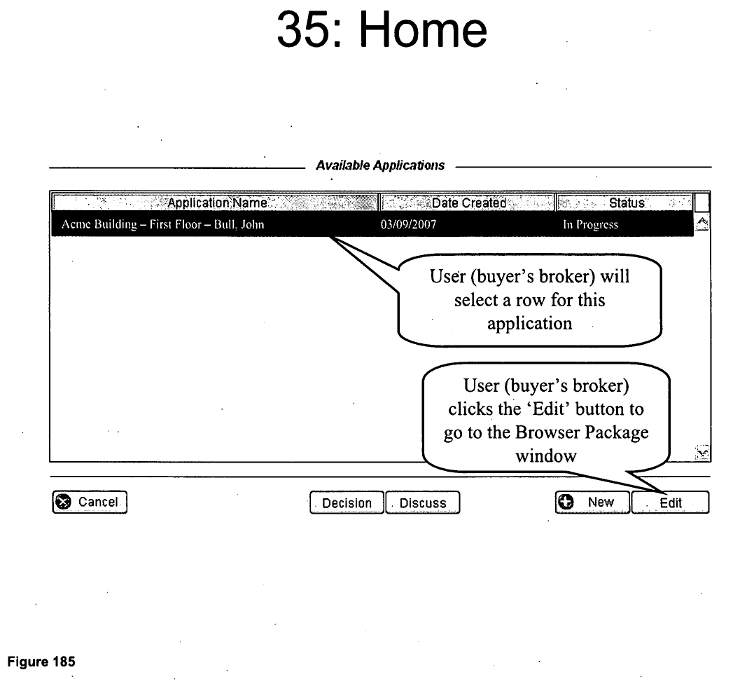

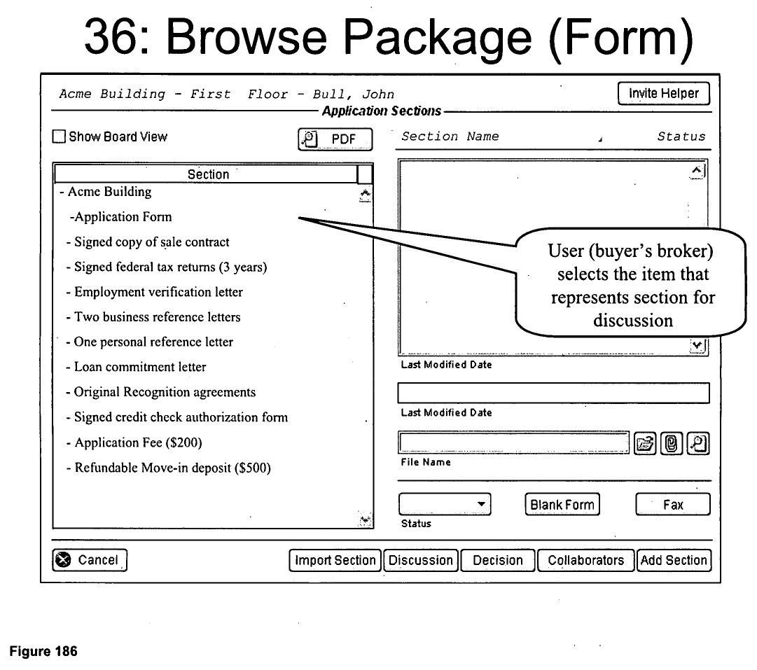

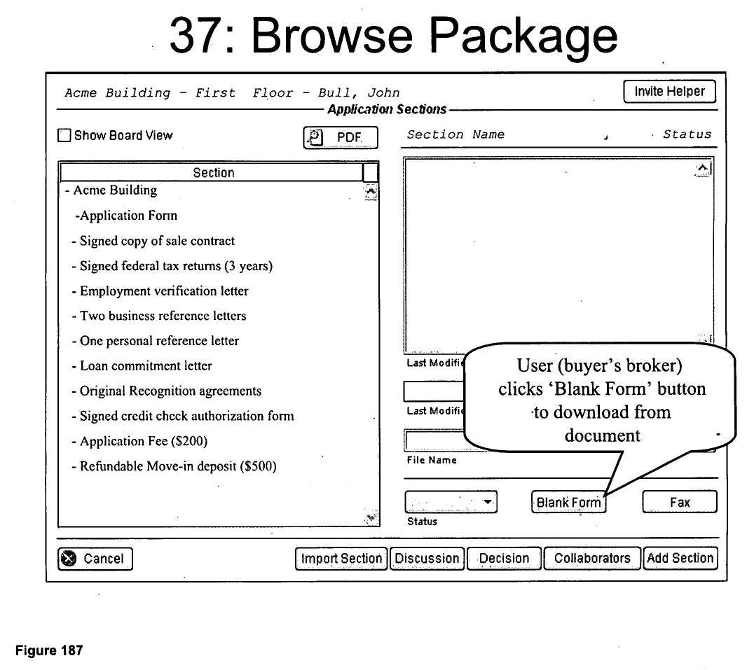

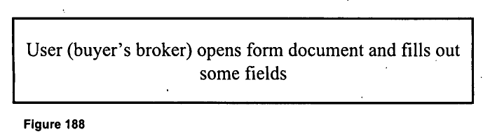

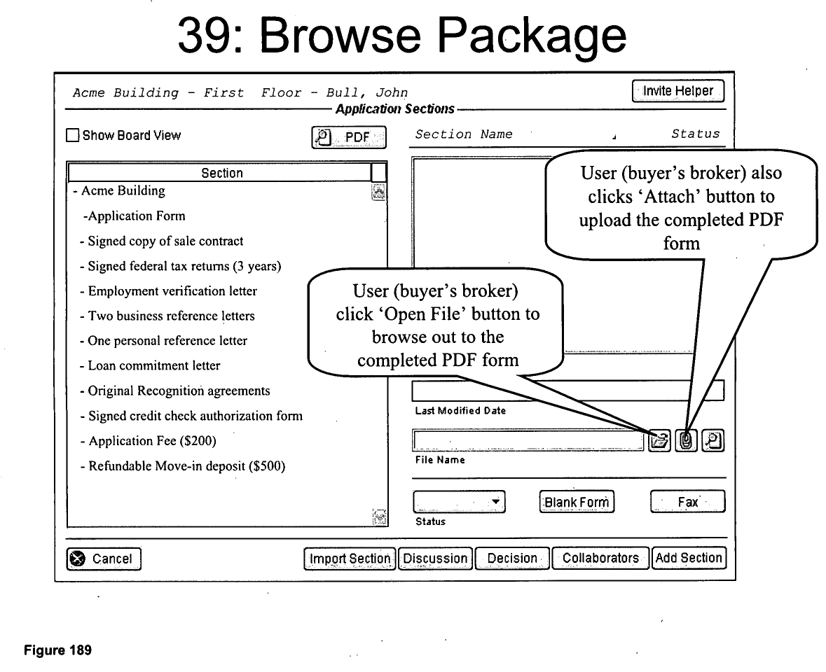

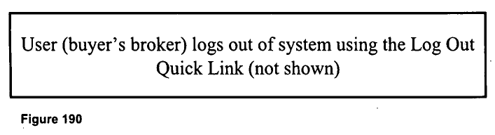

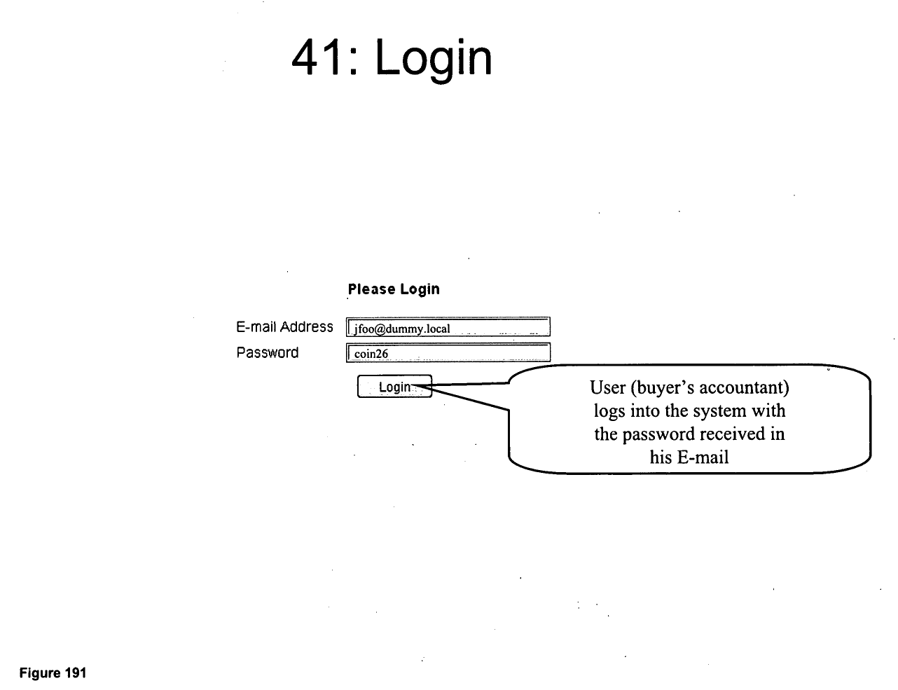

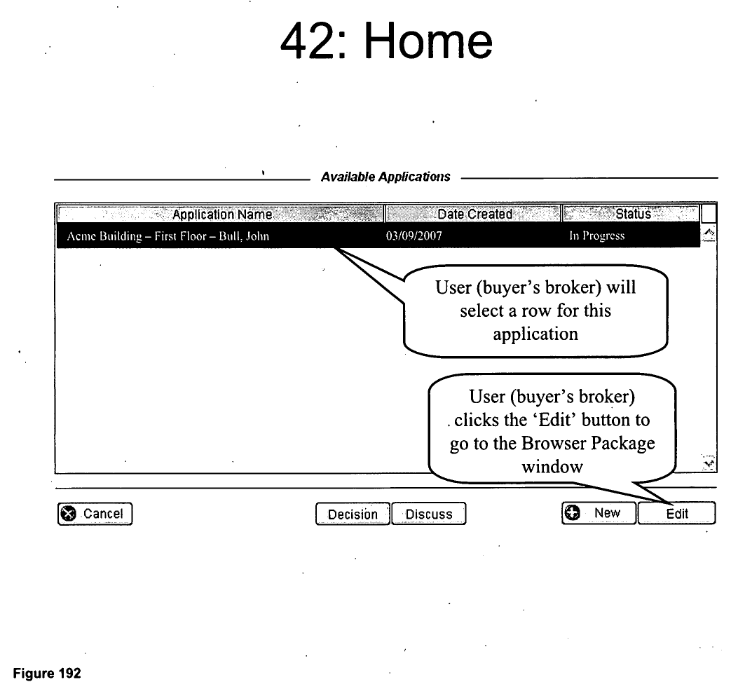

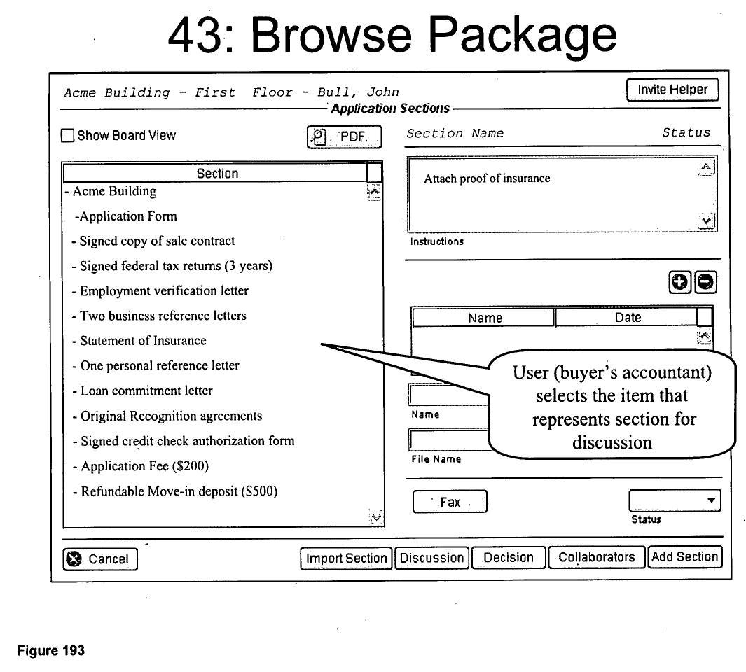

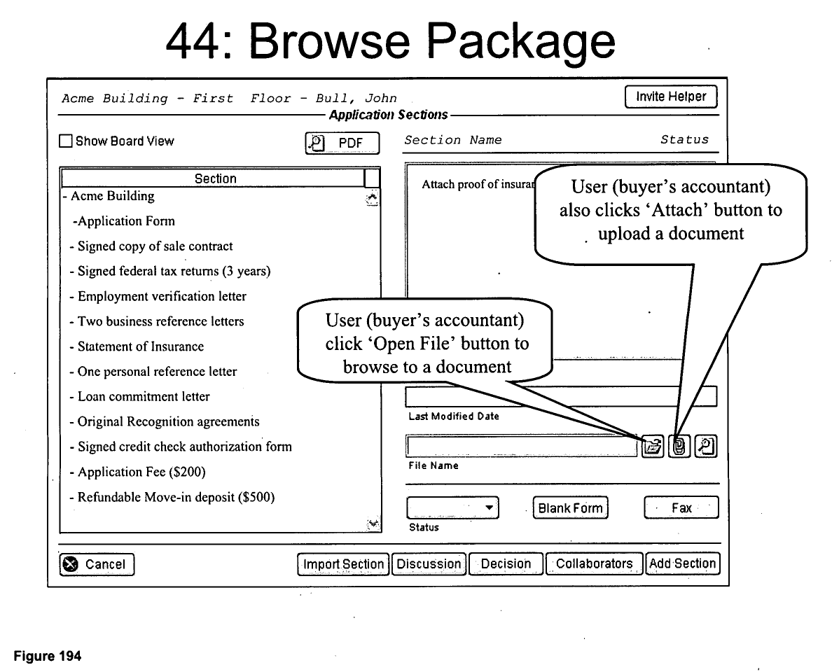

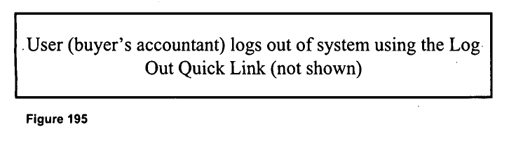

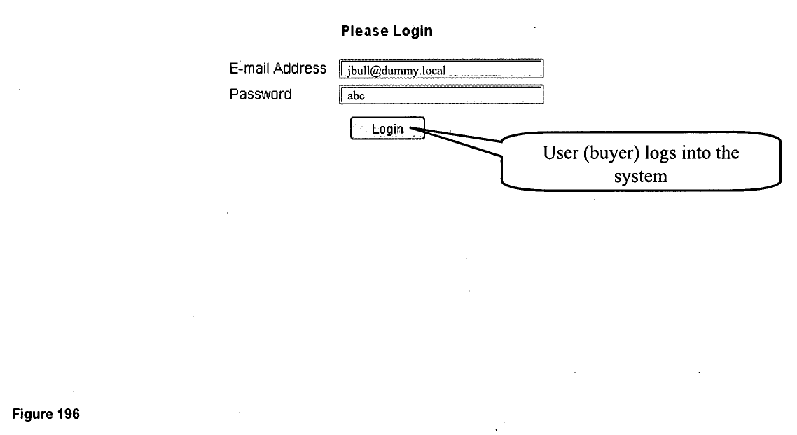

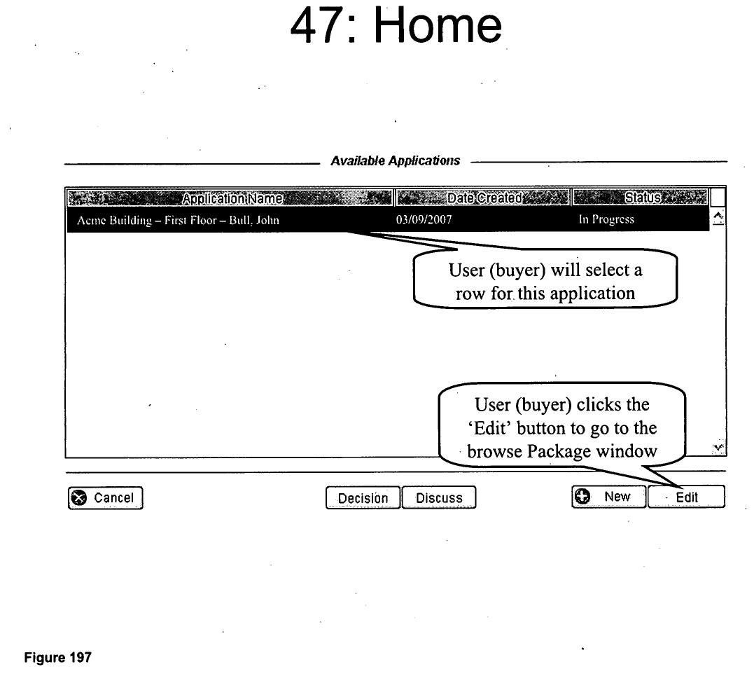

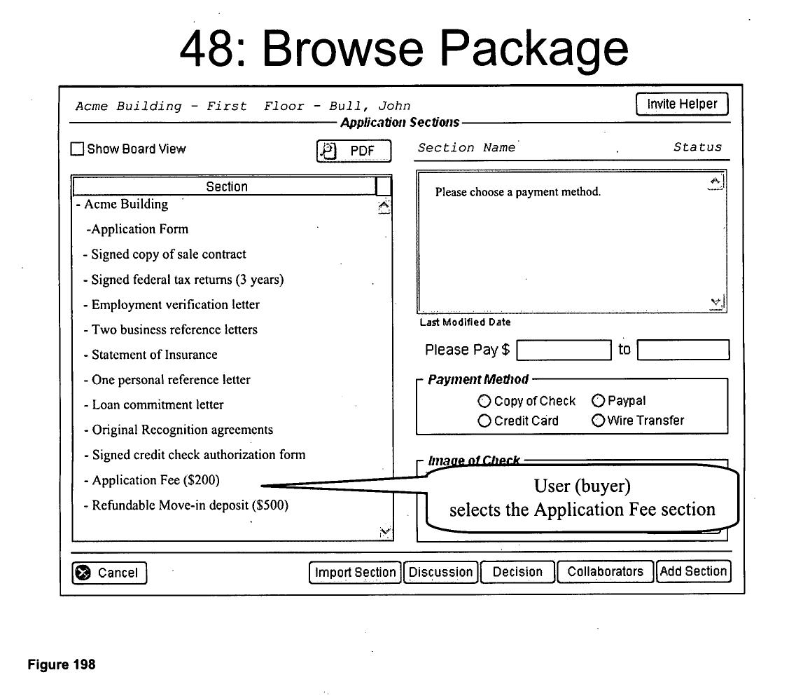

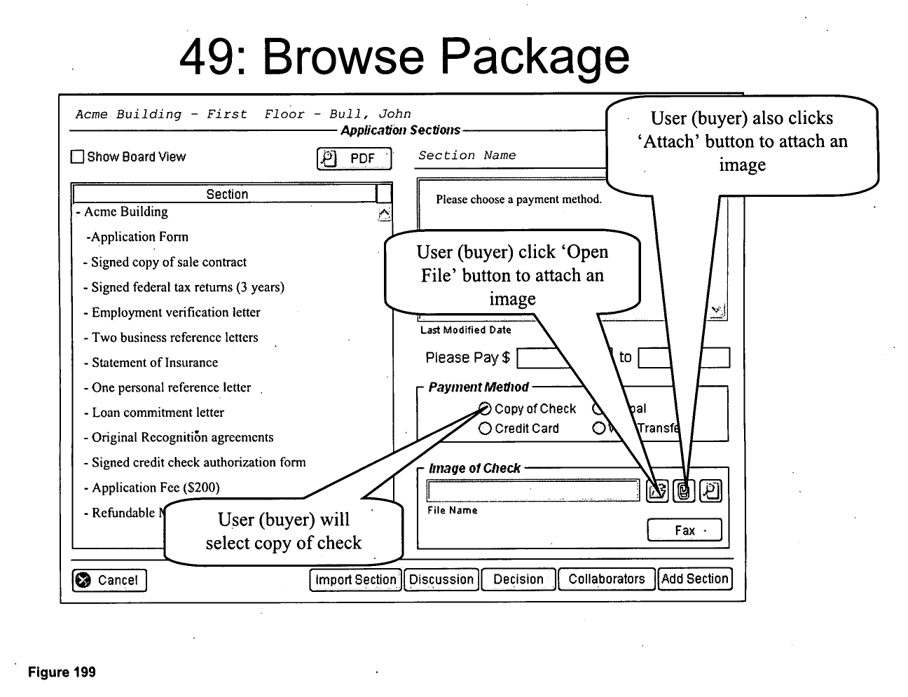

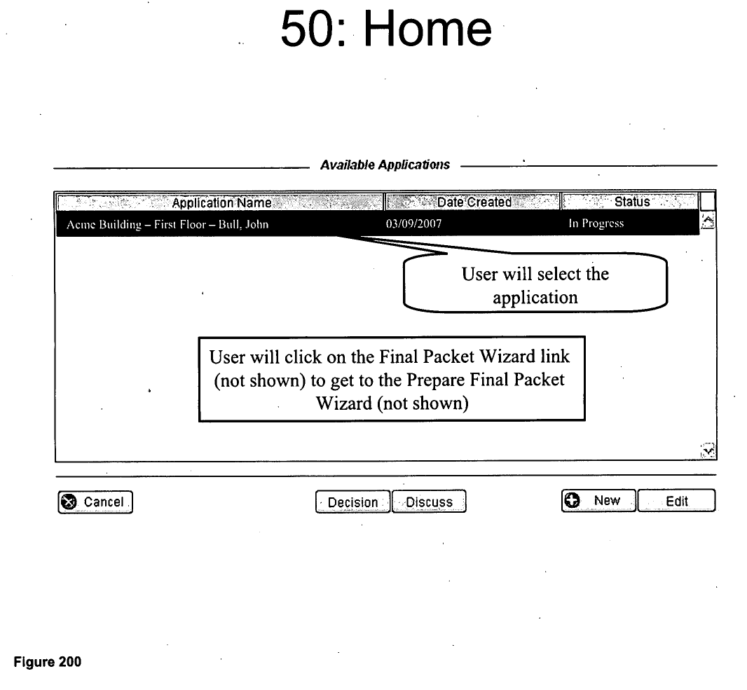

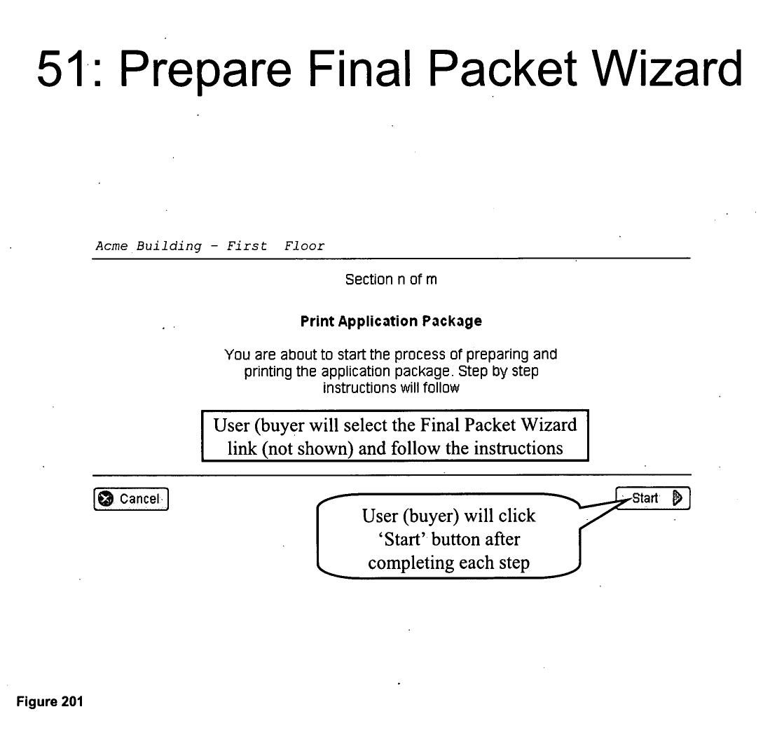

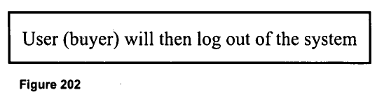

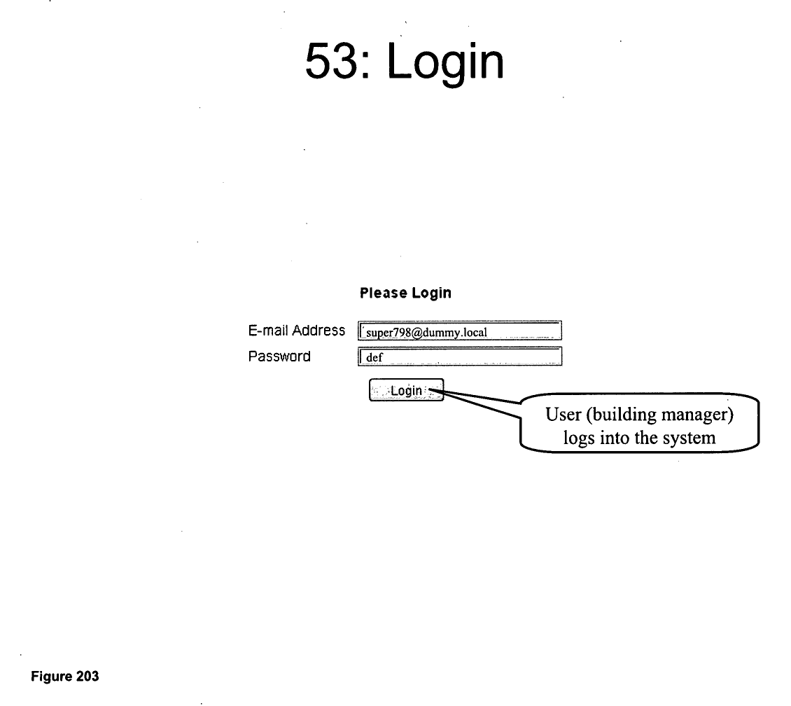

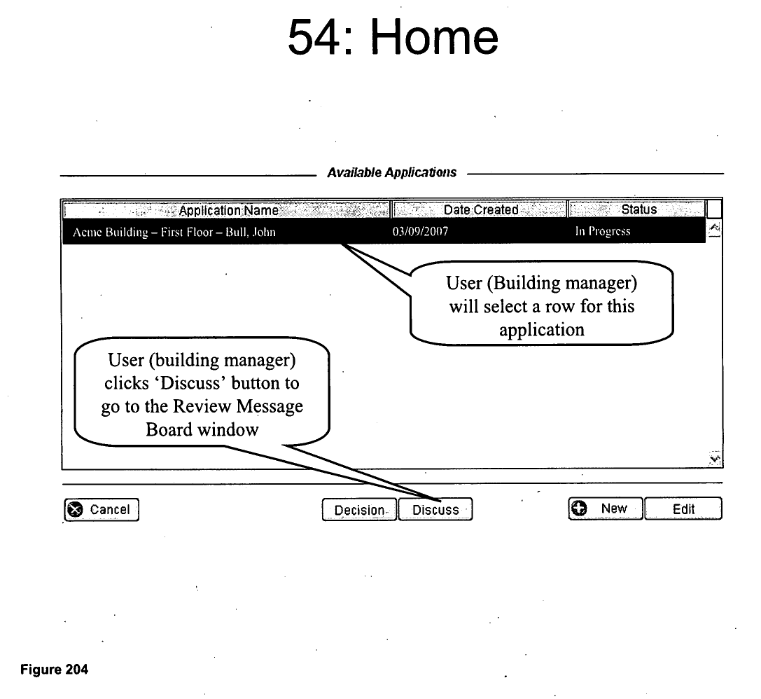

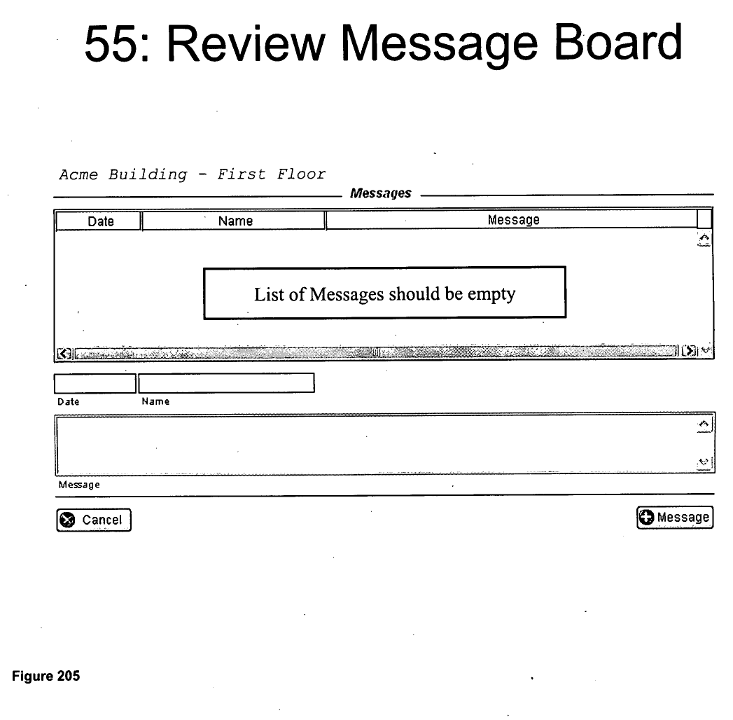

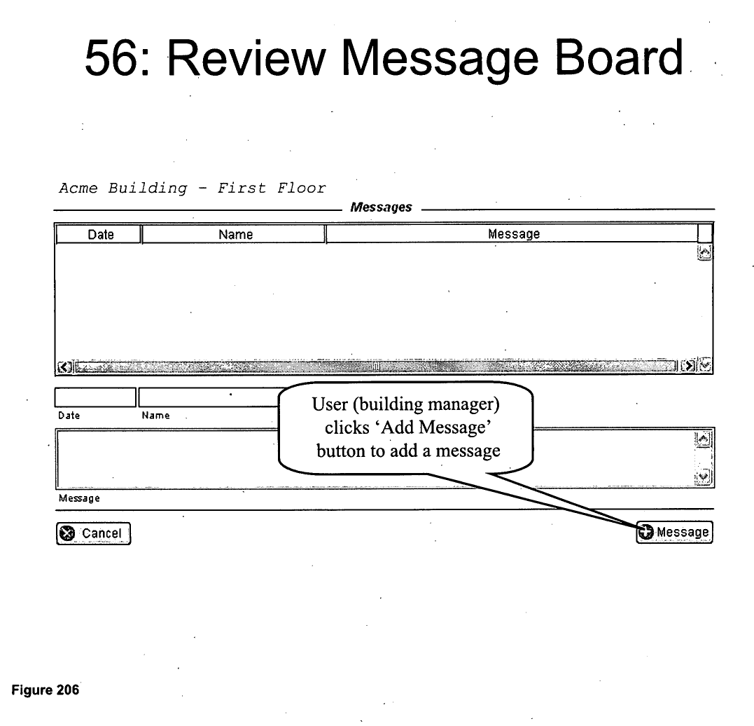

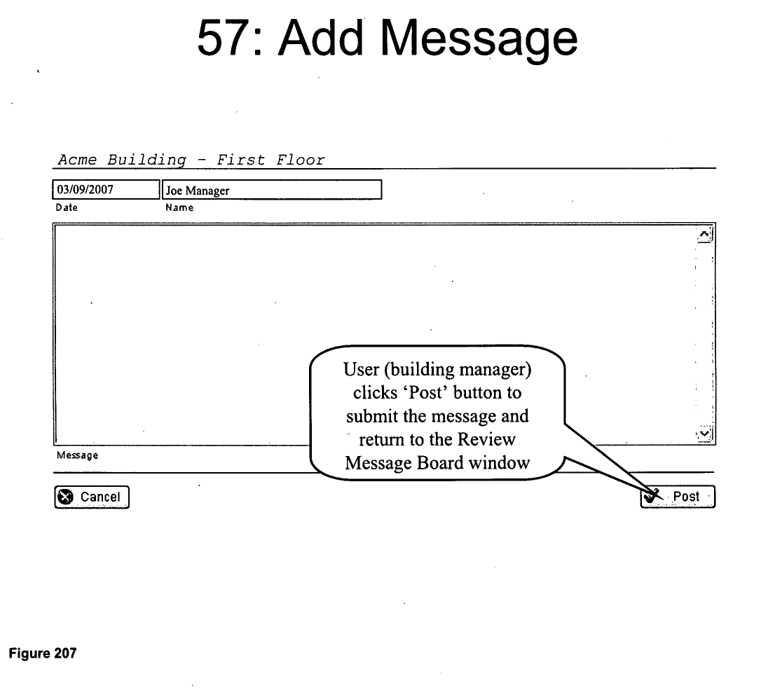

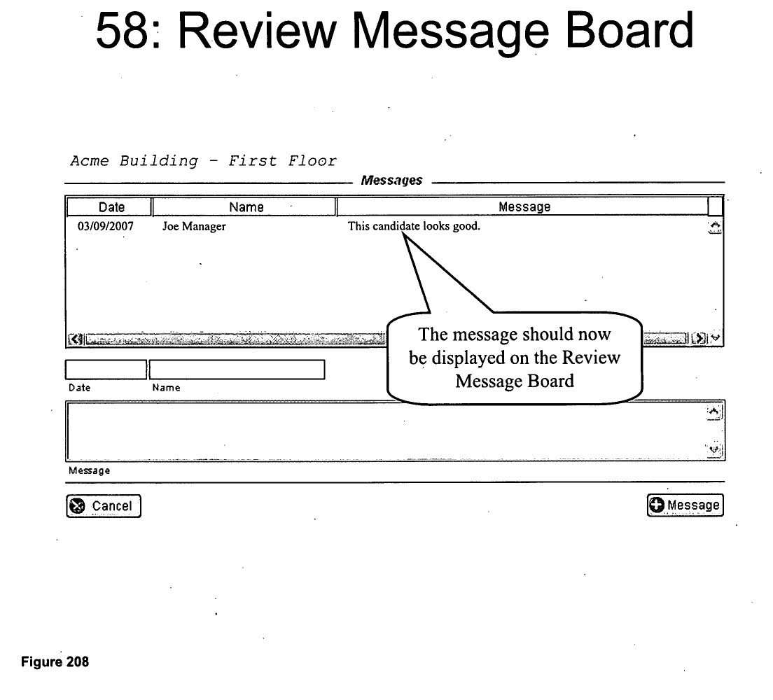

Step 1 (FIG. 136): User representing the buyer accesses the system and chooses Create a new account Quick Link.

Step 2 (FIG. 137): User fills in the information on the Basic Profile Info window. The user then click on the Next button to go to the Buyer Info window.

Step 3 (FIG. 138): The user leaves the information blank and presses Submit to continue

Step 4 (FIG. 139): A message appear indicating that the account has been created and an e-mail containing the password sent to the user. Upon clicking on the OK button, the user is returned to the original Login page

Step 5 (FIG. 140): The user selects the Logout Quick Link to log out of the system.

Step 6 (FIG. 141): User reads the e-mail sent by the system in order to learn his password

Step 7 (FIG. 142): User accesses the system. He then enters his e-mail address and password and clicks on the Login button.

Step 8 (FIG. 143): After clicking the Login button, the user is transported to the main menu containing the list of applications. He selects the Change Account Profile Quick Link.

Step 9 (FIG. 144): The user reviews his information on the Basic Profile Info window. He will then click on the Next button

Step 10 (FIG. 145): The user will review his information on the Buyer Info window. He then clicks on the Submit button

Step 11 (FIG. 146): A message is displayed on the Account Change Notification window indicating that the account information has been updated. The user then clicks on the OK button to return to the main menu.

Step 12 (FIG. 147): The user will select the Change Password Quick Link.

Step 13 (FIG. 148): The Change Password screen appear and the user will enter his desired password in the two fields and click on the Next button.

Step 14 (FIG. 149): If the password was changed successfully, he will receive a message to that effect. Clicking on the OK button will return him to the main menu.

Step 15 (FIG. 150): The Home window displays a list of applications with which the user is involved. The list is empty (no current applications). The user will use the New button to go to the Basic Deal Info window.

Step 16 (FIG. 151): The Basic Deal Info window displays a list of buildings contained in the system. The user will click on the row containing the desired building and click on the Start button.

Step 17 (FIG. 152): The Pick Unit window contains a list of units in the selected building. The user will click on the row containing the desired unit and then click on the Next button to return to the Browse Package window.

Step 18 (FIG. 153): Click on the Collaborators button to go to the List Collaborators window.

Step 19 (FIG. 154): The user will click on the Invite New Button to invite a new collaborator.

Step 20 (FIG. 155): The user will enter the E-mail address for the user representing the buyer's agent and then click on the Next button.

Step 21 (FIG. 156): Since the individual doesn't have an account on the system, the Invite Collaborator window appear, and the user is asked to provide the first and last name as well as the role on the application. Click on Next to get to the next window.

Step 22 (FIG. 157): The next screen to appear is the Sections/Permissions window. Select the option indicating that the invited user is able to read and write all sections and then click on the Next button.

Step 23 (FIG. 158): The Notification Preview window appear, listing the options selected for the invited user. Clicking on the Next button will submit the request and transport the user back to the List Collaborators window.

Step 24 (FIG. 159-163): Repeat the above steps to add the buyer's lawyer.

Step 25 (FIG. 164-168): Repeat the above steps to add the buyer's accountant

Step 26 (FIG. 169): Select the Logout Quick Link to log out of the system.

Step 27 (FIG. 170): The user representing the Buyer's Broker will check his e-mail for the message inviting him to join the process.

Step 28 (FIG. 171): The user (buyer's broker) will use the link in the e-mail to access the system.

Step 29 (FIG. 172): The user (buyer's broker) is taken to the Basic Profile Info window and will fill out his account data. He will then click on the Next button.

Step 30 (FIG. 173): The user (buyer's broker) will skip over the information and press Submit to go to the Confirmation Window

Step 31 (FIG. 174): The user (buyer's broker) will then see a confirmation message indicating that his account has been created.

He can then click on the OK button to return to the main menu where he can log out by clicking on the Logout Quick Links button.

Step 32 (FIG. 175): The user (buyer's broker) will then read his e-mail and obtain the password for his account.

Step 33 (FIG. 176-183): The users representing the buyer's attorney and buyer's accountant will then repeat the above steps so that they can obtain the information for their account.

Step 34 (FIG. 184): The user representing the buyer's broker logs on to the system using the password received in his e-mail.

Step 35 (FIG. 185): On the main menu, the user (buyer's broker) will select the row for this application and then click on the Edit button. This will transport the user to the Browse Package window.

Step 36 (FIG. 186): The user (buyer's broker) will select the item in the tree structure that represents the section for discussion. This displays the information for the section on the right hand side

Step 37 (FIG. 187): The user (buyer's broker) will download the form document by clicking on the Blank Form button

Step 38 (FIG. 188): The user (buyer's agent) will open the form document and fill out some of the fields.

Step 39 (FIG. 189): The user (buyer's agent) will upload the completed PDF form by using the Open File and Attach button.

Step 40 (FIG. 190): The user (buyer's broker) will use the Logout Quick Link to log out of the system.

Step 41 (FIG. 191): The user representing the buyer's accountant logs on using the information he received in the e-mail.

Step 42 (FIG. 192): The user (buyer's accountant) will select the row for the application and click on Edit to get to the Browse Package window.

Step 43 (FIG. 193): On the Browse Package window, he will select the section Statement of Insurance, which displays the information on the right hand side.

Step 44 (FIG. 194): The user (buyer's accountant) will upload a document by using the Open File and Attach buttons.

Step 45 (FIG. 195): The user (buyer's accountant) will use the Logout Quick Link to log out of the system.

Step 46 (FIG. 196): The user representing the buyer logs in to the system.

Step 47 (FIG. 197): The user (buyer) will select the application and then click on Edit to get to the Browse Package window.

Step 48 (FIG. 198): The user (buyer) will select the section Application Fee, which causes the information to appear on the right hand side.

Step 49 (FIG. 199): The user (buyer) will select Copy of Check and then attach an image document using the Open File and Attach buttons.

Step 50 (FIG. 200): Select the application and click on the Final Packet Wizard link to get to the Prepare Final Packet Wizard.

Step 51 (FIG. 201): The user (buyer) will then select the Prepare Final Packet Quick-Link and follow the instructions as they appear, clicking on next after completing each step.

Step 52 (FIG. 202): The user (buyer) will then log out of the system.

Step 53 (FIG. 203): The user (building manager) logs in to the system.

Step 54 (FIG. 204): The user (building manager) will click on the row for the application being acted upon and then click on the Discuss button to get to the Review Message Board window.

Step 55 (FIG. 205): At this time, the list of messages should be empty.

Step 56 (FIG. 206): The user (building manager) will click on the add message button to add the message.

Step 57 (FIG. 207): After entering the message, he will click on Post to submit the message and return to the Review Message Board window.

Step 58 (FIG. 208): The user (building manager) should now see his message on the message board.

Step 59 (FIG. 209): The user (building manager) logs out of the system using the Logout quick link.

Step 60 (FIG. 210): The user representing the building manager logs on to the system.

Step 61 (FIG. 211): The user (building manager) will select the application and then click on the Decision button.

Step 62 (FIG. 212): The user (building manager) will fill in the information on the Indicate Decision window and then click on the Next button.

Step 63 (FIG. 213): The user (building manager) logs out of the system using the Logout Quick Link.

Step 64 (FIG. 214): The user representing the buyer will check his E-mail for the acceptance notice.

Step 65 (FIG. 215): The user representing the buyer's agent will check his E-mail for the acceptance notice.

The scenario labeled “Setup Reference Section” from the previous section is also provided as an example through the system. Screen shots are shown for each step of the scenario

Step 1 (FIG. 216-218): The individual representing the system administrator logs on to the system.

Step 2 (FIG. 219): The user will see the administrative home page. From this page, he will click on the Edit Reference Sections quick link.

Step 3 (FIG. 220-222): The user will see the Browse Section List window containing the list of reference sections configured on the system. Since this is a new system, the list is empty. He will click on the add (plus sign) button to setup a new reference section.

Step 4 (FIG. 223-225): The user will enter the name and type of the section in the fields on the right.

Step 5 (FIG. 226): Clicking on the Submit button will save the information.

Step 6 (FIG. 227): Click on the Add button again to obtain the form for the next reference section.

Step 7 (FIG. 228-229): Enter the name and type of the next section to be entered. This is a document section entitled Statement of Insurance.

Step 8 & 9 (FIG. 230) Enter the name and type of the next section to be entered. This is a payment section entitled Application Fee. Enter the information for this section.

Step 10 (FIG. 231): Click on the Submit button to save the information.

Step 11 (FIG. 232): You should now see the three sections listed in the Browse Section List. Click on the row for the Statement of Insurance section to bring up the details in the panel on the right.

Step 12 (FIG. 233): The system administrator logs out of the system using the Logout Quick Link.

The scenario labeled “Building Setup” from the previous section is also provided as an example through the system. Screen shots are shown for each step of the scenario.

Step 1 (FIG. 234): The user representing the building manager logs on to the system and select create a new account link.

Step 2 (FIG. 235): The user will fill out the fields on the Basic Profile Info window. After completing the fields, clicking on the Next button displays the Managing Agent Info window.

Step 3 (FIG. 236): The layout of the Managing Agent Info window has not yet been determined. He will fill out the information as appropriate.

Step 4 (FIG. 237): Clicking on the Next button displays a confirmation message. Click on the OK button on the Confirmation window.

Step 5 (FIG. 238): The system will send the user an e-mail message containing his account name and password. The user will open his e-mail and read the message.

Step 6 (FIG. 239): Log in to the system with the e-mail address and password entered in the previous step. Clicking on the Login button takes the user to the main menu

Step 7 (FIG. 240): From the Quick Links on the main menu, select Configure Building/Application.

Step 8 (FIG. 241): The user will now see the Building List window showing a list of buildings that have been configured in the system that the user is the building manager for. The grid should be empty at this point. He will click on the New button to go to the Building Profile window.

Step 9 (FIG. 242): The user will fill in the information on the Building Profile window.

Step 10 (FIG. 243): Click on the Open File button for the image of the building and select the file containing a picture of the building.

Step 11 (FIG. 244): After closing the file selector window, click on the Attach (paperclip) button for the image file to load it into the system.

Step 12 (FIG. 245): Click on the Next button to go to the Building Units window. At this time, the list of units should be empty.

Step 13 (FIG. 246): Click on the Add (plus sign) button so that you can enter the information for the first unit in the details panel on the right.

Step 14 (FIG. 247): Click on the Open File button and select the file containing the picture of the apartment.

Step 15 (FIG. 248): After you close out the file selector window, click on the Attach button to move the file into the database.

Step 16 (FIG. 249): Click on the Add button again so that you can add information for the second apartment.

Step 17 (FIG. 250): Click on the Open File button and select the file containing the picture of the penthouse apartment.

Step 18 (FIG. 251): After you close out the file selector window, click on the Attach button to move the file into the database

Step 19 (FIG. 252): Click on the Next button on the Building Units window to go to the Board Setup window. At this time, the list for the building should be empty.

Step 20 (FIG. 253): Click on the Add button to set up the right panel for the first board member. Enter the information

Step 21 (FIG. 254): Click on the Add button to set up the right panel for the first board member. Enter the information

Step 22 (FIG. 255): Click on the Previous button two times to return to the Building Profile window.

Step 23 (FIG. 256): Click on the Next button on the Board Setup window to go to the Building Application Templates window. At this point, the Application Templates list should be empty.

Step 24 (FIG. 257): Click on the Add button to create a new template. Enter the Template Name and status in the fields at the bottom. Then click on the Next button to go to the Building Application Template Sections window.

Step 25 (FIG. 258): At this time, the displayed list should be empty. Click on the Import button to get to the Add Section window.

Step 26 (FIG. 259): Click on the Add Sections button to get to the Add Section window

Step 27 (FIG. 260): On the Add Section window, multiple click on all of the items in the Available Sections list. Click on the right pointing arrow to move the sections into application template. This will also transport the user to the Building Application Sections window.

Step 28 (FIG. 261): Review the list sections to make sure that they have all been placed in the application template.

Step 29 (FIG. 262): Click on the Previous button four times to return to the Building Profile window.

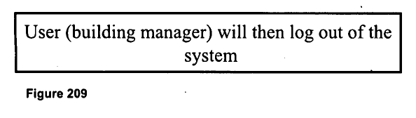

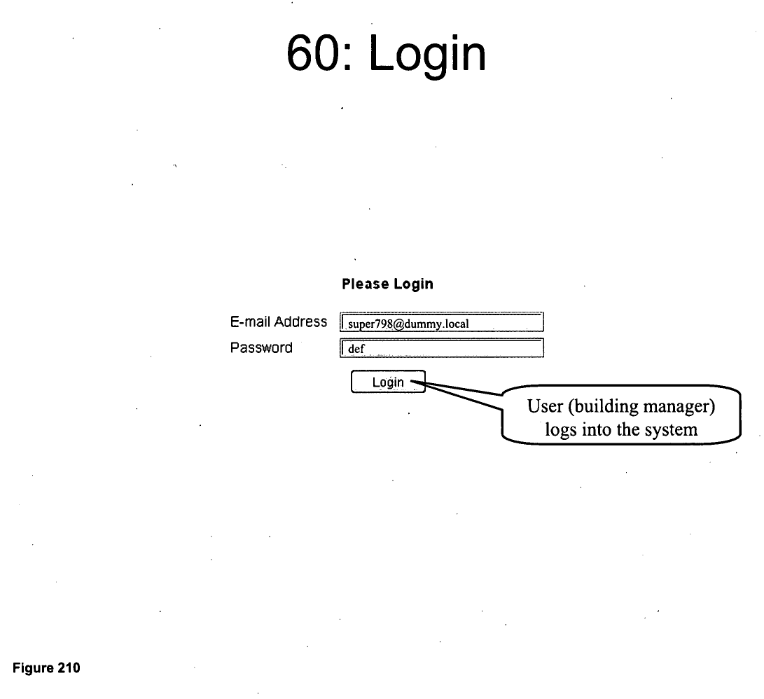

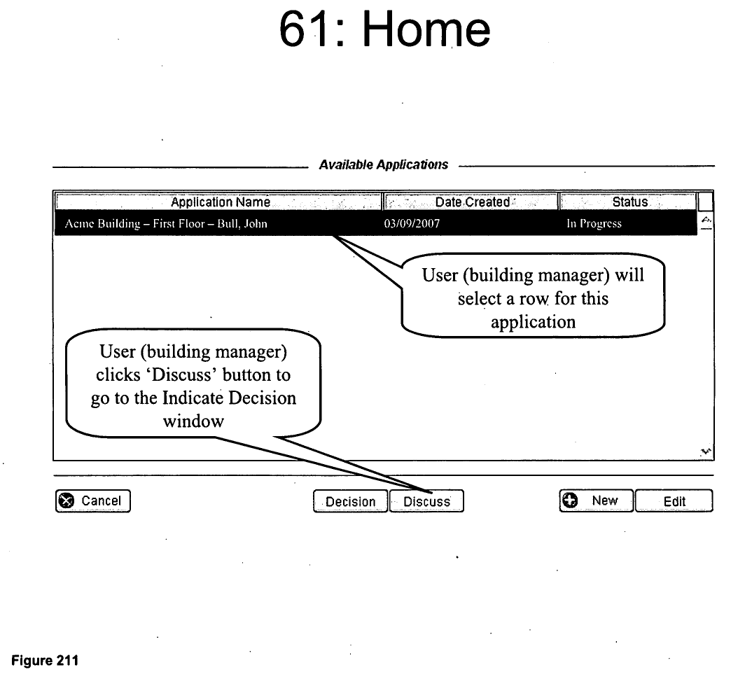

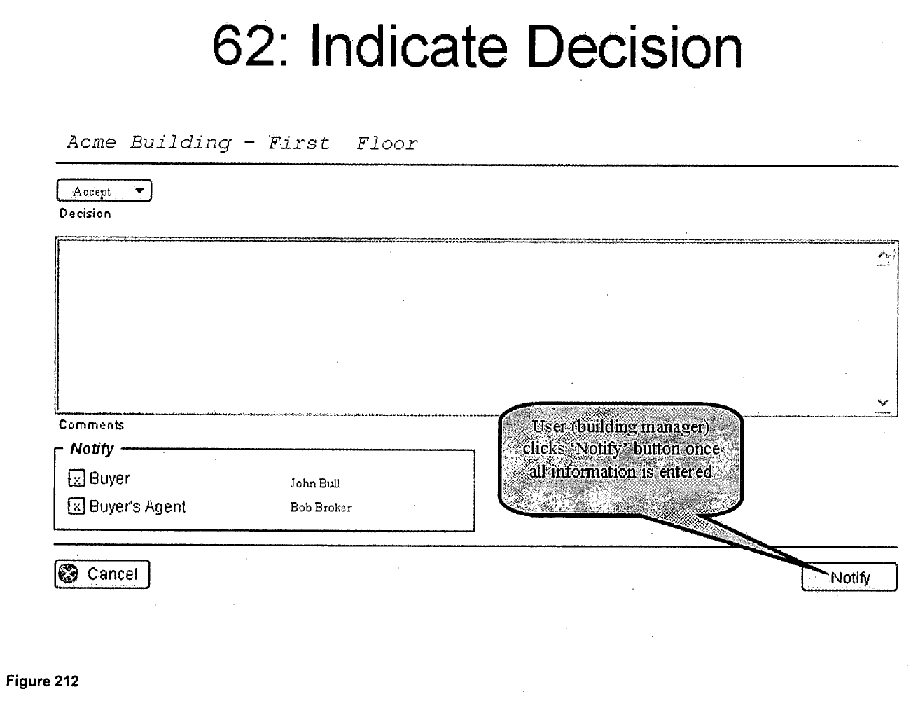

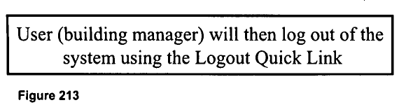

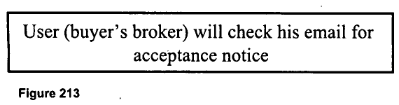

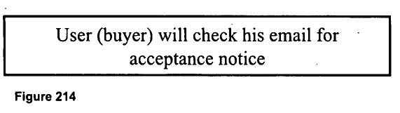

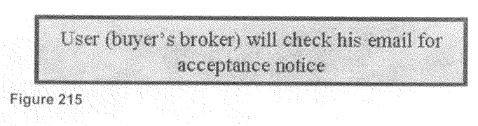

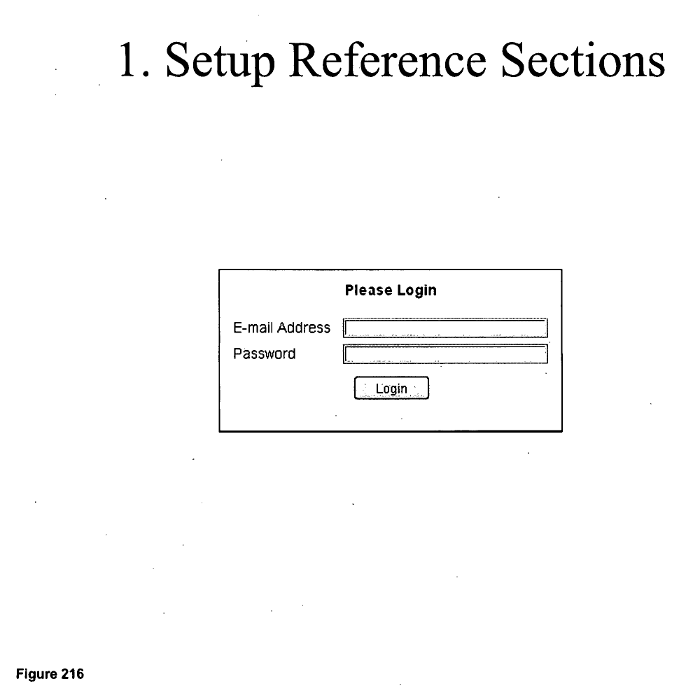

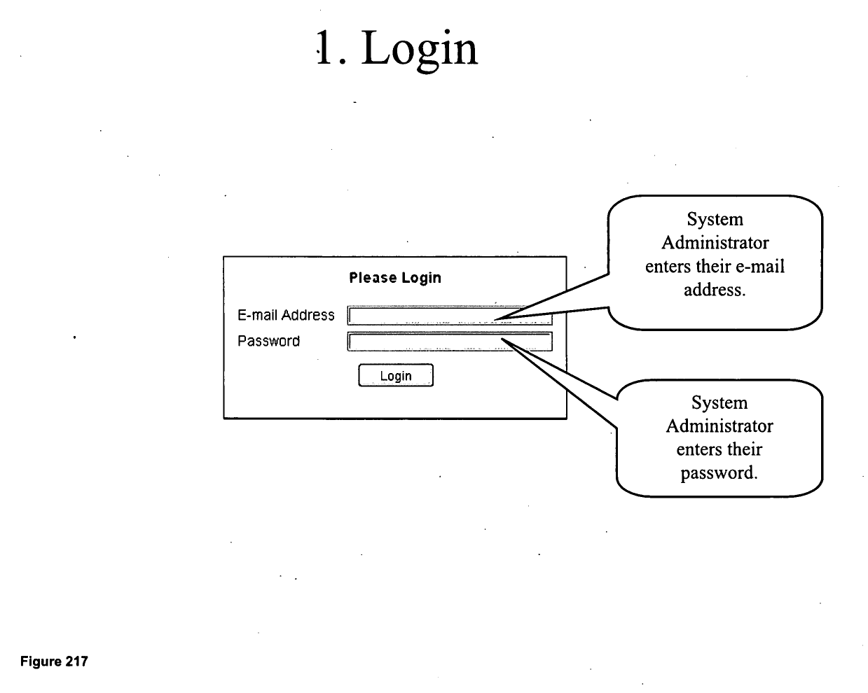

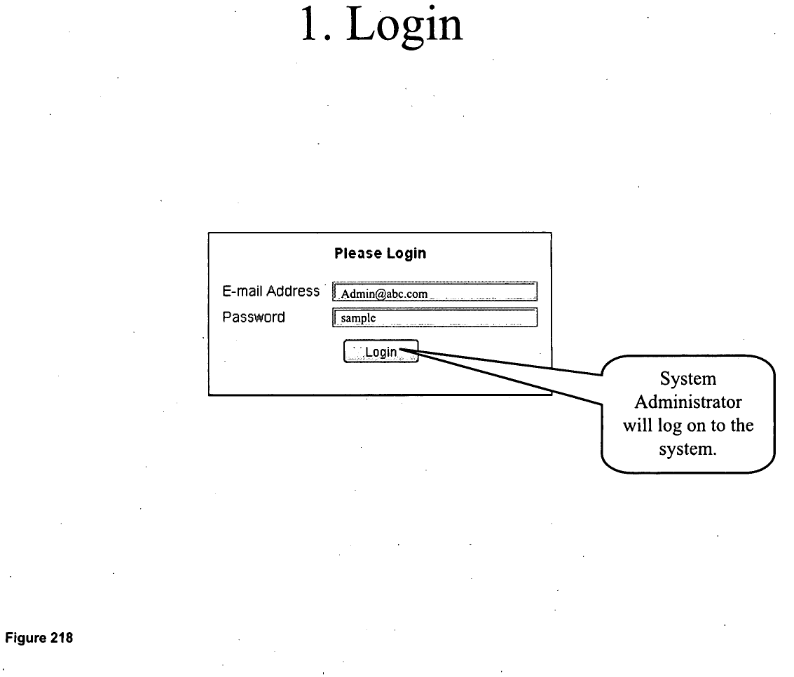

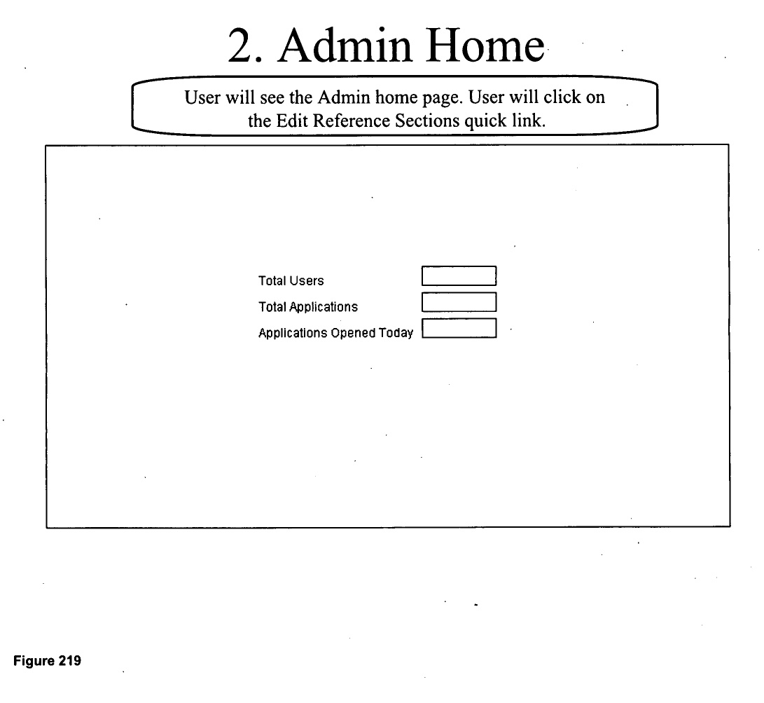

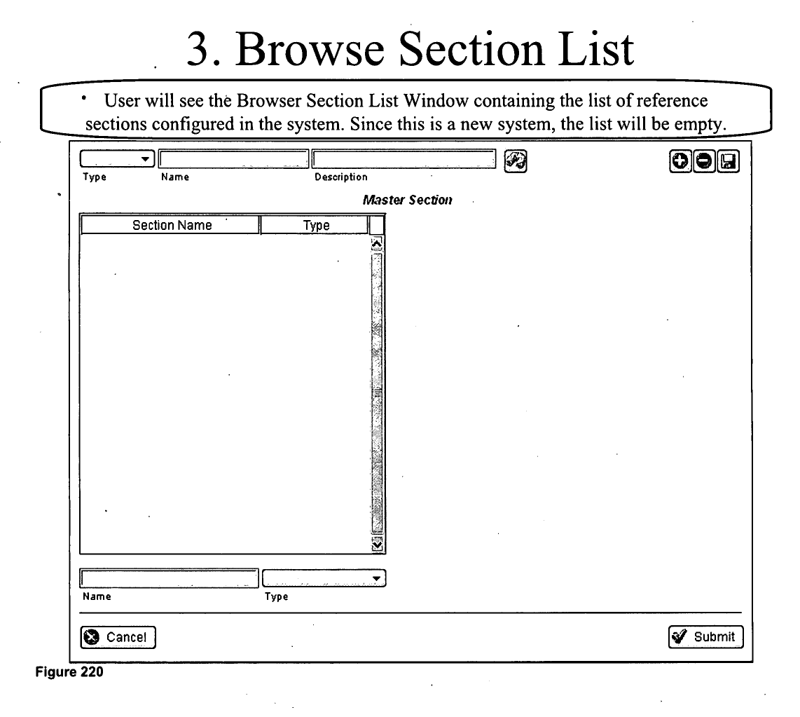

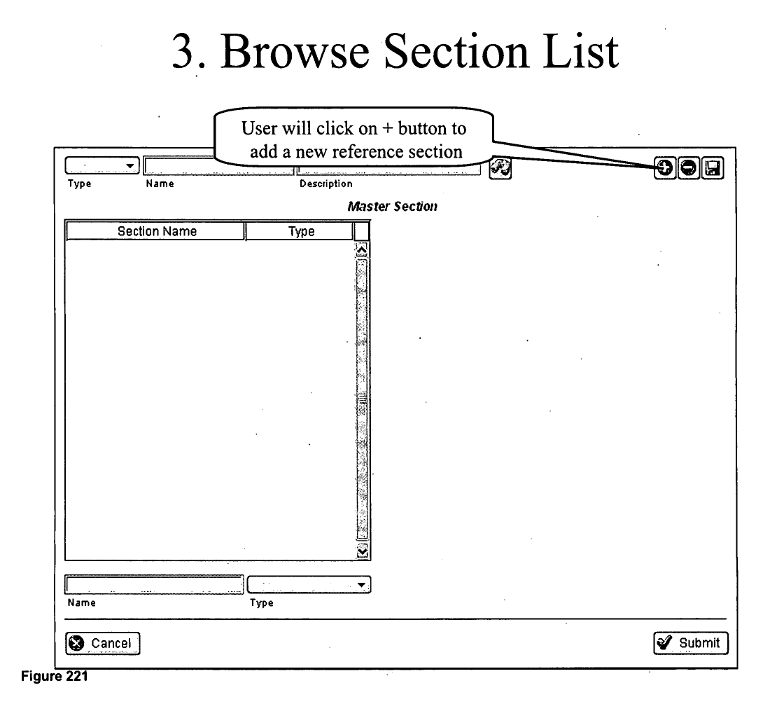

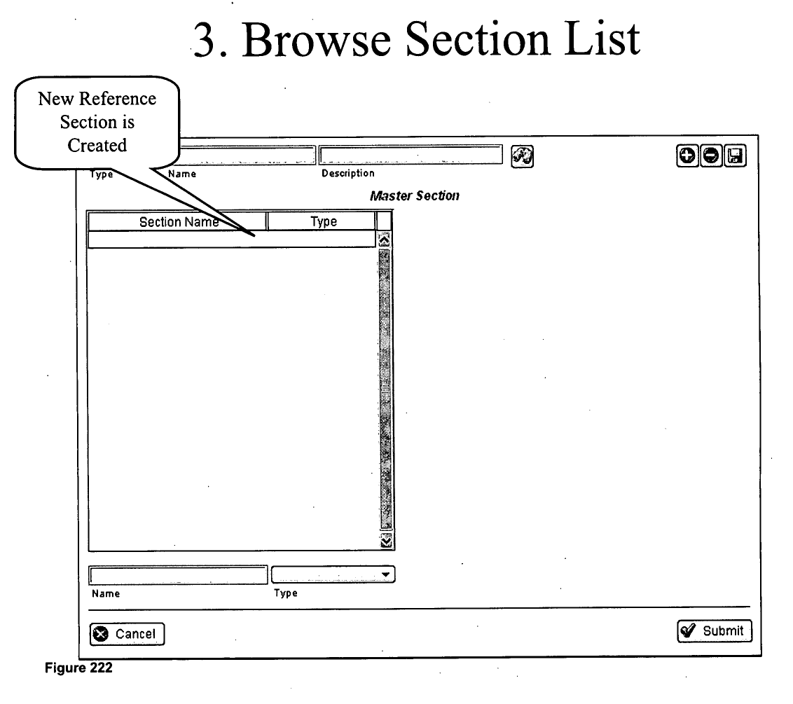

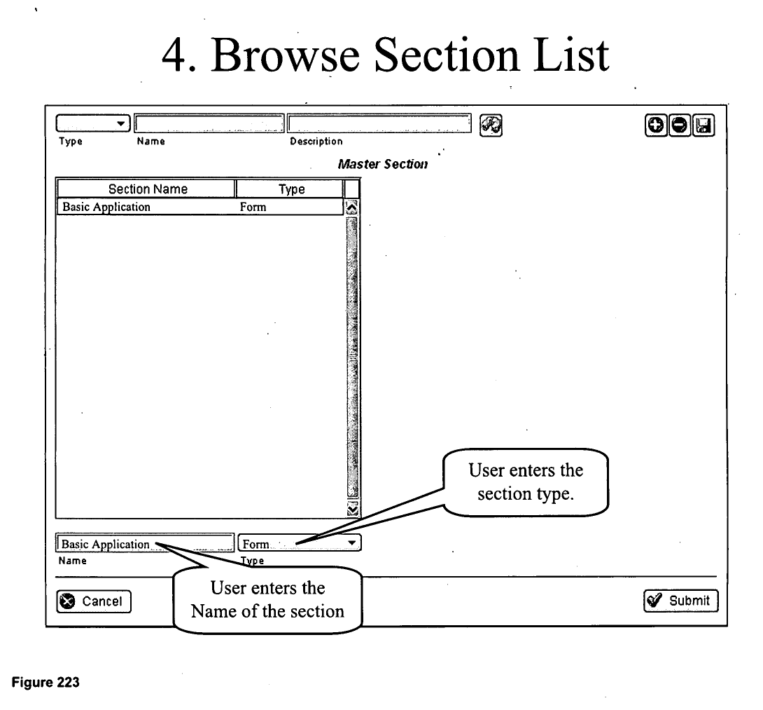

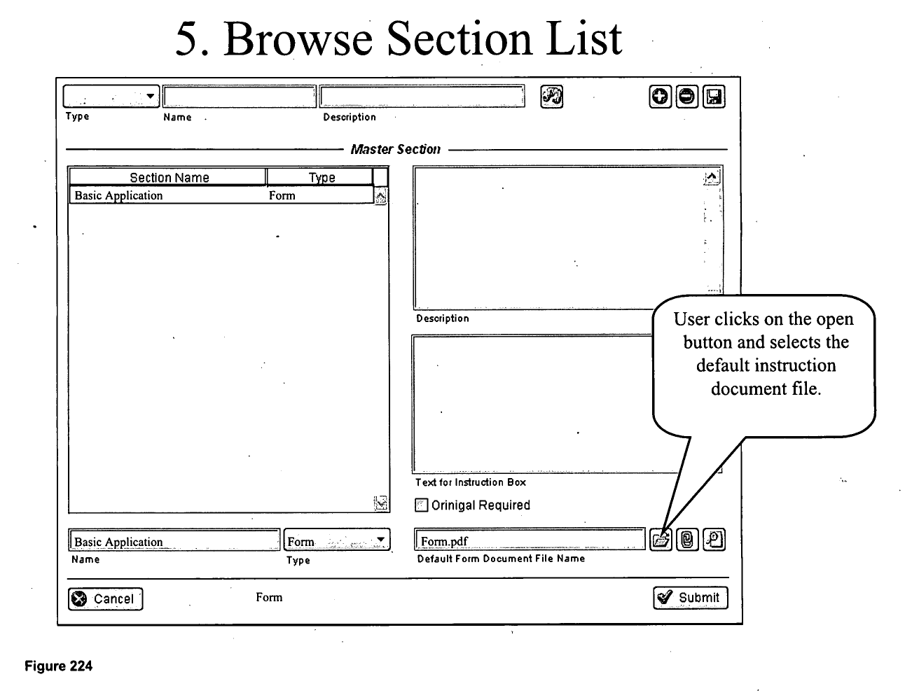

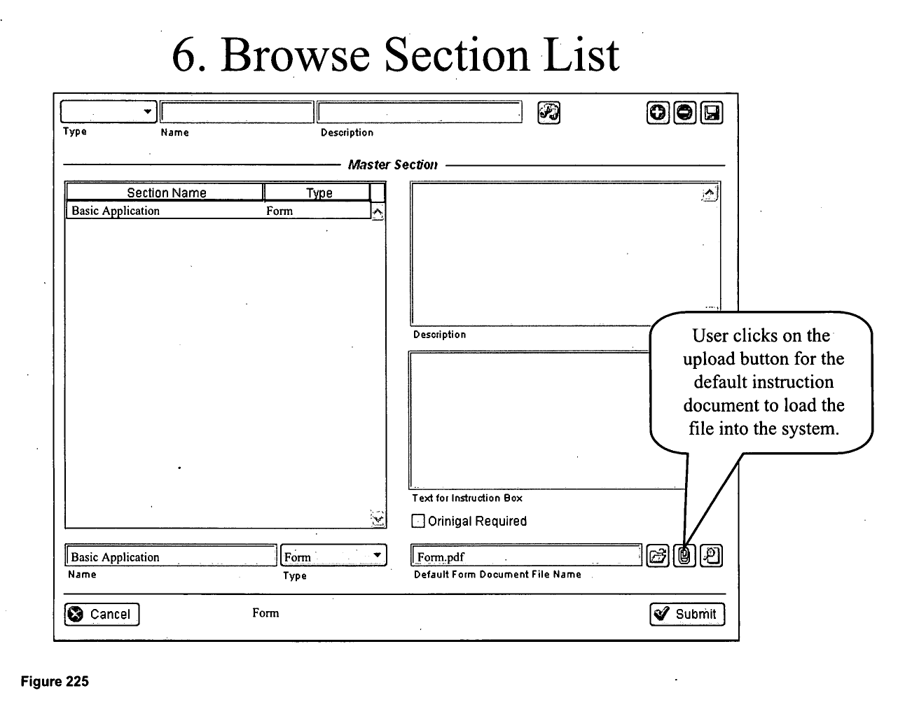

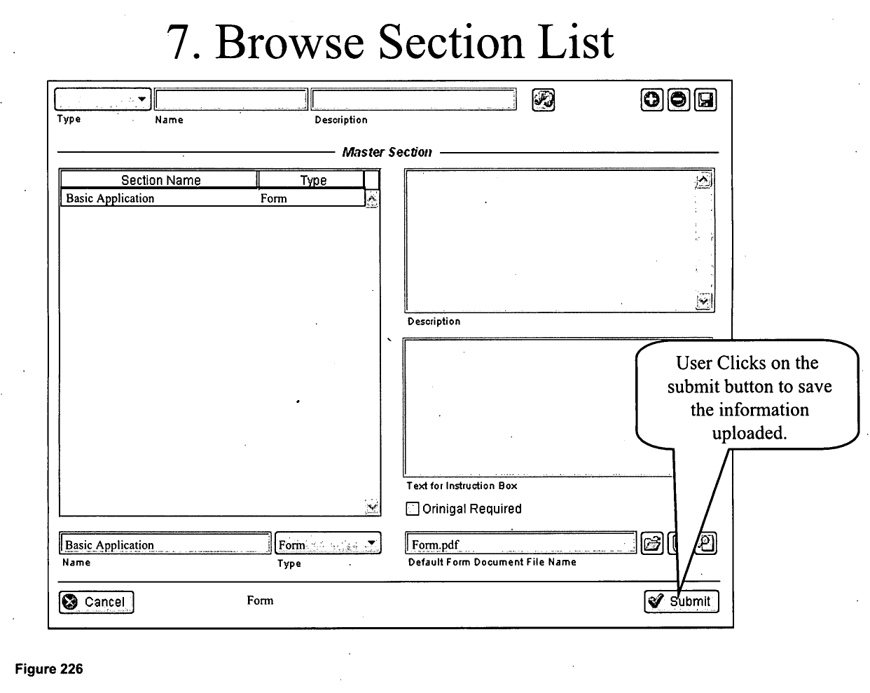

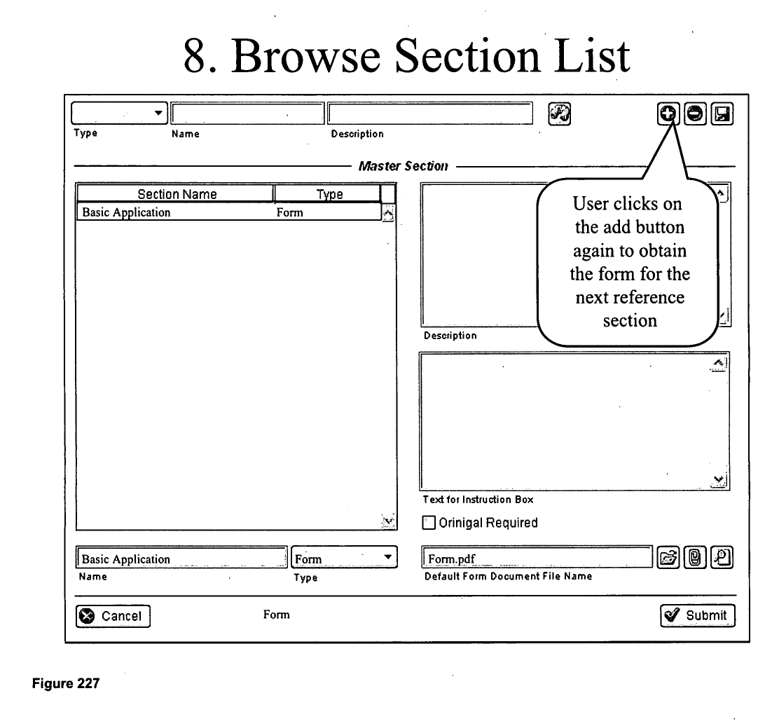

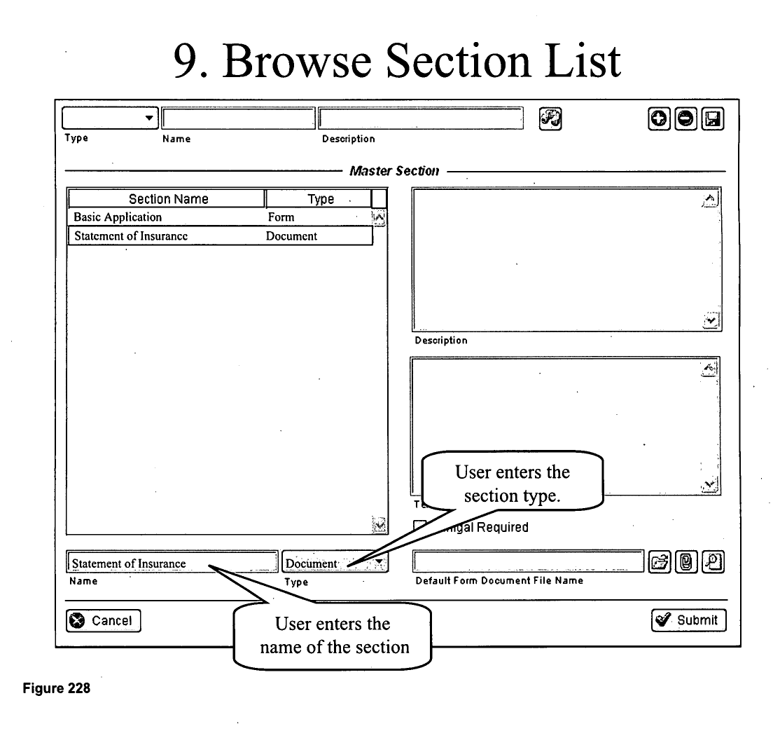

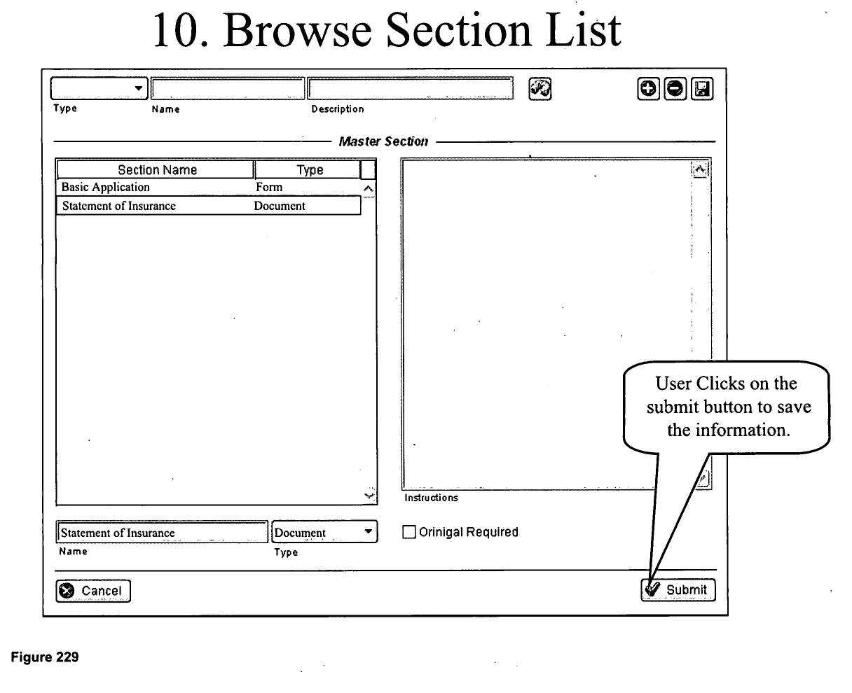

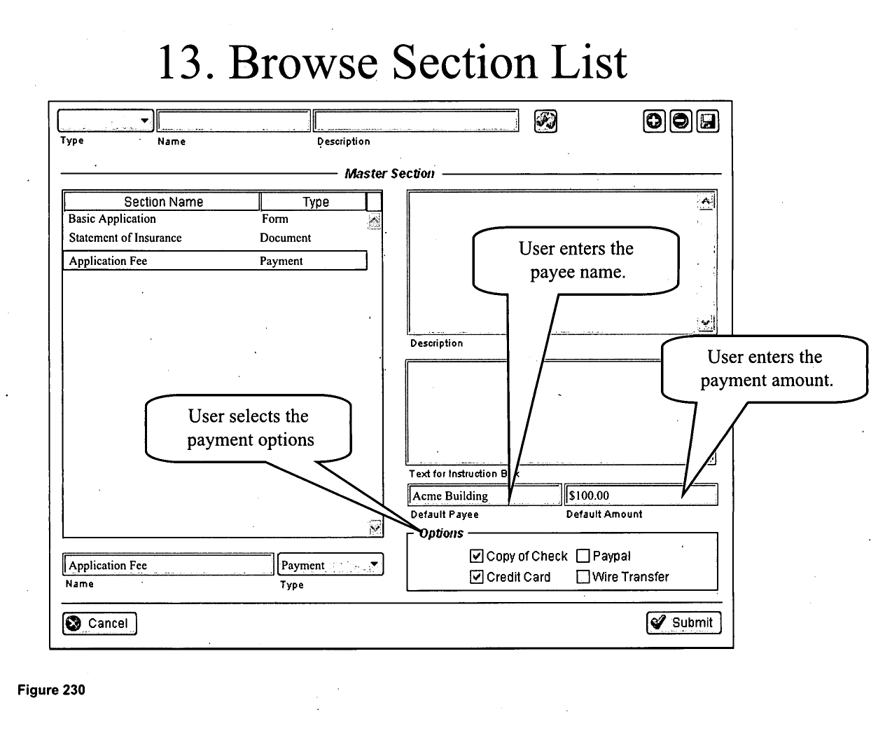

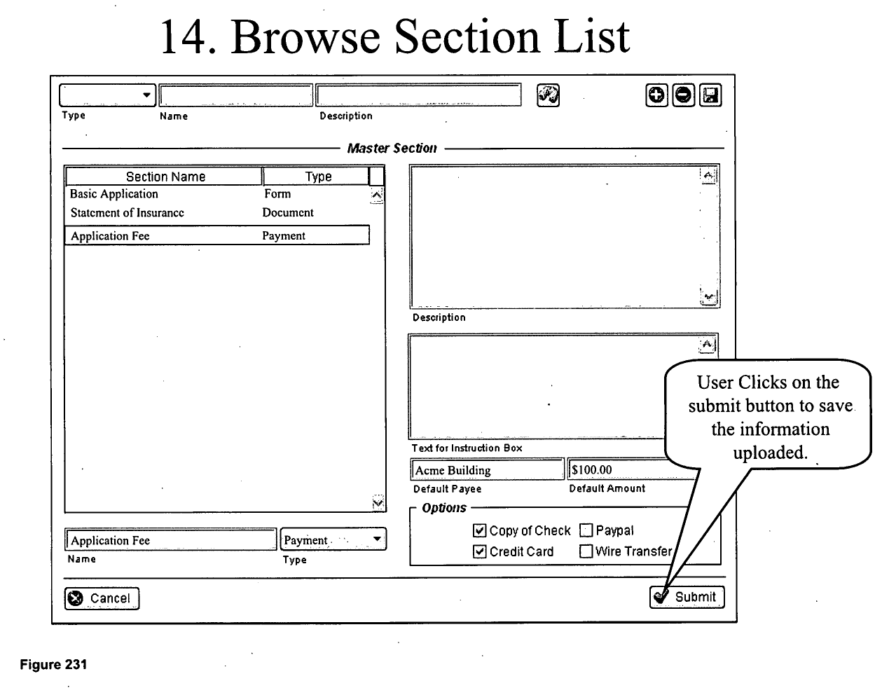

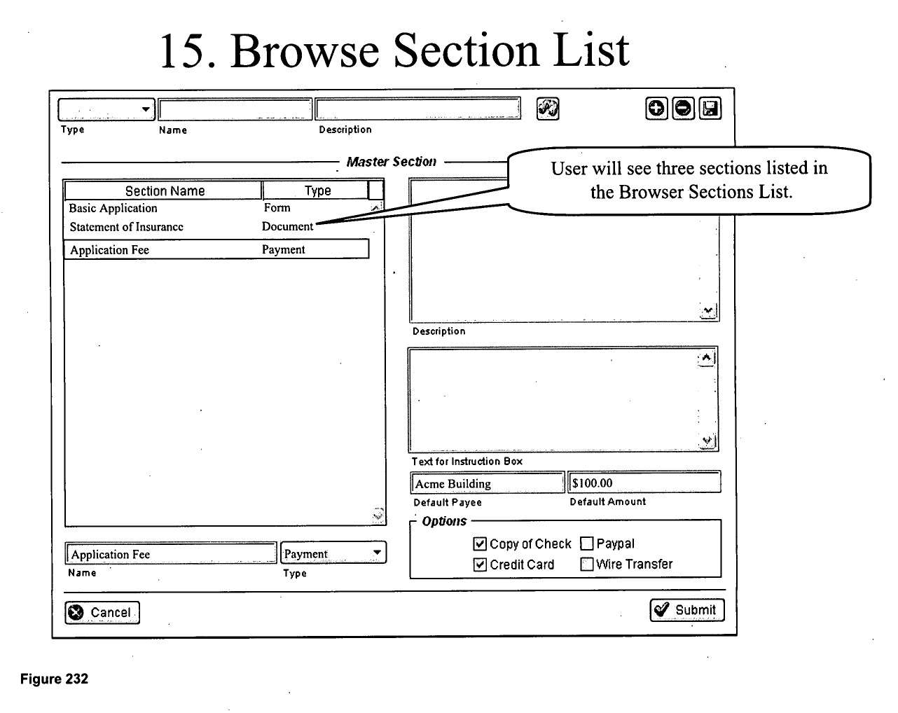

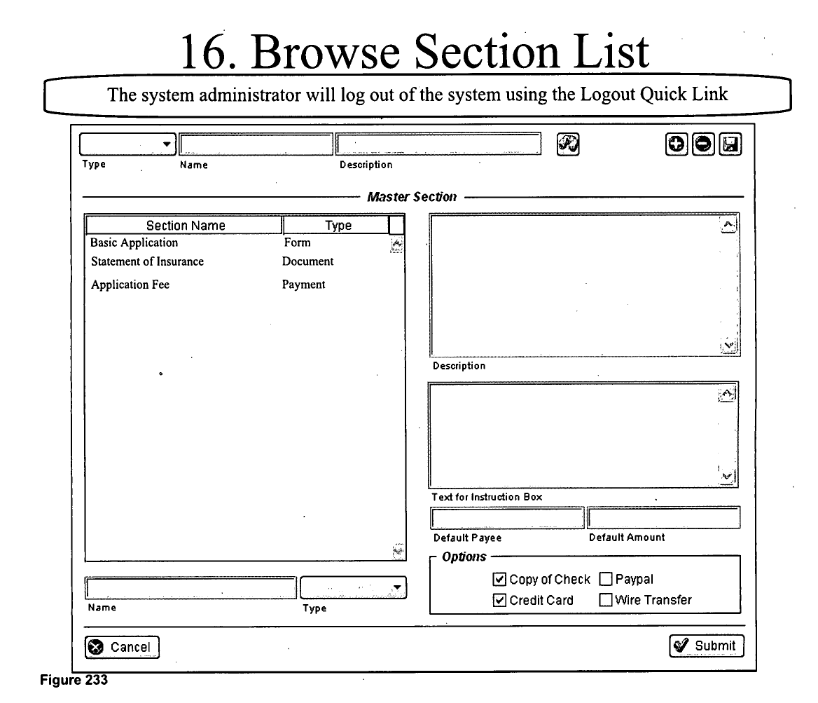

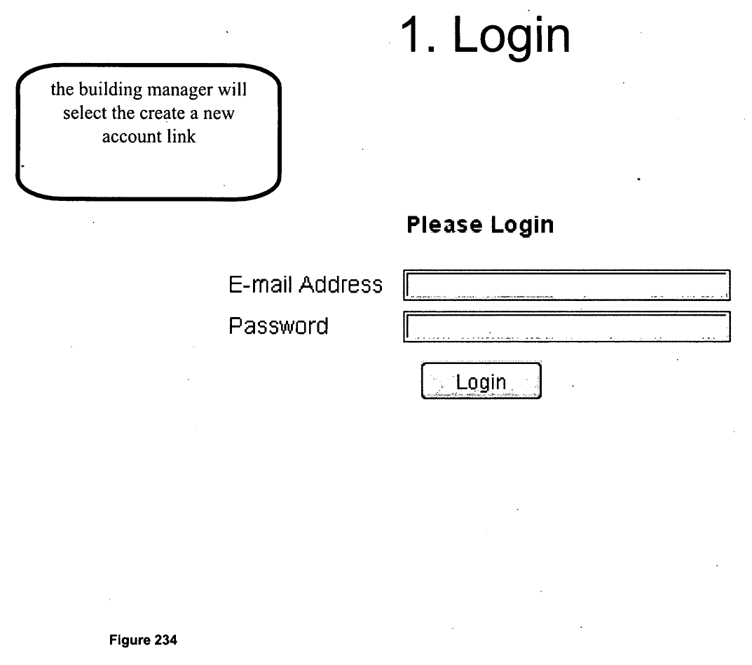

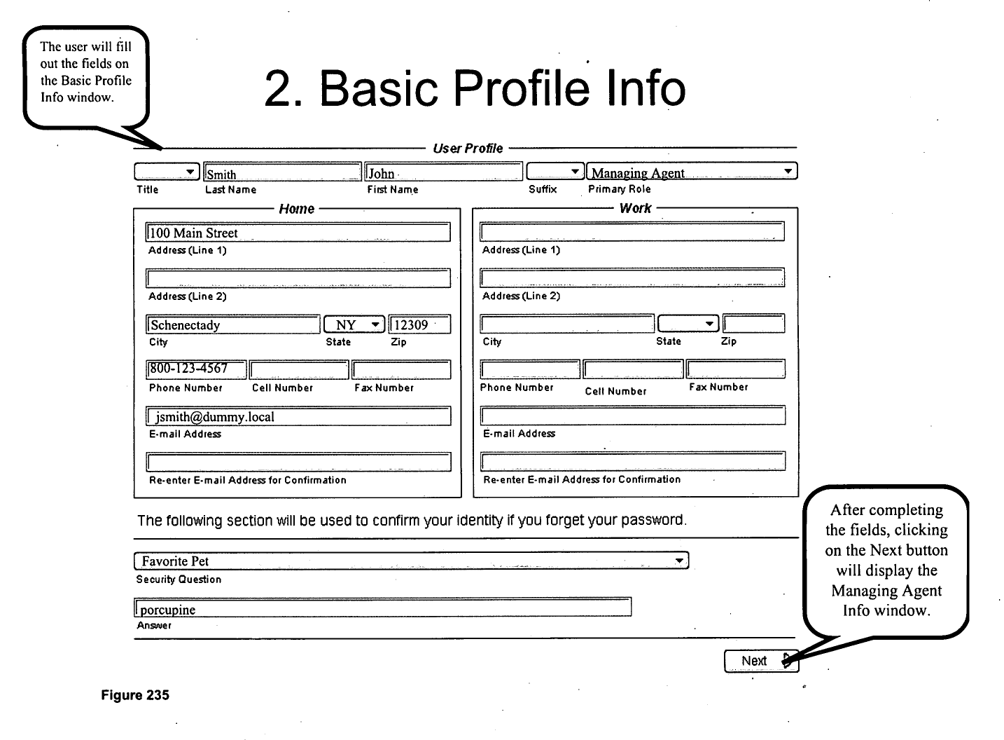

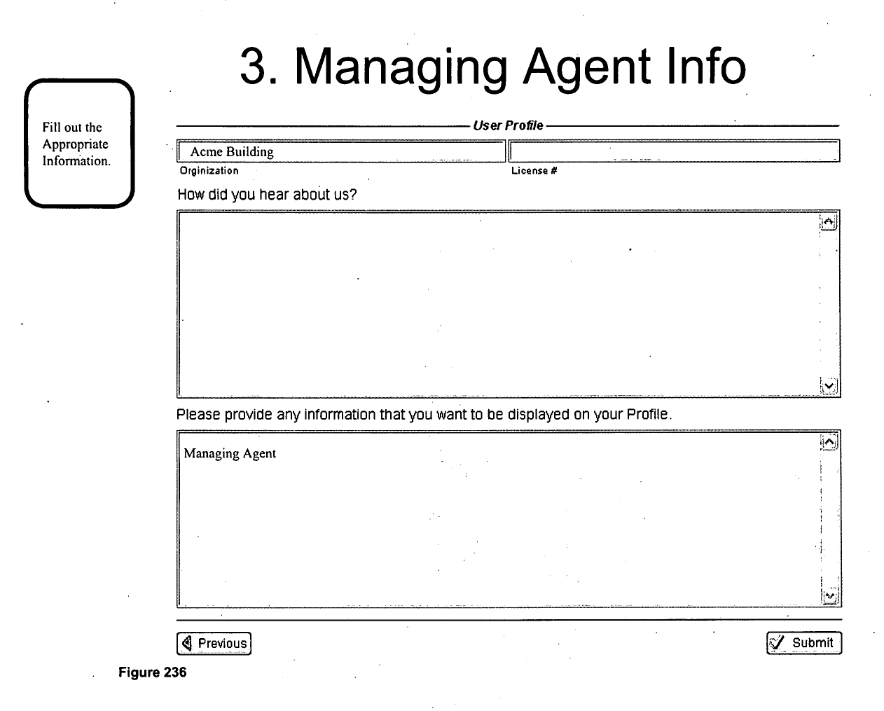

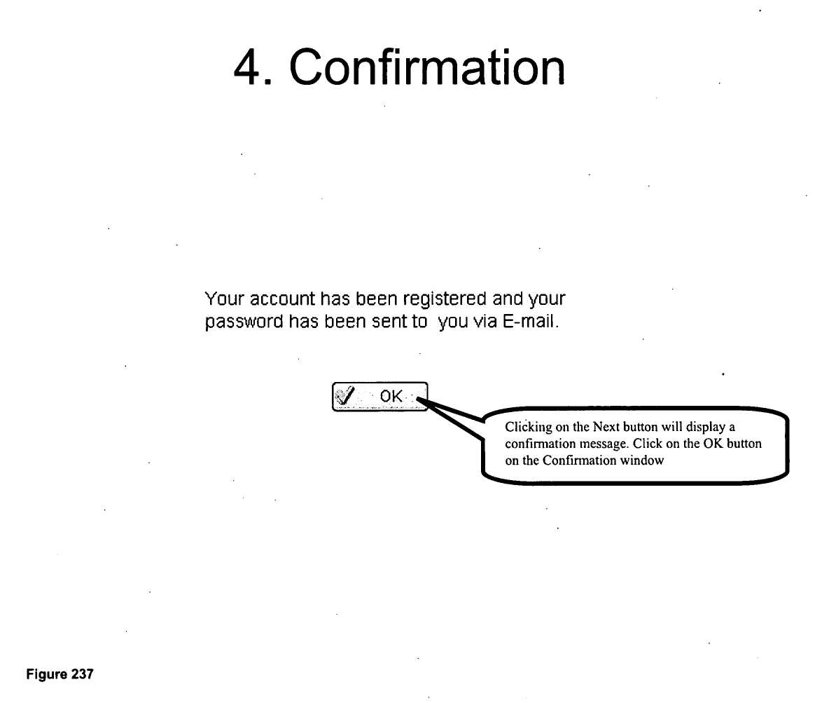

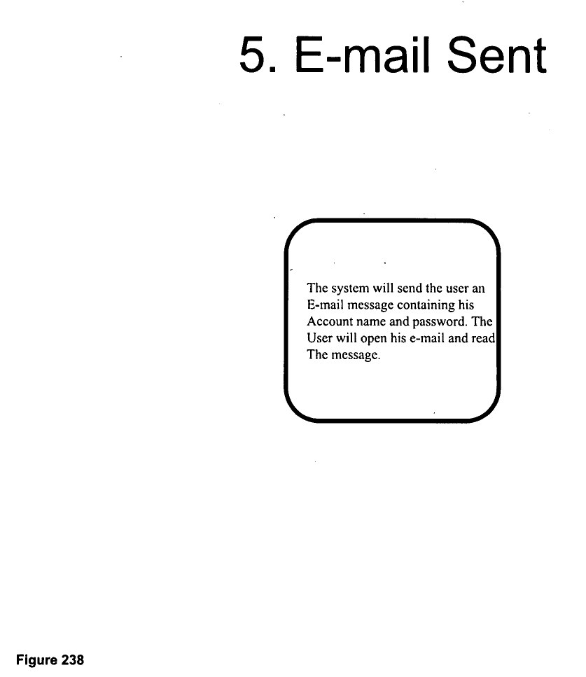

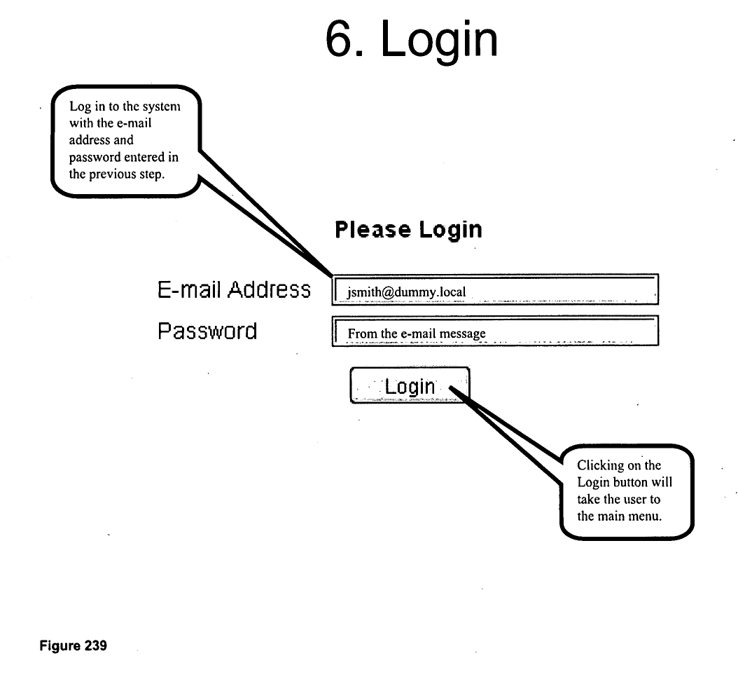

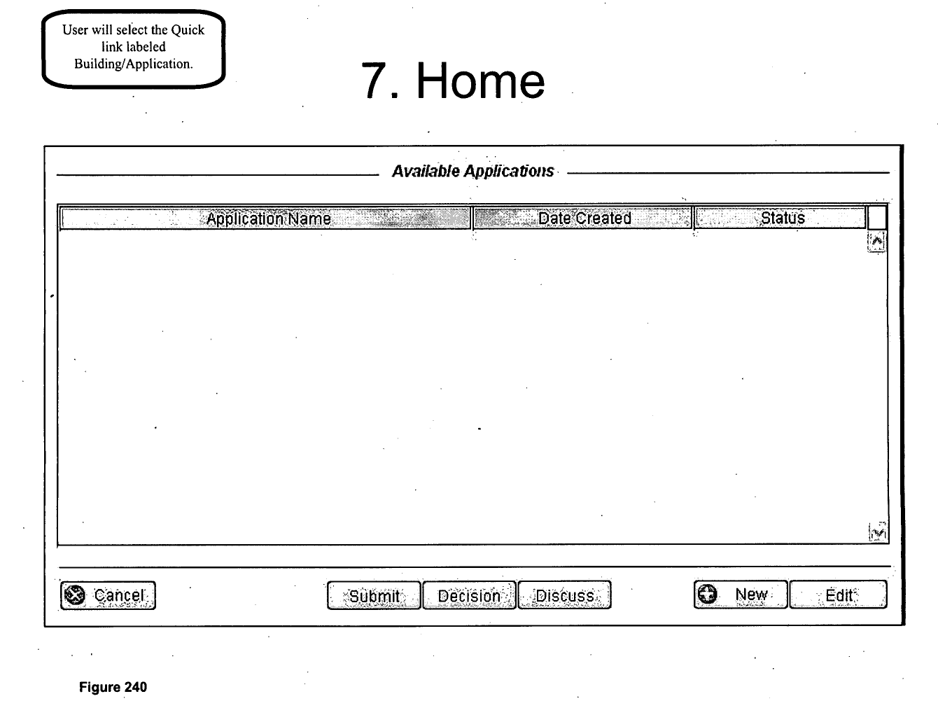

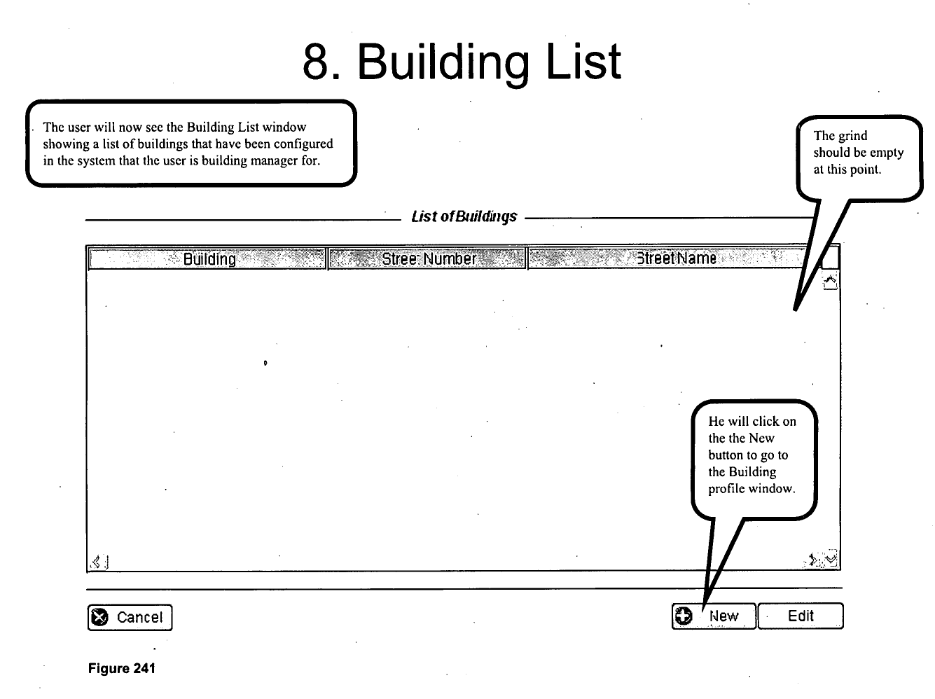

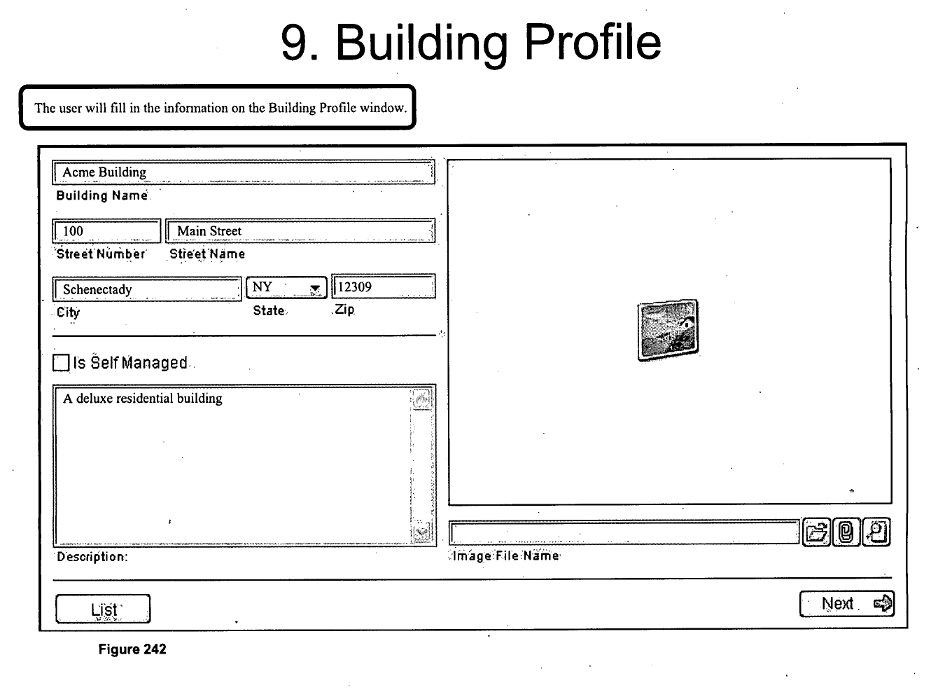

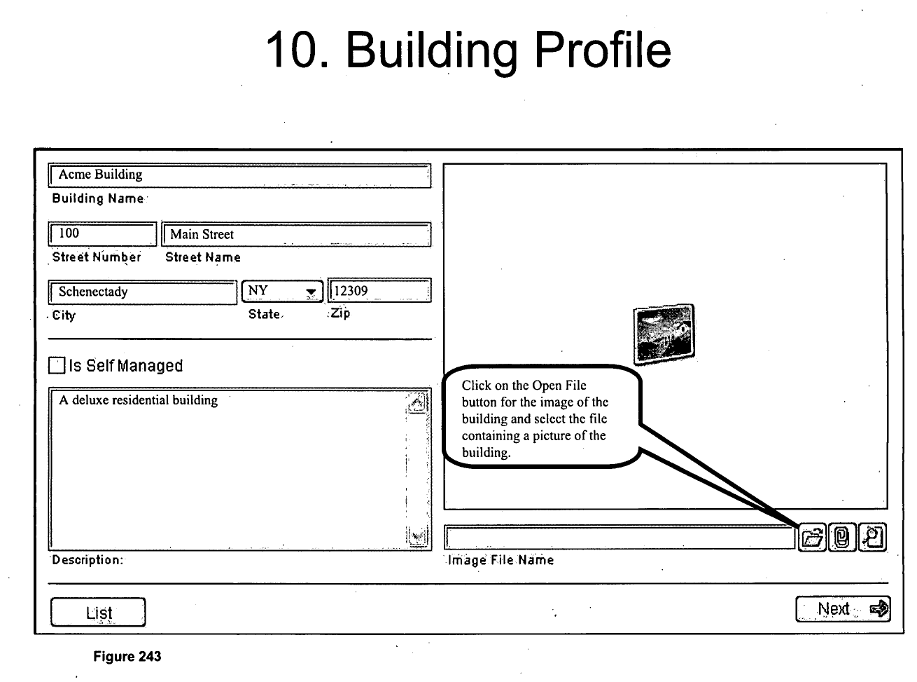

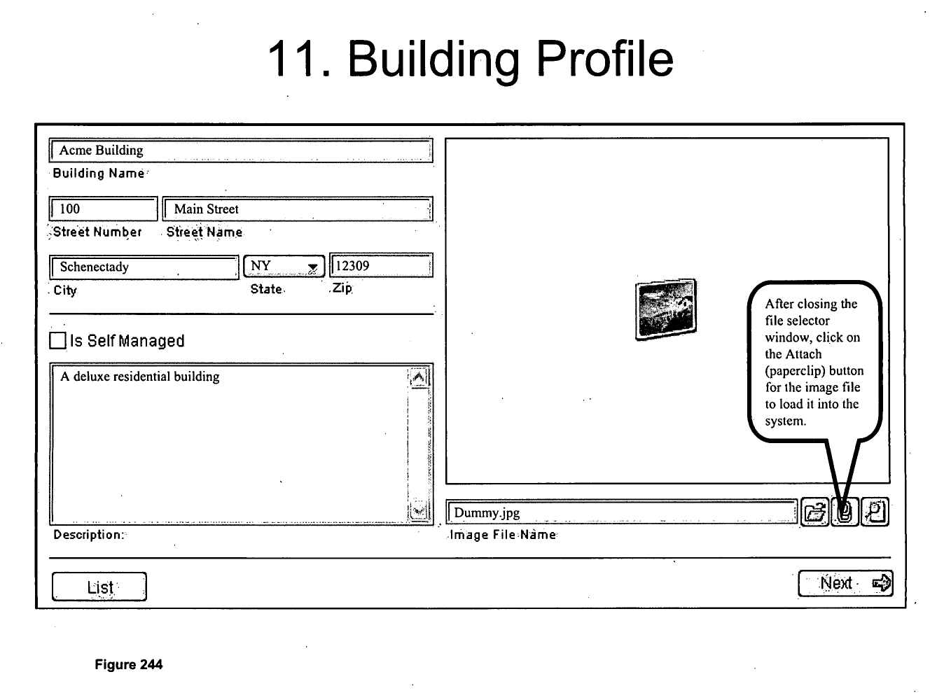

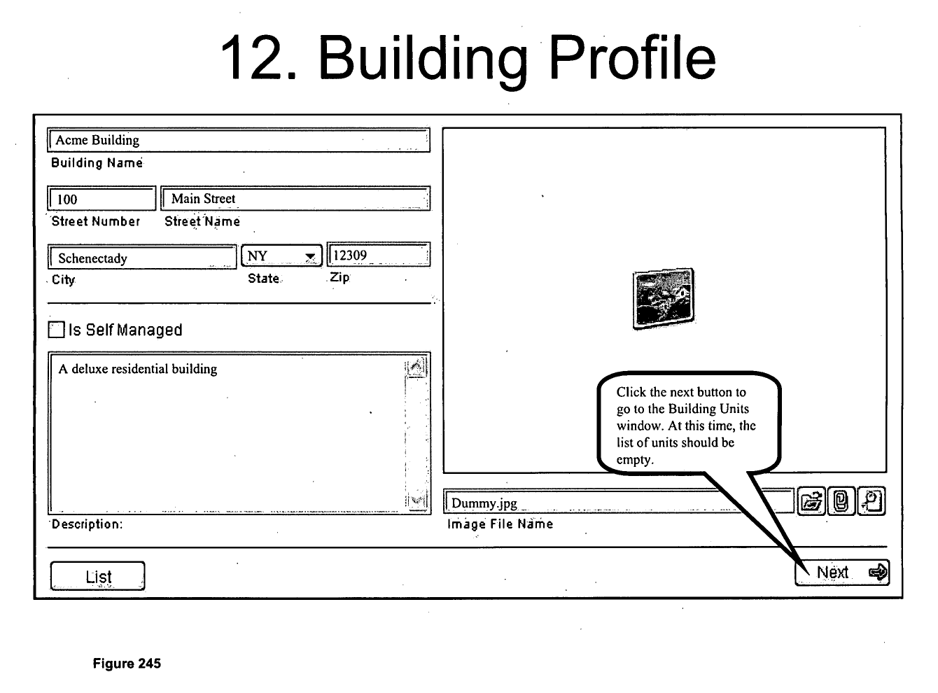

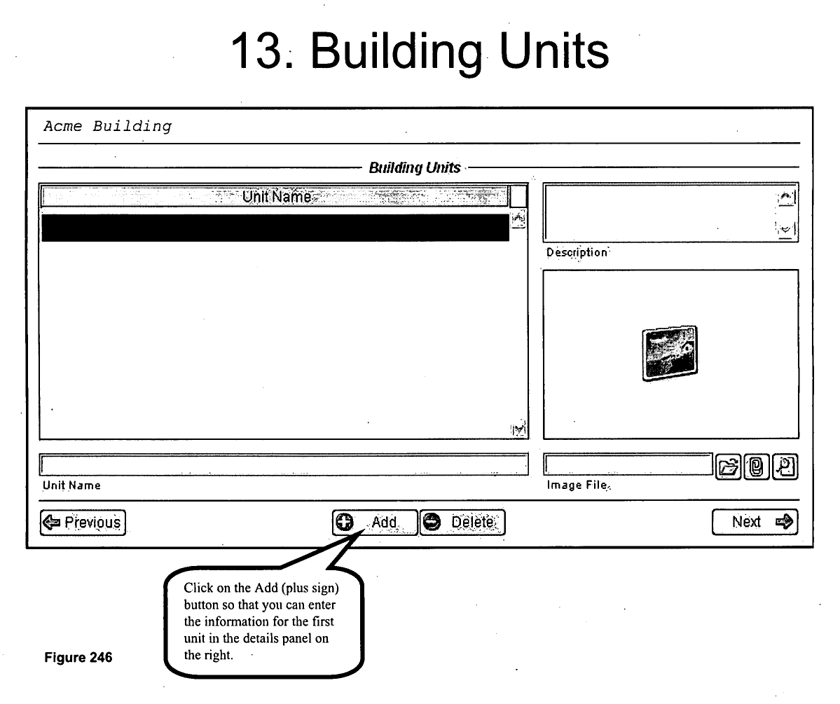

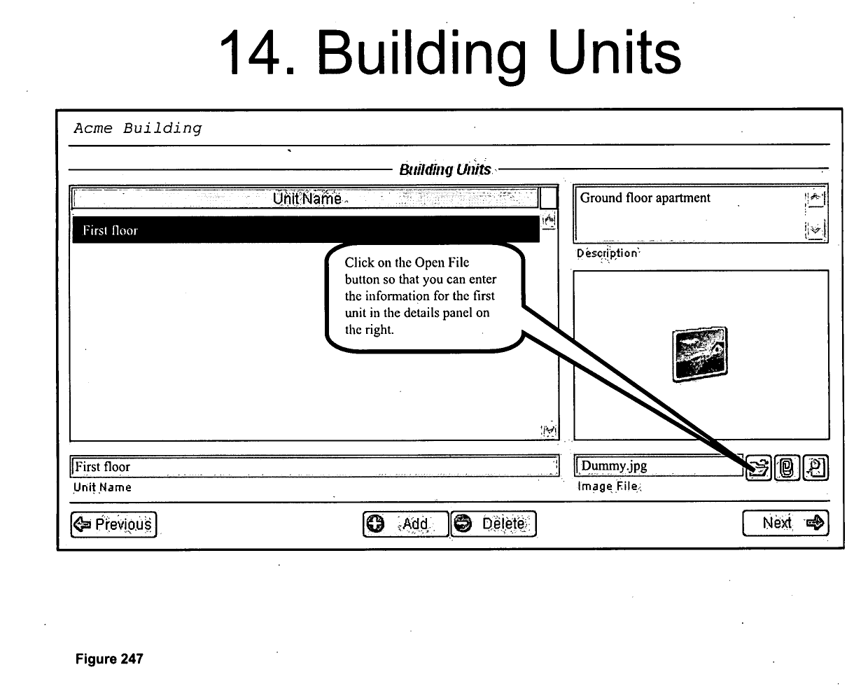

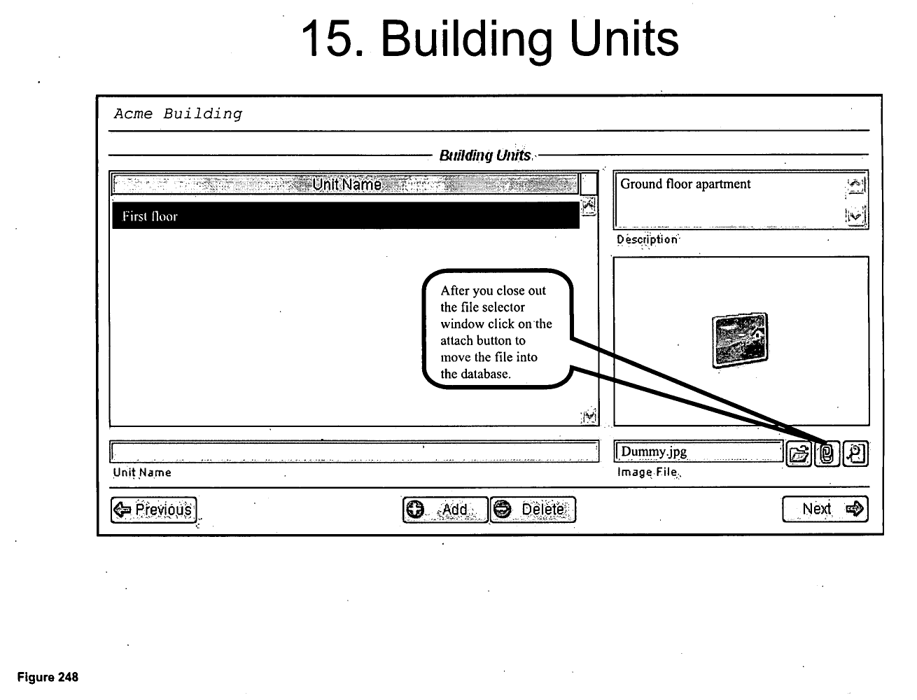

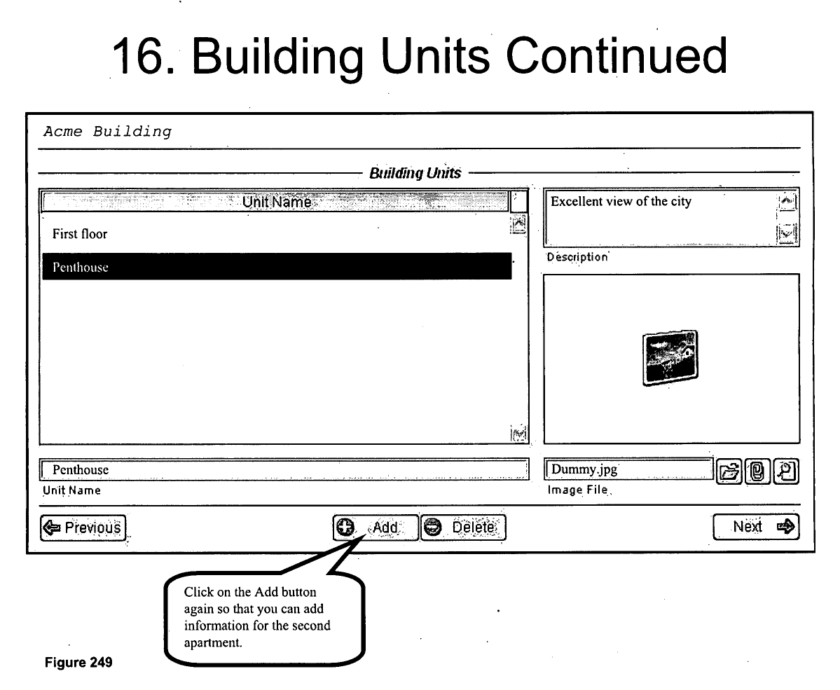

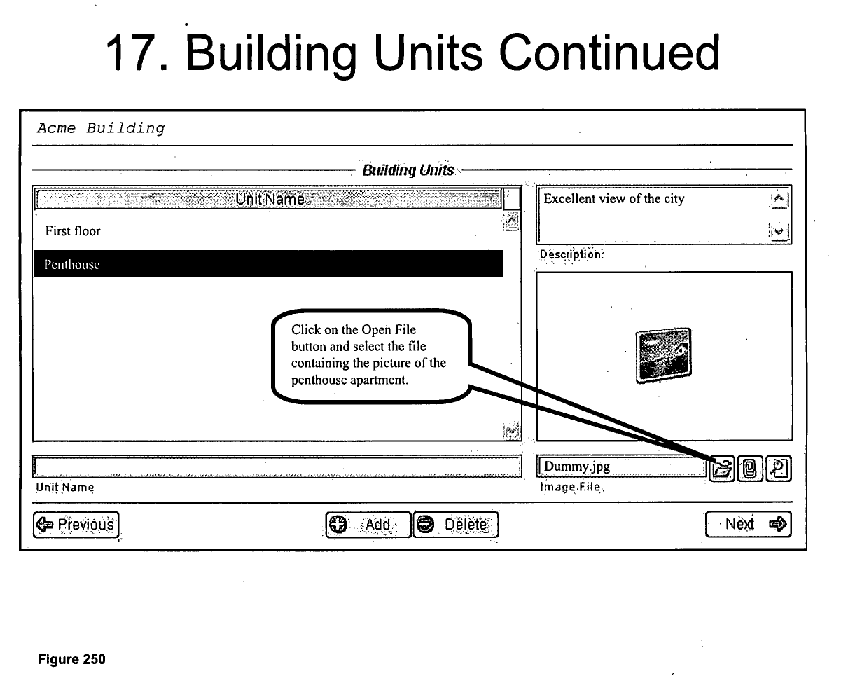

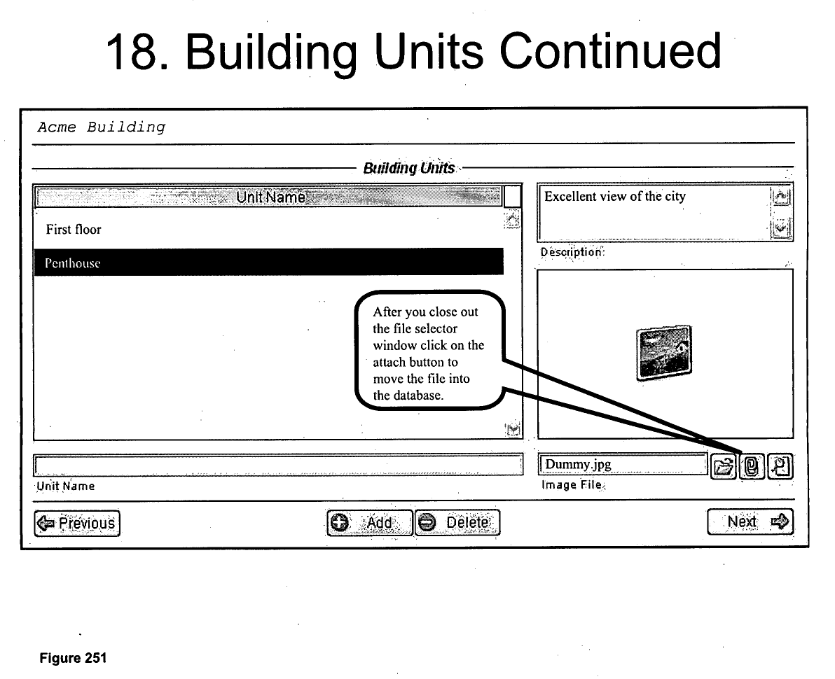

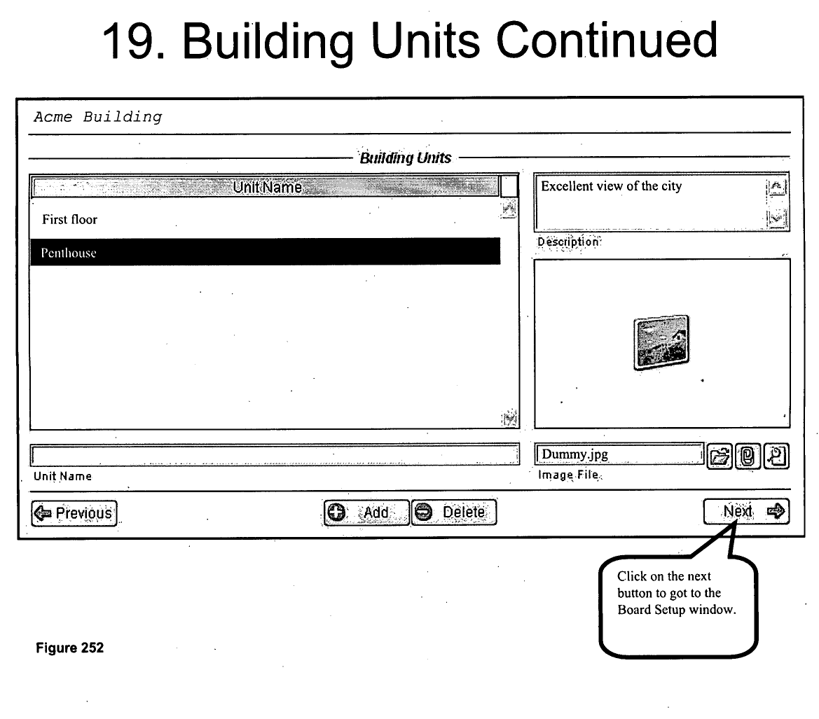

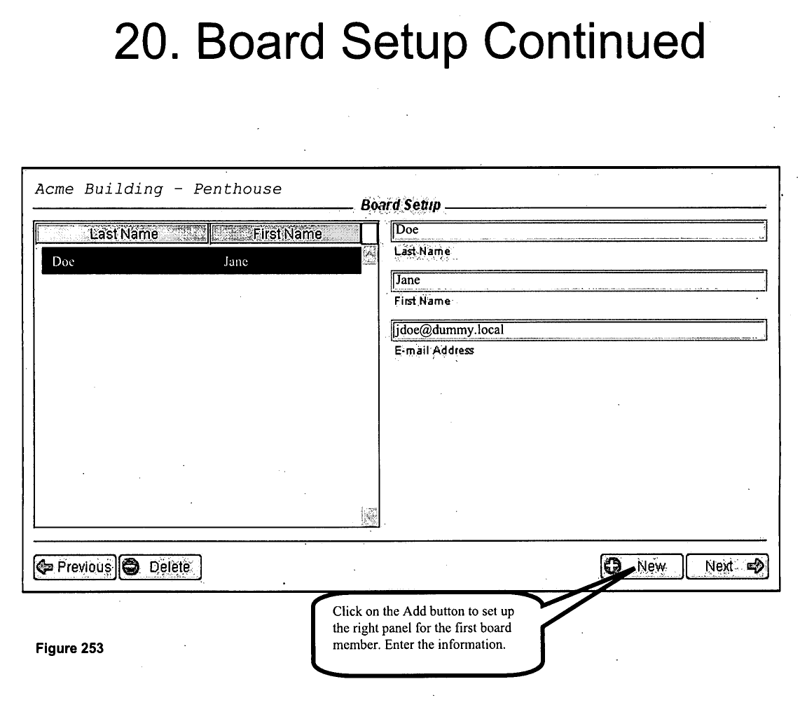

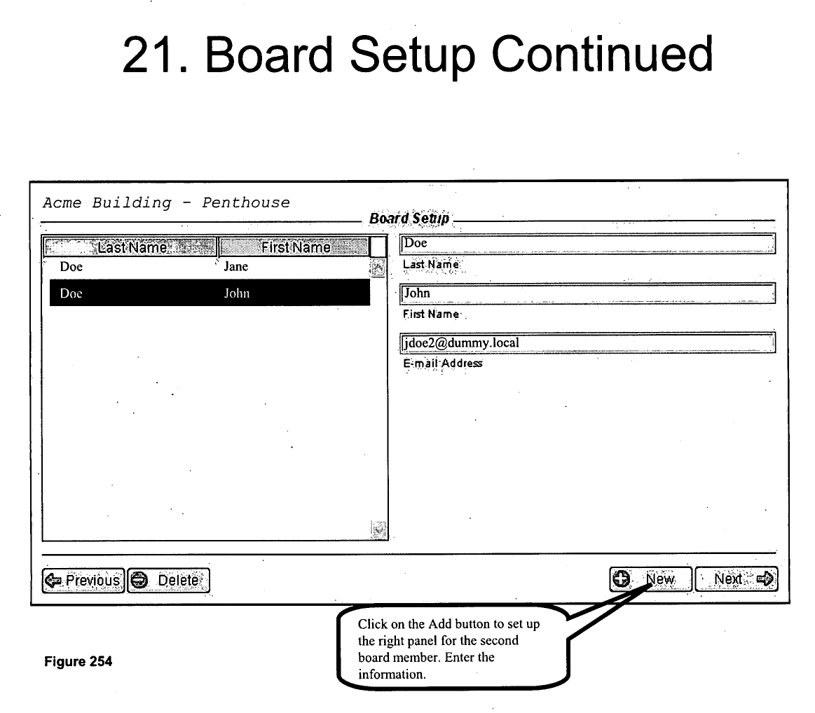

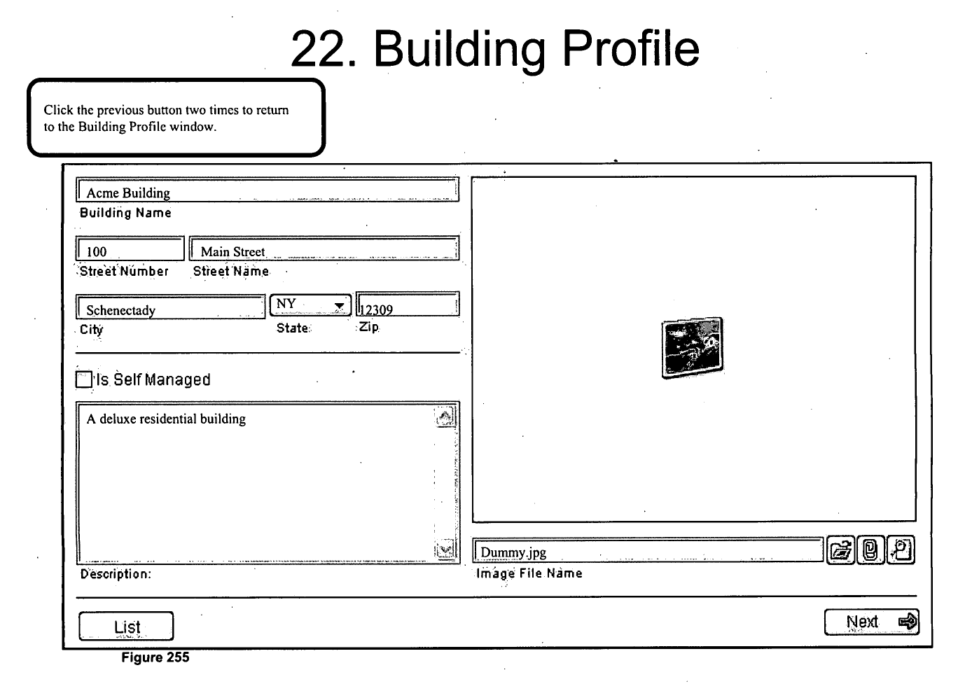

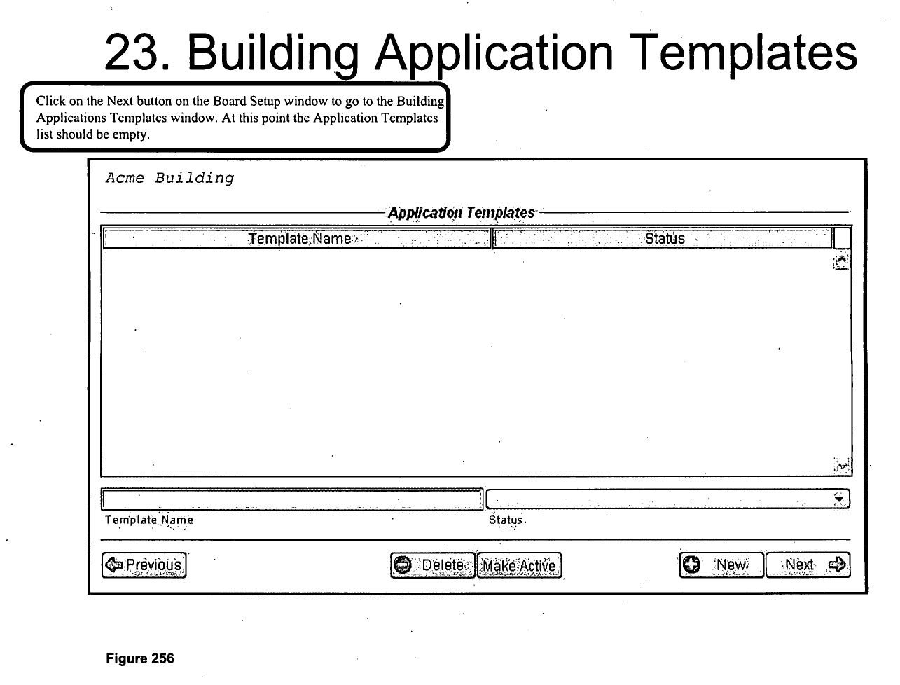

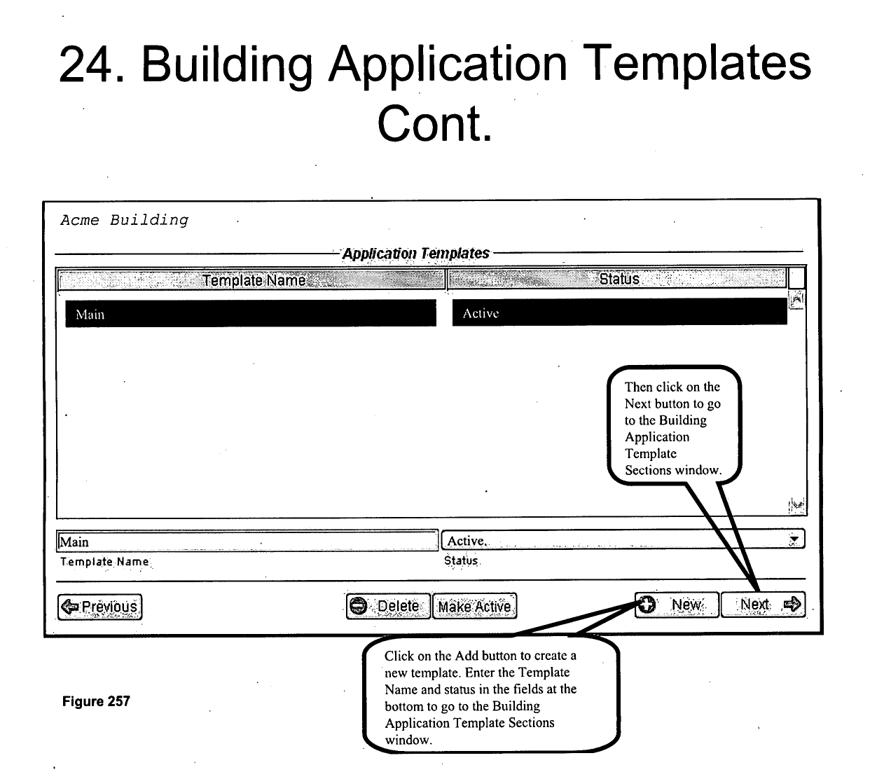

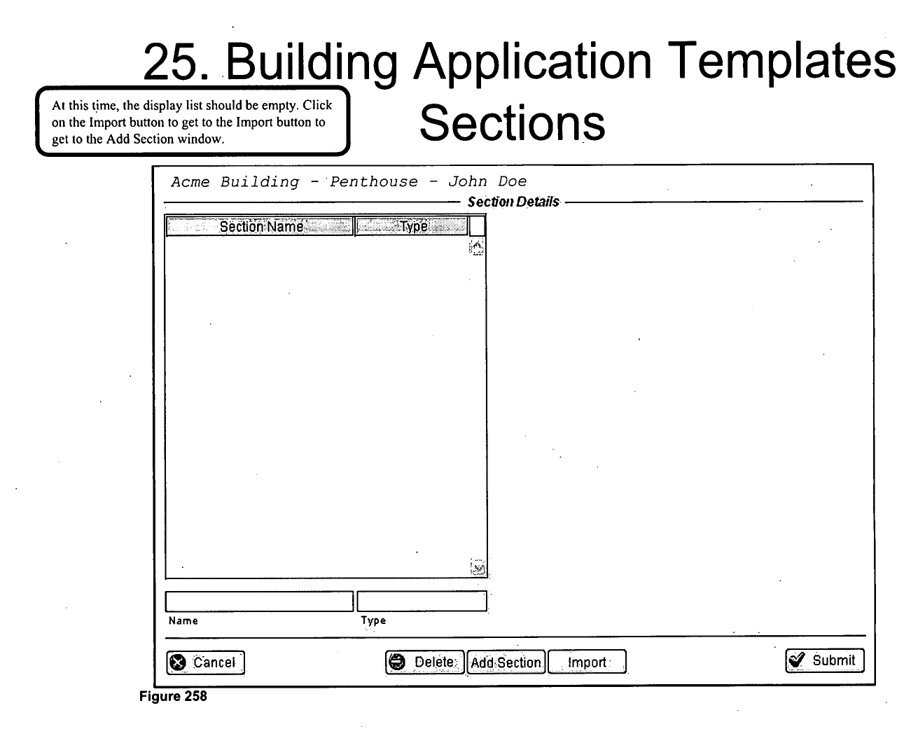

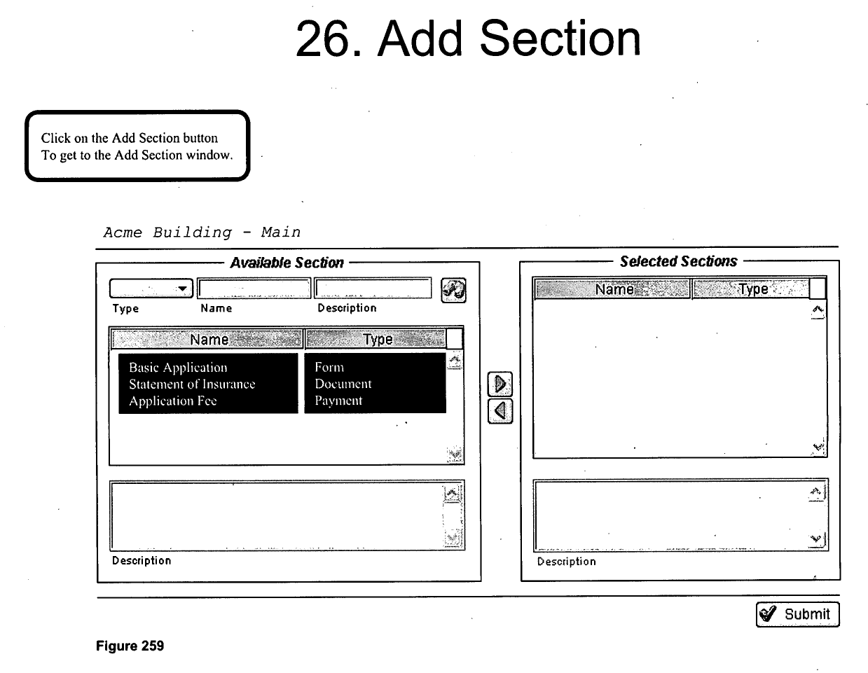

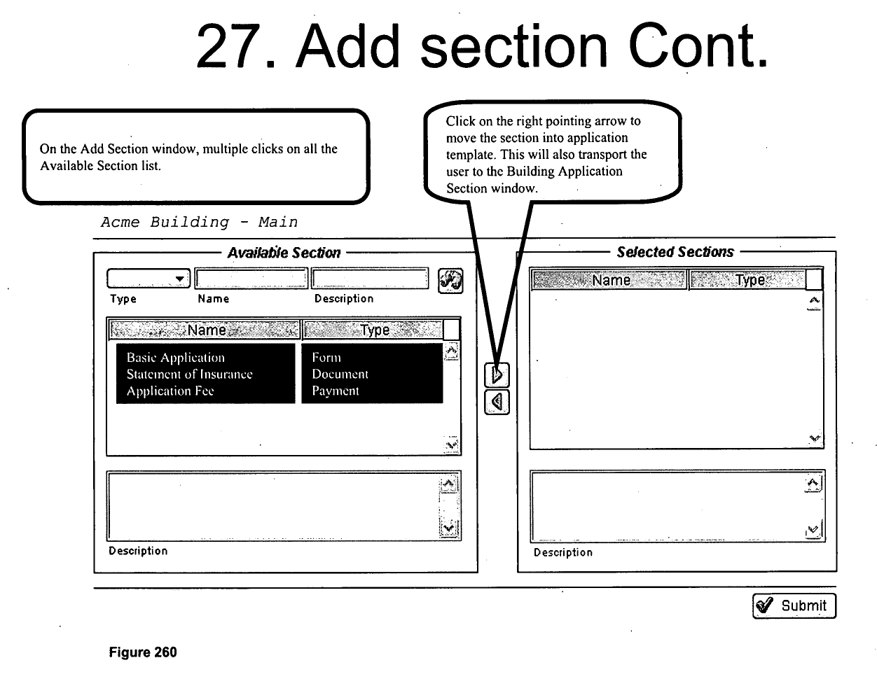

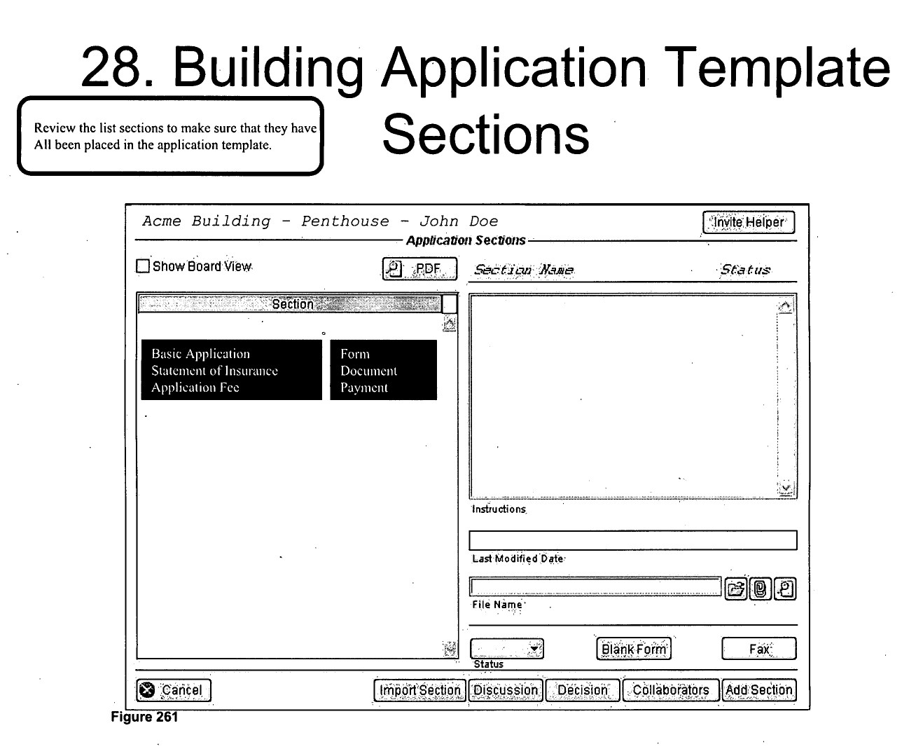

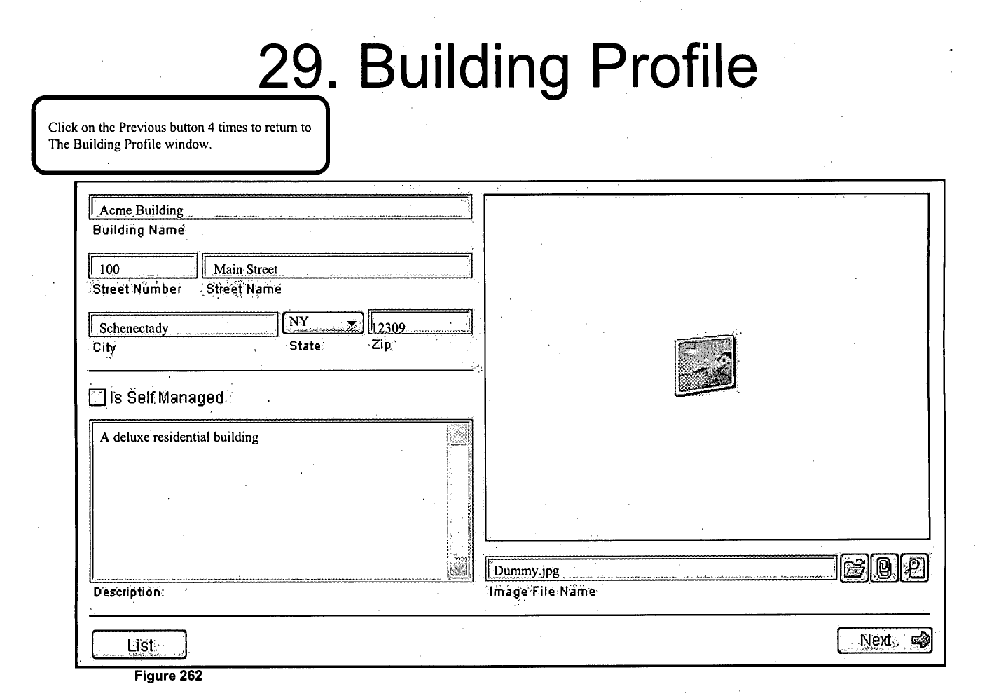

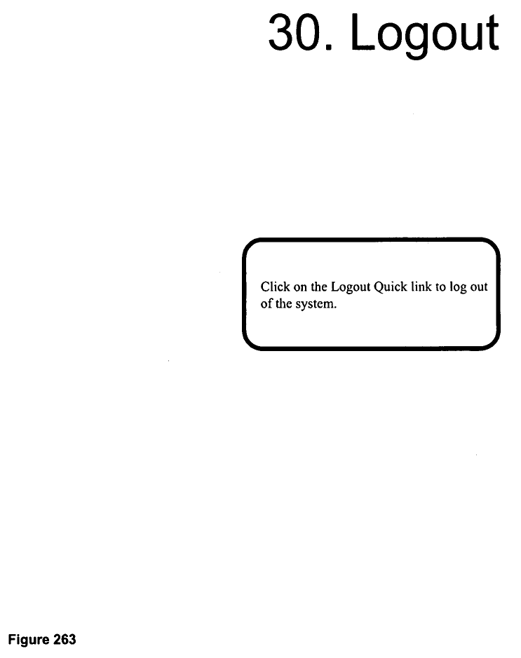

Step 30 (FIG. 263): Click on the Logout Quick Link to log out of the system.

### 13. Appendix D Hardware/Software

The below section is provided as an example. Depending on the specific requirements of a project, a Hardware/Software section may or may not be included.

13a. Overview and Assumptions

The following assumptions have been derived from the non-functional requirements.

The recommended hardware/software deployment listed in this document is only one possible architecture. An alternative Linux/Open Source architecture may also be used, as well as future software/hardware deployments considered for web applications.

13b. One Recommended Hardware/Software Deployment

1) Cisco PIX firewall appliance
2) Internet connection (3 megabits per second with fixed IP address)
3) Microsoft Server for IIS and main database.
a) Dell Power Edge 2850, 2×3.4 Ghz Xeon, 2 GB RAM, Dual NIC
b) Microsoft 2003 Server operating system
c) Microsoft Internet Information Server (IIS)
d) Microsoft SQL Server
e) SSL Certificate
f) ObjectBuilders software
g) Software for processing incoming documents via facsimile
h)-Software for processing Paypal transactions
i) Software for processing credit card transactions
   4) Microsoft Server for document database
a) Dell Power Edge 2850, 2×3.4 Ghz Xeon, 2 GB RAM, Dual NIC
b) Microsoft Server 2003 operating system
c) Microsoft SQL Server (bundled with Microsoft Server 2003 Datacenter but not Microsoft Server 2003 Standard)
d) 300 Gigabytes disk storage for handling documents (At one thousand application packages per year, this should provide sufficient storage for almost ten years. See Business Logic for details.)

13c. Disk Utilization

The assumption is that the incremental disk space requirement on the system housing the document database is ten megabytes per building and thirty megabytes per application package (600 pages at 50 kilobytes per page). For 200 buildings with 1000 application packages, this amounts to two gigabytes plus thirty gigabytes a year.

For the main database, an assumption for the incremental disk space requirement is ten kilobytes per building and twenty kilobytes per application package. This translates to two megabytes plus twenty megabytes a year. This is insignificant compared to the storage requirements for the other software on the system.

Better estimates can be made as experience is gained with the system.

13d. Client System Requirements

The configuration of the client systems for the various users is not within the control of the people in control of the serving systems. However, the client systems should preferably contain the following items:
a. A means of scanning documents to generate a file using TIFF format and the ability to view TIFF files.
b. A means of viewing and editing PDF files. The latest version of Adobe Acrobat Reader should be satisfactory for this purpose.
c. A web browser capable of processing HTML with JavaScript. The browser should also be capable of downloading and uploading files from and to the server. Microsoft Internet Explorer, Apple Safari, and Firefox should cover the vast bulk of existing systems.
d. The client systems should support 128-bit SSL applications. This may have to be reviewed where the client system is outside the United States.
e. A means of connecting to the internet. A high-speed connection is desirable, but not be required. However, the use of a low-speed connection may require large amounts of time for uploading and downloading files.
   There is no requirement for the ability to handle Java applets, but this capability may be added, if desired.

### 14. Appendix E Supporting Documents

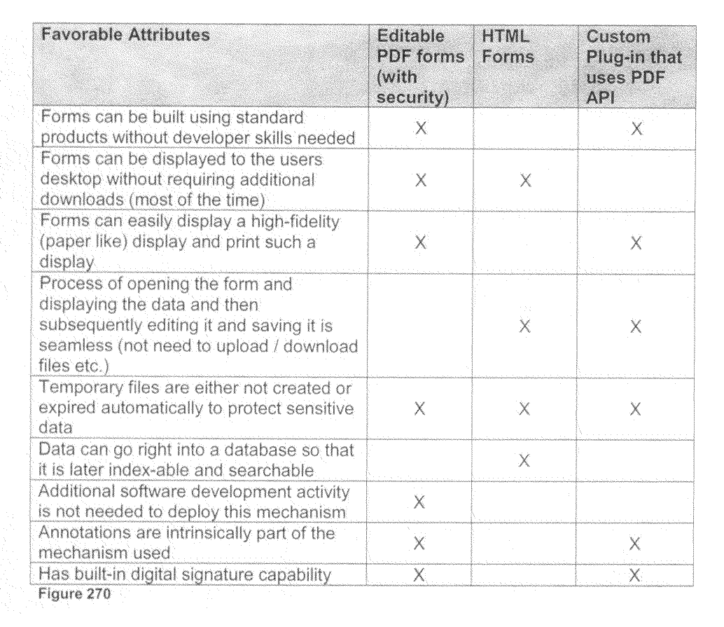

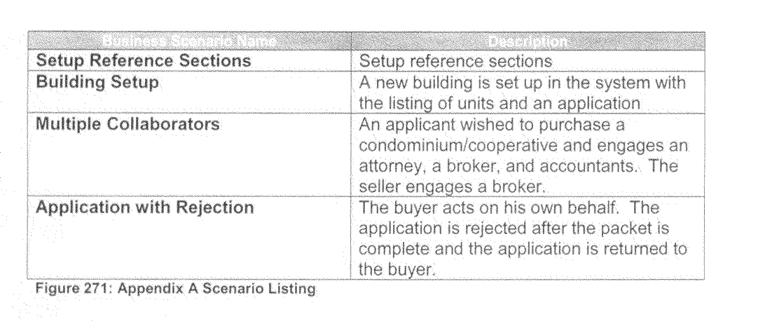

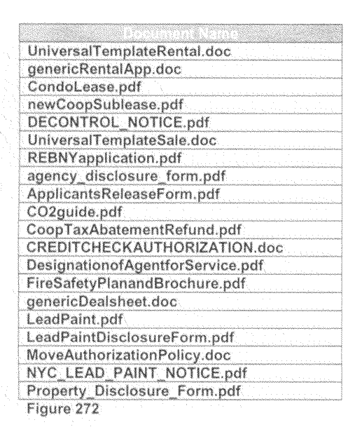

FIG. 272 references a list of supporting documents.

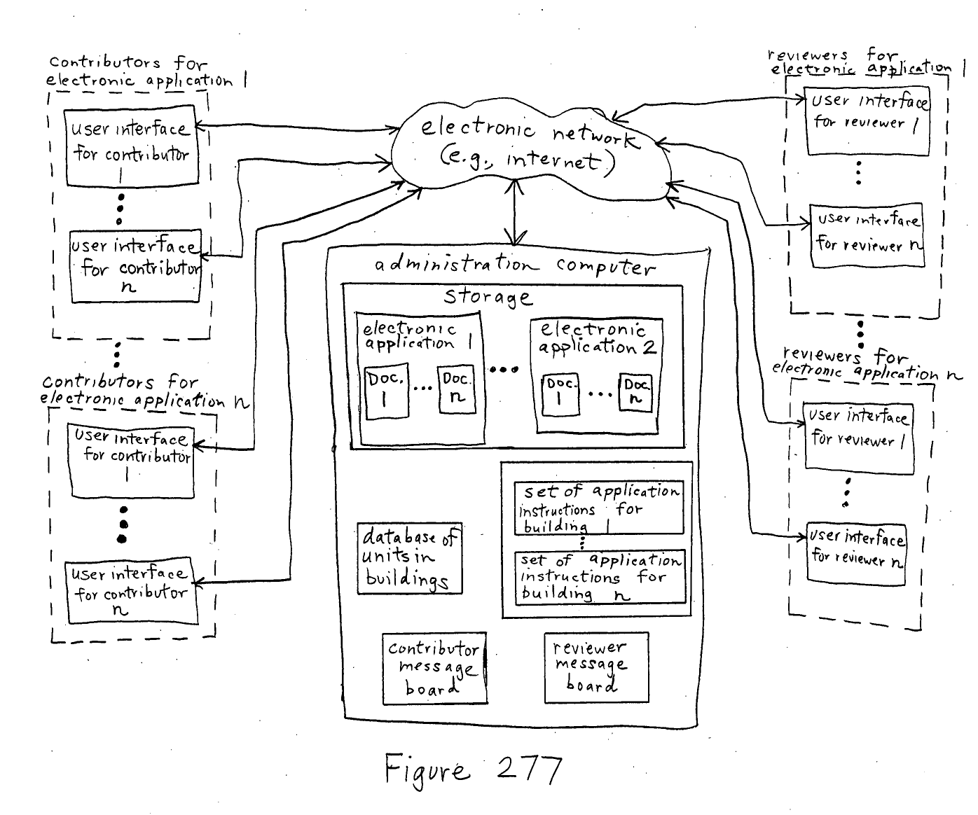

FIG. 277 is a self-explanatory schematic block diagram of one preferred architecture for implementing the present invention.

### IV. CONCLUSION

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media is encoded with computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A computer-implemented method of applying to purchase or lease a unit in a multiunit building or building complex, the method comprising:
(a) providing an administration computer for hosting:
(i) a plurality of electronic applications for purchase or lease of a unit in a multiunit building or building complex, each electronic application including one or more electronic documents that are useful for evaluating factors relevant to an applicant's potential purchase or lease of the unit,
(ii) one or more contributors, and
(iii) a plurality of reviewers;
(b) the one or more contributors and the plurality of reviewers interacting with an electronic application via an electronic network;
(c) the one or more contributors contributing to the one or more electronic documents of the electronic application so as to produce the electronic application; and
(d) the plurality of reviewers accessing the one or more electronic documents of the electronic application so as to review the electronic documents and decide whether to accept the application.

2. The method of claim 1 further comprising:
(e) the administration computer receiving an indication that the electronic application is finished, wherein step (d) further comprises the plurality of reviewers accessing the one or more electronic documents of the finished electronic application so as to review the electronic documents and decide whether to accept an application.

3. The method of claim 2 wherein the step of the administration computer receiving an indication that the electronic application is finished further comprises one or more of the contributors indicating when the electronic application is finished.

4. The method of claim 2 wherein the electronic application requires a predetermined set of electronic documents, and the step of the administration computer receiving an indication that the electronic application is finished further comprises the administration computer automatically determining when the electronic application is finished by monitoring when all of the electronic documents in the predetermined set of electronic documents are present and completed.

5. The method of claim 1 wherein there are a plurality of contributors and in step (c), a plurality of contributors contribute to a plurality of different electronic documents to the electronic application.

6. The method of claim 5 wherein different contributors contribute to different electronic documents.

7. The method of claim 1 further comprising:
(e) the one or more contributors and the plurality of reviewers interacting with the electronic application via respective user interfaces connected to the electronic network.

8. The method of claim 7 further comprising:
(f) the administration computer calculating an amount of environmental resources being saved by using the computer-implemented method compared to printing out the electronic application; and
(g) displaying the amount of saved environmental resources on one or more of the user interfaces.

9. The method of claim 1 wherein the administration computer further hosts:
(iv) a database of units in a plurality of different multiunit buildings or building complexes that are available for purchase or lease, wherein the electronic application is an application for purchase or lease of one of the units in the database.

10. The method of claim 9 wherein the administration computer further hosts:
(v) a plurality of sets of application instructions, each set of application instructions being associated with a particular multiunit building or building complex, wherein the interactions with the electronic application by the one or more contributors depend in part upon the set of application instructions associated with a particular multiunit building or building complex that the electronic application relates to.

11. The method of claim 1 wherein there are a plurality of contributors, the method further comprising:
(e) one or more of the contributors inviting one or more of the other contributors to contribute to the electronic application via the electronic network.

12. The method of claim 1 wherein there are a plurality of contributors who contribute to the one or more electronic documents and step (c) further comprises one or more of the contributors contributing to the one or more electronic documents by adding a new electronic document or editing content to an existing electronic document, and one or more of the other contributors contributing to the one or more electronic documents by reviewing, commenting on, or approving an existing electronic document.

13. The method of claim 1 wherein the electronic application is used to apply to purchase a unit in a multiunit building or building complex, and one or more of the electronic documents relate to ownership conveyance of the unit.

14. The method of claim 1 wherein there are a plurality of contributors, and in step (a), the administration computer further-hosts:
(iv) a first message board for allowing the plurality of contributor to share messages with each other about the one or more electronic documents, and a second message board for allowing the plurality of reviewers to share messages with each other about the electronic application.

15. The method of claim 1 wherein the multiunit building or building complex is a cooperative.

16. The method of claim 1 wherein the multiunit building or building complex is a condominium.

17. The method of claim 1 further comprising:
(e) posting to the administration computer an approval or rejection of the electronic application.
